(19) United States
(12) Patent Application Publication
(10) Pub. No.: US 2007/0297064 A1
(43) Pub. Date: Dec. 27, 2007

(54) Display Device

(75) Inventors: Shinji Watanabe, Hyogo (JP); Katsuhiro Yasuda, Hyogo (JP); Eiji Miyazawa, Hyogo (JP); Nobuaki Kajimoto, Hyogo (JP); Kenichi Koujimoto, Hyogo (JP); Kiyoshi Hamatani, Hyogo (JP); Tomonori Takeuchi, Hyogo (JP); Takako Fukuda, Hyogo (JP); Yoshihide Ootani, Hyogo (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI, HYOGO (JP)

(21) Appl. No.: 11/666,030

(22) PCT Filed: Oct. 26, 2005
(86) PCT No.: PCT/JP05/20056

§ 371 Date: Apr. 23, 2007

(30) Foreign Application Priority Data
Oct. 27, 2004 (JP) 2004-312778
Dec. 8, 2004 (JP) 2004-355757
Dec. 13, 2004 (JP) 2004-359624
Sep. 9, 2005 (JP) 2005-262571
Sep. 12, 2005 (JP) 2005-263753
Sep. 22, 2005 (JP) 2005-276773

(51) Int. Cl. G02B 27/14; G09G 5/00

(52) U.S. Cl. 359/630; 345/7

(57) ABSTRACT

Even if a driver's seat use picture able to be seen from a driver and not able to be seen from a passenger's seat passenger and a passenger's seat use picture able to be seen from a passenger's seat passenger and not able to be seen from the driver are displayed on the common screen, suitable operational control desired by a user is realized. Means are provided for judging whether operations on operating switches 42_{DR} to 47_{DR} and 42_{PA} to 47_{PA} arranged so that an operating region on the display screen for the driver's seat use picture G_{DR} and an operating region on the display screen for the passenger's seat use picture G_{PA} overlap are from the driver's seat direction or from the passenger's seat direction and performing operational control for the picture able to be seen from that direction.

### FIELD OF THE INVENTION

The present invention relates to a display device, more particularly relates to a display device for providing independent, different information to a plurality of viewers (users) substantially simultaneously on the common screen.

### BACKGROUND OF THE INVENTION

While driving a car, a driver is prohibited from watching television, a movie, etc. Current display devices are therefore sometimes designed not to be able to display television, movies, etc. while the car is moving. For this reason, passengers other than the driver (for example, the passenger in the passenger's seat next to the driver) are also often unable to watch television or a movie in a moving car despite their watching television or a movie not being prohibited.

On the other hand, in recent years, in car-mounted display devices, various technology has been proposed making the content of the display to the driver and the content of display to the passengers other than the driver different. For example, the following Patent Document 1, as shown in FIG. 57, discloses the technology of providing light blocking strips 302, 303 on a transparent cover 301 so that light emitted from a strip-like display unit 304 displaying a driver's seat use picture G_{DR} will reach the eyes of the driver DR, but light emitted from a strip-like display unit 305 displaying a passenger's seat use picture G_{PA} will not reach the eyes of the driver DR. On the other hand, light emitted from the strip-like display unit 305 displaying the passenger's seat use picture G_{PA} reaches the eyes of the passenger's seat passenger PA, but light emitted from the strip-like display unit 304 displaying the driver's seat use picture G_{DR} will not reach the eyes of the passenger's seat passenger PA.

Further, the following Patent Documents 2, 3 disclose display devices able to also simultaneously display two pictures by a single liquid crystal display (LCD) and enable different pictures to be seen from the driver's seat and passenger's seat. Further, the following Patent Documents 4, 5 disclose two-screen display devices displaying two types of pictures simultaneously on the common screen.

By employing such technology, as shown in FIG. 58, it is possible to display a map picture 307 of a navigation system on a display device 306 so as to be able to be seen from the driver DR (so as not to be able to be seen from the passenger's seat passenger PA) and display a DVD picture 308 on the display device 306 so as to be able to be seen from the passenger's seat passenger PA (so as not to be able to be seen from the driver DR). Due to this, even while the car is moving, the passenger's seat passenger PA can watch television or a movie etc.

However, in recent display devices, touch panels are employed and operating switches are formed on the display screens. Therefore, when making the content of display to the driver and content of display to the passengers other than the driver different, as shown in FIG. 59, the display image to the driver and the display image to the passengers other than the driver may display the operating switches B_{D1} to B_{D6} and B_{A1} to B_{A6} for the contents of display.

The operating switches B_{D1} to B_{D6} are designed to be able to be seen only by the driver, while the operating switches B_{A1} to B_{A6} are designed to be able to be seen only by the passenger's seat passenger. As shown in FIG. 60, the operating switches B_{D1} to B_{D6} are arranged in same operating regions, that is, the regions P₁ to P₆, as the operating switches B_{A1} to B_{A6} on the display screen. In this way, arrangement of operating switches of the different images at regions of the same operating region on the display screen will be referred to as “the same” or “overlapping”.

For this reason, when for example the region P₅ on the display screen is depressed, whether control in the case where the operating switch B_{D5} “Details” is depressed (control for displaying map picture in more detail) is to be performed or control in the case where the operating switch B_{A5} “Stop” is depressed (control for stopping playback of DVD picture) is to be performed must be suitably judged. In other words, if this judgment cannot be suitably made, suitable operational control desired by the user can no longer be performed.

Further, Patent Documents 6 and 7 disclose barriers for limiting the viewing direction for displaying a 3D image.

From the viewpoint of safety, in Japan, drivers are prohibited from watching television or a movie etc. while driving, so in current car-mounted display devices, a display image such as television or a movie which might be watched by a driver cannot be displayed while the car is moving. For this reason, a passenger other than the driver, for example, the passenger in the passenger's seat next to the driver, cannot watch television or a movie while the car is moving despite his or her watching television or a movie etc. not being prohibited.

On the other hand, in car-mounted display devices, various technology has been proposed for making the content of display to the driver and the content of display to passengers other than the driver different. For example, Patent Document 3, as shown in FIG. 75, discloses arranging a parallax barrier 26′, comprised of a display device sheet member 146 on the front and back surfaces of which light blocking strips 142, 144 are provided, at the front surface side of a liquid crystal panel 21, displaying the driver use display image at the right side (driver's seat side) display use pixels 110 set at every other pixel at the liquid crystal panel 21, and displaying the passenger's seat use display image at the left side (passenger's seat side) display use pixels 109 arranged between the right side (driver's seat side) display use pixels 110. In this display device, by providing the light blocking strips 142, 144, the light emitted from the right side (driver's seat side) display use pixels 110 displaying the driver's seat use display image reaches the eyes of the driver 11, but the light emitted from the left side (passenger's seat side) display use pixels 109 displaying the passenger's seat use display image does not reach the eyes of the driver 11, while the light emitted from the left side (passenger's seat side) display use pixels 109 displaying the passenger's seat use display image reaches the passenger's seat passenger 8, but the light emitted from the right side (driver's seat side) display use pixels 110 displaying the driver's seat use display image does not reach the passenger's seat passenger 8.

By employing such a display device for a car-mounted display device, as shown in FIG. 76, it is possible to display a map display image 5 from the navigation system so as to be able to be seen from the driver 11, but not to be able to be seen from the passenger's seat passenger 8 and to display a DVD display image 8 from a DVD player so as to be able to be seen from the passenger's seat passenger 8 but not to be able to be seen from the driver 11. Due to this, the passenger's seat passenger 8 can watch television or a movie etc. even when the car is moving.

Note that while explained in detail later, arrangement of operating switches of the different images at regions of the same operating region on the display screen will be referred to as “the same” or “overlapping”, while arrangement of operating switches of the different images at positions of different operating regions on the display screen such as the termination switches 41_{DR}, 41_{PA} shown in FIG. 12 will be referred to as “not overlapping”.

Patent Document 1: Japanese Unexamined Patent Publication No. 2003-137005

Patent Document 2: Japanese Unexamined Patent Publication No. 6-186526

Patent Document 3: Japanese Unexamined Patent Publication No. 2000-137443

Patent Document 4: Japanese Unexamined Patent Publication No. 11-331876

Patent Document 5: Japanese Unexamined Patent Publication No. 9-46622

Patent Document 6: Japanese Unexamined Patent Publication No. 10-123461

Patent Document 7: Japanese Unexamined Patent Publication No. 11-84131

### SUMMARY OF THE INVENTION

The present invention has as its object the provision of a display device wherein suitable operational control desired by the user can be performed even if individual information is displayed on the common screen for a plurality of viewing directions, for example, even if a driver's seat use picture which can be seen from the direction in which the driver is present and cannot be seen in the direction in which the passenger's seat passenger is present and a passenger's seat use picture which can be seen from the direction in which the passenger's seat passenger is present and cannot be seen in the direction in which the driver is present are displayed on the common screen.

In particular, in a car-mounted display device, often various input (operations) are performed while monitoring and viewing an image to try to obtain new information. However, when different images are displayed for the driver's seat side and passenger's seat side etc., no clear indication is given as to which operation to perform from the different seat sides when using images of operation buttons displayed on the display unit.

Therefore, the present invention has as another object to provide a display device able to simultaneously display a plurality of images wherein suitable input (operation) from an individual operator viewing each image is possible.

In the above-mentioned car-mounted display device, as the input means, sometimes a touch panel arranged overlaid on the display screen of the display device and a remote operation device wirelessly connected to the display device (usually called a “remote controller”) are employed. When using a touch panel, operating switches are displayed on the display screen of the display device. By the user depressing a region corresponding to an operating switch on the touch panel, the input of the operating switch is performed. Therefore, when making the content of display to the driver and the content of display to a passenger other than the driver different, operating switches for different contents of display may be displayed at the same location on the display screen.

For example, when the content of display to the driver is the operation input screen of a navigation system and the content of display to a passenger other than the driver is the operation input screen of a DVD player, the operating switch displayed at the same location may be an operating switch for the navigation system for the driver and an operating switch for the DVD player for the passenger other than the driver. In this case, when the region corresponding to the operating switches on the touch panel is depressed, which content of display of operating switch has been depressed, that is, whether to perform control for the operating switch for the navigation system or to perform control for the operating switch for the DVD player, must be suitably judged.

Further, even when using a remote controller, whether the input of an operating switch of the remote controller is input corresponding to the content of display to the driver or input corresponding to the content of display to a passenger other than the driver must be suitably judged.

Therefore, the present invention has still another object the provision of a control system enabling suitable operation desired by the user to be performed in a state where individual display images for a plurality of viewing directions are displayed on the common screen of a display unit.

A display device (1) of the present invention includes a display unit for displaying individual information for a plurality of viewing directions on the common screen, an operation inputting unit for receiving operation input, an input direction judgment unit for judging which information among the individually displayed information corresponds to the operation input, and a control unit for performing control based on the results of judgment of the input direction judgment unit.

According to the invention, for example, whether operation input has been performed for the driver's seat side or has been performed for the passenger's seat side can be judged, so subsequent processing and/or control can be easily performed.

A display device (2) of the present invention includes a display unit for displaying individual information for a plurality of viewing directions on the common screen, an operation inputting unit for receiving operation input, an input direction unit for judging which information among the individually displayed information corresponds to the operation input, and a limiting unit for limiting the information receiving the operation input based on the results of judgment by the input direction judgment unit.

According to the display device (2), whether operation input to operating switches arranged so that the operating region on the display screen for information displayed for a certain specific viewing direction (for example, driver's seat use picture G_{DR}) and the operating region on the display screen for other information displayed for a viewing direction separate from the certain specific viewing direction (for example, passenger's seat use picture G_{PA}) (for example, operating switches arranged in the same region E₃ such as the operating switches 42_{DR}, 42_{PA} shown in FIG. 12) overlap corresponds to information displayed for the certain specific viewing direction (for example, direction in which the driver DR is present) or corresponds to information displayed for the other viewing direction (for example, direction in which the passenger's seat passenger PA is present) is judged and the information receiving the operation input is limited based on the results of judgment.

For example, when operating switches arranged so that the operating region on the display screen for the driver's seat use picture G_{DR} and the operating region on the display screen for the passenger's seat use picture G_{PA} overlap are operated from the direction in which the driver DR is present, just the operation for the driver's seat use picture G_{DR} is validated and the operation for the passenger's seat use picture G_{PA} is invalidated. Therefore, suitable operational control desired by the user can be realized.

In this way, even when operating switches arranged so that the operating region on the display screen for the driver's seat use picture G_{DR} and the operating region on the display screen for the passenger's seat use picture G_{PA} overlap are operated, the operational control desired by the user can be realized. In other words, since it is possible to arrange operating switches of different properties in the same region E₃ such as the operating switches 42_{DR}, 42_{PA} shown in FIG. 12, the display screen can be more effectively utilized.

Note that as methods for judging if an operation on operating switches arranged so that the operating region on the display screen for a picture displayed for a certain specific viewing direction (for example, driver's seat use picture G_{DR}) and the operating region on the display screen for a picture displayed for a viewing direction separate from the certain specific viewing direction (for example, passenger's seat use picture G_{PA}) overlap corresponds to information displayed for the certain specific viewing direction (for example, direction in which the driver DR is present) or corresponds to information displayed for the separate viewing direction (for example, direction in which the passenger's seat passenger PA is present), for example, the following a to e may be mentioned.

a) Judgment from direction in which object (finger) approaches touch panel.
i) Firing of infrared rays in vertical direction of touch panel and judgment from which of left or right the object approached from location where the infrared rays were blocked.

b) Judgment from difference in mode of operation.
i) Judgment from difference in depression pressure.
ii) Judgment from difference in depression time.
iii) Judgment from difference in number of times of depression (number of clicks).

c) Giving different objects (devices) to the driver DR and passenger's seat passenger PA and judgment from the object (device).
i) Attaching transmitters of different emitted frequencies or emitted codes etc. to fingers of two and judgment from the differences.
ii) Attaching objects enabling identification from judgment image (rings of different colors) to fingers and judgment from the differences.

d) Bioauthentication (fingerprint part etc.)

e) Judgment from whether an individual is present in that location.
i) Judgment that operation is from driver's seat direction when there is no passenger's seat passenger PA and on the other hand judgment that operation is from passenger's seat direction when there is no driver DR.

Further, a display device (3) of the present invention includes a display unit for displaying individual information for a plurality of viewing directions on the common screen, a first operation input unit arranged in a first region and receiving operation input corresponding to first information among the individually displayed information, and a second operation input unit arranged in a second region not overlapping the first region and receiving operation input corresponding to second information among the individually displayed information.

According to the display device (3), the first operation input unit receiving operation input corresponding to the first information (for example, driver's seat use picture G_{DR}) is arranged at a first region (for example, top side of touch panel), while the second operation input unit receiving operation input corresponding to the second information (for example, passenger's seat use picture G_{PA}) is arranged at a second region not overlapping the first region (for example, bottom side of touch panel).

Therefore, whether operation input was made from the driver's seat direction or was made from the passenger's seat direction, that is, from which direction operation input was made, need not be judged any longer, so the cost can be reduced. Further, in the case of right side steering wheel cars, if arranging an operating switch for receiving only operation input corresponding to the driver's seat use picture G_{DR} at the right side of the touch panel and arranging an operating switch for receiving only operation input corresponding to the passenger's seat use picture G_{PA} at the left side of the touch panel, operation becomes extremely easy.

Further, in a display device (4) of the present invention according to the display device (3), the first operation input unit and the second operation input unit are constituted as a touch panel, the second region is close to the first region, and the layout of the second operation input unit on the screen is substantially the same as the layout of the first operation input unit on the screen.

According to the display device (4), even if the first operation input unit and the second operation input unit are arranged in not overlapping regions (see FIG. 38), their layouts become the same (see FIG. 37). Therefore, even if the viewing direction changes, since the layouts of the operation input units do not change, user friendliness is improved.

Further, a display device (5) of the present invention according to the display device (3) or (4) includes an input direction judgment unit for judging which information among the individually displayed information corresponds to the operation input and an execution control unit for not allowing execution of operational control in accordance with the operation input corresponding to information displayed for a direction different from a certain specific viewing direction when the input direction judgment unit judges that the operation input corresponds to information displayed for the certain specific viewing direction.

When operating switches are provided in the same region E₃ such as the operating switches 42_{DR}, 42_{PA} shown in FIG. 12, unless adding some sort of restrictions to operations, sometimes operational control not desired by the user will be performed. However, different from this, when these are provided in different regions (see FIG. 33, FIG. 34), operational control not desired by the user can be avoided even without restricting operations.

However, the driver DR cannot see the passenger's seat use picture G_{PA} and further the passenger's seat passenger PA cannot see the driver's seat use picture G_{DR}. Therefore, the driver DR cannot accurately recognize the positions of the operating switches provided on the passenger's seat use picture G_{PA}, so is liable to end up touching an operating switch provided on the passenger's seat use picture G_{PA} when intending to touch a part not provided with a driver DR operating switch. Therefore, even if providing operating switches for receiving only operation input corresponding to the driver's seat use picture G_{DR} and operating switches for receiving only operation input corresponding to the passenger's seat use picture G_{PA} in not overlapping regions, it is desirable to add some sort of restriction to operations.

According to the display device (5), when it is judged that the operation input corresponds to information displayed for the certain specific viewing direction (for example, direction in which the driver DR is present), execution of operational control in accordance with the operation input corresponding to information (for example, movie image of DVD player) displayed for a direction different from a certain specific viewing direction (for example, direction in which passenger's seat passenger PA is present) is not allowed.

For example, when the operating switch 52_{DR} (see FIG. 33) for receiving only operation input corresponding to the driver's seat use picture G_{DR} is operated on from the driver's seat direction, that operation is validated, but when the operating switch 52_{PA} for receiving only operation input corresponding to the passenger's seat use picture G_{PA} is operated on, that operation is invalidated. Due to this, it is possible to more reliably prevent erroneous operation of the passenger's seat use picture G_{PA} from the driver's seat direction.

Further, in a display device (6) of the present invention according to any one of the display devices (3) to (5), the input direction judgment unit judges which information among the individually displayed information the operation input corresponds to based on the contact area of an object with the first operation input unit and the second operation input unit.

Even if the first operation input unit and the second operation input unit are arranged in not overlapping regions, the situation might occur where a finger or other object simultaneously touches both. In particular, the chance of this is high when the regions in which these operation input units are arranged are close.

According to the display device (6), the operation input judges which information among the individually displayed information is corresponded to based on the contact area of an object (for example, finger) on these operation input units (area of mark of touch of finger). For example, when two operation buttons are touched simultaneously, the operation of the operation button of the larger contact area side is judged to be desired by the user. Due to this, even if a further plurality of operation buttons are touched simultaneously, suitable processing can be performed.

Further, a display device (7) of the present invention according to any one of the display devices (2) to (5), includes a plurality of detection units provided in a direction perpendicular to the screen and detecting an object approaching the screen and the input direction judgment unit judges which information among the individually displayed information the operation input corresponds to based on information obtained from the detection units.

According to the display device (7), since the detection units are provided in a plurality of levels in a direction perpendicular to the screen, for example, the direction of approach of the object to the screen can be found from a line connecting a point of the object detected by a detection unit provided at the top level and a point of the object detected by a detection unit provided at the bottom level.

If the direction of approach of the object to the screen is found, from which direction the operation input comes is learned. Therefore, by using information obtained from the detection unit, which information among the individually displayed information the operation input corresponds to can be judged with a good accuracy.

Further, a display device (8) of the present invention according to any one of the display devices (2) to (5), includes a detection unit for detecting an object approaching the screen from a certain direction and the input direction judgment unit judges which information among the individually displayed information corresponds to the operation input based on information obtained from the detection unit.

According to the display device (8), the content of detection is simple, but which information of the individually displayed information the operation input corresponds to can be judged. Note that as the detection unit, a heat sensitive sensor detecting the heat of an object (for example, a finger), an infrared ray human sensitive sensor emitting infrared rays and detecting infrared rays reflected from the finger, an air pressure sensor detecting changes in air pressure, etc. may be mentioned.

Further, a display device (9) of the present invention according to any one of the display devices (2) to (5), includes a calculation unit for calculating a direction of a finger touching the screen and the input direction judgment unit judges which information among the individually displayed information the operation input corresponds to based on the direction of the finger touching the screen calculated by the calculation unit.

When the screen is touched from the driver's seat side set at the right side, as shown in FIG. 54(a), the finger faces upward slanted to the left. On the other hand, when the screen is touched from the passenger's seat side set at the left side, as shown in FIG. 54(b), the finger faces upward slanted to the right. In other words, if the direction of the finger is known, the direction of approach of the finger to the screen is known.

According to the display device (9), the direction of the finger touching the screen is calculated and from which direction the operation input is from is judged based on the calculated direction of the finger. Therefore, it is possible to suitably judge which information among the individually displayed information the operation input corresponds to.

Further, a display device (10) of the present invention according to the display device (9) includes a decision unit for determining the method by which the finger touches the screen and the input direction calculation unit considers the method by which the finger touches the screen determined by the decision unit to judge which information among the individually displayed information corresponds to the operation input.

The contact mark of the finger touching the screen is generally an oval shape. Further, the tip part of the finger is often used to touch the screen. For this reason, when touched from the driver's seat side, as shown in FIG. 54(a), the contact mark of the finger is inclined to the right, while when touched from the passenger's seat side, as shown in FIG. 54(b), the contact mark of the finger is inclined to the left. Accordingly, the direction of the finger can be understood from this inclination.

However, the tip part of the finger is not always used to touch the screen. The flat part of the finger may also be used to touch the screen. When using the flat part of the finger, the direction of the oval shape of the mark of the finger differs from the case of use of the tip part of the finger. When touched from the driver's seat side, as shown in FIG. 54(a), the contact mark of the finger inclines to the left, while when touched from the passenger's seat side, as shown in FIG. 54(b), the contact mark of the finger inclines to the right.

According to the display device (10), the method of touching the screen by the finger is determined, the determined method of touching the screen by the finger (use of tip part and use of flat part) is considered, and from which direction the operation input came is judged. Therefore, the judgment of which information among the individually displayed information the operation input corresponds can be performed more suitably.

Further, in a display device (11) of the present invention according to the display device (10), the decision unit decides the method of touching the screen by the finger based on any of a magnitude of the contact area of the finger on the screen, a change in contact area of the finger on the screen, the method of applying pressure on the screen, and prerecorded information.

Between the case where the tip part of the finger contacts the screen and the case where the flat part contacts it, the latter is larger in contact area. Therefore, when the contact area of the finger on the screen is large, it is judged that the screen has been touched by the flat part, while when the contact area is small, it can be judged that the screen has been contacted by the tip part.

Further, when the screen is touched by the flat part of the finger, the time from when the screen is touched to when there is no longer a change in the contact area becomes longer compared to when touched by the tip part. Therefore, when the time from when the screen is touched to when there is no longer a change in the contact area is long, it is judged that the screen was touched by the flat part, while when the time is short, it is judged that the screen was touched by the tip part.

Further, when the screen is touched by the tip part of the finger, the part where a certain magnitude of pressure or more is applied becomes smaller, while when the screen is touched by the flat part, the part where a certain magnitude of pressure or more is applied becomes larger. Therefore, when the part where a certain magnitude of pressure or more is applied becomes smaller, it is judged that the screen was touched by the tip part, while when the part becomes larger, it is judged that the screen was touched by the flat part.

Further, whether the screen is touched by the tip part of the finger or touched by the flat part does not change with each moment. If the user is the same, it may be considered to be always the same. Therefore, if whether the screen is touched by the tip part or touched by the flat part is registered in advance and that information is used, suitable judgment becomes possible.

According to a display device (11), the method of the finger touching the screen is determined based on the size of the contact area of the finger to the screen, the change of the contact area of the finger to the screen, the method of application of pressure to the screen, and the information registered in advance. Therefore, the method of the finger touching the screen can be suitably determined. Note that the contact area of the finger etc. are affected by the size of the finger, so it is possible to register the size of the finger in advance and use the size relative to the registered size to judge if the contact area is large or small.

Further, in a display device (12) of the present invention according to the display devices (9) to (11), the calculation unit finds an approximation line from a set of points at which the screen has been touched and thereby calculates the inclination of the finger touching the screen.

According to the display device (12), an approximation line is found from the set of points at which the screen was touched and the inclination of the finger touching the screen is calculated from the approximation line. Therefore, the inclination of the finger touching the screen can be suitably found. Note that as the method for finding the approximation line from the set of points, for example, the method of finding it using the least square method may be mentioned.

Further, a display device (13) of the present invention according to any one of the display devices (2) to (5), a calculation unit for calculating the inclination of a fingerprint touching the screen and the input direction judgment unit judges which of the information among the individually displayed information the operation input corresponds to based on the inclination of the fingerprint touching the screen calculated by the calculation unit.

The top of the fingerprint forms an upward projecting arc. Further, the screen is almost always touched by the tip part or flat part of the finger. Therefore, the screen is touched by the arc part of the fingerprint. Further, when the screen is touched from the driver's seat side set at the right side, the finger faces upward slanted to the left and the projecting part of the fingerprint inclines to the left. On the other hand, when the screen is touched from the passenger's seat side set at the left side, the finger faces upward slanted to the right and the projecting part of the fingerprint inclines to the right. In other words, if the direction of the fingerprint is known, the direction of approach of the finger to the screen is also known.

According to the display device (13), the direction of the fingerprint touching the screen is calculated and from which direction the operation input came is judged based on the calculated direction of the fingerprint. Therefore, the judgment can be suitably performed. Further, unlike with the direction of the finger, even if operated by the tip part or flat part, the direction of the fingerprint does not change, so processing can be simplified.

Further, in a display device (14) of the present invention according to any one of the display devices (6) to (13), the input direction judgment unit judges which information among the individually displayed information corresponds to the operation input based on the past results of judgment when the input direction judgment unit cannot be judged which information among the individually displayed information corresponds to the operation input.

According to the display device (14), when which information among the individually displayed information the operation input corresponds to cannot be judged (for example, when which of the right or left the finger faces cannot be judged), which information among the individually displayed information the operation input corresponds to is judged based on the past results of judgment. For example, the same judgment as before is performed. The operation is often repeated by the same individual, so performing the same judgment as before becomes extremely effective.

Further, in a display device (15) of the present invention according to any one of the display devices (6) to (14), individual information for at least the direction in which the driver is present and the direction in which the passenger's seat passenger is present are displayed on the common screen, the input direction judgment unit judges if the operation input corresponds to information displayed for the direction in which the driver is present or corresponds to information displayed for the direction in which the passenger's seat passenger is present, and the system is provided with a switch unit for switching the judgment by the input direction judgment unit to the left or right based on the steering wheel mounting position of the car.

According to the display device (15), since the judgment is switched to the left or right based on the steering wheel mounting position of the car, suitable judgment is possible both when the car is a right side steering wheel car and a left side steering wheel car.

A display device (16) of the present invention includes a display unit displaying individual information for a plurality of viewing directions on the common screen, an operation input unit receiving operation input, and a confirmation information request unit requesting input of confirmation information for the operation input.

When different individual information are displayed for a plurality of viewing directions on the common screen, for example, when the driver's seat use picture able to be seen from the direction in which the driver is present and not able to be seen from the direction in which the passenger seat passenger is present and the passenger's seat use picture able to be seen from the direction in which the passenger's seat passenger is present and not able to be seen from the direction in which the driver is present are displayed on the common screen, as explained in the section of the “BACKGROUND OF THE INVENTION”, the chance of operational control different from that desired by the user being performed becomes higher.

According to the display device (16), input of confirmation information for the operation input is demanded and the user can confirm the operation input or cancel it, so operational control different from that desired by the user being performed can be prevented. For example, even if an individual present in a certain specific viewing direction (for example, the driver DR) mistakenly touches an operating switch corresponding to information displayed for a direction different from a certain specific viewing direction (for example, the direction in which the passenger's seat passenger PA is present), that operation can be invalidated.

Further, a display device (17) of the present invention according to the display device (16) includes a report unit reporting the content of control according to the operation input.

According to the display device (17), since the content of control according to the operation input is informed to the user, the user can easily judge if his or her own operation is correct or mistaken, so can easily judge if the operation input should be confirmed or cancelled.

Further, in a display device (18) of the present invention according to the display device (16) or (17), the confirmation information input confirms the operation input.

According to the display device (18), an opportunity for confirming the operation input is provided, so the user can perform a confirmation operation if the operation input was correct and thereby confirm the operation input.

Further, a display device (19) of the present invention according to the display device (18) includes an execution control unit allowing the execution of operational control in accordance with operation input corresponding to information displayed for a certain viewing direction when receiving input of a confirmation operation of the operation input corresponding to information displayed for the certain viewing direction while the opportunity for input of the confirmation information is provided.

According to the display device (19), if there is an instruction from the user confirming the operation input, execution of operational control in accordance with the operation input is allowed. In other words, if there is no instruction from the user confirming the operation input, execution of operational control in accordance with the operation input is not allowed. Therefore, execution of operational control different from that desired by the user can be prevented.

Further, in a display device (20) of the present invention according to the display device (16) or (17), the confirmation information input cancels the operation input.

According to the display device (20), an opportunity for canceling the operation input is provided, so if the user errs in his or her operation input, the cancellation operation may be used to cancel the operation input.

Further, a display device (21) of the present invention according to the display device (20) includes an execution control unit allowing the execution of operational control in accordance with operation input corresponding to information displayed for a viewing direction different from a certain viewing direction when receiving input of a cancellation operation of the operation input corresponding to information displayed for the certain viewing direction while the opportunity for input of the confirmation information is provided.

When different individual information are displayed for a plurality of viewing directions on the common screen, for example, as shown in FIG. 12, when the driver's seat use picture G_{DR} and passenger's seat use picture G_{PA} are displayed, as a case of cancellation of operational control in accordance with an operation of operating switches arranged so that the operating region on the display screen for the driver's seat use picture G_{DR} and the operating region on the display screen for the passenger's seat use picture G_{PA} overlap, the case may be considered where the processing for judgment of whether the operation is an operation from the driver's seat direction or an operation from the passenger's seat direction was not suitably performed. For example, the case may be considered where despite the operation being an operation from the driver's seat direction, it is judged an operation from the passenger's seat direction and not operational control for the driver's seat use picture G_{DR}, but operational control for the passenger's seat use picture G_{PA} is about to be performed.

According to the display device (21), when for example operational control for the driver's seat use picture G_{DR} in accordance with an operation on operating switches arranged so that the operating region on the display screen for the driver's seat use picture G_{DR} and the operating region on the display screen for the passenger's seat use picture G_{PA} overlap (for example, operational control in accordance with depression of the operating switch 42_{DR} shown in FIG. 12) is cancelled, operational control for the passenger's seat use picture G_{PA} (for example, operational control in accordance with depression of the operating switch 42_{PA} shown in FIG. 12) is performed. Therefore, not only is it possible to perform operational control not desired by the user from being executed, but also operational control inherently desired by the user is executed.

Further, a display device (22) of the present invention includes a displaying means for displaying different individual information for a plurality of viewing directions on the common screen and an execution controlling means for allowing execution of operational control corresponding to information displayed for not for a viewing direction different from a certain specific viewing direction, but for the certain specific viewing direction based on information obtained from a certain operation device.

According to the display device (22), execution of operational control corresponding to information displayed not for a viewing direction different from the certain specific viewing direction (for example, the direction in which the driver DR is present) (for example, the direction in which the passenger's seat passenger PA is present), but for the certain specific viewing direction is allowed based on information obtained from the certain operation device (for example, a remote controller). Therefore, when using the certain operation device, only operational control corresponding to information displayed for the certain specific viewing direction is performed, so erroneous operation can be simply prevented.

A display device (23) of the present invention includes a display unit for displaying individual display images for a plurality of viewing directions on the common screen, an operation input unit provided in the display unit, and a control unit for adjusting the display positions of the operation input images showing the operation input positions of the operation input unit for the different viewing directions displayed on the display unit.

Further, in a display device (24) of the present invention according to the display device (23), the control unit adjusts the display position of the operation input image so that the display positions of the operation input images corresponding to the different viewing directions do not overlap on the display unit.

Further, in a display device (25) of the present invention according to the display devices (23) or (24), the control unit adjusts the display position of another operation input image corresponding to another viewing direction among a plurality of viewing directions in accordance with the display position of an operation input image corresponding to one viewing direction in the plurality of viewing directions.

Further, in a display device (26) of the present invention according to the display device (23), the control unit adjusts a display position of an operation input image corresponding to one viewing direction in a plurality of viewing directions and a display position of another operation input image corresponding to another viewing direction in the plurality of viewing directions.

Further, a display device (27) of the present invention according to any one of the display devices (23) to (26) includes an operator identifying unit for identifying an operator and the control unit adjusts the display position of the operation input image based on the identification result of the operator identifying unit.

Further, in a display device (28) of the present invention according to any one of the display devices (23) to (27), the control unit adjusts the display position of the operation input image in accordance with the source corresponding to the display image.

Further, in a display device (29) of the present invention according to any one of the display devices (23) to (28), the system further has a selection unit for selecting a specific pattern from a plurality of operation input image position patterns predetermining display positions of operation input images and the control unit adjusts the display position of an operation input image based on the pattern selected by the selection unit.

Further, a display device (30) of the present invention according to any one of the display devices (23) to (29) includes a registration unit independently registering display positions of operation input images by different viewing directions.

Further, a display device (31) of the present invention according to the display device (30) includes a setting unit for setting a display position of the operation input image based on a display position of the operation input image registered in the registration unit.

A method for customizing an operation input image (32) of the present invention includes an adjustment step of adjusting the display position of the operation input image and a registration step of registering an adjusted display position.

Further, a method for customizing an operation input image (33) of the present invention according to the method for customizing an operation input image (32) includes

the adjustment step includes a specification step of specifying specification information specifying at least one of source information and an operator corresponding to the viewing direction and display image and a step of adjusting the display position of the operation input image step linked with the specified specification information, and

the registration step registers the adjusted display position of the operation input image linked with the specified specification information.

Further, a method for customizing an operation input image (34) of the present invention according to the method for customizing an operation input image (32) or (33) includes a reporting step of reporting when the adjusted display position of the operation input image overlaps the display position of an operation input image for another viewing direction.

A method for setting an operation input image of a display device (35) of the present invention includes a specification step of specifying specification information specifying at least one of source information and an operator corresponding to the viewing direction and display image and a step of setting the operation input image to a prestored display position of the operation input image corresponding to the specified specification information.

Further, in a method for setting an operation input image of a display device (36) of the present invention according to the method for setting an operation input image of a display device (35), the setting step includes a movement step of moving a display position of the operation input image for at least one viewing direction when the display position of the operation input image for one viewing direction and the display position of the operation input image for another viewing direction overlap.

Further, in a method for setting an operation input image of a display device (37) of the present invention according to the method for setting an operation input image of a display device (35), the setting step includes a reporting step of reporting when the display position of the operation input image for one viewing direction and the display position of the operation input image for another viewing direction overlap.

A display device (38) of the present invention includes a display unit able to display a first image able to be viewed in a first direction and a second image able to be viewed in a second direction, a control unit making the display unit display the first image and second image, and a touch panel arranged at a front surface of the display unit, the control unit adjusting display positions of input receiving images at the first image and second image displayed on the display unit so that the operation input positions on the touch panel at the first direction and second direction do not overlap.

Further, in a display device (39) of the present invention according to the display device (38), the control unit adjusts the display position of one input receiving image of the first image and second image in accordance with the position of the other input receiving image.

Further, in a display device (40) of the present invention according to the display device (38), the control unit adjusts the display positions of the input receiving images in accordance with both the directions of the first direction and second direction.

Further, a display device (41) of the present invention according to any one of the display devices (38) to (40) includes an operator identifying unit for identifying the operator and the control unit adjusts a display position of an input receiving image for each operator based on the identification result in the operator identifying unit.

Further, in a display device (42) of the present invention according to the display device (40) or (41), the control unit adjusts the display position of an input receiving image in accordance with the source of the image.

Further, a display device (43) of the present invention according to any one of the display devices (38) to (42) includes a pattern selection unit provided with a plurality of input receiving image display position patterns predetermining display positions of input receiving images and selecting an input receiving image display position pattern and the control unit adjusts the display patterns of the input receiving images in accordance with the selection by the pattern selection unit.

A display device (44) of the present invention includes a display unit able to display a first image able to be viewed in a first direction and a second image able to be viewed in a second direction, a control unit making the display unit display the first image and second image, and a touch panel arranged at a front surface of the display unit and in that the control unit is provided with a registration function for registering the arrangements of input receiving images included in an image displayed on the display unit independently for the first image and second image.

A display device (45) of the present invention includes a display unit able to display a first image able to be viewed in a first direction and a second image able to be viewed in a second direction, a control unit making the display unit display the first image and second image, and a touch panel arranged at a front surface of the display unit, the control unit setting the arrangement of input receiving images included in the image displayed on the display unit independently for the first image and second image when a predetermined operation is performed.

Further, a display device (46) of the present invention according to the display device (45) includes a storing means for storing an arrangement of input receiving images and the control unit reads out the arrangement of input receiving images from the storing means and sets the arrangement of input receiving images included in the image displayed on the display unit.

A method for customizing of display (47) of the present invention in a display device having a display unit able to display a first image able to be viewed in a first direction and a second image able to be viewed in a second direction, a touch panel arranged at a front surface of the display unit, and a control unit making the display unit display the first image and second image, the method includes

a direction determination step of determining a viewing direction, a display position determination step of determining a display position of a display button linked with a viewing direction determined at the direction determination step, and a registration step of registering a display position of a display button determined at the display position determination step.

A method for customizing a display (48) of the present invention in a display device having a display unit able to display a first image able to be viewed in a first direction and a second image able to be viewed in a second direction, a touch panel arranged at a front surface of the display unit, and a control unit making the display unit display the first image and second image, the method includes

a source information determination step of determining the source information, a display position determination step of determining a display position of a display button, and a registration step of registering a display position of a display button determined at the display position determination step linked with the source information determined at the source information determination step.

A method for customizing a display (49) of the present invention in a display device having a display unit able to display a first image able to be viewed in a first direction and a second image able to be viewed in a second direction, a touch panel arranged at a front surface of the display unit, and a control unit making the display unit display the first image and second image, the method includes

an operator identification step of identifying an operator, a display position determination step of determining a display position of a display button, and a registration step of registering a display position of a display button determined at the display position determination step linked with an operator selected at the operator identification step.

Further, a method for customizing a display (50) of the present invention according to any one of the methods for customizing of the display (47) to (49) includes, between the display position determination step and the registration step, a comparison step of comparing a display position of a display button already registered in a direction different from a viewing direction selected at the direction section step and a display position of a display button determined at the display position determination step and a notification step of notifying when display positions of display buttons of the two directions overlap in the comparison step.

Further, a method for customizing a display (51) of the present invention according to any one of the methods for customizing the display (47) to (49) includes a source information determination step of determining the source information before the registration step and the registration step registers the display position of a display button determined at the display position determination step linked with source information determined at the source information determination step.

Further, a method for customizing of display (52) of the present invention according to any one of the methods for customizing the display (47) to (49) includes an operator identification step of identifying the operator before the registration step and the registration step registers a display position of a display button determined at the display position determination step linked with the operator identified at the operator identification step.

Further, a method for customizing a display (53) of the present invention according to any one of the methods for customizing the display (47) to (49) includes an operator identification step of identifying an operator before the registration step and the registration step registers a display position of a display button determined at the display position determination step linked with source information determined at the source information determination step and the operator identified at the operator identification step.

A method for setting (54) of the present invention in a display device having a display unit able to display a first image able to be viewed in a first direction and a second image able to be viewed in a second direction, a touch panel arranged at a front surface of the display unit, and a control unit making the display unit display the first image and second image, the method includes

a direction determination step of determining the viewing direction, a display position reading step of reading a prestored display position of a display button corresponding to the viewing direction determined at the direction determination step, and a setting step of setting a display position of a display button read out at the display position reading step.

A method for setting (55) of the present invention in a display device having a display unit able to display a first image able to be viewed in a first direction and a second image able to be viewed in a second direction, a touch panel arranged at a front surface of the display unit, and a control unit making the display unit display the first image and second image, the method includes

a source information determination step of determining the source information, a display position reading step reading out a prestored display position of a display button source information determined at the source information determination step, and a setting step of setting the display position of a display button read out at the display position reading step.

A method for setting (56) of the present invention in a display device having a display unit able to display a first image able to be viewed in a first direction and a second image able to be viewed in a second direction, a touch panel arranged at a front surface of the display unit, and a control unit displaying the first image and the second image on the display unit, the method includes

an operator identification step of identifying an operator, a display position reading step of reading out a prestored display position of a display button corresponding to the operator identified at the operator identification step, and a setting step of setting a display position of a display button read out at the display position reading step.

Further, a method for setting (57) of the present invention according to any one of the methods for setting (54) to (56) includes a source information determination step of determining source information before the display position reading step and the display position reading step reads out a prestored display position of a display button corresponding to the viewing direction determined at the direction determination step and source information determined at the source information determination step.

Further, a method for setting (58) of the present invention according to any one of the methods for setting (54) to (56) includes an operator identification step of identifying an operator before the display position reading step and the display position reading step reads out a prestored display position of a display button corresponding to a viewing direction determined at the direction determination step and the operator identified at the operator identification step.

Further, a method for setting (59) of the present invention according to any one of the methods for setting (54) to (56) includes an operator identification step of identifying an operator before the display position reading step and the display position reading step reads out a prestored display position of a display button corresponding to source information determined at the source information determination step and the operator identified at the operator identification step.

Further, a method for setting (60) of the present invention according to any one of the methods for setting (54) to (56) includes, between the display position reading step and the setting step, a comparison step of comparing a display position of a display button displayed in a direction different from the viewing direction selected at the direction selection step and a display position of a display button read out at the display position reading step and a display position movement step of moving positions so that overlapping display button positions do not overlap when display positions of display buttons of the two directions overlap at the comparison step.

Further, a method for setting (61) of the present invention includes between the display position reading step and the setting step, a comparison step of comparing a display position of a display button displayed in a direction different from the viewing direction selected at the direction selection step and a display position of a display button read out at the display position reading step and a notification step of notifying when the display positions of display buttons of the two directions overlap at the comparison step.

A display device (62) of the present invention includes a display unit having a first display region and a second display region and displaying the first display region and the second display region differentiated according to the angle of the line of sight of the viewer, a first drive unit for making the first display region display the first image, a second drive unit for making the second display region display the second image independent from the first image, and a control unit controlling the first drive unit to make a driver's seat use operation button image be displayed on the first display region and controlling the second drive unit to make passenger's seat use operation button image different from the driver's seat use operation button image be displayed on the second display region.

A display device (63) of the present invention includes an input unit provided on the display unit and the control unit judges that an operation button has been selected by depression of an input device on the operation button image. A so-called touch panel or other input system may be used to display an operation button image on a display unit and the displayed operation button image and input unit may be used to perform the desired input.

A method for customizing an operation button image (64) of the present invention includes a step of inputting seat information selecting one of a first seat and second seat, a step of determining a display position at a display unit of an operation button at an operation button image linked with the seat information, and a step of registering the determined operation button image.

Further, a method for customizing an operation button image (65) of the present invention according to the method for customizing an image (64) includes a step of prohibiting the registration step when the display position at the display unit of the operation button image already registered linked with a seat other than the selected seat and the display position at the display position of the operation button image determined linked with the seat information overlap on the display unit. Even when one display unit displays a plurality of images (or display images), there is a single input unit, so the operation button images can be registered so that the operation inputs for the plurality of images do not become confused.

Further, a method for customizing an operation button image (66) of the present invention according to the method for customizing an image (64) or (65) includes a step of inputting seat information selecting one of the first seat and second seat, a step of reading out an operation button image corresponding to the seat information, and a step of enabling utilization of the read out operation button image.

Further, a method for customizing an operation button image (67) of the present invention according to any one of the methods for customizing an image (64) to (66) includes a step prohibiting the step of enabling utilization when the display position at the display unit of the operation button image already utilized linked with a seat other than the selected seat and the display position at the display position of the operation button at the operation button image read out linked with the seat information overlap on the display unit. Even when one display unit displays a plurality of images (or display images), there is a single input unit, so the operation button images can be used so that the operation inputs for the plurality of images do not become confused.

A control system (68) of the present invention includes a display device having a display unit displaying individual display images for a plurality of viewing directions on the common screen, a remote control system outputting to the display device a control signal for controlling a plurality of signal sources corresponding to the individual display images for a plurality of viewing directions and remotely controlling the display device, a setting unit for setting a specific signal source in the plurality of signal sources, and a control unit controlling the signal source set by the setting unit based on the control signal. For example, it is also possible to provide a mode setting switch and input an operation from the remote controller for display screen corresponding to a mode set by the mode setting switch.

Further, in each of the control systems (69) to (72) of the present invention according to the control system (68), the control unit and setting unit are provided at any of the remote control system or display device.

Further, a control system (73) of the present invention according to any one of the control systems (69) to (72) includes a condition judgment unit judging if a condition invalidating control of a signal source corresponding to the display image for a specific viewing direction among the plurality of viewing directions stands and a setting control unit controlling the setting by the setting unit based on the results of judgment of the condition judgment unit. When the condition for invalidating the control stands, operation by the remote controller becomes no longer possible. For example, due to this, the driver will not be distracted by operation of the remote controller.

Further, in each of the control systems (74) and (75) of the present invention according to the control system (73), the condition setting unit and setting control unit are provided at either of the remote control system or display device.

Further, in a control system (76) of the present invention according to any one of the control systems (73) to (75) includes a termination unit for terminating control by the setting control unit. In special cases, even when the condition for invalidating control stands, operation by the remote controller becomes possible.

A control system (77) of the present invention includes a display device having a display unit displaying individual display images for a plurality of viewing directions on the common screen, a remote control system outputting to the display device a control signal for controlling a plurality of signal sources corresponding to individual display images for a plurality of viewing directions and remotely controlling the display device, a display switch unit switching from the common screen display of the plurality of display images of the individual display images for the plurality of viewing directions to single screen display of only a predetermined single display image among the individual display images for the plurality of viewing directions, and a control unit controlling the signal source corresponding to the predetermined single display image switched by the display switch unit based on the control signal. In the state of the split display, the single display is changed to once, then operation input by the remote controller is enabled.

Further, in each of the control systems (78) to (81) of the present invention according to the control system (77), the control unit and display switch unit are provided at one of the remote control system or display device.

Further, a control system (82) of the present invention according to any one of the control systems (78) to (81) includes a condition judgment unit judging if a condition invalidating control of a signal source corresponding to the display image for a specific viewing direction among the plurality of viewing directions stands and a switching control unit controlling the switching by the display switching unit based on the results of judgment of the condition judgment unit. When the condition for invalidating the control stands, operation by the remote controller becomes no longer possible. For example, due to this, the driver will not be distracted by operation of the remote controller.

Further, in each of the control systems (83) and (84) of the present invention according to the control system (82), the condition setting unit and switching control unit are provided in either of the remote control system or display device.

Further, a control system (85) of the present invention according to any one of the control systems (82) to (84) includes a termination unit for terminating control by the switching control unit.

A control system (86) of the present invention includes a display device having a display unit displaying individual display images for a plurality of viewing directions on the common screen, a remote control system having a plurality of operation input units corresponding to a plurality of signal sources corresponding to individual display images for the plurality of viewing directions, a control signal generation unit generating control signals corresponding to the plurality of operation input units, and an output unit outputting the control signals to the display device and remotely controlling the display device, and a control unit controlling the plurality of signal sources based on the control signals. For example, it is comprised using a remote controller having all operating switches corresponding to all modes and enabling operation input without being distracted by mode switching etc.

Further, in each of the control systems (87) and (88) of the present invention according to the control system (86), the control unit is provided at one of the display device or remote control system.

A control system (89) of the present invention includes a display device having a display unit displaying individual display images for a plurality of viewing directions on the common screen and an operating unit outputting a control signal for a single signal source corresponding to a display image for a single viewing direction among the plurality of viewing directions and a remote control system outputting control signals for other signal sources corresponding to the display images for the other viewing directions among the plurality of viewing directions. For example, the driver use display image is designed to be operated by input only from the display unit, while the passenger's seat use display image is designed to be operated by input only from the remote controller.

A control system (90) of the present invention includes a display device having a display device displaying individual display images for a plurality of viewing directions on the common screen, a remote control system outputting control signals for controlling a plurality of signal sources corresponding to the individual display images for a plurality of viewing directions to the display device and remotely controlling the display device, a remote control direction detection unit detecting a direction in which the remote control system is present, and a control unit controlling the signal sources corresponding to the results of detection of the remote control direction detection unit based on the control signals. For example, it is designed to confirm the position of the remote controller and confirm from the position of the remote controller which viewing direction of the display screen among the plurality of viewing directions the operation input was performed for.

Further, in each of the control systems (91) and (92) of the present invention according to the control system (90), the remote control direction detection unit is provided at the remote control system or display device.

An operational control system of the present invention (93) includes a displaying means able to display a first display image able to be seen from a first direction and not able to be seen from a second direction and display a second display image able to be seen from the second direction and not able to be seen from the first direction simultaneously on the common screen, a remote operating means configured separate from the displaying means and outputting an operation signal corresponding to an operation on the first display image or an operation on the second display image, and an operational controlling means for operational control in accordance with the operation signal from the remote operating means, a mode setting information output unit outputting mode setting information instructing setting of any operation mode of a first operation mode for performing an operation on the first display image and a second operation mode for performing an operation on the second display image in response to a predetermined operation and an operation mode control unit setting the first operation mode or second operation mode based on the mode setting information output from the mode setting information output unit, outputting an operation signal corresponding to an operation on the first display image when an operation is performed in the first operation mode, and outputting an operation signal corresponding to an operation on the second display image when an operation is performed in the second operation mode.

According to the invention (93), when a viewer performs a predetermined operation on the remote operating means, a first operation mode for the first display image or a second operation mode for the second display image is set. In this state, when the viewer operates the remote operating means, an operation signal corresponding to the performed operation is output. That is, when the viewer performs an operation in the first operation mode, an operation signal corresponding to an operation on the first display image is output, while when the viewer performs an operation in the second operation mode, an operation signal corresponding to an operation on the second display image is output. Therefore, if the viewer sets an operation mode corresponding to the display image desired to be operated on, it is possible to suitably perform an operation on the display image desired to be operated on. Due to this, it is possible to use one remote operating means to suitably perform operations on two display images.

An operational control system (94) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separate from the displaying means and outputting an operation signal corresponding to an operation on the first display image or an operation on the second display image, and an operational controlling means for operational control in accordance with the operation signal from the remote operating means; provided with a mode setting information output unit outputting mode setting information instructing setting of any operation mode of a first operation mode for performing an operation on the first display image and a second operation mode for performing an operation on the second display image in response to a predetermined operation and an operation mode control unit setting the first operation mode or second operation mode based on the mode setting information output from the mode setting information output unit, outputting an operation signal corresponding to an operation on the first display image when an operation is performed in the first operation mode, and outputting an operation signal corresponding to an operation on the second display image when an operation is performed in the second operation mode; and provided with a valid operation setting condition judging means for judging if a valid operation setting condition for invalidating an operation on the first display image and validating an operation on the second display image stands and an operation limiting means for validating only the operation by the second operation mode and invalidating the operation by the first operation mode when the valid operation setting condition judging means judges that the valid operation setting condition stands.

According to the invention (94), if setting an operation mode corresponding to a display image which the viewer desires to operate on as explained above, an operation for the display image desired to be operated on can be suitably performed. On the other hand, when the valid operation setting condition stands, just an operation by the second operation mode, that is, an operation on the second display image, is validated, while the operation by the first operation mode, that is, an operation on the first display image, is invalidated. Due to this, an operation on the first display image from the remote operating means can be limited. For example, when the valid operation setting condition is the state where the driver of the car should concentrate on driving and the valid operation setting condition stands, the operation on the driver's seat use display image (first display image) can be invalidated and only the operation on the passenger's seat use display image (second display image) can be validated. Due to this, the driver can be kept from being distracted by the operation of the remote operating means and safety during driving can be improved.

An operational control system (95) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separate from the displaying means and outputting an operation signal corresponding to an operation on the first display image or an operation on the second display image, and an operational controlling means for operational control in accordance with the operation signal from the remote operating means; provided with a mode setting information output unit outputting mode setting information instructing setting of any operation mode of a first operation mode for performing an operation on the first display image and a second operation mode for performing an operation on the second display image in response to a predetermined operation and an operation mode control unit setting the first operation mode or second operation mode based on the mode setting information output from the mode setting information output unit, outputting an operation signal corresponding to an operation on the first display image when an operation is performed in the first operation mode, and outputting an operation signal corresponding to an operation on the second display image when an operation is performed in the second operation mode; and provided with priority operation setting condition judging means for judging whether a priority operation setting condition for giving priority to an operation on the second display image over an operation on the first display image stands and an operation limiting means validating an operation by the second operation mode and invalidating the operation by the first operation mode when the priority operation setting condition judging means judges that the priority operation setting condition stands and validates an operation by the first operation mode when invalidation termination is instructed.

According to the invention (95), if setting an operation mode corresponding to a display image which a viewer desires to operate on in the above mentioned way, an operation on a display image desired to be operated on can be suitably performed. On the other hand, when the priority operation setting condition stands, at the remote operating means, operation by the second operation mode is validated and operation by the first operation mode is invalidated, that is, only an operation on the second display image becomes possible. Further, if the viewer instructs invalidation termination, an operation by the first operation mode is validated. Due to this, in the remote operating means, priority can be given to an operation on the second display image. For example, when the priority operation setting condition is a state where the driver of a car should concentrate on driving and the priority operation setting condition stands, an operation on the passenger's seat use display image (second display image) is given priority to for execution. If the viewer performs an invalidation termination operation as necessary, an operation on the driver's seat use display image (first display image) can also be performed.

Due to this, the driver can be kept from being distracted by the operation of the remote operating means and safety during driving can be improved. Further, an operation on the driver's seat use display image can also be performed as needed, so the operability and convenience can be improved.

Further, in an operational control system (96) of the present invention according to the operational control system (95), the operation limiting means validates an operation by the first operation mode, then invalidates an operation by the first operation mode after the elapse of a predetermined time. When validating an operation by the second operation mode and invalidating an operation by the first operation mode and when operation by the first operation mode is validated by an invalidation termination operation of the viewer, an operation by the first operation mode is invalidated after a predetermined time elapses. Due to this, it is possible to limit an operation on the first display image and give priority to an operation on the second display image. Therefore, for example, it is possible to limit an operation on the driver's seat use display image (first display image) and give priority to an operation on the passenger's seat use display image (second display image), so it is possible to improve the safety at the time of driving.

Further, in an operational control system (97) of the present invention according to any one of the operational control systems (92) to (96), the remote operating means is provided with a report unit reporting to the view which of the first operation mode and the second operation mode is set. A viewer can easily determine the operation mode set in the remote operating means. Due to this, the operability and convenience can be improved.

Further, in an operational control system (98) of the present invention according to any one of the operational control systems (92) to (97), the remote operating means is provided with a guide unit for informing a change in the operation mode to a viewer. A viewer can therefore easily determine that the operation mode has been changed. Due to this, the operability and convenience can be improved.

An operational control system (99) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separate from the displaying means and outputting an operation signal corresponding to an operation on the first display image or an operation on the second display image, and an operation controlling means for operational control in accordance with the operation signal from the remote operating means and

making the displaying means display a single screen combining the display of the first display image and the display of the second display image and performing operational control only for a display image displayed on the single screen display.

According to the present invention (99), for example, when the displaying means displays a single screen in response to a predetermined operation of the viewer and a viewer performs an operation on a displayed display image in the state where the displaying means displays a single screen, operational control in accordance with an operation on the display image displayed on the single screen by the operational controlling means is performed. Further, when an operation is performed for a not displayed display image, the operational controlling means does not perform operational control. Therefore, the viewer performs an operation in a state displaying a single screen by a display image desired to be operated on, so an operation on a display image desired to be operated on can be suitable performed. Due to this, a single remote operating means can be used to suitably perform operations on two display images. Further, since only a display image operated on is displayed on the displaying means, a viewer can easily grasp which display image is being operated on.

Further, an operational control system (100) of the present invention according to the operational control system (99) includes a valid operation setting condition judging means for judging if a valid operation setting condition for invalidating an operation on the first display image and validating an operation on the second display image stands and,

when the valid operation setting condition judging means judges that the valid operation setting condition stands, the operational controlling means makes the displaying means display the single screen by a display image of display of a second display image. When the valid operation setting condition stands, a single screen is displayed by a display image of the display of the second display image and only an operation on the second display image is validated. Due to this, it is possible to limit an operation on the first display image from the remote operating means. For example, when the valid operation setting condition is a state where the driver of a car should concentrate on driving and the valid operation setting conditions stands, it is possible to invalidate an operation on the driver's seat use display image (first display image) and validate an operation on the passenger's seat use display image (second display image). Due to this, a driver can be kept from being distracted by operation of the remote operating means and safety during driving can be improved.

Further, an operational control system (101) of the present invention according to the operational control system (99) includes a priority operation setting condition judging means for judging if a priority operation setting condition for giving priority to an operation on the second display image over an operation on the first display image stands,

the operational controlling means makes the displaying means display the single screen by a display image of a display of the second display image when the priority operation setting condition judging means judges that the priority operation setting condition stands, and

the operational controlling means makes the displaying means display a single screen by a display image of a display of the first display image in response to a predetermined operation. When the priority operation setting condition stands, the displaying means displays a single screen by a display image of the display of the second display image and operation on the second display image becomes possible. In this state, when for example a viewer performs a predetermined operation, the displaying means displays a single screen by a display image of the display of the first display image and operation on the first display image becomes possible. Due to this, it becomes possible to give priority to an operation on the second display image in the remote operating means. For example, when the priority operation setting condition is a state where the driver of the car should concentrate on driving and the priority operation setting condition stands, it is possible to give priority to an operation on the passenger's seat use display image (second display image). If the viewer performs a switching operation as required, an operation on the driver's seat use display image (first display image) can also be performed.

Due to this, the driver can be kept from being distracted by the operation of the remote operating means and safety during driving can be improved. Further, an operation on the driver's seat use display image can also be performed as needed, so the operability and convenience can be improved.

Further, in an operational control system (102) of the present invention according to any one of the operational control systems (99) to (101), after a predetermined time elapses when switching from a split display of a different display image of the display of the first display image and display image of the second display image to a single screen display, the operational controlling means returns to the split display. After a predetermined time elapses when switching from a split display to a single screen display for operation, the original split display is returned to. Therefore, it is possible to reduce the inconvenience of the viewer of a display image not operated on.

An operational control system (103) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separately from the displaying means and outputting an operation signal corresponding to an operation on the first display image or an operation on the second display image, and an operational controlling means for performing operational control in accordance with the operation signal from the remote operating means and having

an operating switch for the first display image and an operating switch for the second display image.

According to the invention (103), since the remote operating means is provided in advance with an operating switch for the first display image and an operating switch for the second display image, the viewer need only operate the operating switch for the display image desired to be operated on when performing an operation on a desired display image. Due to this, it is possible to use a single operating means to suitably perform operations on two display images.

Further, an operational control system (104) of the present invention according to the operational control system (103) includes a valid operation setting condition judging means for judging if a valid operation setting condition for invalidating an operation on the first display image and validating an operation on the second display image stands and

an operation limiting means for validating the operation of an operating switch for the second display image and invalidating the operation of an operating switch for the first display image when the valid operation setting condition judging means judges that the valid operation setting condition stands. When the valid operation setting conditions stand, only an operating switch for the second display image becomes valid. Due to this, it is possible to limit an operation on the first display image from the remote operating means. For example, when making the valid operation setting condition the state where the driver of a car should concentrate on driving and the valid operation setting condition stands, it is possible to invalidate an operation on the driver's seat use display image (first display image) and validate an operation on the passenger's seat use display image (second display image). Due to this, the driver can be kept from being distracted by operation of the remote operating means and safety during driving can be improved.

Further, an operational control system (105) of the present invention according to the operational control system (104) includes a reporting means for reporting to a viewer that an operation with respect to the first display image is invalidated and an operation of the second display image is validated. According to the present invention, the viewer can easily learn of a display image which can be operated on by the remote operating means. Due to this, the operability and convenience can be improved.

An operational control system (106) of the present invention includes a displaying means able to display a first display image able to be seen from a first direction and not able to be seen from a second direction and display a second display image able to be seen from the second direction and not able to be seen from the first direction simultaneously on the common screen,

a touch panel type operating means having a touch panel arranged so as to overlap the screen of the displaying means and outputting an operation signal corresponding to an operation on the first display image,

a remote operating means configured separately from the display means and outputting an operation signal corresponding to an operation on the second display image, and

an operational controlling means for performing operational control in accordance with operation signals from the touch panel type operating means and the remote operating means.

According to the invention (106), an operation on the first display image can be performed by the touch panel type operating means, while an operation on the second display image can be performed by the remote operating means. Due to this, operations on two display images can be suitably performed.

Further, an operational control system (107) of the present invention according to the operational control system (106) includes a valid operation setting condition judging means for judging if a valid operation setting condition for invalidating an operation on the first display image and validating an operation on the second display image stands and

an operation limiting means for validating only an operation by the touch panel type operating means and invalidating an operation by the remote operating means when the valid operation setting condition judging means judges that the valid operation setting condition stands. When the valid operation setting condition stands, only an operation on the second display image by the remote operating means becomes valid. Due to this, it is possible to limit an operation on the first display image. For example, a valid operation setting condition is a state where the driver of a car should concentrate on driving and the valid operation setting condition stands. It is possible to invalidate an operation on the driver's seat use display image (first display image) and validate an operation on the passenger's seat use display image (second display image). Due to this, the driver can be kept from being distracted by operation of the remote operating means and safety during driving can be improved.

An operational control system (108) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separately from the displaying means and outputting an operation signal corresponding to an operation on the first display image or an operation on the second display image, and an operational controlling means performing in accordance with an operation signal from the remote operating means and

provided with a remote operation direction detecting means for detecting a direction in which the remote operating means is present and

the operational controlling means prohibits execution of operational control in accordance with an operation signal output from the remote operating means in accordance with a detected direction of the remote operation direction detecting means.

According to the invention (108), the direction in which the remote operating means is present is detected, and in accordance with the detected direction, execution of operational control in accordance with an operation on the first display image or an operation on the second display image is prohibited. Therefore, when the remote operating means is operated, it is possible to detect from which direction the operator performed the operation and prohibit execution of operational control in accordance with the operation if a direction covered by the limit on operations. For example, when applied to a car, if prohibiting operational control in accordance with an operation from the driver's seat direction, it is possible to prohibit an operation by the driver while driving and execute only operational control in accordance with an operation by the passenger's seat passenger or another passenger.

An operational control system (109) of the present invention includes a displaying means able to display a first display image able to be seen from a first direction and not able to be seen from a second direction and display a second display image able to be seen from the second direction and not able to be seen from the first direction simultaneously on the common screen, a remote operating means configured separately from the displaying means and outputting an operation signal corresponding to an operation on the first display image or an operation on the second display image, and operational controlling means for performing operational control in accordance with an operation signal from the remote operating means and

provided with a remote operation direction detecting means for detecting a direction in which the remote operating means is present and

the remote operational controlling means prohibits output of an operational signal in accordance with a detected direction of the remote operation direction detecting means.

According to the invention (109), the direction in which the remote operating means is present is detected and, in accordance with the detected direction, output of an operation signal corresponding to an operation on the first display image or an operation on the second display image is prohibited. Therefore, when the remote operating means is operated, from which direction the operator operated it can be detected and if a direction covered by the limit on operations, output of an operation signal corresponding to the operation can be prohibited. Due to this, execution of operational control in accordance with an operation from a direction covered by the limit on operations can be prohibited. For example, when applied to a car, if prohibiting the output of an operation signal corresponding to an operation from the driver's seat direction, operation by the driver while driving can be prohibited and only operational control in accordance with an operation by a passenger's seat passenger or other passenger can be executed.

### BRIEF DESCRIPTION OF THE DRAWINGS

FIG. 1 is an explanatory view for explaining a function of displaying individual pictures for a plurality of viewing directions on the common screen in a display device according to embodiment (1) of the present invention;

FIG. 2 is a perspective view showing an example of the case of mounting a display device according to embodiment (1) on a car;

FIG. 3(a) is a view schematically showing a display state when viewing a display unit from the front, and FIG. 3(b) is a cross-sectional view along the line B-B in FIG. 3(a);

FIG. 4 is a circuit diagram showing the outline of a TFT board forming part of a display unit;

FIG. 5 is a block diagram schematically showing key parts of an AV navigation system mounted in a car employing a display device according to embodiment (1);

FIG. 6 is a block diagram showing the general configuration of an image output unit;

FIG. 7 is a block diagram showing the general configuration of a memory;

FIG. 8 is a block diagram showing the general configuration of a control unit;

FIG. 9 is a view showing the front view of the outside of a display device according to embodiment (1);

FIG. 10 is a schematic view showing the state around the display unit;

FIG. 11 is a flowchart showing a processing operation performed by a control unit in an AV navigation system employing a display device according to embodiment (1);

FIG. 12(a) is an explanatory view for explaining pixels used for a driver's seat use picture and pixels used for a passenger's seat use picture, FIG. 12(b) is a view showing an example of a driver's seat use picture, and FIG. 12(c) is a view showing an example of a passenger's seat use picture;

FIG. 13(a) is an explanatory view for explaining pixels used for a driver's seat use picture and pixels used for a passenger's seat use picture, FIG. 13(b) is a view showing an example of a driver's seat use picture, and FIG. 13(c) is a view showing an example of a passenger's seat use picture;

FIG. 14(a) is an explanatory view for explaining pixels used for a driver's seat use picture and pixels used for a passenger's seat use picture, FIG. 14(b) is a view showing an example of a driver's seat use picture, and FIG. 14(c) is a view showing an example of a passenger's seat use picture;

FIG. 15 is a flowchart showing a processing operation performed by a control unit in an AV navigation system employing a display device according to embodiment (1);

FIG. 16 is a flowchart showing a processing operation performed by a control unit in an AV navigation system employing a display device according to another embodiment;

FIG. 17(a) is an explanatory view for explaining pixels used for a driver's seat use picture and pixels used for a passenger's seat use picture, FIG. 17(b) is a view showing an example of a driver's seat use picture, and FIG. 17(c) is a view showing an example of a passenger's seat use picture;

FIG. 18 is a flowchart showing a processing operation performed by a control unit in an AV navigation system employing a display device according to another embodiment;

FIG. 19 is a flowchart showing a processing operation performed by a control unit in an AV navigation system employing a display device according to another embodiment;

FIG. 20(a) is an explanatory view for explaining pixels used for a driver's seat use picture and pixels used for a passenger's seat use picture, FIG. 20(b) is a view showing an example of a driver's seat use picture, and FIG. 20(c) is a view showing an example of a passenger's seat use picture;

FIG. 21 is a flowchart showing a processing operation performed by a control unit in an AV navigation system employing the display device according to the embodiment (2);

FIG. 22 is a flowchart showing a processing operation performed by a control unit in an AV navigation system employing a display device according to another embodiment;

FIG. 23 is a flowchart showing a processing operation performed by a control unit in an AV navigation system employing a display device according to another embodiment;

FIG. 24 is a flowchart showing a processing operation performed by a control unit in an AV navigation system employing a display device according to another embodiment;

FIG. 25 is a flowchart showing a processing operation performed by a control unit in an AV navigation system employing a display device according to embodiment (3);

FIG. 26 is a flowchart showing a processing operation performed by a control unit in an AV navigation system employing a display device according to another embodiment;

FIG. 27 is a flowchart showing a processing operation performed by a control unit in an AV navigation system employing a display device according to another embodiment;

FIG. 28 is a flowchart showing a processing operation performed by a control unit in an AV navigation system employing a display device according to another embodiment;

FIG. 29 is a flowchart showing a processing operation performed by a control unit in an AV navigation system employing a display device according to another embodiment;

FIG. 30 is a flowchart showing a processing operation performed by a control unit in an AV navigation system employing a display device according to another embodiment;

FIG. 31 is a flowchart showing a processing operation performed by a control unit in an AV navigation system employing a display device according to another embodiment;

FIG. 32 is a flowchart showing a processing operation performed by a control unit in an AV navigation system employing a display device according to an embodiment (4);

FIG. 33(a) is an explanatory view for explaining pixels used for a driver's seat use picture and pixels used for a passenger's seat use picture, FIG. 33(b) is a view showing an example of a driver's seat use picture, and FIG. 33(c) is a view showing an example of a passenger's seat use picture;

FIG. 34(a) is an explanatory view for explaining pixels used for a driver's seat use picture and pixels used for a passenger's seat use picture, FIG. 34(b) is a view showing an example of a driver's seat use picture, and FIG. 34(c) is a view showing an example of a passenger's seat use picture;

FIG. 35 is a flowchart showing a processing operation performed by a control unit in an AV navigation system employing a display device according to embodiment (4);

FIG. 36 is a flowchart showing a processing operation performed by a control unit in an AV navigation system employing a display device according to embodiment (5);

FIG. 37(a) is an explanatory view for explaining pixels used for a driver's seat use picture and pixels used for a passenger's seat use picture, FIG. 37(b) is a view showing an example of a driver's seat use picture, and FIG. 37(c) is a view showing an example of a passenger's seat use picture;

FIG. 38(a) is an explanatory view for explaining the scope of display of operating switches able to be used for a driver's seat use picture and the scope of reception of operation input, FIG. 38(b) is an explanatory view for explaining the scope of display of operating switches able to be used for a passenger's seat use picture and the scope of reception of operation input, and FIG. 38(c) is an explanatory view for explaining the scope of reception of operation input of each operating switch;

FIG. 39 is a flowchart showing a processing operation performed by a control unit in an AV navigation system employing a display device according to embodiment (5);

FIG. 40 is a flowchart showing a processing operation performed by a control unit in an AV navigation system employing a display device according to another embodiment;

FIG. 41 is a flowchart showing a processing operation performed by a control unit in an AV navigation system employing a display device according to another embodiment;

FIG. 42 is a flowchart showing a processing operation performed by a control unit in an AV navigation system employing a display device according to another embodiment;

FIG. 43(a) is an explanatory view for explaining pixels used for a driver's seat use picture and pixels used for a passenger's seat use picture, FIG. 43(b) is a view showing an example of a driver's seat use picture, and FIG. 43(c) is a view showing an example of a passenger's seat use picture;

FIG. 44(a) is an explanatory view for explaining the scope of display of operating switches able to be used for a driver's seat use picture and the scope of reception of operation input, FIG. 44(b) is an explanatory view for explaining the scope of display of operating switches able to be used for a passenger's seat use picture and the scope of reception of operation input, and FIG. 44(c) is an explanatory view for explaining the scope of reception of operation input of each operating switch;

FIG. 45 is a flowchart showing a processing operation performed by a control unit in an AV navigation system employing a display device according to embodiment (6);

FIG. 46 is a flowchart showing a processing operation performed by a control unit in an AV navigation system employing a display device according to another embodiment;

FIG. 47 is a flowchart showing a processing operation performed by a control unit in an AV navigation system employing a display device according to another embodiment;

FIG. 48 is a flowchart showing a processing operation performed by a control unit in an AV navigation system employing a display device according to another embodiment;

FIG. 49(a) is a front view of a display unit forming part of the display device according to embodiment (7), while FIG. 49(b) is a cross-sectional view along the line B-B of (a);

FIG. 50 is a flowchart showing a processing operation performed by a control unit in an AV navigation system employing a display device according to embodiment (7);

FIG. 51 is a front view of a display unit forming part of the display device according to embodiment (8);

FIG. 52 is a flowchart showing a processing operation performed by a control unit in an AV navigation system employing a display device according to embodiment (9);

FIG. 53(a) is a view showing a mark of a finger touching a touch panel and detection points, and FIG. 53(b) is a view showing an approximation line found from the detection points;

FIG. 54(a) is a view showing a contact mark of a finger when a driver touches a touch panel, and FIG. 54(b) is a view showing a contact mark of a finger when a passenger's seat passenger touches a touch panel;

FIG. 55 is a flowchart showing a processing operation performed by a control unit in an AV navigation system employing a display device according to embodiment (10);

FIG. 56(a) is a view showing an example of a state of display displayed on a display unit forming part of a display device, and FIG. 56(b) is a view showing an example of a state of display displayed on a display unit forming part of a display device;

FIG. 57 is a view schematically showing the structure of a display device for realizing a split display;

FIG. 58(a) is a view showing an example of a state of display displayed on a display unit forming part of a display device, and FIG. 58(b) is a view showing an example of a state of display displayed on a display unit forming part of a display device;

FIG. 59(a) is a view showing an example of a state of display displayed on a display unit forming part of a display device, and FIG. 59(b) is a view showing an example of a state of display displayed on a display unit forming part of a display device;

FIGS. 60(a) to (c) are views for explaining the states of display;

FIG. 61 is a block diagram showing the general configuration of a display device according to embodiment (11);

FIG. 62 is a view showing an example of arrangement of speakers and sensors;

FIG. 63 is a view showing the outlines of the cross-sectional shape of a display unit;

FIG. 64 is a view showing the operation flow at the time of registration;

FIG. 65 is a view showing an example of a customization use display screen;

FIG. 66 is a view showing an example of a seat setting use display screen;

FIG. 67 is a view showing an example of an individual setting use display screen;

FIG. 68 is a view showing an example of a source setting use display screen;

FIG. 69(a) is a view showing an example of a passenger's seat side operation button array, and FIG. 69(b) is a view showing an example of a driver's seat side operation button array;

FIG. 70(a) is a view showing an example of a passenger's seat side operation button array, and FIG. 70(b) is a view showing an example of a driver's seat side operation button array;

FIG. 71 is a view showing the operation flow at the time of operation;

FIG. 72 is a view for explaining the state of arrangement of operation buttons;

FIG. 73 is a schematic block diagram of a control system according to embodiments (12) to (16);

FIG. 74 is a front view of a display device 20;

FIG. 75 is a schematic view showing the structure of the display unit 4 in the display device 20;

FIG. 76(a) is a front view showing an example of display of a driver's seat side of the display unit 4, and FIG. 76(b) is a front view showing an example of display of a passenger side of the display unit 4;

FIG. 77 is a flowchart showing the processing operation in the embodiment (12);

FIG. 78 is a flowchart showing the processing operation in the embodiment (12);

FIG. 79 is a flowchart showing the processing operation in the embodiment (12);

FIG. 80 is a flowchart showing the processing operation in the embodiment (13);

FIG. 81 is a flowchart showing the processing operation in the embodiment (13);

FIG. 82 is a flowchart showing the processing operation in the embodiment (13);

FIG. 83 is a flowchart showing the processing operation in the embodiment (14);

FIG. 84 is a flowchart showing the processing operation in the embodiment (15); and

FIG. 85 is a flowchart showing the processing operation in the embodiment (16).

### DESCRIPTION OF THE PREFERRED EMBODIMENTS

Below, display devices according to embodiments of the present invention will be explained based on the drawings.

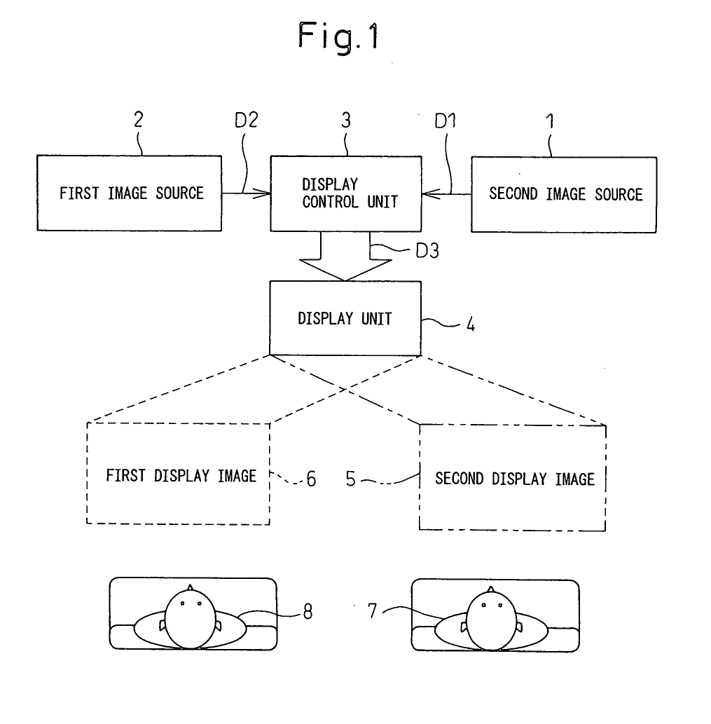

FIG. 1 is an explanatory view for explaining a function of displaying individual pictures for a plurality of viewing directions on the common screen in a display device. In the figure, 1 shows a first image source, while 2 shows a second image source. As the image source, for example, a DVD player, television receiver, navigation system, etc. may be mentioned.

First image data D1 obtained from the first image source 1 and second image data D2 obtained from the second image source 2 are supplied to a display control unit 3. These first image data D1 and second image data D2 are processed by the display control unit 3 so that the display unit 4 can display them substantially simultaneously, while the processed display data D3 is supplied to the display unit 4.

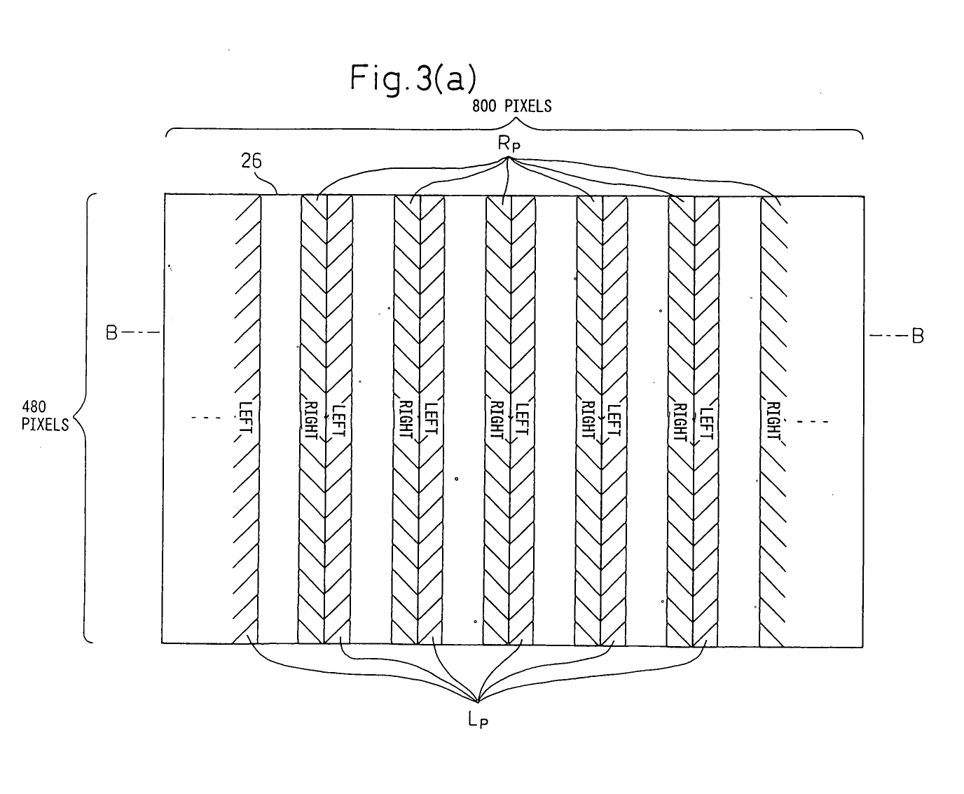

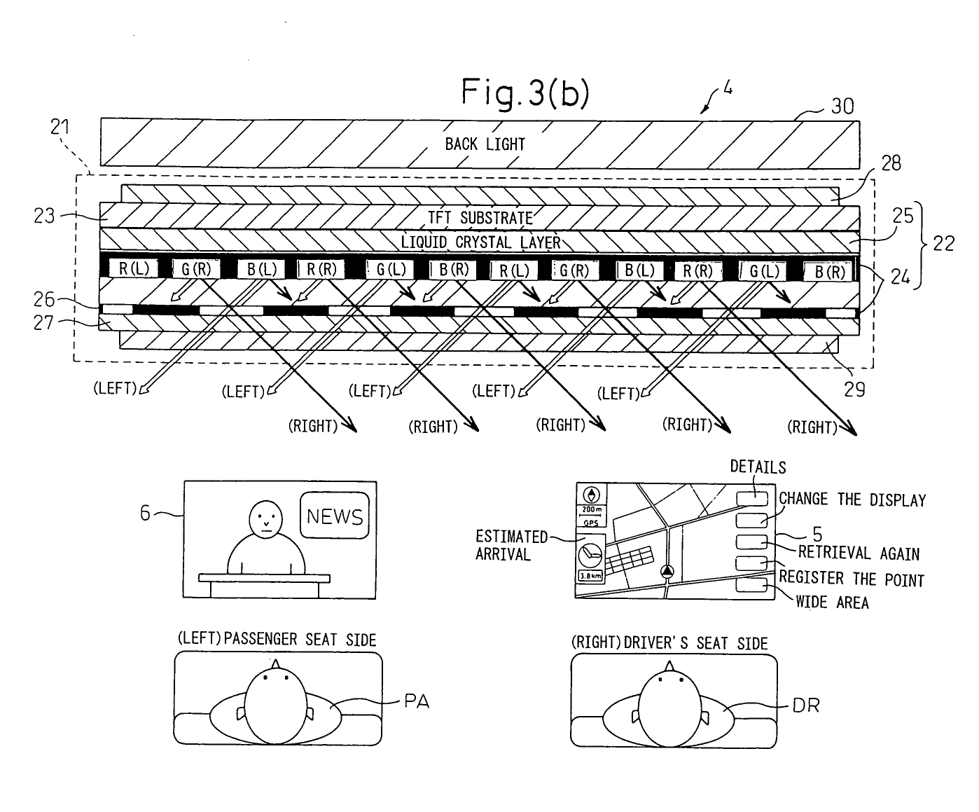

The display unit 4 will be explained in detail later, but as shown in FIG. 3(b) it is comprised including a liquid crystal panel 21 provided with a parallax barrier 26. Half of the total pixels in the horizontal direction (for example, the even number columns) are used for the display of the first display image 5 based on the first image source 1, while the remaining half (for example, the odd number columns) are used for the display of the second display image 6 based on the second image source 2.

The pixels for the first display image 5 can be seen from a viewer (user) 7 positioned at the right side of the display unit 4, but the pixels for the second display image 6 are blocked by the parallax barrier 26 formed on the front surface of the display unit 4 and cannot be seen from the viewer 7. On the other hand, the pixels for the second display image 6 can be seen from a viewer (user) 8 positioned at the left side of the display unit 4, but the pixels for the first display image 5 are blocked by the parallax barrier 26 formed on the front surface of the display unit 4 and cannot be seen from the viewer 8.

As explained above, it is possible to create a situation where the second display image 6 cannot be seen, but the first display image 5 can be seen or where the first display image 5 cannot be seen, but the second display image 6 can be seen in accordance with the positional relationship with the display unit 4, in other words, in accordance with the viewing angle of the display unit 4. Therefore, the same screen can provide information or content different for the left and right viewers (users) 7, 8. Of course, if the first image source 1 and the second image source 2 are the same, the left and right viewers 7, 8 can view the same display image.

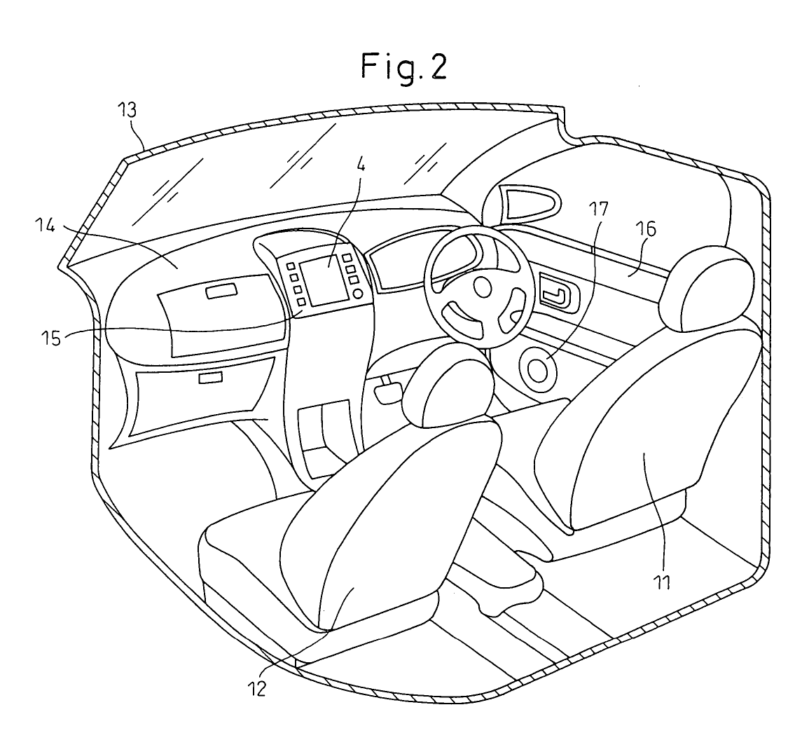

FIG. 2 is a perspective view showing one example of the case of mounting the display device on a car. The display unit 4 forming part of the display device is arranged at the substantial center of a dashboard 14 provided below a windshield 13 in front of the driver's seat 11 and passenger's seat 12. Various types of operations for the display device are performed by operation of a touch panel formed at the front surface of the display unit 4, an operating unit 15 provided around it, an infrared ray or wireless remote controller (not shown), etc. Further, a speaker 17 is provided at each door 16 of the car. Audio or an alarm etc. associated with the display image is output from the speakers 17.

Due to this, for example, it is possible to make just the map image of a navigation system visible from the first viewing direction constituted by the driver's seat and make just a television reception image or DVD movie image visible from the second viewing direction constituted by the passenger's seat 12. Therefore, the driver DR seated at the driver's seat 11 can receive assistance in driving from the car navigation while the passenger's seat passenger PA seated at the passenger's seat 13 can enjoy television or a movie.

Further, the display images are displayed using the entire screen of the display unit 4 (for example, 7 inch), so the screen size does not become small like with a conventional multiwindow display. That is, the driver DR and the passenger's seat passenger PA appear to solely use the screen, so the driver DR and the passenger's seat passenger PA can be provided with suitable information or content.

Next, the configuration of the display unit 4 of the display device will be explained in detail. FIG. 3(a) is a view schematically showing the state of display when viewing the display unit 4 from the front, while FIG. 3(b) is a cross-sectional view along the line B-B in FIG. 3(a). The display unit 4 is comprised of a liquid crystal panel 21 and a backlight 30. The liquid crystal panel 21 is arranged slightly separated from the backlight 30 and has pixels comprised of RGB colors (3 primary colors).

Further, the liquid crystal panel 21 is structured as a board 22 comprised of a TFT (thin film transistor) substrate 23 and a color filter board 24 between which a liquid crystal layer 25 is held, a parallax barrier 26, and a glass sheet 27 held between a polarizing plate 28 provided at the backlight 30 side and a polarizing plate 29 provided at the front of the light emitting direction side. As the liquid crystal panel 21, for example, one of 800 pixels in the horizontal direction and 480 pixels in the vertical direction is employed.

The pixels of the liquid crystal panel 21 are controlled for display grouped into right side (driver's seat 11) use pixels R_{P} and left side (passenger's seat 12) use pixels L_{P} alternately in the vertical direction. That is, half of the total number of pixels in the horizontal direction of the liquid crystal panel 21 are used for the display of the first display image 5, while the remaining half of the pixels are used for the display of the second display image 6.

The parallax barrier 26 is formed by strips provided at predetermined intervals in the horizontal direction (intervals enabling the direction of emission of light from each pixel to be restricted to either the left or right). Due to the parallax barrier 26, the right side (driver's seat 11) use pixels R_{P} are blocked from being displayed to the left side (driver's seat 12), but are not blocked from display to the right side and can be seen from the right side driver's seat 11, while the left side (passenger's seat 12) use pixels L_{P} are blocked from display to the right side (driver's seat 11), but are not blocked from display to the left side and can be seen from the left side passenger's seat 12.

That is, when viewing the liquid crystal panel 21 from the right side, the parallax barrier 26 covers and conceals the left side pixels L_{P} whereby the right side pixels R_{P} can be seen, while when viewing the liquid crystal panel 21 from the left side, the parallax barrier 26 covers and conceals the right side pixels R_{P}, whereby the left side pixels L_{P} can be seen. Note that if viewing the liquid crystal panel 21 from close to the front, both the right side pixels R_{P} and the left side pixels L_{P} can be seen, therefore the first display image 5 and the second display image 6 are seen superposed.

Further, if changing the control of display for the pixels of the liquid crystal panel 21 and the arrangement of the parallax barrier 26, it is also possible to display different images for three directions or more. Further, the parallax barrier 26 may be configured by an electrically drivable liquid crystal shutter etc. to make the viewing angle variable.

Further, the alternately arranged right side pixels R_{P} and left side pixels L_{P} of FIG. 3 have RGB colors, but it is also possible to configure the vertical directions of the groups by single colors such as R columns, G columns, and B columns, Further, they may also be configured by columns of mixed pluralities of RGB colors.

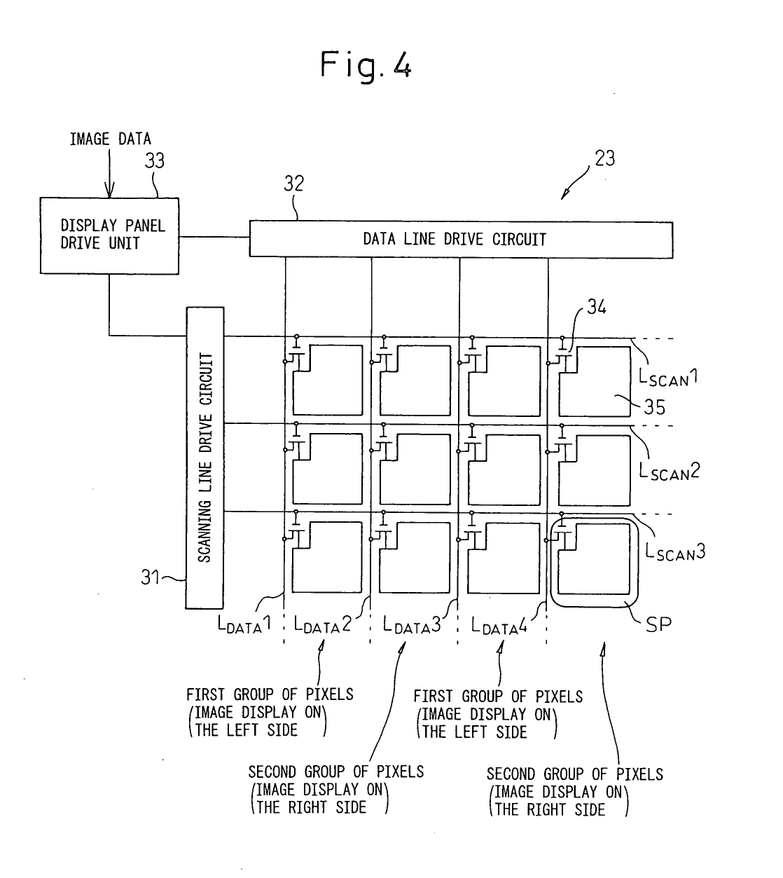

FIG. 4 is a circuit diagram showing an outline of a TFT substrate 23 forming part of the display unit 4. The TFT substrate 23 is comprised of a scanning line drive circuit 31, a data line drive circuit 32, scanning lines L_{SCAN}1, L_{SCAN}2, . . . connected to the scanning line drive circuit 31, data lines L_{DATA}1, L_{DATA}2, . . . connected to the data line drive circuit 32, and a display panel drive unit 33 connected to the scanning line drive circuit 31 and data line drive circuit 32.

The regions surrounded by the scanning lines L_{SCAN}1, L_{SCAN}2, . . . , and data lines L_{DATA}1, L_{DATA}2, . . . are used as units to form a plurality of subpixels SP. Each subpixel SP is formed with a pixel electrode 34 applying voltage to the liquid crystal layer 25 (see FIG. 3(b)) and a TFT element 35 controlling switching of the same.

The display panel drive unit 33 is configured to control the driving timing of the scanning line drive circuit 31 and data line drive circuit 32. The scanning line drive circuit 31 is configured to perform selective scanning of the TFT elements 35, while the data line drive circuit 32 is configured to control the voltage applied to the pixel electrodes 34.

The subpixels SP for example send the first pixel data D1 (for right side image display) to the data lines L_{DATA}2, L_{DATA}4 and the second pixel data D2 (for left side image display) to the data line L_{DATA}1, L_{DATA}3 based on the composite data of the first image data D1 (see FIG. 1) and second image data D2 or individual image data of the first image data D1 and second image data D2, whereby the first image data D1 group forming the first display image 5 (see FIG. 1) and the second image data D2 group forming the second display image 6 are formed. Note that even when displaying individual images in three directions or more, it is sufficient to execute drive control similar to the above. For example, to display individual images in three directions, it is sufficient to form first, second, and third image data groups.

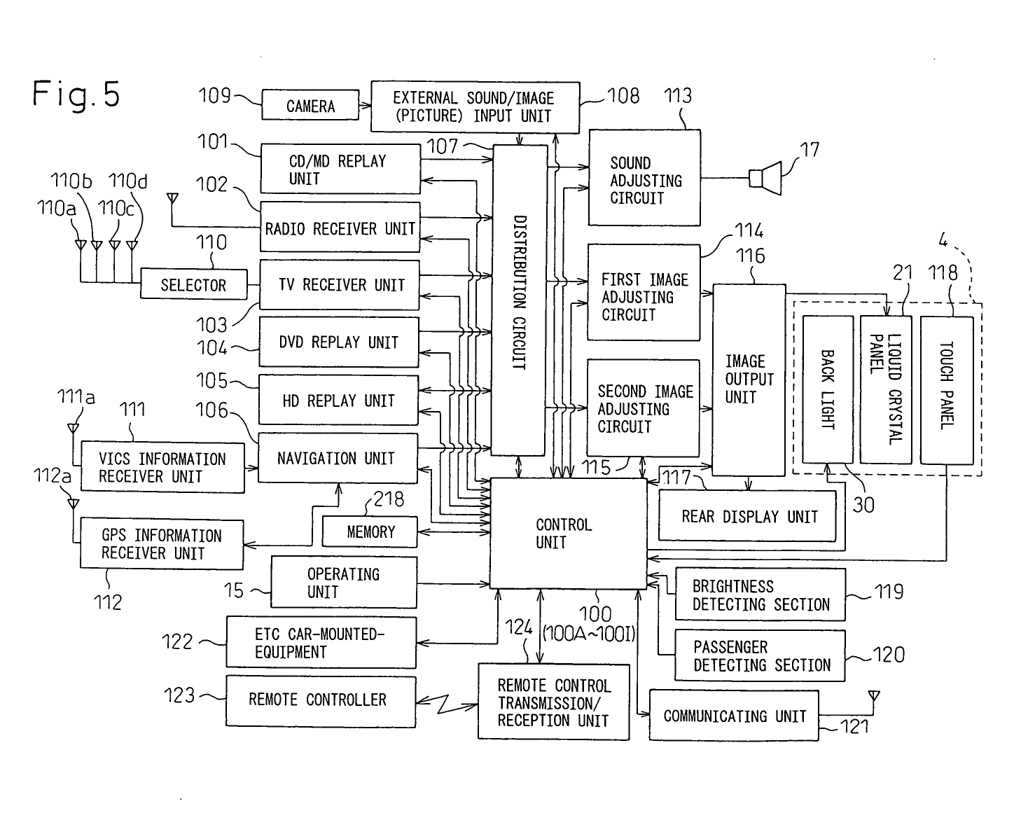

FIG. 5 is a block diagram schematically showing the key parts of an AV (audio visual) navigation system employing a display device. Components having the same function as the parts explained in FIG. 1 to FIG. 4 are assigned the same notations.

The AV navigation system is provided with various types of sources including a CD/MD replay unit 101, radio receiver unit 102, TV receiver unit 103, DVD replay unit 104, HD (hard disk) replay unit 105, and navigation unit 106. These various types of sources are connected through signal lines to a distribution circuit 107. Further, an external sound/image (picture) input unit 108 is connected through a signal line to the distribution circuit 107. The external sound/image (picture) input unit 108 is connected to a camera (for example, a rear monitoring camera) 109, but may also be connected to a video camera, a game machine, etc.

Further, the TV receiver unit 103 is connected to a selector 110, while the selector 110 is connected to antennas 110a to 110d provided at the front right, front left, rear right, and rear left of the car. The navigation unit 106 is connected to a VICS information receiver unit 111 and GPS information receiver unit 112, while the VICS information receiver unit 111 and GPS information receiver unit 112 are connected to the antennas 111a, 112b.

The distribution circuit 107 is connected through signal lines to an sound adjusting circuit 113, a first image adjusting circuit 114, and a second image adjusting circuit 115. The sound adjusting circuit 113 is connected to the speakers 17 provided at the doors 16 (see FIG. 2), the first image adjusting circuit 114 and second image adjusting circuit 115 are connected through signal lines to the image output unit 116, and the image output unit 116 is connected through a signal line to a liquid crystal panel 21 of the display unit 4 and through signal lines to a rear display unit 117.

Note that the rear display unit 117 is provided for the rear seats of the car and is designed to be able to display an image the same as that displayed on the display unit 4 through the image output unit 116 or one of the driver's seat use image or passenger's seat use image. The display unit 4 is comprised of a backlight 30, liquid crystal panel 21, and touch panel 118. The operation signal to the touch panel 118 is input to the control unit 100.

Further, a brightness detecting section (for example, car light switch, optical sensor, etc.) 119, passenger detecting section (for example, pressure sensor etc.) 120, communicating unit 121 having a wireless communication function, ETC car-mounted equipment 122, remote control transmission/reception unit 124 for transferring data with a remote controller 123, operating unit 15, and memory 125 are connected to the control unit 100.

The control unit 100 is connected through control lines to various types of sources 101 to 106, a distribution circuit 107, an external sound/image (picture) input unit 108, various types of adjusting circuits 113 to 115, an image output unit 116, a display unit 4, and other parts in the system and is configured to control the parts of the system overall.

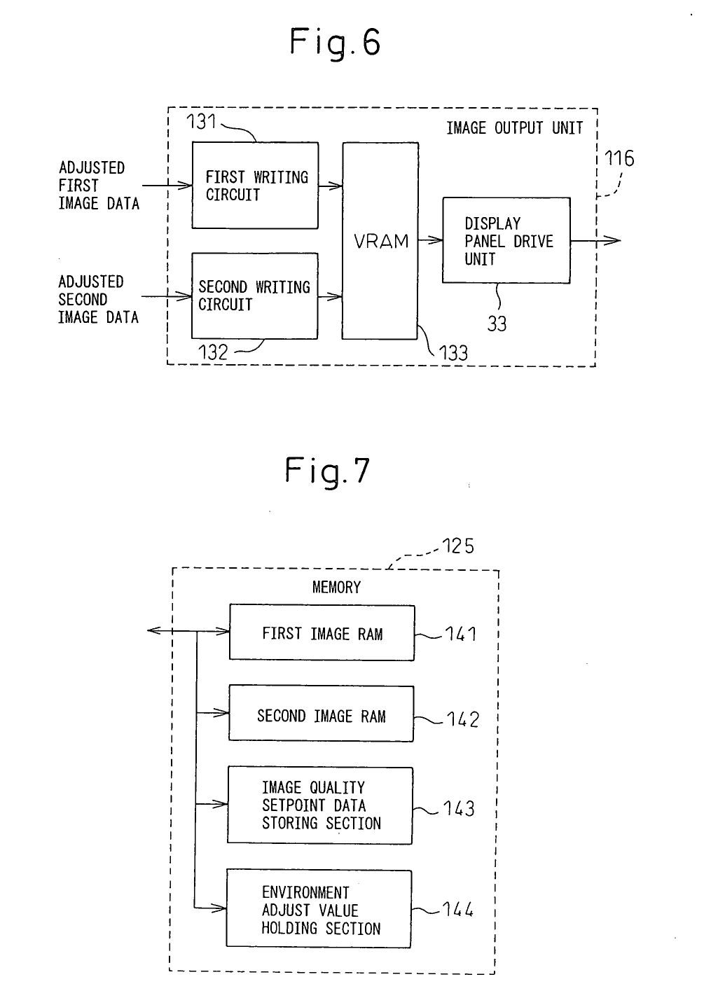

FIG. 6 is a block diagram showing the general configuration of the image output unit 116. Components having the same function as the parts explained in FIG. 1 to FIG. 5 are assigned the same notations. The image output unit 116 is comprised of a first writing circuit 131 connected to the first image adjusting circuit 114 (see FIG. 5), a second writing circuit 132 connected to the second image adjusting circuit 115, a VRAM 133, and a display panel drive unit 33.

For example, the first writing circuit 131 writes image data corresponding to the even number columns of the image in the image data adjusted by the first image adjusting circuit 114 in the corresponding region in the VRAM 133, while the second writing circuit 132 writes image data corresponding to the odd number columns of the image in the image data adjusted by the second image adjusting circuit 115. The display panel drive unit 33 is a circuit for driving the liquid crystal panel 21 (see FIG. 3, FIG. 5) and is designed to drive the corresponding pixels of the liquid crystal panel 21 based on the image data stored in the VRAM 133 (composite data of first image data D1 and second image data D2).

Note that the VRAM 133 is written with image data so as to correspond to a multiview display use image combining the first image data D1a and the second image data D2. A single drive circuit is sufficient. The operation is also the same as the operation of the drive circuit of an ordinary liquid crystal display device. Further, as another mode, it is also possible to provide a first display panel drive unit and second display panel drive unit driving corresponding pixels of the liquid crystal panel 21 based on the first image data D1 and second image data D2 without combining those image data.

FIG. 7 is a block diagram showing the general configuration of the memory 125. The memory 125 is comprised of a first image RAM 141 and second image RAM 142 able to write image quality adjustment values of the first display image 5 (see FIG. 1) and second display image 6 set by the user, an image quality setpoint data storing section 143 in which a plurality of levels of adjustment values for adjustment of the quality of the first display image 5 and second display image 6 are selectively stored, and an environment adjust value holding section 144 holding the state of adjustment of the quality of the first display image 5 and second display image 6 for the surrounding environment. The image quality setpoint data storing section 143 and environment adjust value holding section 144 are comprised of a flash memory or other electrically rewritable nonvolatile memory or battery backed up volatile memory.

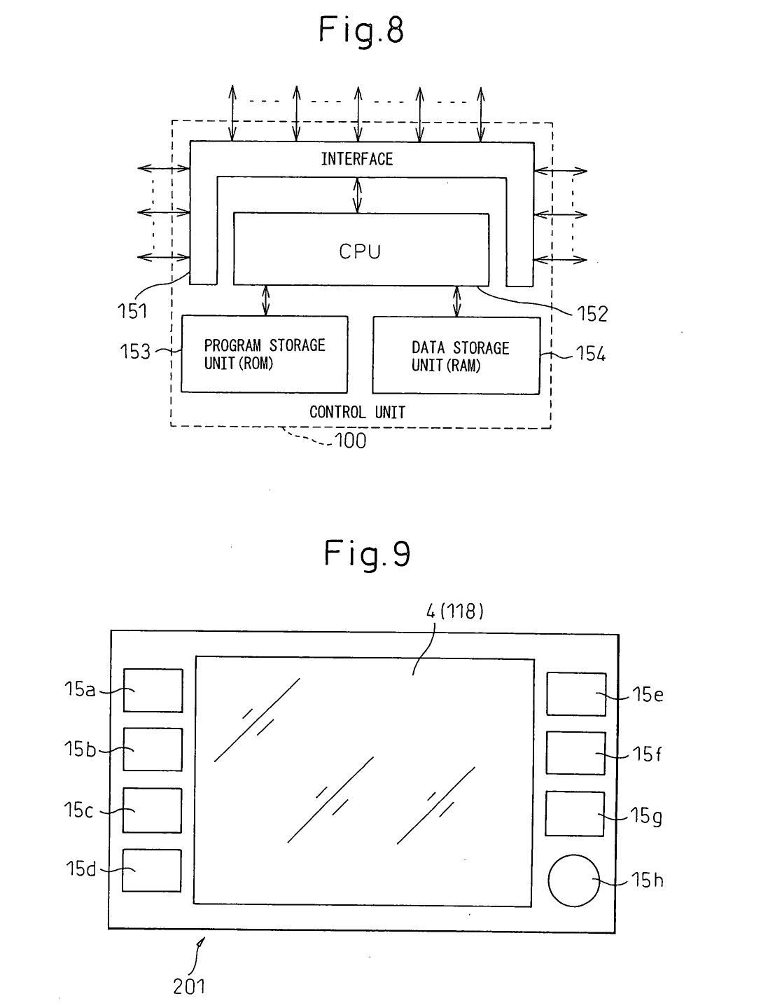

FIG. 8 is a block diagram showing the general configuration of the control unit 100. The control unit 100 is comprised of an interface 151 connected to the different parts in the system, a CPU 152 controlling the different parts of the system as a whole, a program storage unit (ROM) 153 storing the various types of programs required for system operation, and a data storage unit (RAM) 154 storing various types of data. Note that the ROM 153 and the RAM 154 may be built in the CPU 152 or may be provided externally. The ROM 153 may also be an electrically rewritable nonvolatile memory like a flash memory.

The control unit 100, as shown in FIG. 5, is designed to perform various types of control based on operation signals from the touch panel 118 or operating unit 15, remote controller 123, etc. and for example controls the various types of sources 101 to 106 and distribution circuit 107, controls the output of the image data or sound data of the selected two sources or one source, and controls the image data or sound data of the selected source(s) through the distribution circuit 107 to distribute the image data to the first image adjusting circuit 114 and second image adjusting circuit 115 and the sound data to the sound adjusting circuit 113.

The first image adjusting circuit 114 and second image adjusting circuit 115 adjust the image data in luminance and hue, contrast, etc. based on a control signal from the control unit 100 and output the adjusted image data to the image output unit 116. The image output unit 116 drives the liquid crystal panel 21 to display the image based on a control signal from control unit 100.

Further, the sound adjusting circuit 113 adjusts the balance, volume, audio, etc. of the speakers 17 based on a control signal from the control unit 100 and outputs the adjusted sound from the speakers. Further, the control unit 100 performs control to display an operation menu for controlling the various types of sources 101 to 106.

For example, when the HD replay unit 105 is selected, the MP3 file or other music data or JPEG file or other image data, navigation use map data, etc. stored in the hard disk (not shown) is read out and a menu display for selection of the music data etc. or image data are displayed on the display unit 4. Note that the navigation unit 106 is provided with a map information storage unit (using a region of part of the hard disk) storing map information used for navigation and is able to display on the display unit 4 a navigation image generated utilizing the information obtained through the VICS information receiver unit 111 or GPS information receiver unit 112. Further, the TV receiver unit 103 is designed to receive a desired analog TV broadcast signal or a digital TV broadcast signal through any of the antennas 110a to 110d selected by the selector 110.

Further, the control unit 100 performs control for changing the settings of the output image or sound based on the information detected by the brightness detecting section 119 or individual detecting section 120. Further, the communicating unit 121 and the ETC car-mounted equipment 122 are connected to the control unit 100. The control unit 100 performs control to make the display unit 4 display toll information from the ETC car-mounted equipment 122 or controls the communicating unit 121 for wireless connection with a mobile phone etc. to perform control to make the display unit 4 display information relating to that control. Further, the control unit 100 performs processing for storing image quality setting information or programs, car information, and other various types of setting information in the memory 125.

The above FIG. 1 to FIG. 8 explain the parts of the configuration common to all of the embodiments explained below.

Below, an AV navigation employing a system in which a display device according to embodiment (1) of the present invention will be explained.

FIG. 9 is a view showing a front view of the appearance of a display device according to embodiment (1). In the figure, 201 indicates a display device. The display device 201 is comprised of a display unit 4 formed with the touch panel 118 on its surface and an operating unit 15 (operating switches 15a to 15h) provided around it.

The display unit 4, as shown in FIG. 3, includes a parallax barrier 26 etc. and displays the driver's seat use picture G_{DR} and the passenger's seat use picture G_{PA} split on the common screen. The driver DR can be made to view the driver's seat use picture G_{DR}, while the passenger's seat passenger PA can be made to view the passenger's seat use picture G_{PA}.

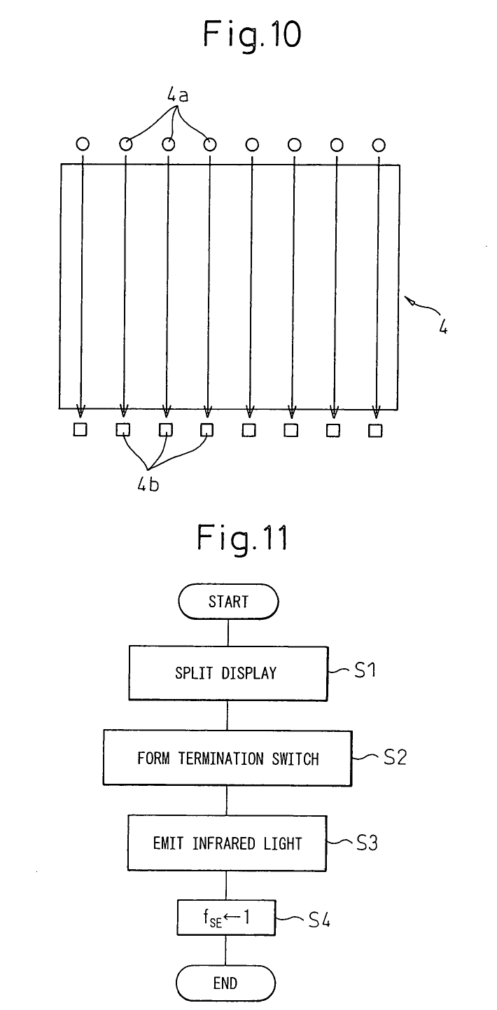

Further, at the top and bottom ends of the display unit 4, as shown in FIG. 10, infrared ray LEDs 4a and phototransistors 4b are arranged facing each other. These infrared ray LEDs 4a and phototransistors 4b are used for judging from which direction (driver's seat or passenger's seat) the operation input was made.

If a finger etc. approaches the display unit 4, the infrared rays emitted from the infrared ray LEDs 4a are blocked, the infrared rays no longer reach the phototransistors 4b, and the phototransistors 4b turn off. For example, when turning off in order from the phototransistors 4b present at the right side, the finger approached from the right side, that is, the driver's seat side, while conversely when turning off in order from the phototransistors 4b present at the left side, the finger approached from the left side, that is, the passenger's seat side.

Further, the control unit 100 receives as input the signals from the phototransistors 4b, can recognize the on/off states of the phototransistors 4b, and can judge from which direction the operation input was made. Note that the judgment of from which direction the operation input was made is not limited to this. When judging this by a different mode, the infrared ray LEDs 4a and phototransistors 4b are not always necessary.

A processing operation [1-11] performed by the control unit 100 in an AV navigation system employing the display device according to embodiment (1) will be explained based on the flowchart shown in FIG. 11. Note that this processing operation [1-1] is an operation performed when a split display (multiview) allowing the driver DR to view the driver's seat use picture G_{DR} and allowing the passenger's seat passenger PA to view the passenger's seat use picture G_{PA} is instructed from the user by operation of an operating switch or the operating unit 15 formed on the display unit 4, the remote controller 123, etc.

Note that when the split display is the default (that is, when a split display is performed after the power of the AV navigation system is turned on), there is no need for an instruction of a split display from the user, the processing operation [1-1] explained from here becomes unnecessary, and the split display flag f_{SE} for showing that split display is being performed also becomes unnecessary. However, when using the infrared ray LEDs 4a and phototransistors 4b for the judgment of from which direction the operation input was made, it is necessary to make the infrared ray LEDs 4a emit infrared light at some sort of timing and set a state enabling an object (for example, finger) approaching the display unit 4 to be detected.

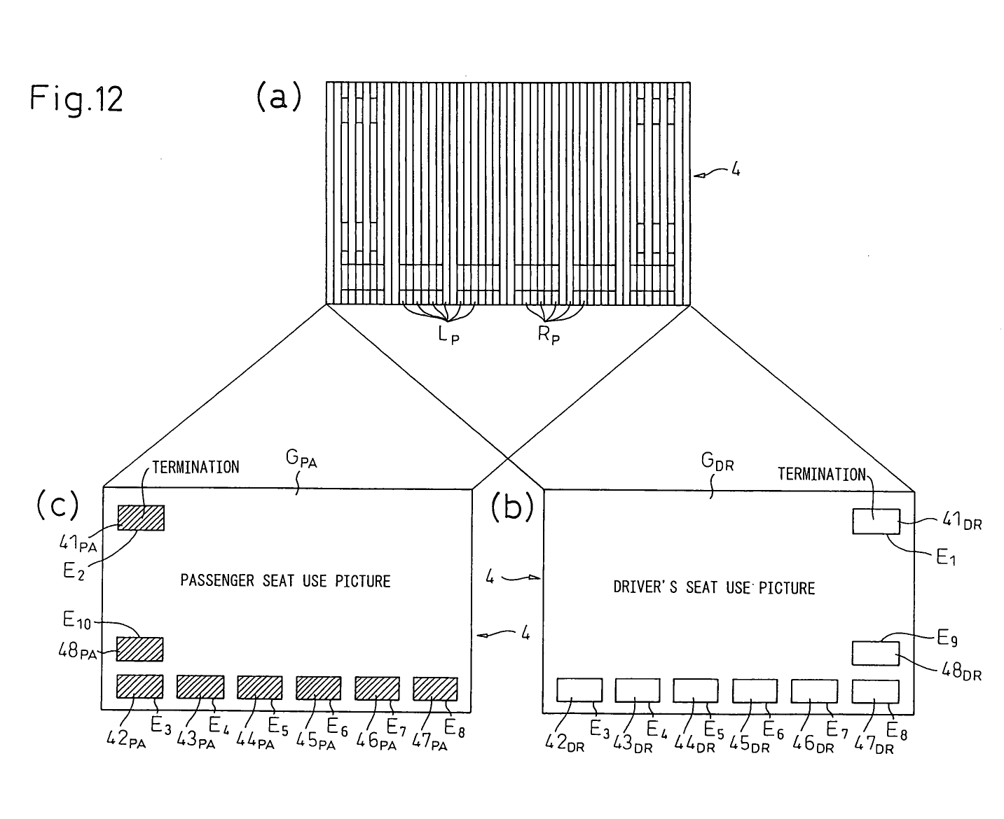

If the user instructs a split display, first, based on predetermined conditions, as shown in FIG. 12, one of the two pictures is displayed as the driver's seat use picture G_{DR} and the other is displayed as the passenger's seat use picture G_{PA} (step S1), then a termination switch 41_{DR} for termination of the split display is formed at the top right of the driver's seat use picture G_{DR} and a termination switch 41_{PA} for termination of the split display is formed at the top left of the passenger's seat use picture G_{PA} (step S2). Note that as the method of the split display, for example, when a map picture for guidance to the destination is displayed, the method of making the map picture the driver's seat use picture G_{DR} and making a television picture or movie etc. the passenger's seat use picture G_{PA} or the method of displaying the last memories at the viewing directions or the high frequency use ones may be mentioned.

FIG. 12(a) is an explanatory view for explaining pixels used for the driver's seat use picture G_{DR} and pixels used for the passenger's seat use picture G_{PA}, FIG. 12(b) is a view showing an example of the driver's seat use picture G_{DR}, and FIG. 12(c) is a view showing an example of the passenger's seat use picture G_{PA}. As shown in FIG. 12(a), the even number columns or half of the total number of pixels in the horizontal direction (right side pixels R_{P}) are used for the driver's seat use picture G_{DR}, while the odd number columns (left side pixels L_{P}) are used for the passenger's seat use picture G_{PA}.

From FIG. 12, it is learned that the termination switch 41_{DR} is arranged in the region E₁, the termination switch 41_{PA} is arranged in the region E₂ not overlapping with the region E₁, the termination switch 41_{DR} receives only operation input for the driver's seat use picture G_{DR}, and the termination switch 41_{PA} receives only operation input for the passenger's seat use picture G_{PA}.

Further, the operating switches 42_{DR} to 47_{DR} provided at the driver's seat use picture G_{DR} and the operating switches 42_{PA} to 47_{PA} provided at the passenger's seat use picture G_{PA} are arranged in the same regions E₃ to E₈. These operating switches are designed so that the operating region on the display screen for the driver's seat use picture G_{DR} and the operating region on the display screen for the passenger's seat use picture G_{PA} overlap.

An operating switch 48_{DR} provided at the driver's seat use picture G_{DR} is arranged at a region E₉, while an operating switch 48_{PA} provided at the passenger's seat use picture G_{PA} is arranged at a region E₁₀ not overlapping with the region E₉. The operating switch 48_{DR} is designed to receive only the operation input to the driver's seat use picture G_{DR}, while the operating switch 48_{PA} is designed to receive only the operation input to the passenger's seat use picture G_{PA}.

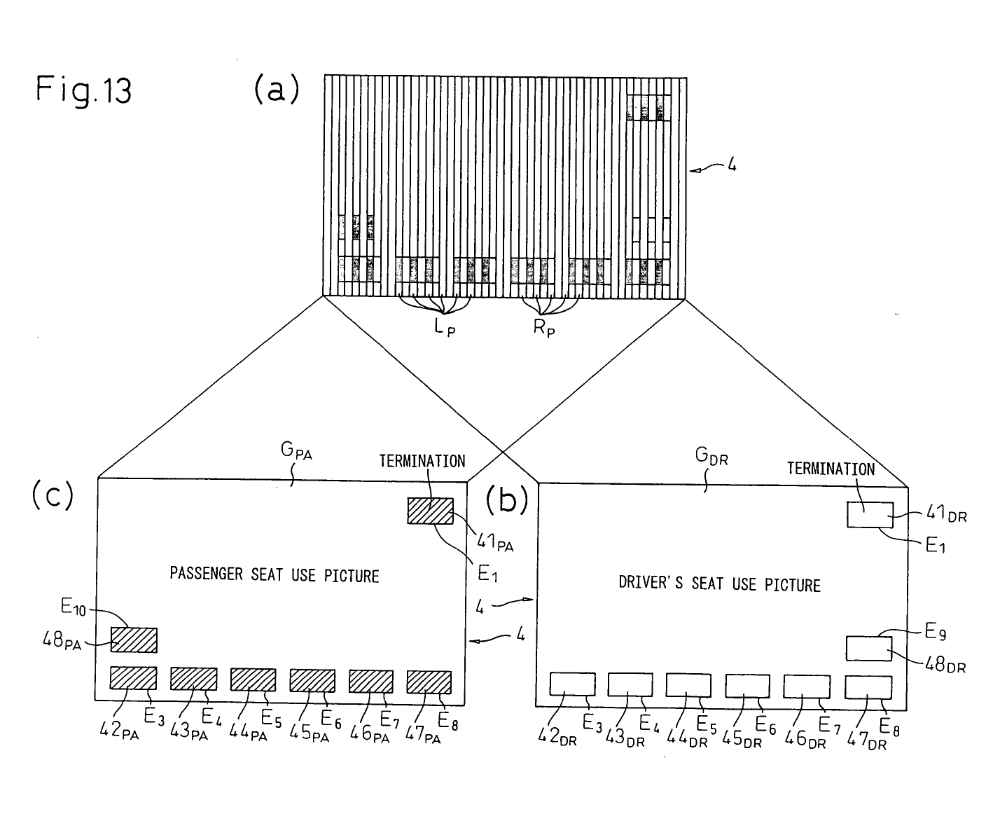

Note that in FIG. 12, the termination switch 41_{DR} is arranged at the region E₁, while the termination switch 41_{PA} is arranged in the region E₂ not overlapping the region E₁, but in another embodiment, for example, as shown in FIG. 13, the termination switch 41_{PA} may also be arranged in the region E₁ in which the termination switch 41_{DR} is arranged.

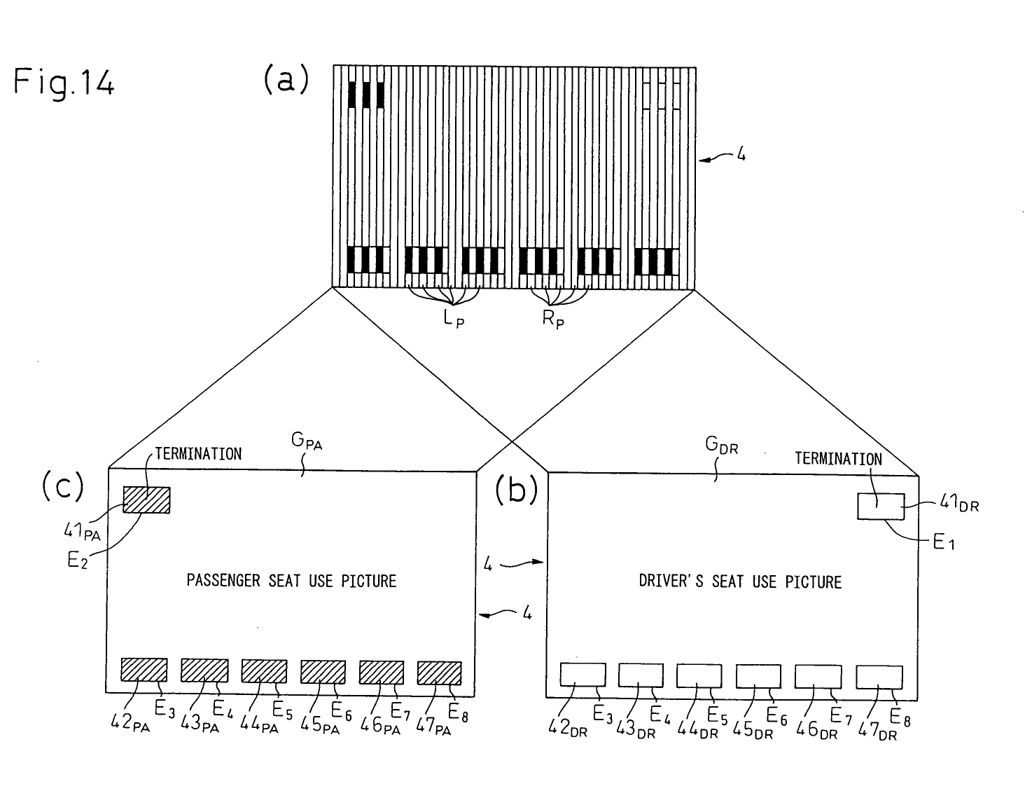

Further, in FIG. 12, the operating switch 48_{DR} is arranged in the region E₉ and the operating switch 48_{PA} is arranged in the region E₁₀ not overlapping the region E₉, but in another embodiment, for example, as shown in FIG. 14, the layouts of the operating switches may be made the same for the driver's seat use picture G_{DR} and the passenger's seat use picture G_{PA}.

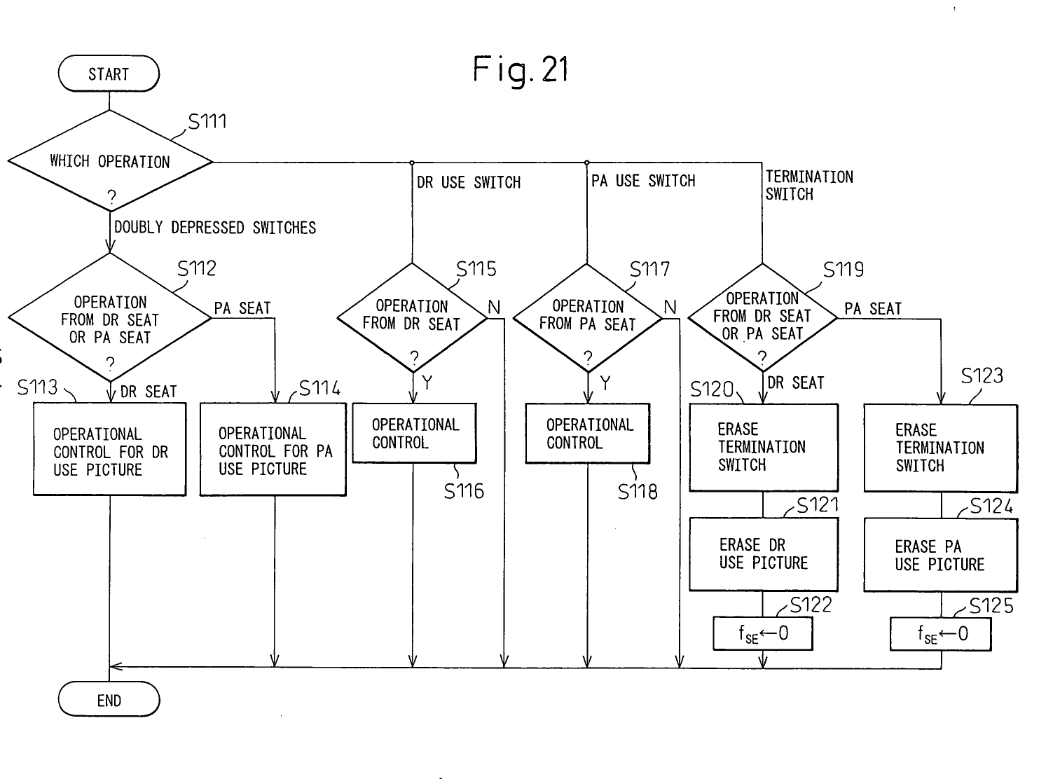

Further, the layouts of the operating switches (42_{DR} to 47_{DR} and 42_{PA} to 47_{PA}), as shown in FIG. 14, may be made the same for the driver's seat use picture G_{DR} and passenger's seat use picture G_{PA} and the layouts of the termination switches (41_{DR} and 41_{PA}), as shown in FIG. 13, may be made the same for the driver's seat use picture G_{DR} and the passenger's seat use picture G_{PA}. Further, as explained above, when a split display is the default, the termination switches (41_{DR} and 41_{PA}) are not required. Note that the processing operation when arranging the termination switches and operating switches as shown in FIG. 13 and FIG. 14 will be explained later using the flowcharts shown in FIG. 21 to FIG. 28.

Further, the operating switches 15a to 15h arranged around the display unit 4 (see FIG. 9) may be designed to handle both of the driver's seat use picture G_{DR} and passenger's seat use picture G_{PA} or may be designed to handle only one or these may be mixed.

After the processing of step S2, the infrared ray LEDs 4a provided at the display unit 4 are made to emit infrared light to set a state where an object (for example, finger) approaching the display unit 4 can be detected (step S3), then a split display flag f_{SE} for showing that a split display is being performed is set to “1” (step S4).

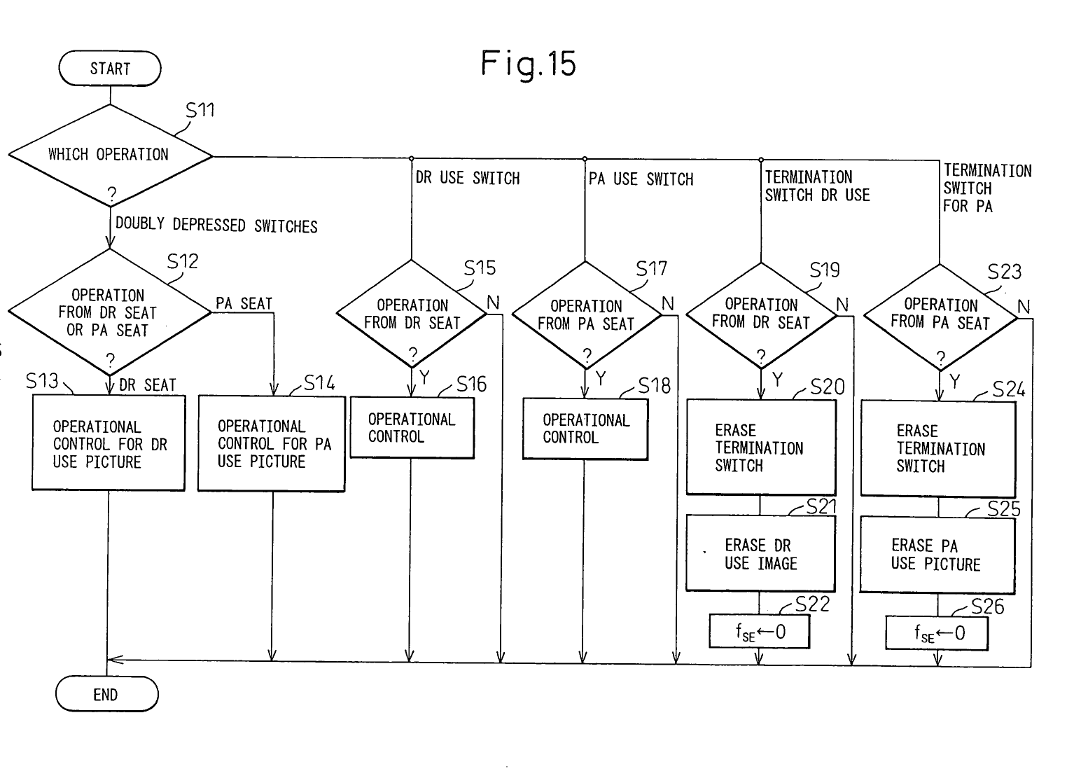

Next, a processing operation [1-2] performed by the control unit 100 in an AV navigation system employing the display device according to the embodiment (1) will be explained based on the flowchart shown in FIG. 15. Note that this processing operation [1-2] is an operation performed when the split display is performed (that is, when the split display flag f_{SE} is “1”) and the user operates termination switches 41_{DR}, 41_{PA} or operating switches 42_{DR} to 48_{DR}, 42_{PA} to 48_{PA} formed on the display unit 4, operating switches 15a to 15h forming part of the operating unit 15, etc. However, when the split display is the default as explained above, only naturally the split display flag f_{SE} is unnecessary. The split display flag f_{SE} being “1” is not included in the starting conditions.

First, it is judged which operating switch was operated (step S11). If judging operating switches where the operating region on the display screen for the driver's seat use picture G_{DR} and the operating region on the display screen for the passenger's seat use picture G_{PA} overlap (overlapping switches (for example, operating switches 42_{DR} to 47_{DR} and 42_{PA} to 47_{PA})) are operated, next whether a switch was operated from the driver's seat side or was operated from the passenger's seat side is judged based on information obtained from the phototransistors 4b (step S12).

When turning off in order from the phototransistors 4b present at the right side of the bottom of the display unit 4, the finger approached from the right side, so it is judged that the operation was performed from the driver's seat side, while conversely when turning off in order from the phototransistors 4b present at the left side of the bottom of the display unit 4, the finger approached from the left side, so it is judged that the operation was performed from the passenger's seat side.

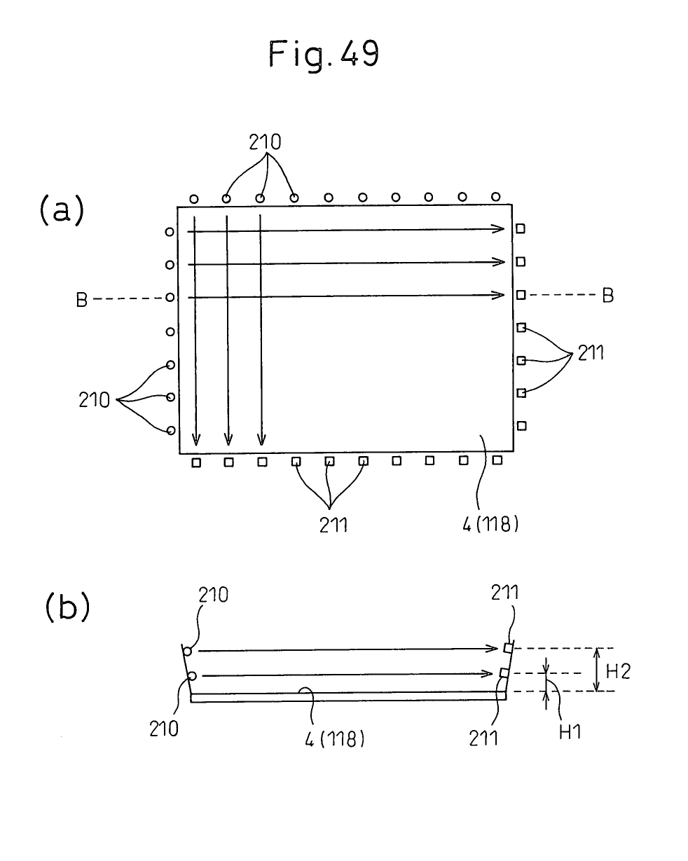

Note that the mode of the judgment of from which direction the operation input was made is not limited to this. For example, a mode of providing infrared ray sensors detecting infrared rays emitted by the finger (human body) at the left and right ends of the display unit 4 and making a judgment from the state of detection of infrared rays may be mentioned. This other mode will be explained in detail later using FIG. 49 to FIG. 55.

At step S12, if it is judged that the operation was performed from the driver's seat side, operational control in accordance with the operation on the driver's seat use picture G_{DR} is performed (step S13), while if it is judged that the operation was performed from the passenger's seat side, operational control in accordance with the operation for the passenger's seat use picture G_{PA} is performed (step S14).

Further, at step S11, if judging that an operating switch receiving only operation input corresponding to the driver's seat use picture G_{DR} (for example, operating switch 48_{DR}, however, termination switch 41_{DR} excluded) is operated, next, it is judged that the operation was performed from the driver's seat side based on the information obtained from the phototransistors 4b (step S15).

If judging that the operation was performed from the driver's seat side, operational control in accordance with the operation is performed (step S16), while if it is judged that the operation was not performed from the driver's seat side (that is, the operation was performed from the passenger's seat side), the operation is deemed an erroneous operation and the processing operation [1-2] is ended as it is.

Further, at step S11, if judging that an operating switch receiving only operation input corresponding to the passenger's seat use picture G_{PA} (for example, operating switch 48_{PA}, however, termination switch 41_{PA} excluded) is operated, next, it is judged that the operation was performed from the passenger's seat side based on information obtained from the phototransistors 4b (step S17).

If it is judged that the operation was performed from the passenger's seat side, operational control in accordance with the operation is performed (step S18), while if it is judged that the operation was not performed from the passenger's seat side (that is, the operation was performed from the driver's seat side), the operation is deemed an erroneous operation and the processing operation [1-2] is ended as it is.

Further, at step S11, if it is judged that the termination switch 41_{DR} provided at the driver's seat use picture G_{DR} for terminating the split display is operated, next it is judged if the operation was performed from the driver's seat side based on the information obtained from the phototransistors 4b (step S19).

If it is judged that the operation was performed from the driver's seat side, the termination switches 41_{DR}, 41_{PA} are erased from the screen (step S20), among the two pictures, the driver's seat use picture G_{DR} is erased and the passenger's seat use picture G_{PA} is displayed on the full screen (step S21), then the split display flag f_{SE} is returned to zero (step S22). On the other hand, if it is judged that the operation was not performed from the driver's seat side (that is, the operation was performed from the passenger's seat side), the operation is deemed an erroneous operation and the processing operation [1-2] is ended as it is.

Further, at step S1, when it is judged that the termination switch 61_{PA} provided at the passenger's seat use picture G_{PA} for terminating the split display is operated, next it is judged if the operation was performed from the passenger's seat side based on information obtained from the phototransistors 4b (step S23).

If it is judged that the operation was performed from the passenger's seat side, the termination switches 41_{DR}, 41_{PA} are erased from the screen (step S24), among the two pictures, the passenger's seat use picture G_{PA} is erased and the driver's seat use picture G_{DR} is displayed on the full screen (step S25), then the split display flag f_{SE} is returned to zero (step S26). On the other hand, if it is judged that the operation was not performed from the passenger's seat side (that is, the operation was performed from the driver's seat side), the operation is deemed an erroneous operation and the processing operation [1-2] is ended as it is.

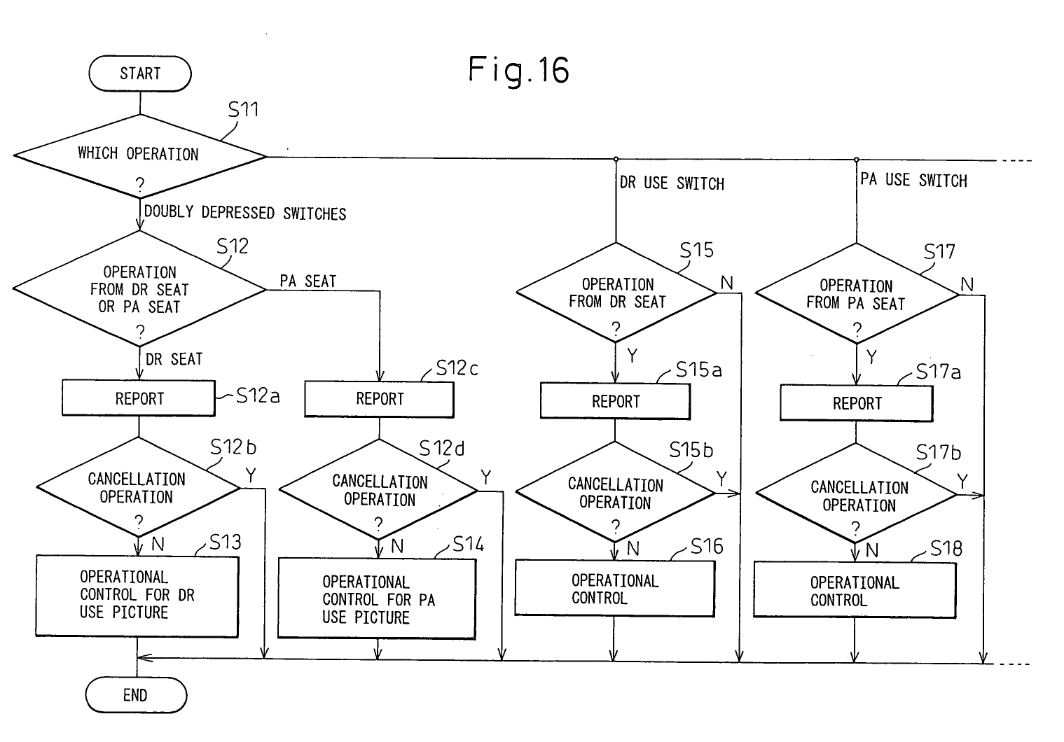

Here, if the operation direction becomes clear as with the processing operation of steps S12 to S14, the corresponding operational control is performed. In a display device according to another embodiment, as shown in FIG. 16, the content of the operational control is reported to the user before operational control (step S12a, S12c, S15a, S17a) and the user is given an opportunity for confirmation (request for input of confirmation information). If the user indicates his or her intent of cancellation within a predetermined time (for example, 3 seconds) (input of confirmation information) (steps S12b, S12d, S15b, S17b), the operational control need not be executed. Note that as the reporting method, for example, the method of output by audio from the speakers 17 or the method of display of the report image may be mentioned.

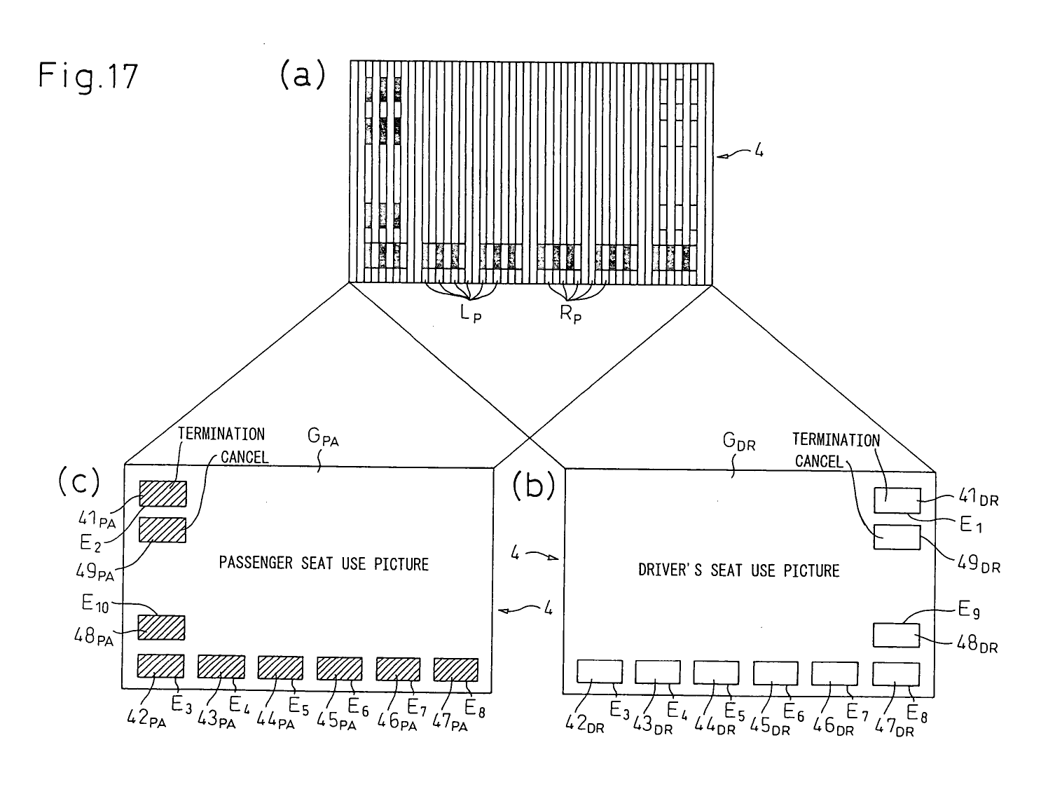

Further, as the method of the confirmation the intent of cancellation by the user, for example, the method of judging if the user speaks the word “cancel” or, as shown in FIG. 17, the method of providing the cancellation switches 49_{DR}, 49_{PA} and pressing a cancellation switch 49_{DR} or 49_{PA} may be mentioned.

Further, here, by reporting the content of the operational control, the fact that there was some sort of operation is reported, but in another embodiment, it is also possible to display the above-mentioned “cancellation switch” or the later-mentioned “confirmation switch” so as to report the fact that there was some sort of operation.

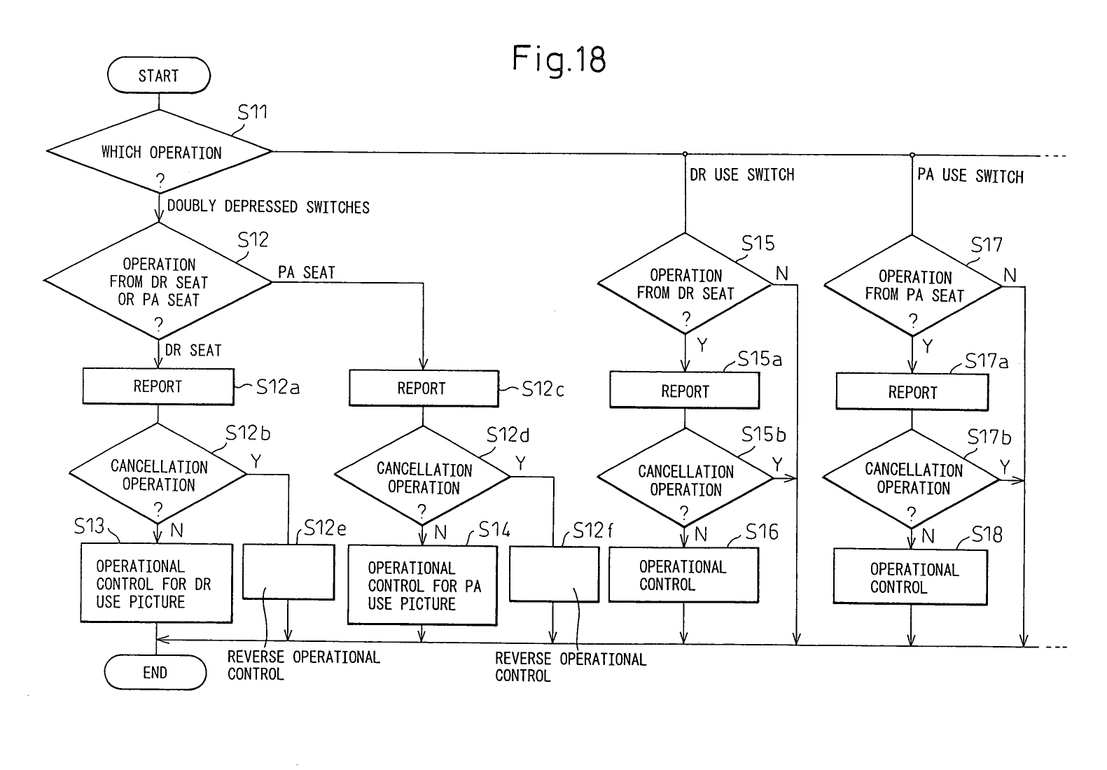

Further, in a display device according to still another embodiment, when operational control in accordance with an operation on the operating switches 42_{DR} to 47_{DR}, 42_{PA} to 47_{PA} arranged so that the operating regions on the display screen for the driver's seat use picture G_{DR} and the operating regions on the display screen for the passenger's seat use picture G_{PA} overlap as shown in FIG. 18 (overlapping switches), for example, operational control for the driver's seat use picture G_{DR}, is cancelled, operational control for the passenger's seat use picture G_{PA} is performed (step S12e), while conversely when operational control for the passenger's seat use picture G_{PA} is cancelled, operational control for the driver's seat use picture G_{DR} may be performed (step S12f). Due to this, not only can execution of operational control not desired by the user be prevented, but also the work of redoing the operation etc. can be reduced.

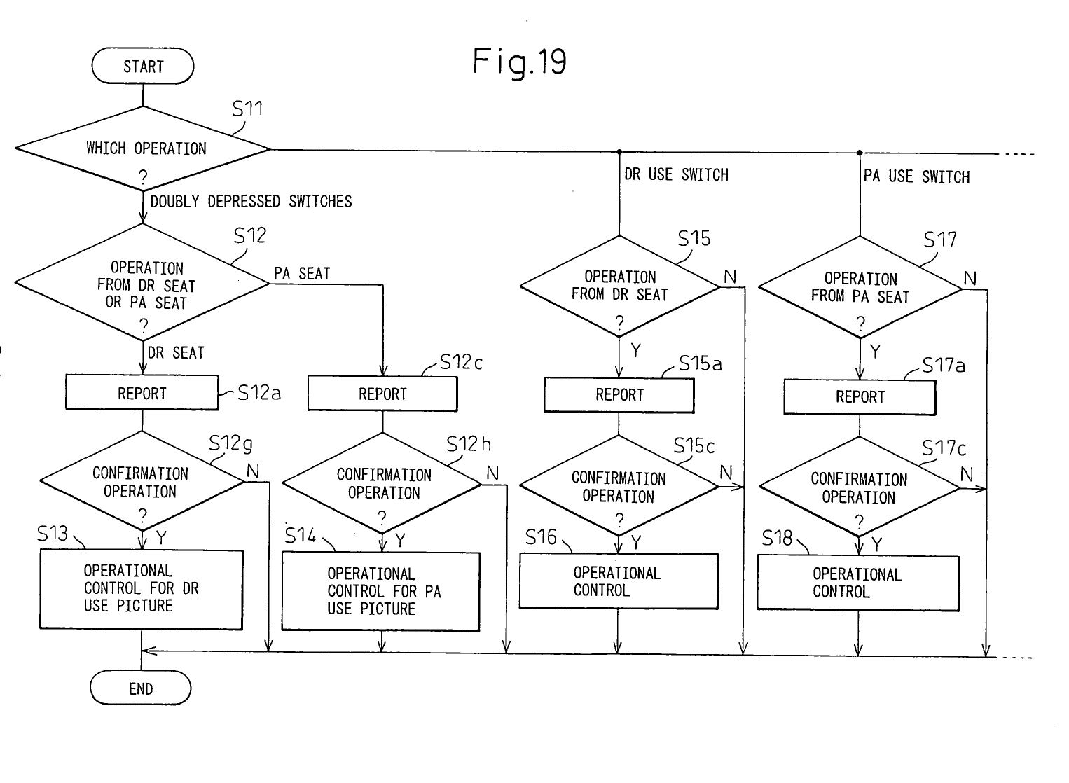

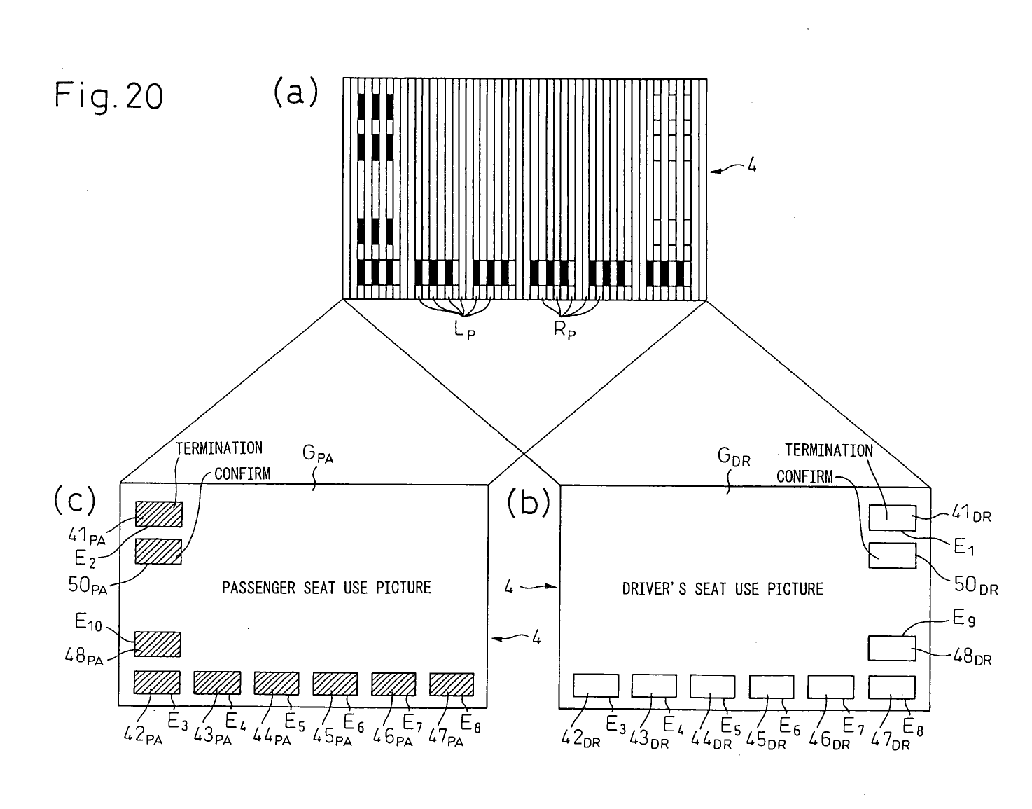

Further, in a display device according to another embodiment, as shown in FIG. 19, before operational control, the content of the operational control is reported to the user (step S12a, S12c, S15a, S17a) and the user is given an opportunity for confirmation (request for input of confirmation information). If the user indicates his or her intent of confirmation within a predetermined period (for example, 3 seconds) (input of confirmation information) (steps S12g, S12h, S15c, S17c), the operational control is executed. If the user does not indicate his or her intent of confirmation, the operational control need not be executed either. Note that as the method of the user confirming the intent of confirmation, for example, the method of judging if the user has said “OK” or, as shown in FIG. 20, the method of providing confirmation switches 50_{DR}, 50_{PA} and judging if a confirmation switch 50_{DR} or 50_{PA} has been pushed may be mentioned.

According to the AV navigation system employing a display device according to embodiment (1), it is judged if the operation on operating switches arranged so that the operating region on the display screen for the driver's seat use picture G_{DR} and the operating region on the display screen for the passenger's seat use picture G_{PA} overlap (for example, operating switches arranged in the same region such as the operating switches 42_{DR} to 47_{DR} and 42_{PA} to 47_{PA} shown in FIG. 12) was made from the driver's seat side or was made from the passenger's seat side. If the operation was made from the driver's seat side, operational control in accordance with the operation on the driver's seat use picture G_{DR} is performed, while if it is judged that the operation was made from the passenger's seat side, operational control in accordance with the operation for the passenger's seat use picture G_{PA} is performed.

For example, when the operating switches 42_{DR}, 42_{PA} arranged so that the operating region on the display screen for the driver's seat use picture G_{DR} and the operating region on the display screen for the passenger's seat use picture G_{PA} overlap (overlapping switches) are operated by the driver DR, just the operation on the driver's seat use picture G_{DR} is validated (that is, the operating switch 42_{DR} is operated) and an operation on the passenger's seat use picture G_{PA} is invalidated. Therefore, the suitable operational control desired by the user can be realized.

In this way, even when operating switches 42_{DR} to 47_{DR} and 42_{PA} to 47_{PA} arranged so that the operating region on the display screen for the driver's seat use picture G_{DR} and the operating region on the display screen for the passenger's seat use picture G_{PA} (overlapping switches) are operated, the operational control desired by the user can be realized. In other words, it is possible to arrange operating switches of different properties in the same region as shown by the operating switches 42_{DR} to 47_{DR} and 42_{PA} to 47_{PA} shown in FIG. 12, so the display screen can be more effectively used.

Below, an AV navigation system employing a display device according to embodiment (2) of the present invention will be explained.

However, the AV navigation system is configured in the same way as the AV navigation system shown in FIG. 5 except for the control unit 100, so the control unit is assigned a different notation. The rest of the explanation will be omitted.

The control unit 100A performs a processing operation [2-1] similar to the processing operation [1-1] performed by the control unit 100 (see FIG. 11) to control the pixel display as shown in FIG. 13(a), display the driver's seat use picture G_{DR} such as shown in FIG. 13(b), and display the passenger's seat use picture G_{PA} such as shown in FIG. 13(c).

Next, a processing operation [2-2] performed by the control unit 100A in an AV navigation system employing the display device according to embodiment (2) will be explained based on the flowchart shown in FIG. 21. Note that this processing operation [2-2] is an operation performed when the split display is performed (that is, when the split display flag f_{SE} is “1”) and the user operates one of the termination switches 41_{DR}, 41_{PA} or operating switches 42_{DR} to 48_{DR} and 42_{PA} to 48_{PA} formed on the display unit 4 or the operating switches 15a to 15h forming part of the operating unit 15.

First, it is judged which operating switch was operated (step S111). If it is judged that operating switches arranged so that the operating region on the display screen for the driver's seat use picture G_{DR} and the operating region on the display screen for the passenger's seat use picture G_{PA} overlap (overlapping switches (for example, operating switches 42_{DR} to 47_{DR}, 42_{PA} to 47_{PA}, however, termination switches 41_{DR}, 41_{PA} excluded)) were operated, next, it is judged whether the operation was performed from the driver's seat side or the operation was performed from the passenger's seat side based on the information obtained from the phototransistors 4b (step S112).

If it is judged that the operation was performed from the driver's seat side, operational control in accordance with the operation on the driver's seat use picture G_{DR} is performed (step S113), while if it is judged that the operation was performed from the passenger's seat side, operational control in accordance with the operation for the passenger's seat use picture G_{PA} is performed (step S114).

Further, at step S111, if it is judged that an operating switch receiving only operation input corresponding to the driver's seat use picture G_{DR} (for example, operating switch 48_{DR}) is operated, next it is judged if the operation was performed from the driver's seat side based on the information obtained from the phototransistors 4b (step S115).

If it is judged that the operation was performed from the driver's seat side, operational control according to the operation is performed (step S116). On the other hand, if it is judged that the operation was not performed from the driver's seat side (that is, the operation was performed from the passenger's seat side), the operation is deemed to be an erroneous operation and the processing operation [2-2] is ended as is.

Further, at step S111, if it is judged that an operating switch receiving only operation input corresponding to the passenger's seat use picture G_{PA} (for example, operating switch 48_{PA}) was operated, next it is judged if the operation was performed from the passenger's seat side based on information obtained from the phototransistors 4b (step S117).

If it is judged that the operation was performed from the passenger's seat side, operational control in accordance with the operation is performed (step S118), while if it is judged that the operation was not performed from the passenger's seat side (that is, the operation was performed from the driver's seat side), the operation is deemed to be an erroneous operation and the processing operation [2-2] is ended as is.

Further, at step S111, if it is judged that the termination switches 41_{DR}, 41_{PA} arranged so that the operating region on the display screen for the driver's seat use picture G_{DR} and the operating region on the display screen for the passenger's seat use picture G_{PA} overlap, next it is judged if the operation was performed from the driver's seat side based on the information obtained from the phototransistors 4b (step S119).

If it is judged that the operation was performed from the driver's seat side, the termination switches 41_{DR}, 41_{PA} are erased from the screen (step S120), among the two pictures, the driver's seat use picture G_{DR} is erased and the passenger's seat use picture G_{PA} is displayed on the full screen (step S121), then the split display flag f_{SE} is returned to zero (step S122).

On the other hand, if it is judged that the operation was not performed from the driver's seat side (that is, the operation was performed from the passenger's seat side), the termination switches 41_{DR}, 41_{PA} are erased from the screen (step S123), among the two pictures, the passenger's seat use picture G_{PA} is erased and the driver's seat use picture G_{DR} is displayed on the full screen (step S124), then the split display flag f_{SE} is returned to zero (step S125).

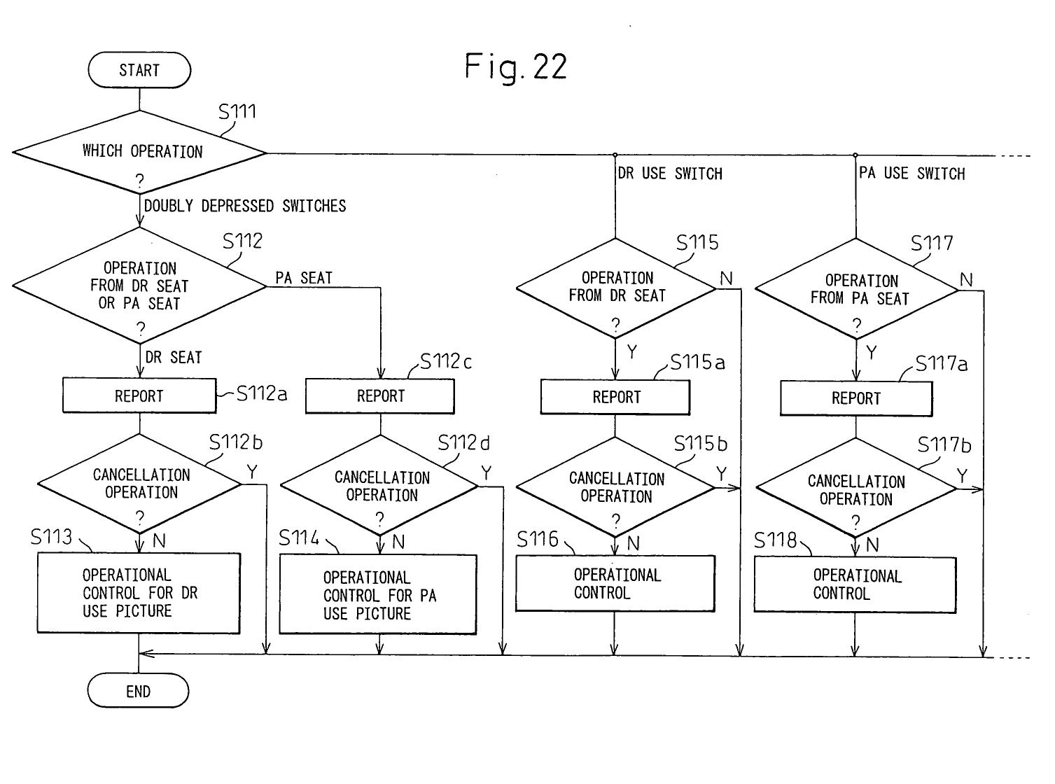

Here, as in the processing operation of step S112 to S114, if the operation direction is known, operational control corresponding to this is performed, but in a display device according to another embodiment, as shown in FIG. 22, the content of the operational control is reported to the user before operational control (step S112a, S112c, S115a, S117a) and the user is given an opportunity for confirmation (request for input of confirmation information). If the user indicates his or her intent of cancellation within a predetermined time (for example, 3 seconds) (input of confirmation information) (steps S112b, S112d, S115b, S117b), the operational control need not be executed. Note that as the reporting method, for example, the method of output by audio from the speakers 17 or the method of display of the report image may be mentioned.

Further, here, the content of the operational control is reported so as to report that there was some sort of operation, but in another embodiment, it is also possible to display the above-mentioned “cancellation switch” or the later mentioned “confirmation switch” to report that there was some sort of operation.

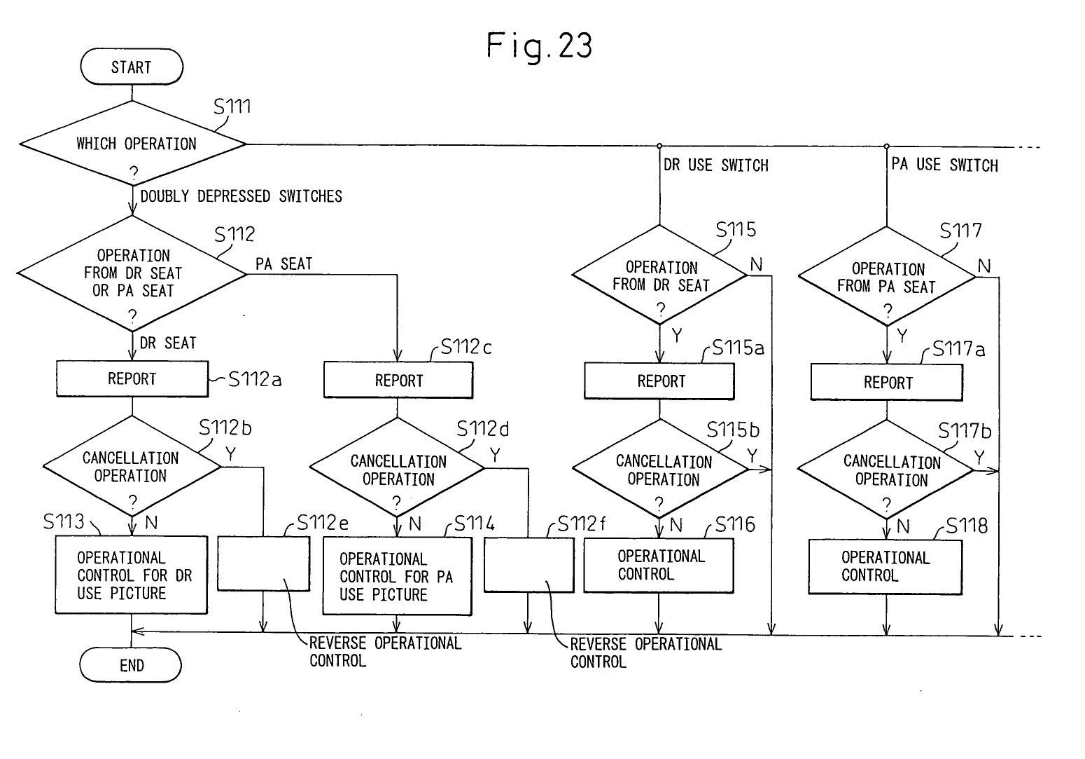

Further, in a display device according to another embodiment, as shown in FIG. 23, when operational control in accordance with an operation on operating switches 42_{DR} to 47_{DR} and 42_{PA} to 47_{PA} arranged so that the operating region on the display screen for the driver's seat use picture G_{DR} and the operating region on the display screen for the passenger's seat use picture G_{PA} overlap (overlapping switches), for example, operational control for the driver's seat use picture G_{DR}, is cancelled, operational control for the passenger's seat use picture G_{PA} is performed (step S112e), while conversely when operational control for the passenger's seat use picture G_{PA} is cancelled, operational control for the driver's seat use picture G_{DR} may also be performed (step S112f). Due to this, not only is it possible to prevent execution of operational control not desired by the user, but it is also possible to reduce the work of redoing the operation.

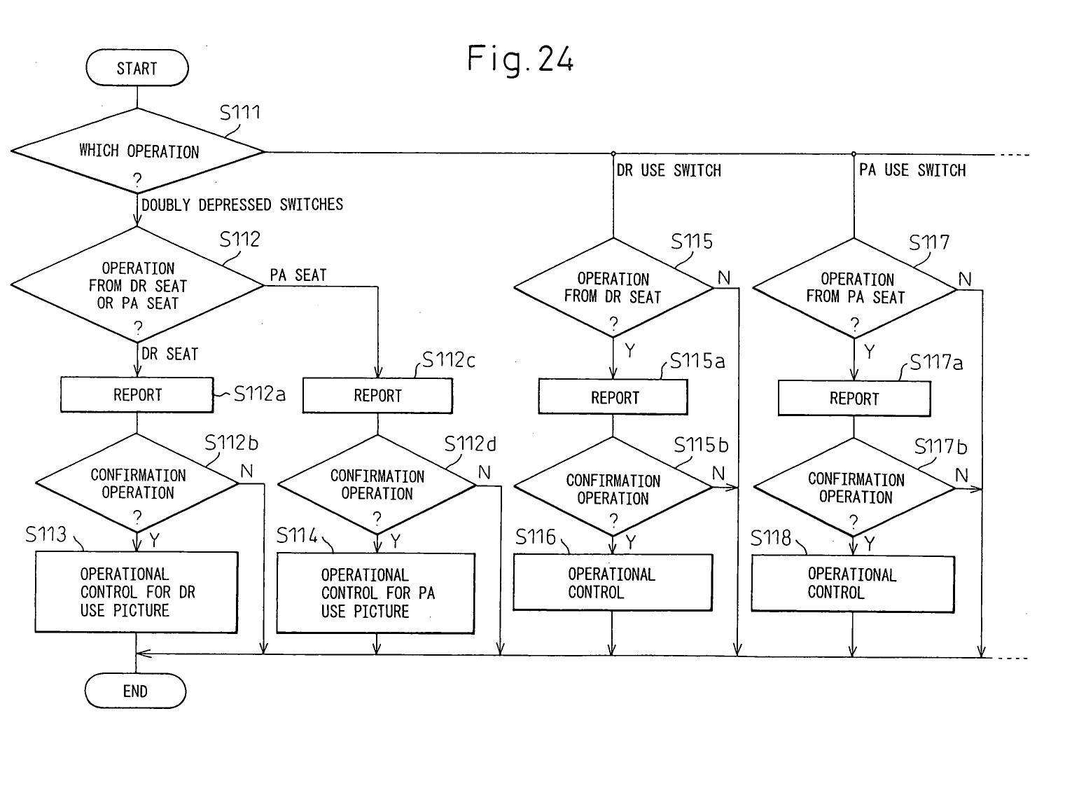

Further, in a display device according to another embodiment, as shown in FIG. 24, the content of the operational control is reported to the user before operational control (step S112a, S112c, S115a, S117a) and the user is given an opportunity for confirmation (request for input of confirmation information). If the user indicates his or her intent of confirmation within a predetermined time (for example, 3 seconds) (input of confirmation information) (steps S112g, S112h, S115c, S117c), the operational control is executed. If not indicating his or her intent of confirmation, the operational control need not be executed. Note that as the method of the user confirming his or her intent of confirmation, for example, the method of the user saying “OK” or, in the same way as shown in FIG. 20, the method of providing a confirmation switch and judging if the confirmation switch has been pressed may be mentioned.

Below, an AV navigation system employing a display device according to embodiment (3) of the present invention will be explained.

However, the AV navigation system is configured in the same way as the AV navigation system shown in FIG. 5 except for the control unit 100, so the control unit is assigned a different notation. The rest of the explanation will be omitted.

The control unit 100B performs a processing operation [3-1] similar to the processing operation [1-1] (see FIG. 11) performed by the control unit 100 to control the pixel display as shown in FIG. 14(a), display the driver's seat use picture G_{DR} such as shown in FIG. 14(b), and display the passenger's seat use picture G_{PA} such as shown in FIG. 14(c).

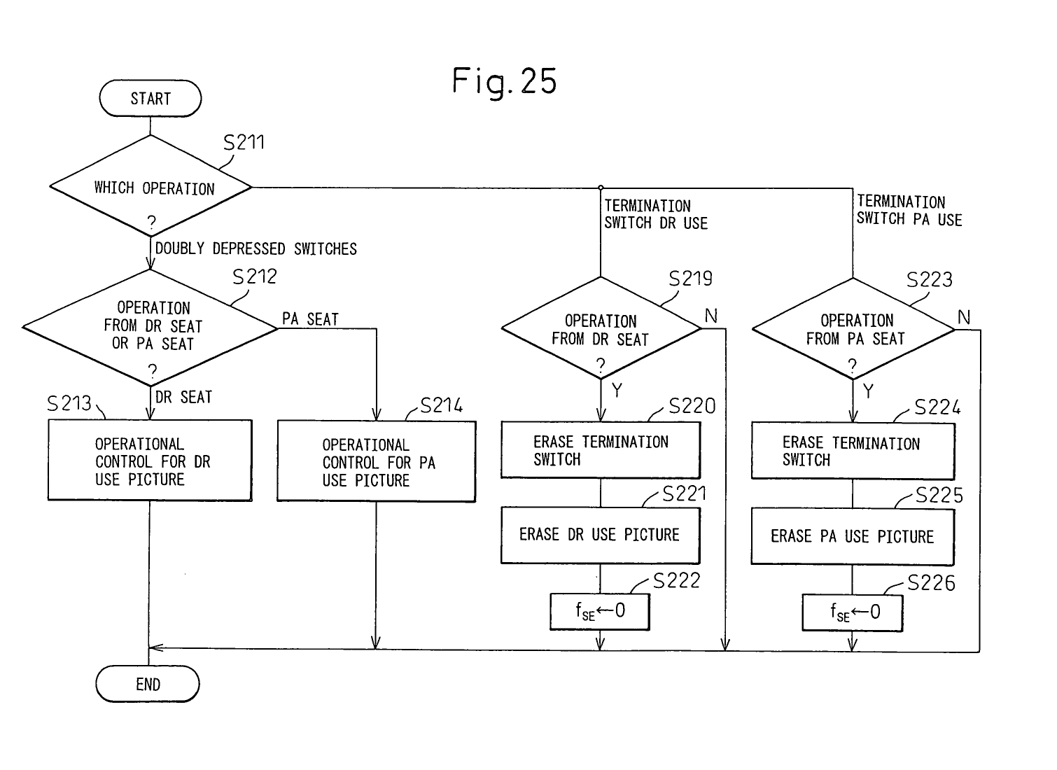

Next, a processing operation [3-2] performed by the control unit 100B in an AV navigation system employing the display device according to the embodiment (3) will be explained based on the flowchart shown in FIG. 25. Note that this processing operation [3-2] is an operation performed when the split display is performed (that is, when the split display flag f_{SE} is “1”) and the user operates one of the termination switches 41_{DR}, 41_{PA} or operating switches 42_{DR} to 47_{DR} and 42_{PA} to 47_{PA} formed at the display unit 4 or the operating switches 15a to 15h forming part of the operating unit 15 etc.

First, it is judged which operating switch was operated (step S211). If it is judged that operating switches arranged so that the operating region on the display screen for the driver's seat use picture G_{DR} and the operating region on the display screen for the passenger's seat use picture G_{PA} overlap (overlapping switches (for example, operating switches 42_{DR} to 47_{DR} and 42_{PA} to 47_{PA})) were operated, next it is judged whether the operation was performed from the driver's seat side or the operation was performed from the passenger's seat side based on the information obtained from the phototransistors 4b (step S212).

At step S212, if it is judged that the operation was performed from the driver's seat side, operational control in accordance with the operation on the driver's seat use picture G_{DR} is performed (step S213), while if it is judged that the operation was performed from the passenger's seat side, operational control in accordance with the operation for the passenger's seat use picture G_{PA} is performed (step S214).

Further, at step S211, if it is judged that the termination switch 41_{DR} provided at the driver's seat use picture G_{DR} for terminating the split display is operated, next it is judged if the operation was performed from the driver's seat side based on the information obtained from the phototransistors 4b (step S219).

If it is judged that the operation was performed from the driver's seat side, the termination switches 41_{DR}, 41_{PA} are erased from the screen (step S220), among the two pictures, the driver's seat use picture G_{DR} is erased and the passenger's seat use picture G_{PA} is displayed on the full screen (step S221), then the split display flag f_{SE} is returned to zero (step S222). On the other hand, if it is judged that the operation was not performed from the driver's seat side (that is, the operation was performed from the passenger's seat side), the operation is deemed to be an erroneous operation and the processing operation [3-2] is ended as is.

Further, at step S211, when it is judged that the termination switch 41_{PA} provided at the passenger's seat use picture G_{PA} for terminating the split display is operated, next, it is judged if the operation was performed from the passenger's seat side based on information obtained from the phototransistors 4b (step S223).

If it is judged that the operation was performed from the passenger's seat side, the termination switches 41_{DR}, 41_{PA} are erased from the screen (step S224), among the two pictures, the passenger's seat use picture G_{PA} is erased and the driver's seat use picture G_{DR} is displayed on the full screen (step S225), then the split display flag f_{SE} is returned to zero (step S226). On the other hand, if it is judged that the operation was not performed from the passenger's seat side (that is, the operation was performed from the driver's seat side), the operation is deemed to be an erroneous operation and the processing operation [3-2] is ended as is.

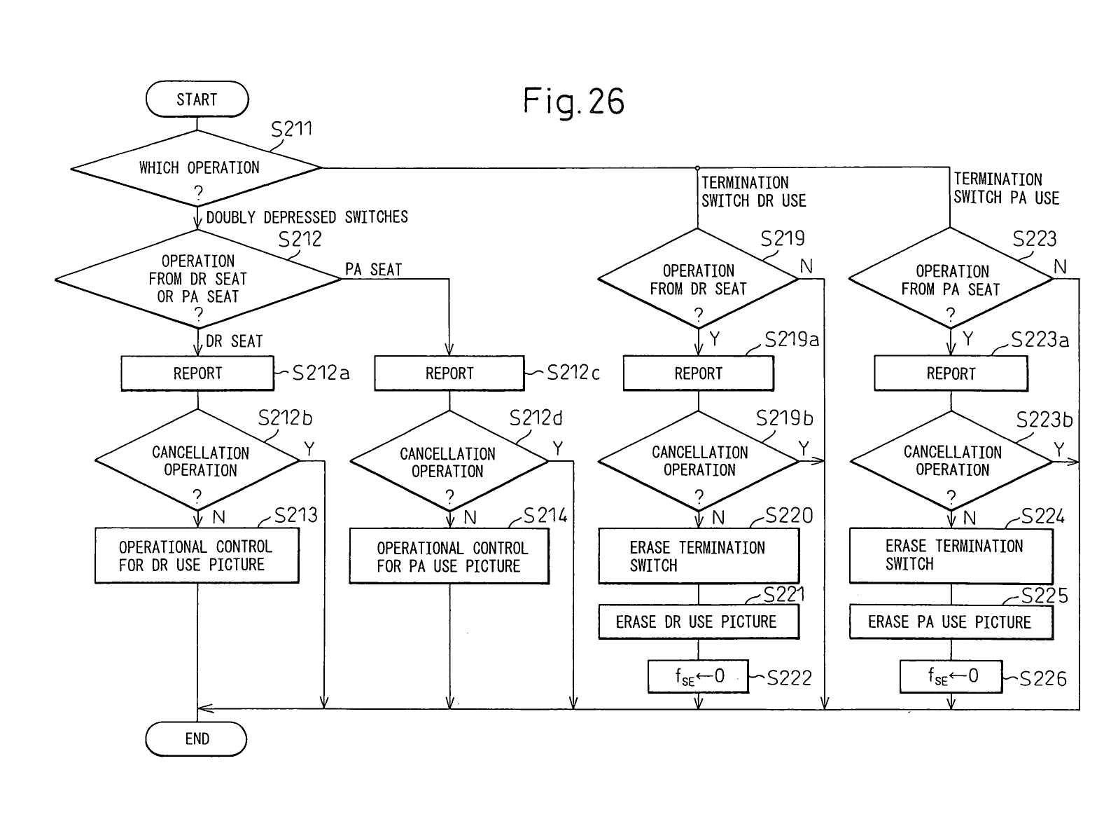

Here, as in the processing operation of step S212 to S214 and S219 to S226, if the operation direction is known, operational control corresponding to this is performed, but in a display device according to another embodiment, as shown in FIG. 26, the content of the operational control is reported to the user before operational control (step S212a, S212c, S219a, S223a) and the user is given an opportunity for confirmation (request for input of confirmation information). If the user indicates his or her intent of cancellation within a predetermined time (for example, 3 seconds) (input of confirmation information) (steps S212b, S212d, S219b, S223b), the operational control need not be executed. Note that as the reporting method, for example, the method of output by audio from the speakers 17 or the method of display of the report image may be mentioned.

Further, as the method of the confirmation of the intent of cancellation by the user, for example, the method of judging if the user speaks the word “cancel” or, as shown in FIG. 17, the method of providing cancellation switches and pressing a cancellation switch may be mentioned.

Further, here, by reporting the content of the operational control, the fact that there was some sort of operation is reported, but in another embodiment, it is also possible to display the above-mentioned “cancellation switch” or the later-mentioned “confirmation switch” so as to report the fact that there was some sort of operation.

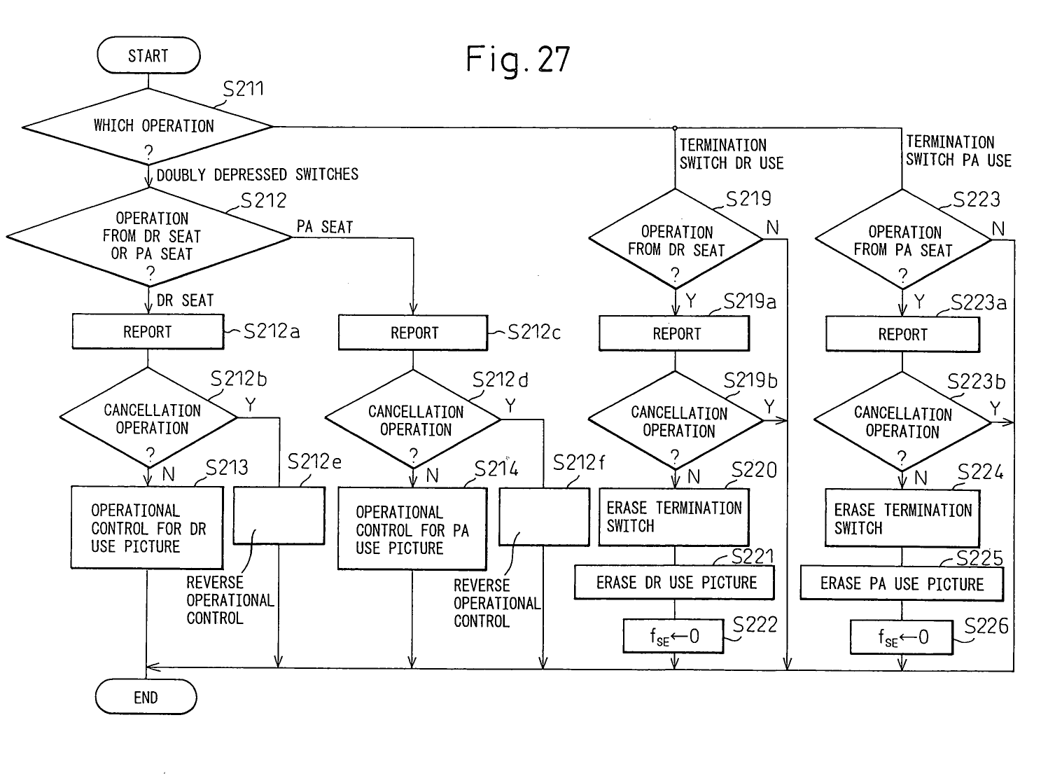

Further, in a display device according to still another embodiment, when operational control in accordance with an operation on the operating switches 42_{DR} to 47_{DR}, 42_{PA} to 47_{PA} arranged so that the operating regions on the display screen for the driver's seat use picture G_{DR} and the operating regions on the display screen for the passenger's seat use picture G_{PA} overlap as shown in FIG. 27 (overlapping switches), for example, operational control for the driver's seat use picture G_{DR}, is cancelled, operational control for the passenger's seat use picture G_{PA} is performed (step S212e), while conversely when operational control for the passenger's seat use picture G_{PA} is cancelled, operational control for the driver's seat use picture G_{DR} may be performed (step S212f). Due to this, not only can execution of operational control not desired by the user be prevented, but also the work of redoing the operation etc. can be reduced.

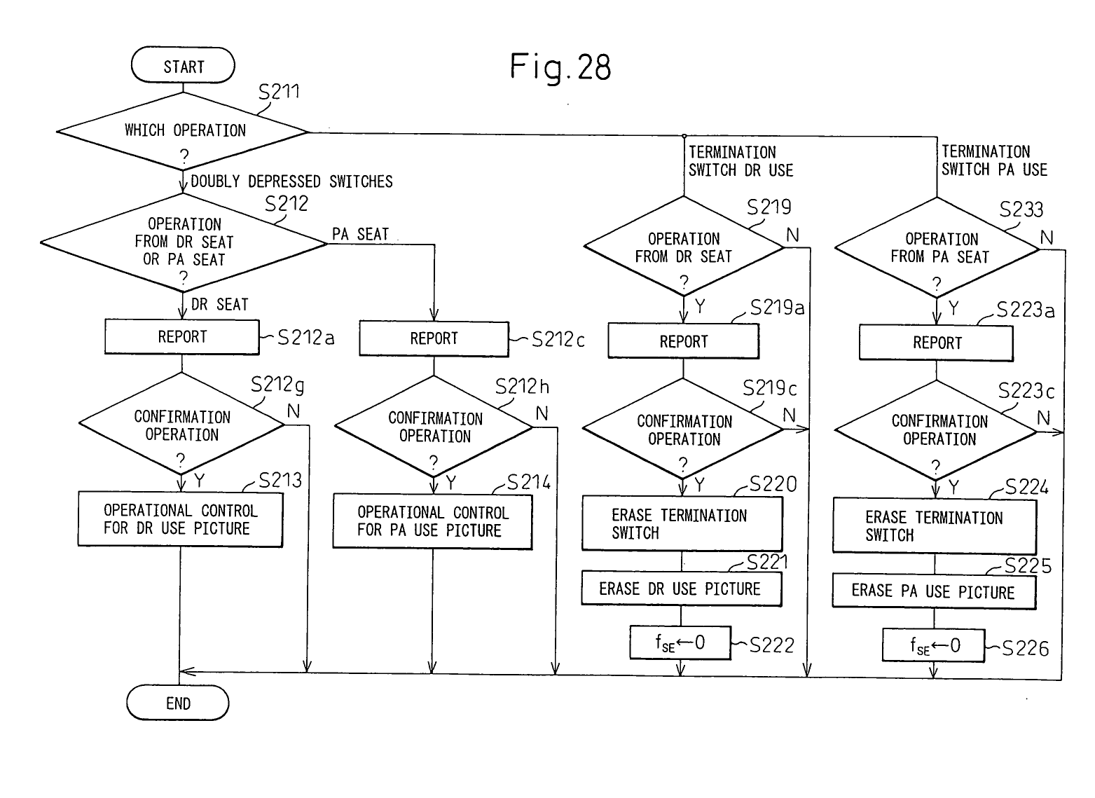

Further, in a display device according to another embodiment, as shown in FIG. 28, before operational control, the content of the operational control is reported to the user (steps S212a, S212c, S219a, S223a) and the user is given an opportunity for confirmation (request for input of confirmation information). If the user indicates his or her intent of confirmation within a predetermined period (for example, 3 seconds) (input of confirmation information) (steps S212g, S212h, S219c, S223c), the operational control is executed. If the user does not indicate his or her intent of confirmation, the operational control need not be executed either. Note that as the method of the user confirming the intent of confirmation, for example, the method of judging if the user has said “OK” or, as shown in FIG. 20, the method of providing confirmation switches and judging if a confirmation switch has been pushed may be mentioned. Further, it is also possible not to report the content of operational control and display a “cancellation switch” or “confirmation switch” to report that there was some sort of operation.

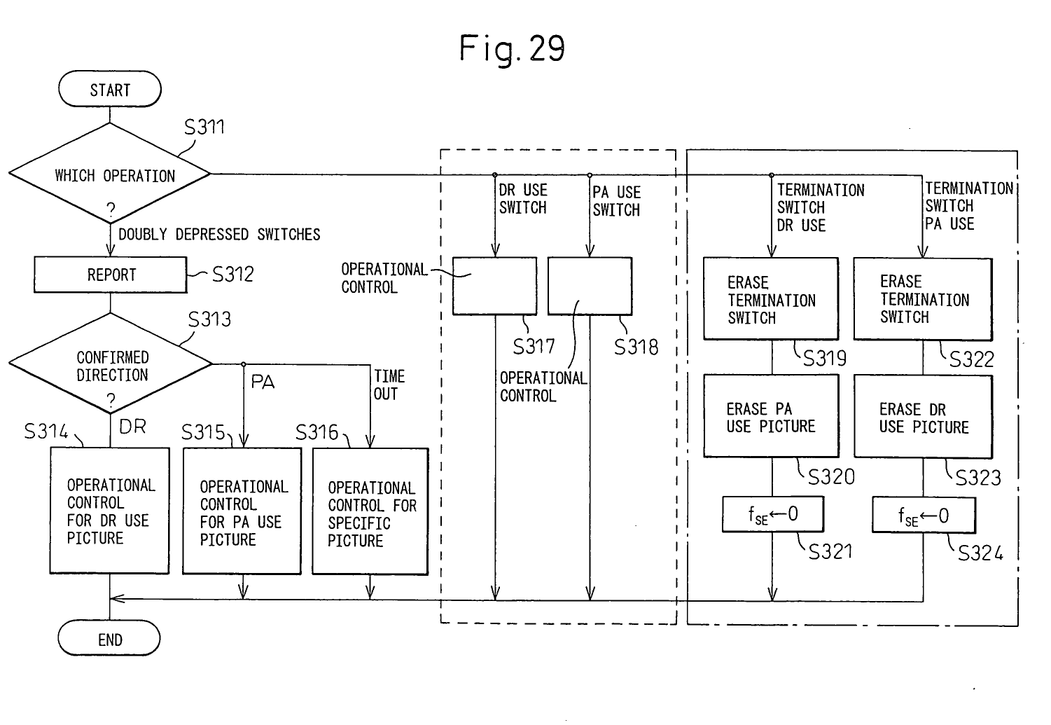

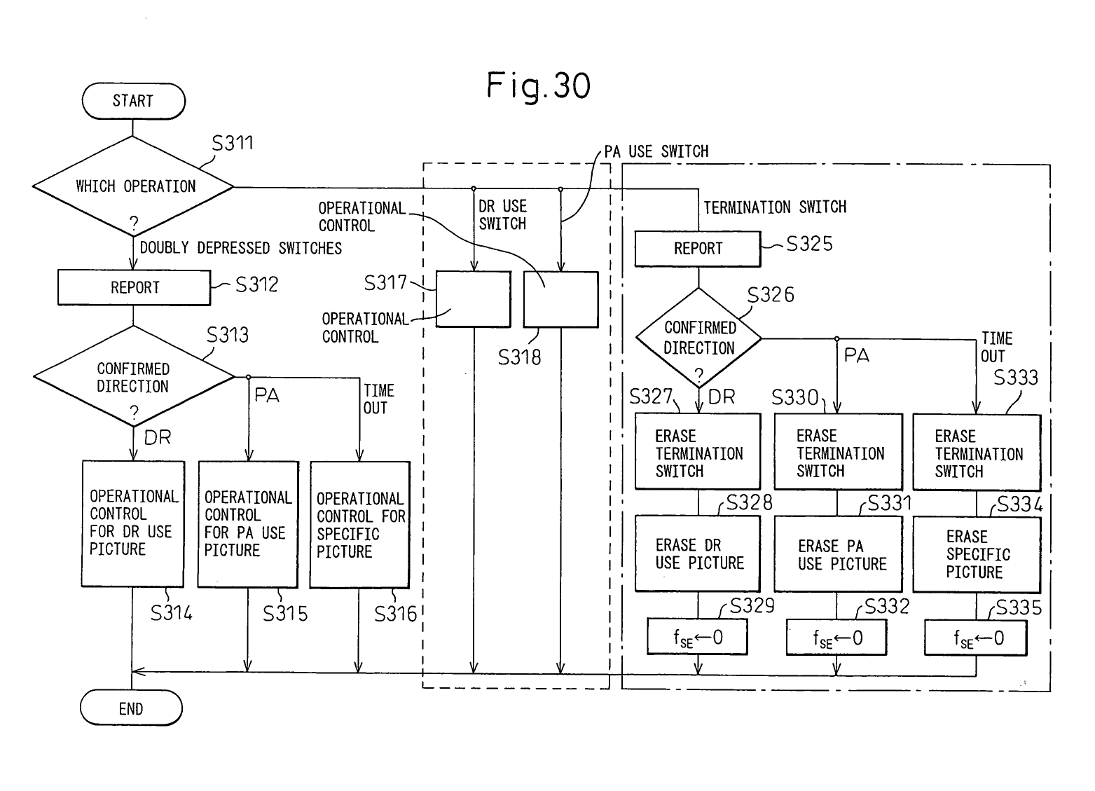

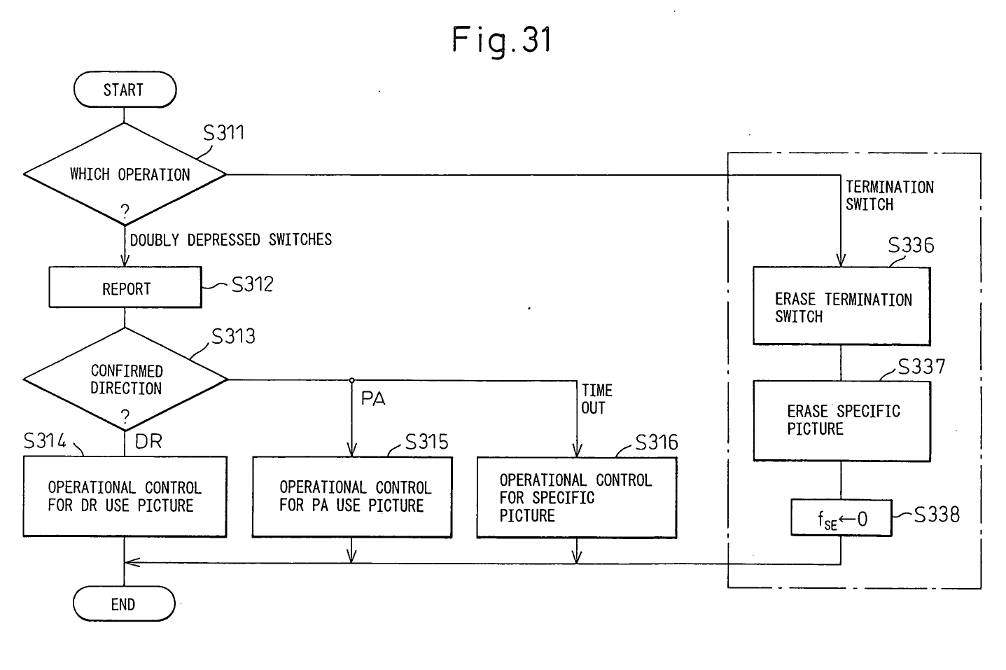

In the AV navigation system employing the display device according to embodiments (1) to (3), as shown in FIG. 12 to FIG. 14, when it is judged that operating switches 42_{DR} to 47_{DR} and 42_{PA} to 47_{PA} arranged so that the operating region on the display screen for the driver's seat use picture G_{DR} and the operating region on the display screen for the passenger's seat use picture G_{PA} overlap (overlapping switches) were operated, it is judged from which direction the operation input was made so as to perform suitable processing, but next the processing operation performed by the control unit in the case where the above-mentioned means for judging the direction of operation input (infrared ray LEDs 4a and phototransistors 4b etc.) or the later-mentioned means for judging the direction of operation input (see FIG. 49 to FIG. 55) will be explained based on the flowchart shown in FIG. 29. Note that here the case of display as shown in FIG. 12 will be explained. The case of the display shown in FIG. 13 and FIG. 14 will be explained later using the flowcharts of FIG. 30 and FIG. 31.

First, it is judged which operating switch was operated (step S311). If it is judged that operating switches where the operating region on the display screen for the driver's seat use picture G_{DR} and the operating region on the display screen for the passenger's seat use picture G_{PA} overlap (overlapping switches (for example, operating switches 42_{DR} to 47_{DR} and 42_{PA} to 47_{PA})) are operated, next the content of the operational control is displayed, the cancellation switches 49_{DR}, 49_{PA} shown in FIG. 17 or the confirmation switches 50_{DR}, 50_{PA} shown in FIG. 20 are displayed, the content of the operational control or the fact that there was some sort of operation is informed to the driver DR and the passenger's seat passenger PA, and an opportunity for confirmation is given (request for operation of input of confirmation information, step S312). Note that as explained above, it is also possible not to report the content of operational control and display a “cancellation switch” or “confirmation switch” to report that there was some sort of operation.

When it is judged that the intent of “execution of operational control for driver's seat use picture G_{DR} OK” was expressed (for example, as shown in FIG. 20, when the confirmation switches 50_{DR}, 50_{PA} are displayed, the driver use confirmation switch 50_{DR} is operated or, as shown in FIG. 17, when the cancellation switches 49_{DR}, 49_{PA} are displayed, the passenger's seat passenger use cancellation switch 49_{PA} is operated) (step S313), operational control for the driver's seat use picture G_{DR} is executed (step S314).

On the other hand, when it is judged that the intent of “execution of operational control for passenger's seat use picture G_{PA} OK” was expressed (for example, as shown in FIG. 20, when the confirmation switches 50_{DR}, 50_{PA} are displayed, the passenger use confirmation switch 50_{PA} is operated or, as shown in FIG. 17, when the cancellation switches 49_{DR}, 49_{PA} are displayed, the driver use cancellation switch 49_{DR} is operated) (step S313), operational control for the passenger's seat use picture G_{PA} is executed (step S315).

Further, if it is judged that a certain fixed time (for example, 3 seconds) has elapsed from when the opportunity for confirmation was given (from when input of confirmation information was requested) (step S313), operational control for a specific picture is performed (step S316). For example, under a condition where the driver must particularly concentrate on driving such as when curves continue during driving, operation of the “confirmation switch” or “cancellation switch” is difficult. For this reason, as shown in FIG. 20, when neither of the confirmation switches 50_{DR}, 50_{PA} has been operated for a certain fixed time when the confirmation switches 50_{DR}, 50_{PA} are displayed, it is judged that the situation is one where operation by the driver DR is difficult and even if desiring operation, the driver DR cannot operate the driver use confirmation switch 50_{DR}, it is deemed that an operation for confirmation of the operational control for the driver's seat use picture G_{DR} was performed (that is, the confirmation switch 50_{DR} was operated), and operational control for the driver's seat use picture G_{DR} is executed.

On the other hand, as shown in FIG. 17, when neither of the cancellation switches 49_{DR}, 49_{PA} has been operated for a certain fixed time when the cancellation switches 49_{DR}, 49_{PA} are displayed, it is judged that the situation is one where operation by the driver DR is difficult and even if desiring operation, the driver DR cannot operate the driver use cancellation switch 49_{DR}, it is deemed that an operation for cancellation of the operational control for the driver's seat use picture G_{DR} was performed (that is, the cancellation switch 49_{DR} was operated), and operational control for the passenger's seat use picture G_{PA} is executed.

Further, at step S311, if it is judged that an operating switch receiving only operation input for the driver's seat use picture G_{DR} (for example, operating switch 48_{DR}, however, termination switch 41_{DR} excluded) has been operated, operational control in accordance with the operation is performed (step S317), while if it is judged that an operating switch receiving only operation input for the passenger's seat use picture G_{PA} (for example, operating switch 48_{PA}, however, termination switch 41_{PA} excluded) has been operated, operational control in accordance with the operation is performed (step S318).

At step S311, when it is judged that the termination switch 41_{DR} provided at the driver's seat use picture G_{DR} for terminating the split display is operated, the termination switches 41_{DR}, 41_{PA} are erased from the screen (step S319), among the two pictures, the driver's seat use picture G_{DR} is erased and the passenger's seat use picture G_{PA} is displayed on the full screen (step S320), then the split display flag f_{SE} is returned to zero (step S321).

At step S311, when it is judged that the termination switch 41_{PA} provided at the passenger's seat use picture G_{PA} for terminating the split display is operated, the termination switches 41_{DR}, 41_{PA} are erased from the screen (step S322), among the two pictures, the passenger's seat use picture G_{PA} is erased and the driver's seat use picture G_{DR} is displayed on the full screen (step S323), then the split display flag f_{SE} is returned to zero (step S324).

Next, the processing operation performed by the control unit for the case of not the display as shown in FIG. 12, but the case of display as shown in FIG. 13 will be explained based on the flowchart shown in FIG. 30. However, except for the part surrounded by the one-dot chain line, it is the same as the processing operation shown in FIG. 29, so here only the different parts will be explained. Note that in the case of the display as shown in FIG. 14, the processing of the part surrounded by broken lines becomes unnecessary.

At step S311, when it is judged that the termination switch 41_{DR} provided at the driver's seat use picture G_{DR} for terminating the split display or the termination switch 41_{PA} provided at the passenger's seat use picture G_{PA} for terminating the split display is operated, the fact that a termination operation was performed is displayed, the cancellation switches 49_{DR}, 49_{PA} shown in FIG. 17 or the confirmation switches 50_{DR}, 50_{PA} shown in FIG. 20 are displayed and the fact of the termination operation being performed or there having been some sort of operation is informed to the driver DR and passenger's seat passenger PA, and an opportunity for confirmation is given (request for operation for input of confirmation information, step S325). Note that as explained above, the fact that a termination operation was performed is not reported. The fact that there has been some sort of operation may also be reported by displaying the “confirmation switches” or “cancellation switches”.

When it is judged that the intent of “execution of control for termination of split display of driver's seat use picture G_{DR} OK” has been expressed (for example, as shown in FIG. 20, when the confirmation switches 50_{DR}, 50_{PA} are displayed, the driver use confirmation switch 50_{DR} is operated or, as shown in FIG. 17, when the cancellation switches 49_{DR}, 49_{PA} are displayed, the passenger's seat passenger use cancellation switch 49_{PA} is operated) (step S326), the termination switches 41_{DR}, 41_{PA} are erased from the screen (step S327), among the two pictures, the driver's seat use picture G_{DR} is erased and the passenger's seat use picture G_{PA} is displayed on the full screen (step S328), then the split display flag f_{SE} is returned to zero (step S329).

On the other hand, when it is judged that the intent of “execution of control for termination of split display of passenger's seat use picture G_{PA} OK” has been expressed (for example, as shown in FIG. 20, when the confirmation switches 50_{DR}, 50_{PA} are displayed, the passenger use confirmation switch 50_{PA} is operated or, as shown in FIG. 17, when the cancellation switches 49_{DR}, 49_{PA} are displayed, the driver's seat passenger use cancellation switch 49_{DR} is operated) (step S326), the termination switches 41_{DR}, 41_{PA} are erased from the screen (step S330), among the two pictures, the passenger's seat use picture G_{PA} is erased and the driver's seat use picture G_{DR} is displayed on the full screen (step S331), then the split display flag f_{SE} is returned to zero (step S332).

Further, if it is judged that a certain fixed time (for example, 3 seconds) has elapsed from when the opportunity for confirmation was given (from when input of confirmation information was requested) (step S326), the termination switches 41_{DR}, 41_{PA} are erased from the screen (step S333), among the two pictures, the specific picture is erased and another picture not the specific picture is displayed on the full screen (step S334), then the split display flag f_{SE} is returned to zero (step S335).

For example, under a condition where the driver must particularly concentrate on driving such as when curves continue during driving, operation of the “confirmation switch” or “cancellation switch” is difficult. For this reason, as shown in FIG. 20, when neither of the confirmation switches 50_{DR}, 50_{PA} has been operated for a certain fixed time when the confirmation switches 50_{DR}, 50_{PA} are displayed, it is judged that the situation is one where operation by the driver DR is difficult and even if desiring operation, the driver DR cannot operate the driver use confirmation switch 50_{DR}, it is deemed that an operation for termination of the split display for the driver's seat use picture G_{DR} was performed (that is, the confirmation switch 50_{DR} was operated), the driver's seat use picture G_{DR} is erased, and the passenger's seat use picture G_{PA} is displayed on the full screen.

On the other hand, as shown in FIG. 17, when neither of the cancellation switches 49_{DR}, 49_{PA} has been operated for a certain fixed time when the confirmation switches 49_{DR}, 49_{PA} are displayed, it is judged that the situation is one where operation by the driver DR is difficult and even if desiring operation, the driver DR cannot operate the driver use cancellation switch 49_{DR}, it is deemed that an operation for cancellation of the operation for termination of the split display for the driver's seat use picture G_{DR} was performed (that is, the cancellation switch 49_{DR} was operated),

the passenger's seat use picture G_{PA} is erased, and the driver's seat use picture G_{DR} is displayed on the full screen.

Next, another processing operation performed by the control unit for the case of display such as shown in FIG. 13 will be explained based on the flowchart shown in FIG. 31. However, except for the part surrounded by the one-dot chain line, it is the same as the processing operation shown in FIG. 29, so here only the different parts will be explained. Note that in the case of the display such as shown in FIG. 14, the processing of the part surrounded by broken lines becomes unnecessary.

At step S311, when it is judged that the termination switch 41_{DR} provided at the driver's seat use picture G_{DR} for terminating the split display or the termination switch 41_{PA} provided at the passenger's seat use picture G_{PA} for terminating the split display is operated, the termination switch 41_{DR}, 41_{PA} are erased from the screen (step S336), among the two pictures, the specific picture is erased and another picture not the specific picture is displayed on the full screen (step S337), then the split display flag f_{SE} is returned to zero (step S338).

For example, when the passenger's seat passenger PA finishes watching the desired program, movie, etc. there is a high chance of he or she instructing termination of the split display. On the other hand, the driver DR often requests the constant display of some sort of picture such as a navigation picture so there is a low chance of the driver DR instructing erasure of the picture display (termination of split display). Further, there is a high chance of the driver DR desiring full screen display of the driver's seat use picture G_{DR} when the passenger's seat passenger PA gets out of the car etc. Therefore, the termination switches 41_{DR}, 41_{PA} being operated means there is a high chance of the desire for full screen display of the driver's seat use picture G_{DR}, so it is particularly effective if the specific picture is made the passenger's seat use picture G_{PA} and the picture not the specific picture is made the driver's seat use picture G_{DR}.

Further, as explained above, when the layout of the operating switches (42_{DR} to 47_{DR} and 42_{PA} to 47_{PA}) is the same between the driver's seat use picture G_{DR} and the passenger's seat use picture G_{PA} as shown in FIG. 14 and the layout of the termination switches (41_{DR} and 41_{PA}) is the same between the driver's seat use picture G_{DR} and passenger's seat use picture G_{PA} as shown in FIG. 13, it is sufficient to perform the processing of the processing operation shown in FIG. 30 minus the part surrounded by the broken lines or the processing operation shown in FIG. 31.

Below, an AV navigation system employing a display device according to embodiment (4) of the present invention will be explained.

However, the AV navigation system is configured in the same way as the AV navigation system shown in FIG. 5 except for the control unit 100, so the control unit is assigned a different notation. The rest of the explanation will be omitted.

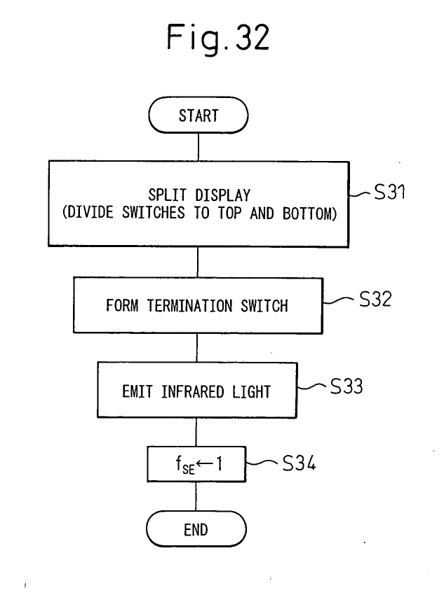

A processing operation [4-1] performed by the control unit 100C in an AV navigation system employing the display device according to the embodiment (4) will be explained based on the flowchart shown in FIG. 32. Note that this processing operation [4-1] is the operation performed when a split display (multiview) allowing the driver DR to view the driver's seat use picture G_{DR} and allowing the passenger's seat passenger PA to view the passenger's seat use picture G_{PA} is instructed from the user by operation of an operating switch or the operating unit 15 formed on the display unit 4, the remote controller 123, etc.

Note that when the split display is the default (that is, when a split display is performed after the power of the AV navigation system is turned on), there is no need for an instruction of a split display from the user, the processing operation [4-1] explained from here becomes unnecessary, and the split display flag f_{SE} for showing that split display is being performed also becomes unnecessary. However, when using the infrared ray LEDs 4a and phototransistors 4b for the judgment of from which direction the operation input was made, it is necessary to make the infrared ray LEDs 4a emit infrared light at some sort of timing and set a state enabling an object (for example, finger) approaching the display unit 4 to be detected.

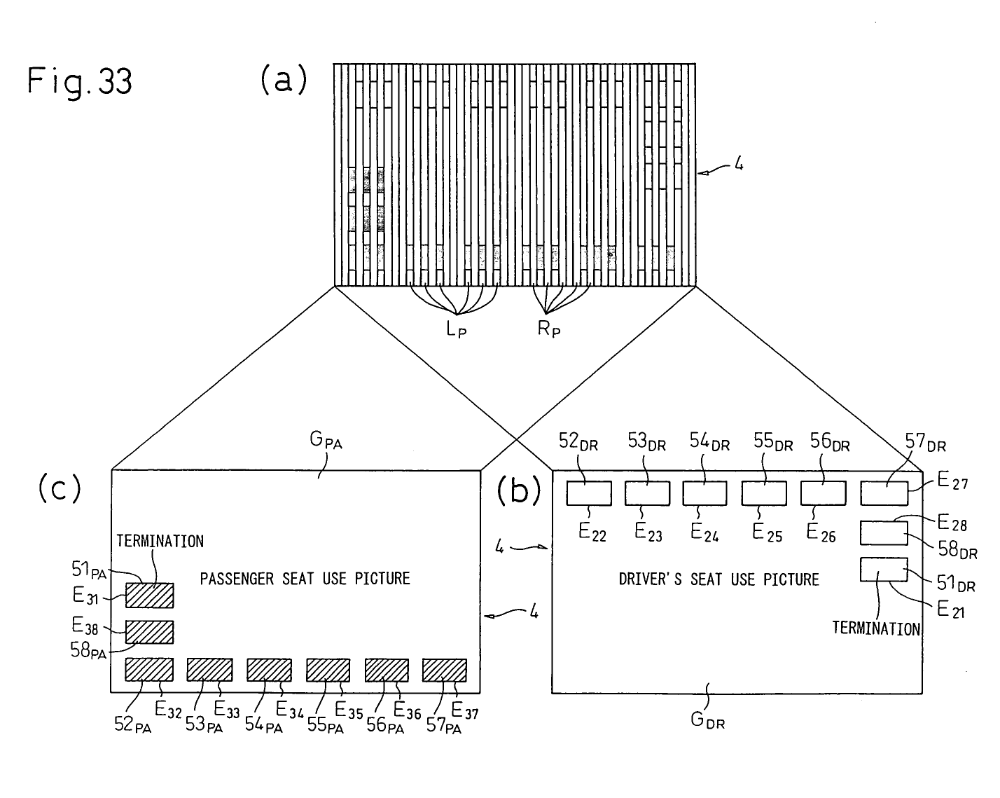

If the user instructs a split display, first, based on predetermined conditions, as shown in FIG. 33, one of the two pictures is displayed as the driver's seat use picture G_{DR} and the other is displayed as the passenger's seat use picture G_{PA} (step S31), then a termination switch 51_{DR} for termination of the split display is formed at the top right of the driver's seat use picture G_{DR} and a termination switch 51_{PA} for termination of the split display is formed at the top left of the passenger's seat use picture G_{PA} (step S32).

FIG. 33(a) is an explanatory view for explaining pixels used for the driver's seat use picture G_{DR} and pixels used for the passenger's seat use picture G_{PA}, FIG. 33(b) is a view showing an example of the driver's seat use picture G_{DR}, and FIG. 33(c) is a view showing an example of the passenger's seat use picture G_{PA}. As shown in FIG. 33(a), the even number columns or half of the total number of pixels in the horizontal direction (right side pixels R_{P}) are used for the driver's seat use picture G_{DR}, while the odd number columns (left side pixels L_{P}) are used for the passenger's seat use picture G_{PA}.

From FIG. 33, it is learned that the termination switch 51_{DR} receiving only operation input for the driver's seat use picture G_{DR} and the operating switches 52_{DR} to 58_{DR} are arranged in the regions E₂₁ to E₂₈ positioned at the top of the display unit 4 and the termination switch 51_{PA} receiving only operation input for the passenger's seat use picture G_{PA} and the operating switches 52_{PA} to 58_{PA} are arranged at the regions E₃₁ to E₃₈ positioned at the bottom of the display unit 4 not overlapping the regions E₂₁ to E₂₈.

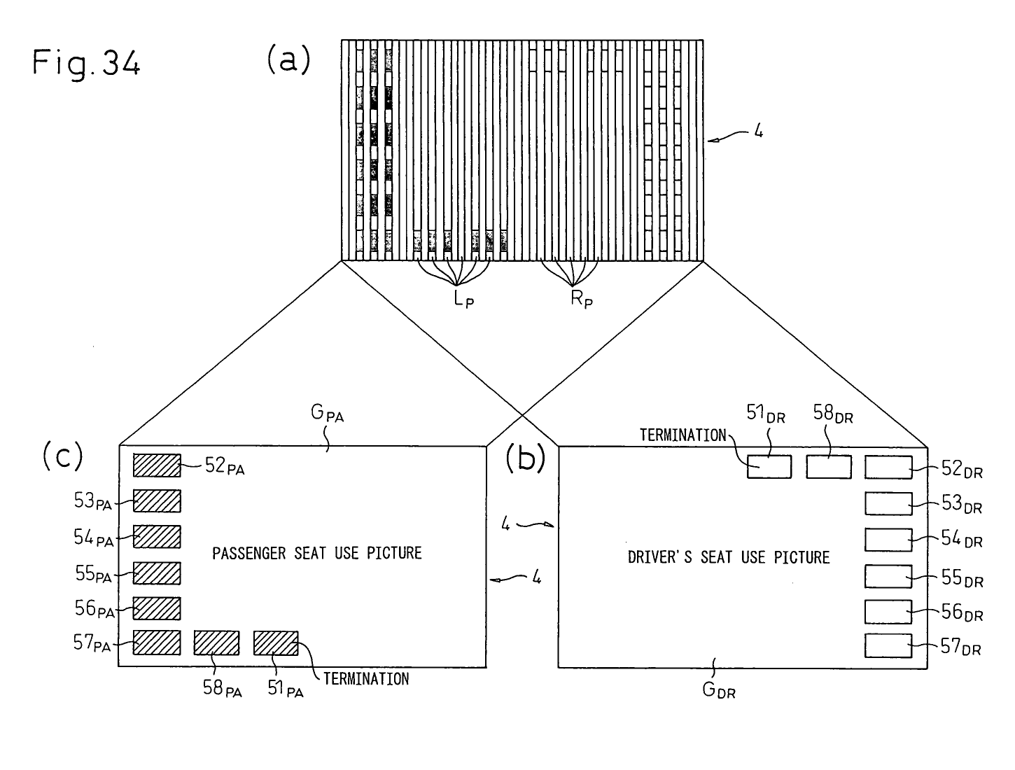

Note that in FIG. 33, switches for receiving only operation input for the driver's seat use picture G_{DR} and switches for receiving only operation input for the passenger's seat use picture G_{PA} are arranged divided between the top side and bottom side of the display unit 4, but in another embodiment, for example, as shown in FIG. 34, it is also possible to arrange switches for receiving only operation input for the driver's seat use picture G_{DR} and switches for receiving only operation input for the passenger's seat use picture G_{PA} divided between the right side and left side of the display unit 4.

After the processing of step S32, the infrared ray LEDs 4a provided at the display unit 4 are made to emit infrared light to set a state where an object (for example, finger) approaching the display unit 4 can be detected (step S33), then a split display flag f_{SE} for showing that a split display is being performed is set to “1” (step S34).

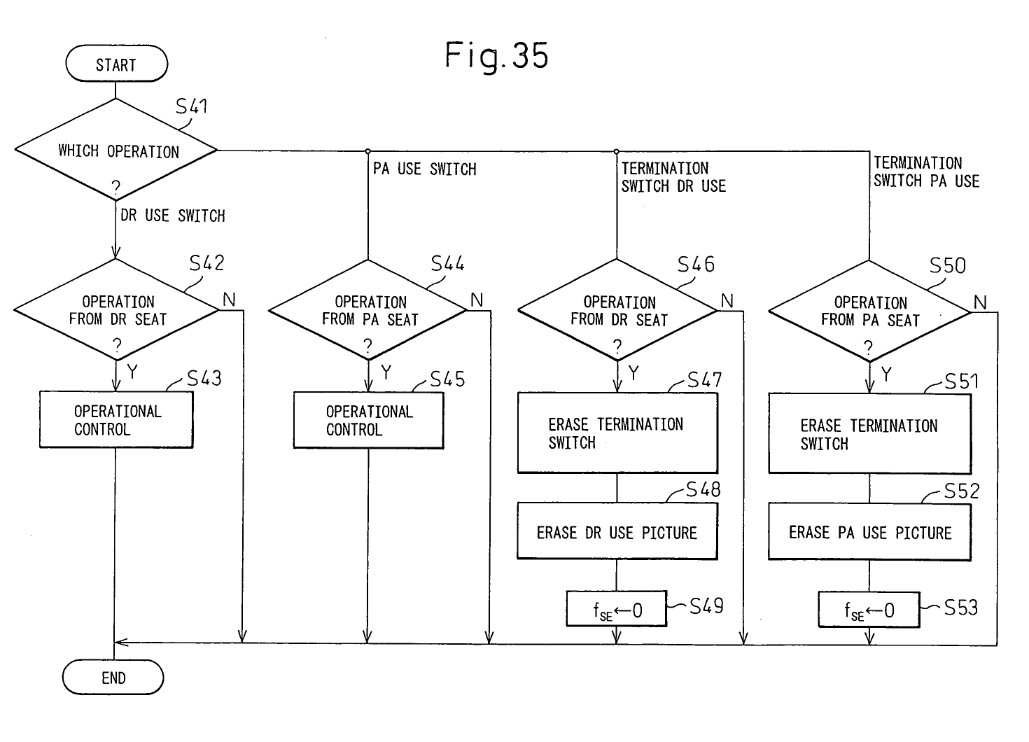

Next, a processing operation [4-2] performed by the control unit 100C in an AV navigation system employing the display device according to the embodiment (4) will be explained based on the flowchart shown in FIG. 35. Note that this processing operation [4-2] is an operation performed when the split display is performed (that is, when the split display flag f_{SE} is “1”) and the user operates termination switches 51_{DR}, 51_{PA} or operating switches 52_{DR} to 58_{DR}, 52_{PA} to 58_{PA} formed on the display unit 4, operating switches 15a to 15h forming part of the operating unit 15, etc. However, when the split display is the default as explained above, only naturally the split display flag f_{SE} is unnecessary. The split display flag f_{SE} being “1” is not included in the starting conditions.

First, it is judged which operating switch was operated (step S41). If judging that an operating switch receiving only operation input for the driver's seat use picture G_{DR} (for example, operating switches 52_{DR} to 58_{DR}, however, termination switch 51_{DR} excluded) has been operated, next, it is judged that the operation was performed from the driver's seat side based on information obtained from the phototransistors 4b (step S42).

If it is judged that the operation was performed from the driver's seat side, operational control in accordance with the operation is performed (step S43), while if it is judged that the operation was not performed from the driver's seat side (that is, the operation was performed from the passenger's seat side), the operation is deemed an erroneous operation and the processing operation [4-2] is ended as it is.

Further, at step S41, if judging that an operating switch receiving only operation input for the passenger's seat use picture G_{PA} (for example, operating switches 52_{PA} to 58_{PA}, however, termination switch 51_{PA} excluded) has been operated, next, it is judged if the operation was performed from the passenger's seat side based on information obtained from the phototransistors 4b (step S44).

If it is judged that the operation was performed from the passenger's seat side, operational control in accordance with the operation is performed (step S45), on the other hand, if it is judged the operation was not performed from the passenger's seat side (that is, the operation was performed from the driver's seat side), the operation is deemed an erroneous operation and the processing operation [4-2] is ended as it is.

Further, at step S41, when it is judged that the termination switch 51_{DR} provided at the driver's seat use picture G_{DR} for terminating the split display is operated, next it is judged if the operation was performed from the driver's seat side based on the information obtained from the phototransistors 4b (step S46).

If it is judged that the operation was performed from the driver's seat side, the termination switches 51_{DR}, 51_{PA} are erased from the screen (step S47), among the two pictures, the driver's seat use picture G_{DR} is erased and the passenger's seat use picture G_{PA} is displayed on the full screen, the termination switch 51_{PA} and operating switches 52_{PA} to 58_{PA} which had been arranged concentrated at a region at the bottom are returned to their normal positions (step S48), then the split display flag f_{SE} is returned to zero (step S49). On the other hand, if it is judged that the operation was not performed from the driver's seat side (that is, the operation was performed from the passenger's seat side), the operation is deemed an erroneous operation and the processing operation [4-2] is ended as it is.

Further, at step S41, when it is judged that the termination switch 51_{PA} provided at the passenger's seat use picture G_{PA} for terminating the split display is operated, next it is judged if the operation was performed from the passenger's seat side based on the information obtained from the phototransistors 4b (step S50).

If it is judged that the operation was performed from the passenger's seat side, the termination switches 51_{DR}, 51_{PA} are erased from the screen (step S51), among the two pictures, the passenger's seat use picture G_{PA} is erased and the driver's seat use picture G_{DR} is displayed on the full screen, the termination switch 51_{DR} and operating switches 52_{DR} to 58_{DR} arranged concentrated in a top side region are returned to their normal positions (step S52), then the split display flag f_{SE} is returned to zero (step S53). On the other hand, if it is judged that the operation was not performed from the passenger's seat side (that is, the operation was performed from the driver's seat side), the operation is deemed an erroneous operation and the processing operation [4-2] is ended as it is.

According to the AV navigation system employing a display device according to the embodiment (4), the termination switch 51_{DR} and operating switches 52_{DR} to 58_{DR} able to receive only operation input for the driver's seat use picture G_{DR} are arranged at the top side of the display unit 4, while the termination switch 51_{PA} and operating switches 52_{PA} to 58_{PA} able to receive only operation input for the passenger's seat use picture G_{PA} are arranged at the bottom side of the display unit 4, so erroneous operation can be prevented.

Further, when it is judged that the operation was made from the driver's seat side, operational control in accordance with the operation for the passenger's seat use picture G_{PA} is not performed, Further, when it is judged that the operation was made from the passenger's seat side, operational control in accordance with the operation on the driver's seat use picture G_{DR} is not performed. For example, when the driver DR operates an operating switch for the driver's seat use picture G_{DR}, that operation is validated, but when the driver DR operates an operating switch for the passenger's seat use picture G_{PA}, that operation is invalidated. Due to this, it is possible to reliably prevent an erroneous operation by the driver DR on the passenger's seat use picture G_{PA}.

Below, an AV navigation system employing a display device according to embodiment (5) of the present invention will be explained.

However, the AV navigation system is configured in the same way as the AV navigation system shown in FIG. 5 except for the control unit 100, so the control unit is assigned a different notation. The rest of the explanation will be omitted.

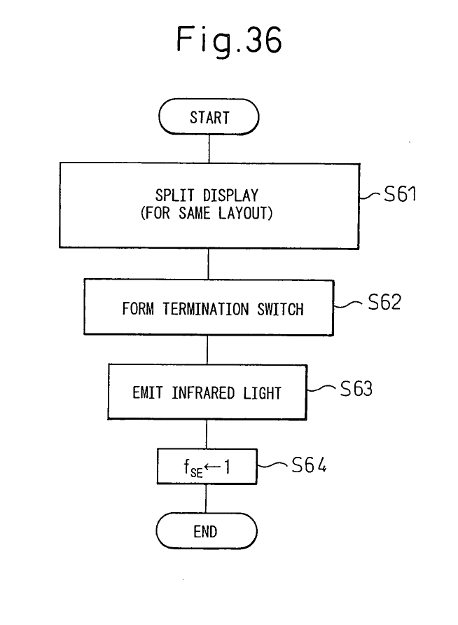

A processing operation [5-1] performed by the control unit 100D in an AV navigation system employing the display device according to the embodiment (5) will be explained based on the flowchart shown in FIG. 36. Note that this processing operation [5-1] is an operation performed when a split display (multiview) allowing the driver DR to view the driver's seat use picture G_{DR} and allowing the passenger's seat passenger PA to view the passenger's seat use picture G_{PA} is instructed from the user by operation of an operating switch or the operating unit 15 formed on the display unit 4, the remote controller 123, etc.

Note that when the split display is the default (that is, when a split display is performed after the power of the AV navigation system is turned on), there is no need for an instruction of a split display from the user, the processing operation [5-1] explained from here becomes unnecessary, and the split display flag f_{SE} for showing that split display is being performed also becomes unnecessary. However, when using the infrared ray LEDs 4a and phototransistors 4b for the judgment of from which direction the operation input was made, it is necessary to make the infrared ray LEDs 4a emit infrared light at some sort of timing and set a state enabling an object (for example, finger) approaching the display unit 4 to be detected.

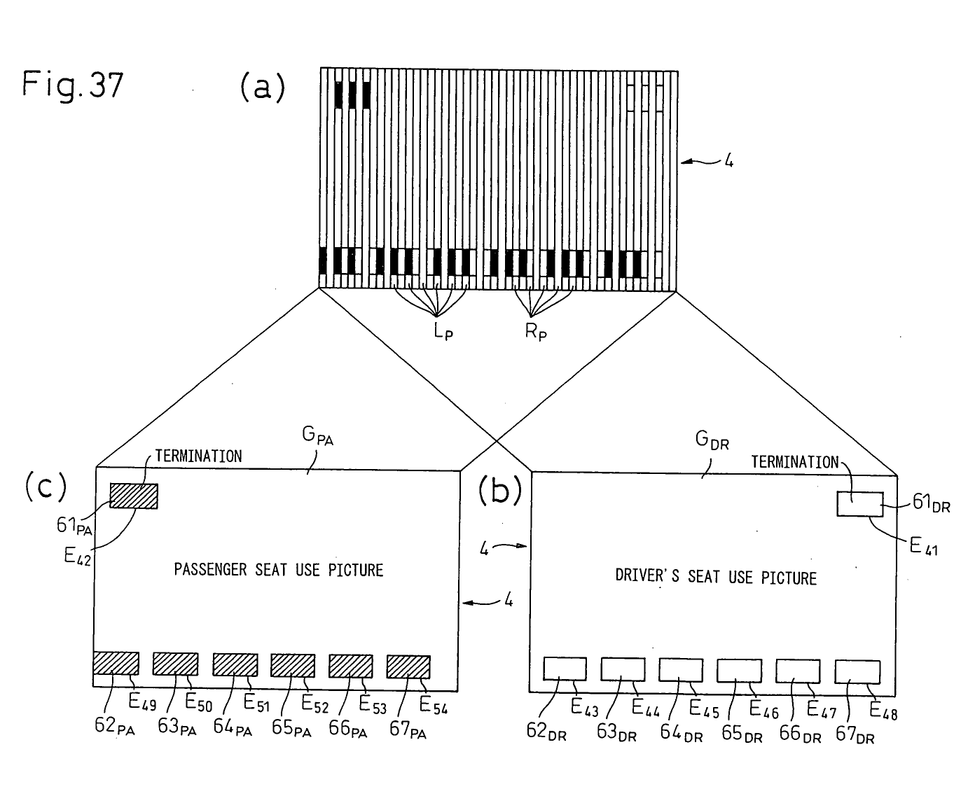

If the user instructs a split display, first, based on predetermined conditions, as shown in FIG. 37, one of the two pictures is displayed as the driver's seat use picture G_{DR} and the other is displayed as the passenger's seat use picture G_{PA} (step S61), then a termination switch 41_{DR} for termination of the split display is formed at the top right of the driver's seat use picture G_{DR} and a termination switch 61_{PA} for termination of the split display is formed at the top left of the passenger's seat use picture G_{PA} (step S62).

FIG. 37(a) is an explanatory view for explaining pixels used for the driver's seat use picture G_{DR} and pixels used for the passenger's seat use picture G_{PA}, FIG. 37(b) is a view showing an example of the driver's seat use picture G_{DR}, and FIG. 37(c) is a view showing an example of the passenger's seat use picture G_{PA}. As shown in FIG. 37(a), the even number columns or half of the total number of pixels in the horizontal direction (right side pixels R_{P}) are used for the driver's seat use picture G_{DR}, while the odd number columns (left side pixels L_{P}) are used for the passenger's seat use picture G_{PA}.

From FIG. 37, it is learned that the termination switch 61_{DR} receiving only operation input for the driver's seat use picture G_{DR} is arranged in the region E₄₁ and the termination switch 61_{PA} receiving only operation input for the passenger's seat use picture G_{PA} is arranged in the region E₄₂. Further, operating switches 62_{DR} to 67_{DR} receiving operation input for the driver's seat use picture G_{DR} are arranged in the regions E₄₃ to E₄₈ and operating switches 62_{PA} to 67_{PA} receiving operation input for the passenger's seat use picture G_{PA} are arranged in the regions E₄₉ to E₅₄ partially overlapping the regions E₄₃ to E₄₈. The layouts of the operating switches 62_{DR} to 67_{DR} and the operating switches 62_{PA} to 67_{PA} are substantially the same.

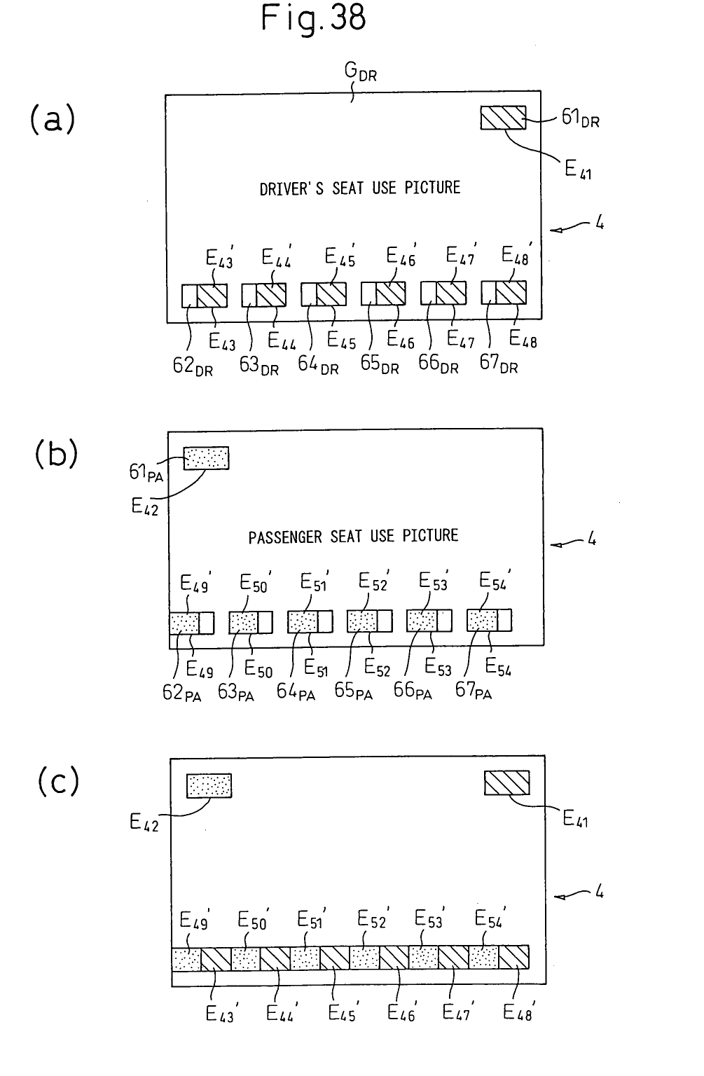

FIG. 38(a) is an explanatory view for explaining the scope of display of operating switches able to be used for a driver's seat use picture G_{DR} and the scope of reception of operation input, FIG. 38(b) is an explanatory view for explaining the scope of display of operating switches able to be used for a passenger's seat use picture G_{PA} and the scope of reception of operation input, and FIG. 38(c) is an explanatory view for explaining the scope of reception of operation input of each operating switch.

As shown in FIG. 38, the operating switches 62_{DR} to 67_{DR} do not match in scopes of display, that is, the regions E₄₃ to E₄₈, and scopes of reception of operation input (that is, scopes of receiving touch), that is, the regions E₄₃′ to E₄₈′. The scopes of reception of operation input are narrower. The operating switches 62_{PA} to 67_{PA} similarly do not match in scopes of display, that is, the regions E₄₉ to E₅₄, and scopes of reception of operation input (that is, scopes of receiving touch), that is, the regions E₄₉′ to E₅₄′. The scopes of reception of operation input are narrower. Further, the scopes of reception of operation input for the operating switches 62_{DR} to 67_{DR} (regions E₄₃′ to E₄₈′) and the scopes of reception of operation input for the operating switches 62_{PA} to 67_{PA} (regions E₄₉′ to E₅₄′) do not overlap.

After the processing of step S62, the infrared ray LEDs 4a provided at the display unit 4 are made to emit infrared light to set a state where an object (for example, finger) approaching the display unit 4 can be detected (step S63), then a split display flag f_{SE} for showing that a split display is being performed is set to “1” (step S64).

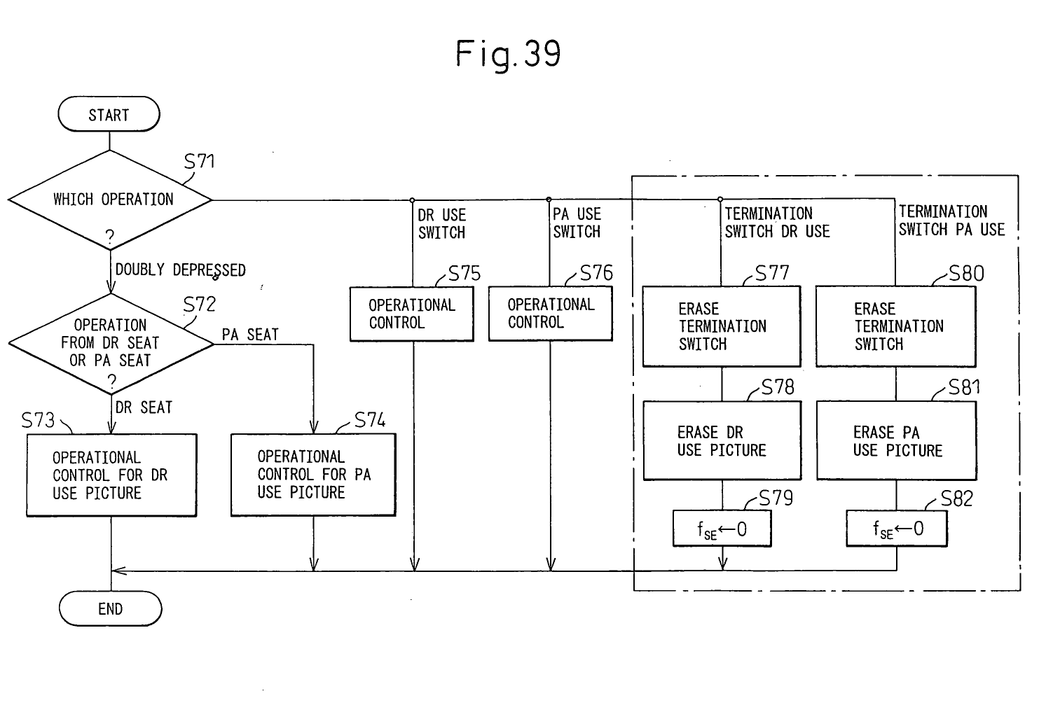

Next, a processing operation [5-2] performed by the control unit 100D in an AV navigation system employing the display device according to the embodiment (5) will be explained based on the flowchart shown in FIG. 39. Note that this processing operation [5-2] is an operation performed when the split display is performed (that is, when the split display flag f_{SE} is “1”) and the user operates termination switches 61_{DR}, 61_{PA} or operating switches 62_{DR} to 67_{DR}, 62_{PA} to 67_{PA} formed on the display unit 4, operating switches 15a to 15h forming part of the operating unit 15, etc. However, when the split display is the default as explained above, only naturally the split display flag f_{SE} is unnecessary. The split display flag f_{SE} being “1” is not included in the starting conditions.

First, it is judged which operating switch was operated (step S71). If judging there was a double depression, it is judged whether the operation was performed from the driver's seat side or the operation was performed from the passenger's seat side based on the information obtained from the phototransistors 4b (step S72). “Double depression” means the case where when not only the operating switches 62_{DR} to 67_{DR} receiving operation input for the driver's seat use picture G_{DR} but simultaneously the operating switches 62_{PA} to 67_{PA} receiving operation input for the passenger's seat use picture G_{PA} are operated, for example, the case where not only the region E₄₃′, but also the adjoining region 49′ is touched.

If it is judged that the operation was performed from the driver's seat side, operational control in accordance with the operation on the driver's seat use picture G_{DR} is performed (step S73), while if it is judged that the operation was performed from the passenger's seat side, operational control in accordance with the operation for the passenger's seat use picture G_{PA} is performed (step S74).

Further, at step S71, if it is judged that an operating switch receiving only operation input for the driver's seat use picture G_{DR} (for example, part of the regions E₄₃′ to E₄₈′ of the operating switches 62_{DR} to 67_{DR}) has been operated, operational control in accordance with the operation is performed (step S75), while if judging that an operating switch receiving only operation input for the passenger's seat use picture G_{PA} (for example, part of the regions E₄₉′ to E₅₄′ of the operating switches 62_{PA} to 67_{PA}) has been operated, operational control in accordance with the operation is performed (step S76).

Further, at step S71, when it is judged that the termination switch 61_{DR} provided at the driver's seat use picture G_{DR} for terminating the split display is operated, the termination switches 61_{DR}, 61_{PA} are erased from the screen (step S77), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S78), then the split display flag f_{SE} is returned to zero (step S79).

Further, at step S71, when it is judged that the termination switch 61_{PA} provided at the passenger's seat use picture G_{PA} for terminating the split display is operated, the termination switches 61_{DR}, 61_{PA} are erased from the screen (step S80), among the two pictures, the passenger's seat use picture G_{PA} is erased and the driver's seat use picture G_{DR} is displayed on the full screen (step S81), then the split display flag f_{SE} is returned to zero (step S82).

According to the AV navigation system employing a display device according to the embodiment (5), even if arranging the scopes of reception of operation input of the operating switches 62_{DR} to 67_{DR} for the driver's seat use picture G_{DR} (regions E₄₃′ to E₄₈′) and the scopes of reception of operation input of the operating switches 62_{PA} to 67_{PA} for the passenger's seat use picture G_{PA} (regions E₄₉′ to E₅₄′) so that they do not overlap, as shown in FIG. 37 and FIG. 38, the layouts of the driver's seat use and passenger's seat use operating switches can be made the same. For this reason, even if the viewing direction changes, the layouts of the operating switches do not change, so user friendliness can be improved.

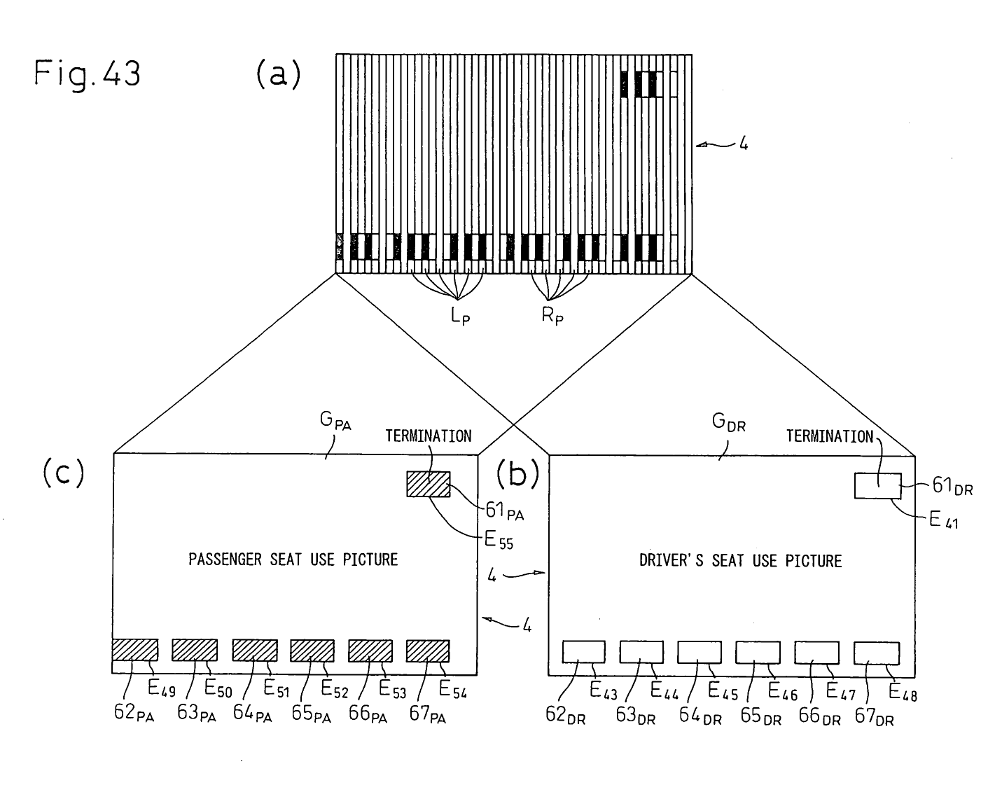

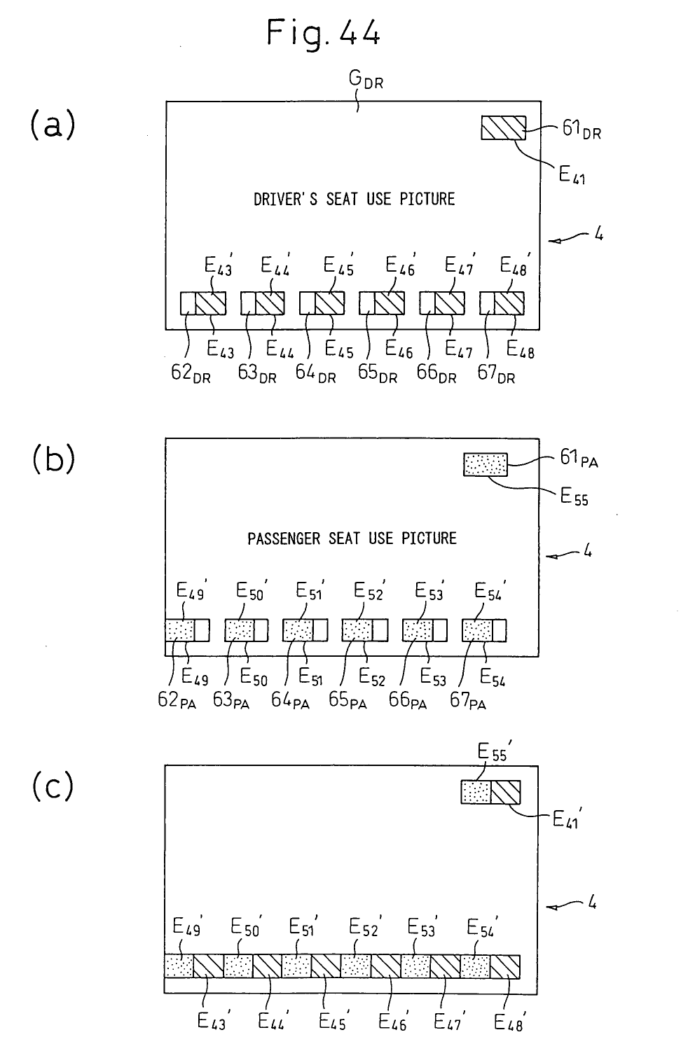

FIG. 43 and FIG. 44 are views showing modifications of the displays shown in FIG. 37 and FIG. 38. The termination switches 61_{DR}, 61_{PA}, in the same way as the other operating switches 62_{DR} to 67_{DR} and 62_{PA} to 67_{PA}, become substantially the same in layout between the driver's seat use picture G_{DR} and the passenger's seat use picture G_{PA}. Further, as shown in FIG. 44, the scope of reception of operation input for the termination switch 61_{DR} (region E₄₁′) and the scope of reception of operation input for the termination switch 61_{PA} (region E₅₅′) do not overlap.

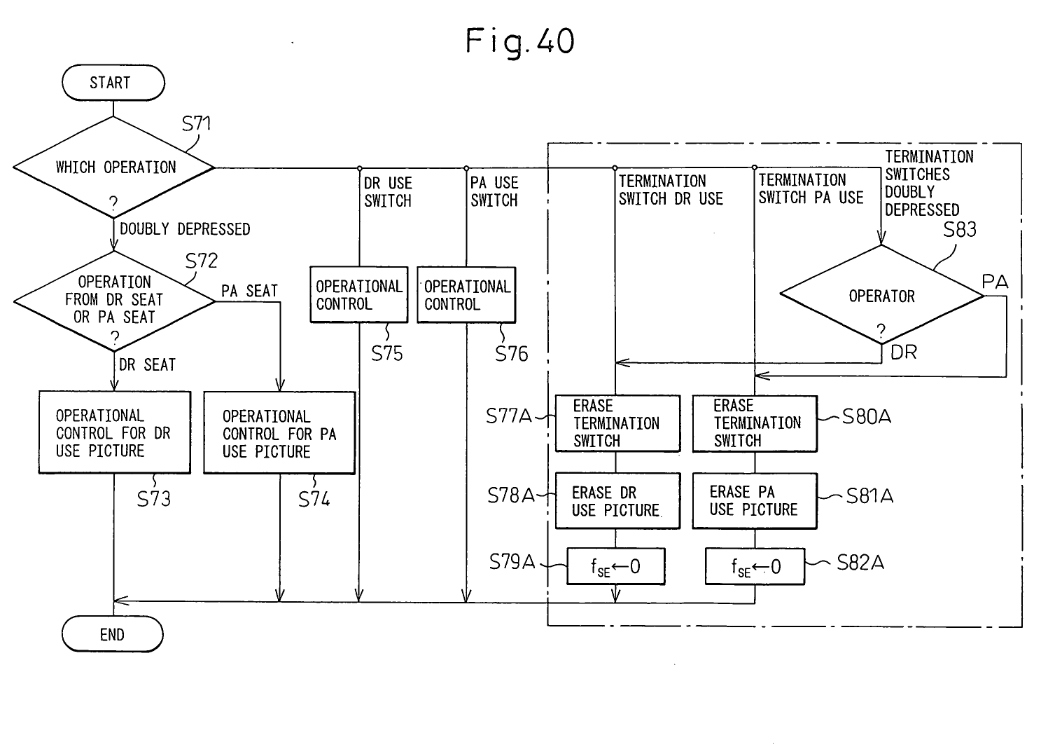

Note that here the flowchart shown in FIG. 39 will be used to explain the case where, as shown in FIG. 37 and FIG. 38, the termination switches 61_{DR}, 61_{PA} differ, but the operating switches 62_{DR} to 67_{DR} and 62_{PA} to 67_{PA} are the same in layout at the driver's seat use picture G_{DR} and passenger's seat use picture G_{PA}, but next the processing operation performed by the control unit for the case where, as shown in FIG. 43 and FIG. 44, the termination switches 61_{DR}, 61_{PA} also have the same layout between the two pictures G_{DR}, G_{PA} will be explained using the flowchart shown in FIG. 40. However, except for the part surrounded by the one-dot chain line, it is the same as the processing operation shown in FIG. 39, so here only the different parts will be explained.

At step S71, when it is judged that the termination switch 61_{DR} provided at the driver's seat use picture G_{DR} for terminating the split display is operated, the termination switches 61_{DR}, 61_{PA} are erased from the screen (step S77A), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S78A), then the split display flag f_{SE} is returned to zero (step S79A).

Further, at step S71, when it is judged that the termination switch 61_{PA} provided at the passenger's seat use picture G_{PA} for terminating the split display is operated, the termination switches 61_{DR}, 61_{PA} are erased from the screen (step S80A), among the two pictures, the passenger's seat use picture G_{PA} is erased and the driver's seat use picture G_{DR} is displayed on the full screen (step S81A), then the split display flag f_{SE} is returned to zero (step S82A).

Further, at step S71, if it is judged that the termination switches 61_{DR}, 61_{PA} were doubly depressed, it is judged whether the operation was performed from the driver's seat side or the operation was performed from the passenger's seat side based on the information obtained from the phototransistors 4b (step S83). If it is judged that the operations of the termination switches 61_{DR}, 61_{PA} were performed from the driver's seat side, in the same way as above, the processing of step S77A to S79A is performed, while if it is judged that the operations of the termination switches 61_{DR}, 61_{PA} were performed from the passenger's seat side, in the same way as above, the processing of step S80A to S82A is performed.

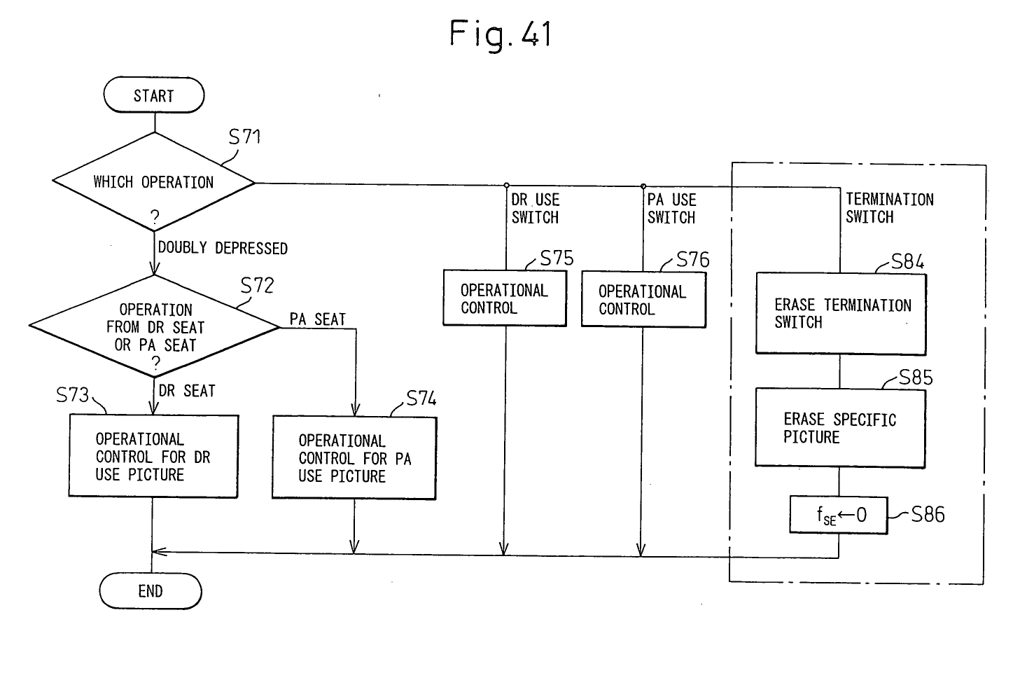

Next, the processing operation performed by the control unit for the case where the termination switches 61_{DR}, 61_{PA} are laid out the same in the two pictures G_{DR}, G_{PA} as shown in FIG. 43, FIG. 44 will be explained using the flowchart shown not in FIG. 40, but in FIG. 41. However, except for the part surrounded by the one-dot chain line, it is the same as the processing operation shown in FIG. 39, so here only the different parts will be explained.

At step S71, when it is judged that the termination switch 61_{DR} provided at the driver's seat use picture G_{DR} for terminating the split display or the termination switch 61_{PA} provided at the passenger's seat use picture G_{PA} for terminating the split display is operated, the termination switches 61_{DR}, 61_{PA} are erased from the screen (step S84), among the two pictures, the specific picture is erased and another picture not the specific picture is displayed on the full screen (step S85), then the split display flag f_{SE} is returned to zero (step S86).

For example, when the passenger's seat passenger PA finishes watching the desired program, movie, etc. there is a high chance of he or she instructing termination of the split display. On the other hand, the driver DR often requests the constant display of some sort of picture such as a navigation picture so there is a low chance of the driver DR instructing erasure of the picture display (termination of split display). Further, there is a high chance of the driver DR desiring full screen display of the driver's seat use picture G_{DR} when the passenger's seat passenger PA gets out of the car etc. Therefore, the termination switches 61_{DR}, 61_{PA} being operated means there is a high chance of the desire for full screen display of the driver's seat use picture G_{DR}, so it is particularly effective if the specific picture is made the passenger's seat use picture G_{PA} and the picture not the specific picture is made the driver's seat use picture G_{DR}.

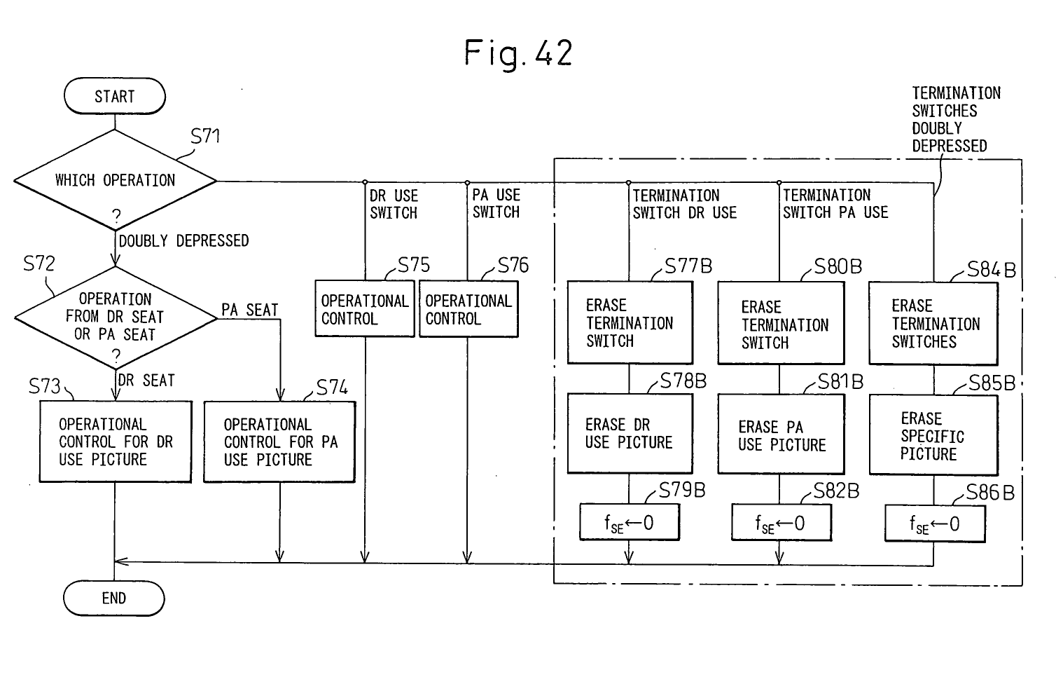

Next, the processing operation performed by the control unit for the case where the termination switches 61_{DR}, 61_{PA} are laid out the same in the two pictures G_{DR}, G_{PA} as shown in FIG. 43, FIG. 44 will be explained using the flowchart shown not in FIG. 40 and FIG. 41, but in FIG. 42. However, except for the part surrounded by the one-dot chain line, it is the same as the processing operation shown in FIG. 39, so here only the different parts will be explained.

At step S71, if it is judged that the termination switch 61_{DR} provided at the driver's seat use picture G_{DR} for terminating the split display is operated, the termination switches 61_{DR}, 61_{PA} are erased from the screen (step S77B), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S78B), then the split display flag f_{SE} is returned to zero (step S79B).

Further, at step S71, when it is judged that the termination switch 61_{PA} provided at the passenger's seat use picture G_{PA} for terminating the split display is operated, the termination switches 61_{DR}, 61_{PA} are erased from the screen (step S80B), among the two pictures, the passenger's seat use picture G_{PA} is erased and the driver's seat use picture G_{DR} is displayed on the full screen (step S81B), then the split display flag f_{SE} is returned to zero (step S82B).

Further, at step S71, if it is judged that the termination switches 61_{DR}, 61_{PA} were doubly depressed, processing the same as steps S84 to S86 shown in FIG. 41 is performed (step S84B to 86B).

Below, an AV navigation system employing a display device according to embodiment (6) of the present invention will be explained.

However, the AV navigation system is configured in the same way as the AV navigation system shown in FIG. 5 except for the control unit 100, so the control unit is assigned a different notation. The rest of the explanation will be omitted.

The control unit 100E performs a processing operation [6-1] similar to the processing operation [5-1] (see FIG. 36) performed by the control unit 100D to control the pixel display as shown in FIG. 37(a), display the driver's seat use picture G_{DR} such as shown in FIG. 37(b) and FIG. 38(a), and display the passenger's seat use picture G_{PA} such as shown in FIG. 37(c) and FIG. 38(b).

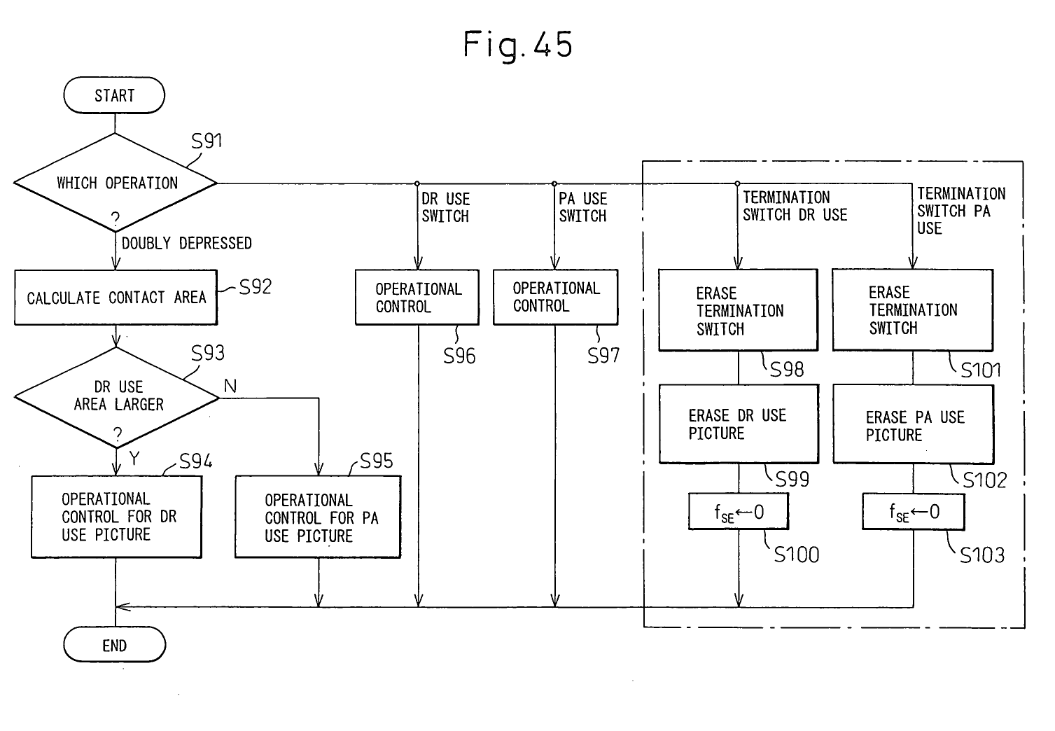

Next, a processing operation [6-2] performed by the control unit 100E in an AV navigation system employing the display device according to the embodiment (6) will be explained based on the flowchart shown in FIG. 45. Note that this processing operation [6-2] is an operation performed when the split display is performed (that is, when the split display flag f_{SE} is “1”) and the user operates termination switches 61_{DR}, 61_{PA} or operating switches 62_{DR} to 67_{DR}, 62_{PA} to 67_{PA} formed on the display unit 4, operating switches 15a to 15h forming part of the operating unit 15, etc. However, when the split display is the default as explained above, only naturally the split display flag f_{SE} is unnecessary. The split display flag f_{SE} being “1” is not included in the starting conditions.

First, it is judged which operating switch was operated (step S91). If judging there was double depression, the contact areas of the operated operating switches (area of marks of touch by finger) are calculated (step S92) and the contact area of the operating switch receiving operation input for the driver's seat use picture G_{DR} and the contact area of the operating switch receiving operation input for the passenger's seat use picture G_{PA} are compared (step S93).

If the contact area of the operating switch receiving operation input for the driver's seat use picture G_{DR} is larger than the contact area of the operating switch receiving operation input for the passenger's seat use picture G_{PA}, it is deemed that the operation was performed from the driver's seat side and operational control in accordance with the operation on the driver's seat use picture G_{DR} is performed (step S94), while if the contact area of the operating switch receiving operation input for the passenger's seat use picture G_{PA} is larger than the contact area of the operating switch receiving operation input for the driver's seat use picture G_{DR}, it is deemed that the operation was performed by the passenger's seat side and operational control in accordance with the operation for the passenger's seat use picture G_{PA} is performed (step S95).

Further, at step S91, if it is judged that an operating switch receiving only operation input for the driver's seat use picture G_{DR} (for example, part of the regions E₄₃′ to E₄₈′ of the operating switches 62_{DR} to 67_{DR}) was operated, operational control in accordance with the operation is performed (step S96), while if it is judged that an operating switch receiving only operation input for the passenger's seat use picture G_{PA} (for example, part of the regions E₄₉′ to E₅₄′ of the operating switches 62_{PA} to 67_{PA}) was operated, operational control in accordance with the operation is performed (step S97).

Further, at step S91, if it is judged that the termination switch 61_{DR} provided at the driver's seat use picture G_{DR} for terminating the split display is operated, the termination switches 61_{DR}, 61_{PA} are erased from the screen (step S98), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S99), then the split display flag f_{SE} is returned to zero (step S100).

Further, at step S91, when it is judged that the termination switch 61_{PA} provided at the passenger's seat use picture G_{PA} for terminating the split display is operated, the termination switches 61_{DR}, 61_{PA} are erased from the screen (step S101), among the two pictures, the passenger's seat use picture G_{PA} is erased and the driver's seat use picture G_{DR} is displayed on the full screen (step S102), then the split display flag f_{SE} is returned to zero (step S103).

According to the AV navigation system employing a display device according to the embodiment (6), even if the scope of reception of operation input of the operating switches 62_{DR} to 67_{DR} for the driver's seat use picture G_{DR} (regions E₄₃′ to E₄₈′) and the scope of reception of operation input of the operating switches 62_{PA} to 67_{PA} for the passenger's seat use picture G_{PA} (regions E₄₉′ to E₅₄′) so as not to overlap, as shown in FIG. 37 and FIG. 38, the layouts of the driver's seat use and passenger's seat use operating switches may also be made the same. Therefore, even if the viewing direction changes, since the layouts of the operation input units do not change, user friendliness is improved.

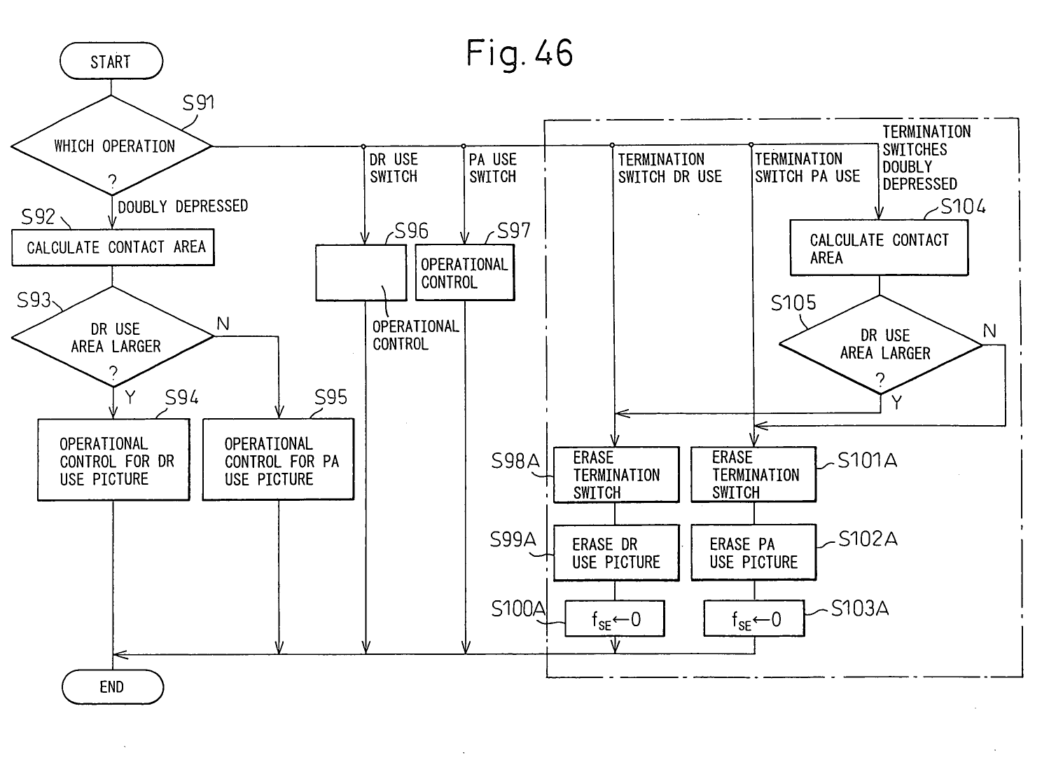

Note that here the flowchart shown in FIG. 45 will be used to explain the case where, as shown in FIG. 37 and FIG. 38, the termination switches 61_{DR}, 61_{PA} differ, but the operating switches 62_{DR} to 67_{DR} and 62_{PA} to 67_{PA} are the same in layout at the driver's seat use picture G_{DR} and passenger's seat use picture G_{PA}. Next the processing operation performed by the control unit for the case where, as shown in FIG. 43 and FIG. 44, the termination switches 61_{DR}, 61_{PA} also have the same layout between the two pictures G_{DR}, G_{PA} will be explained using the flowchart shown in FIG. 46. However, except for the part surrounded by the one-dot chain line, it is the same as the processing operation shown in FIG. 45, so here only the different parts will be explained.

At step S91, when it is judged that the termination switch 61_{PA} provided at the driver's seat use picture G_{DR} for terminating the split display is operated, the termination switches 61_{DR}, 61_{PA} are erased from the screen (step S98A), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S99A), then the split display flag f_{SE} is returned to zero (step S100A).

Further, at step S91, when it is judged that the termination switch 61_{PA} provided at the passenger's seat use picture G_{PA} for terminating the split display is operated, the termination switches 61_{DR}, 61_{PA} are erased from the screen (step S101A), among the two pictures, the passenger's seat use picture G_{PA} is erased and the driver's seat use picture G_{DR} is displayed on the full screen (step S102A), then the split display flag f_{SE} is returned to zero (step S103A).

Further, at step S91, if it is judged that the termination switches 61_{DR}, 61_{PA} were doubly depressed, the contact areas of the operated termination switches 61_{DR}, 61_{PA} (area of marks of touch by finger) are calculated (step S104) and the contact area of the driver's seat use termination switch 61_{DR} and contact area of the passenger's seat use termination switch 61_{PA} are compared (step S105).

When the contact area of the driver's seat use termination switch 61_{DR} is larger than the contact area of the passenger's seat use termination switch 61_{PA}, it is deemed that the operation was performed from the driver's seat side and, in the same way as above, the processing of step S98A to S100A is performed, while when the contact area of the passenger's seat use termination switch 61_{PA} is larger than the contact area of the driver's seat use termination switch 61_{DR}, it is deemed that the operation was performed by the passenger's seat side and, in the same way as above, the processing of step S101A to S103A.

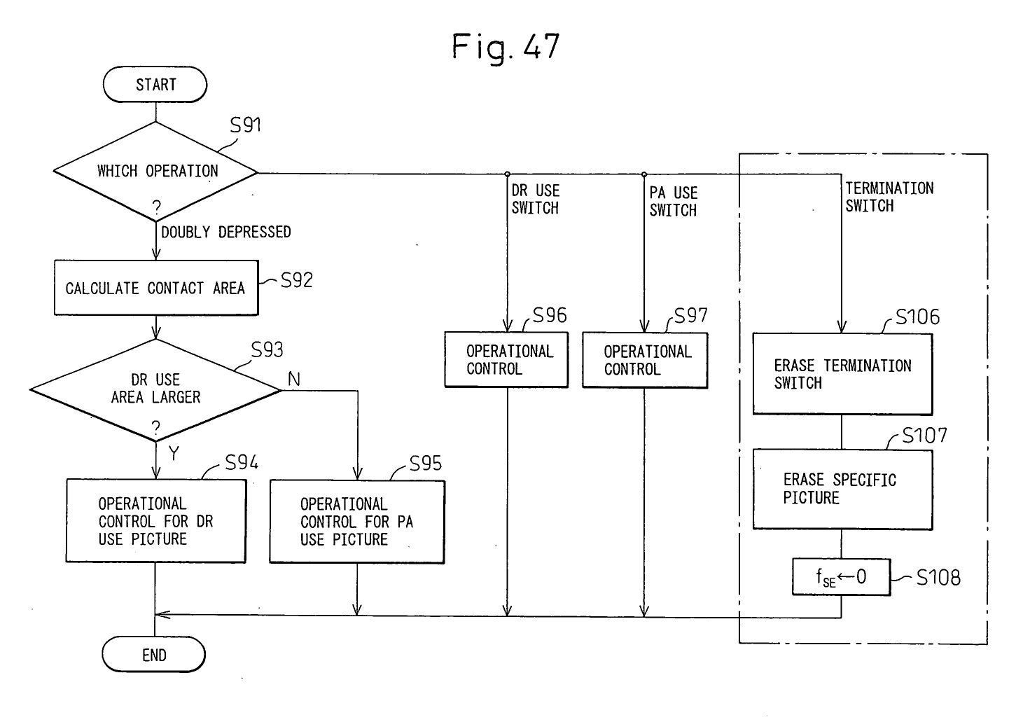

Next, the processing operation performed by the control unit for the case where the termination switches 61_{DR}, 61_{PA} are laid out the same in the two pictures G_{DR}, G_{PA} as shown in FIG. 43, FIG. 44 will be explained using the flowchart shown not in FIG. 46, but in FIG. 47. However, except for the part surrounded by the one-dot chain line, it is the same as the processing operation shown in FIG. 45, so here only the different parts will be explained.

At step S91, when it is judged that the termination switch 61_{DR} provided at the driver's seat use picture G_{DR} for terminating the split display or the termination switch 61_{PA} provided at the passenger's seat use picture G_{PA} for terminating the split display is operated, the termination switches 61_{DR}, 61_{PA} are erased from the screen (step S106), among the two pictures, the specific picture is erased and another picture not the specific picture is displayed on the full screen (step S107), then the split display flag f_{SE} is returned to zero (step S108). It is particularly effective if the specific picture, as explained above, is made the passenger's seat use picture G_{PA} and the picture not the specific picture is made driver's seat use picture G_{DR}.

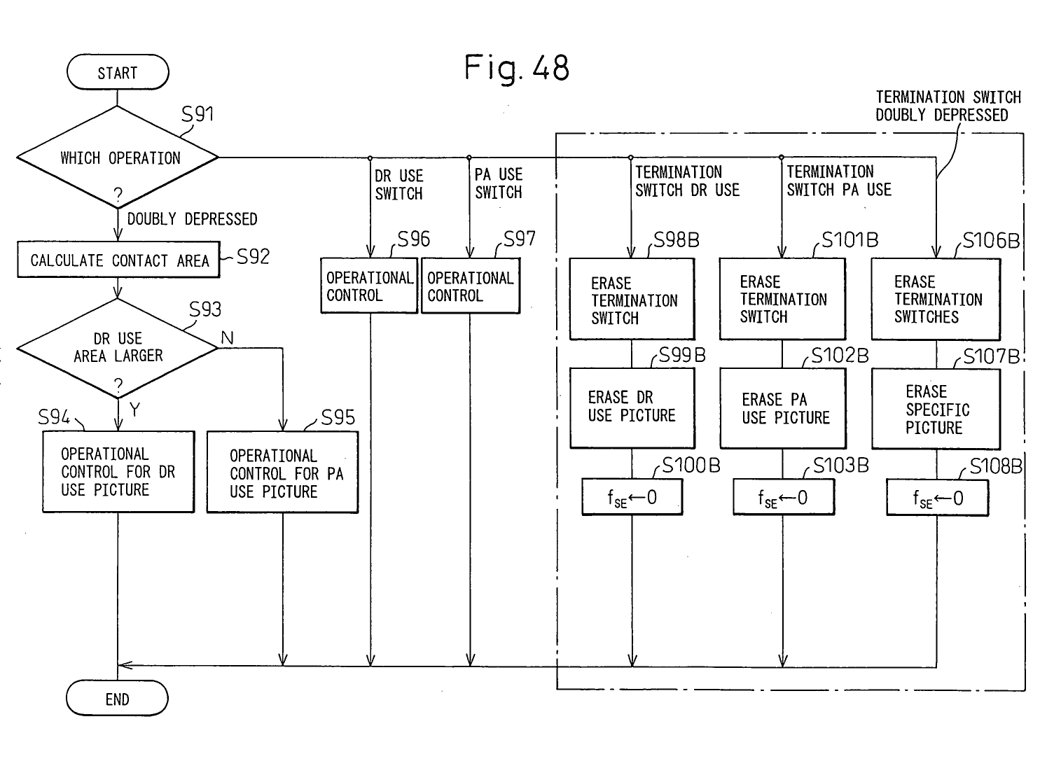

Next, the processing operation performed by the control unit for the case where the termination switches 61_{DR}, 61_{PA} are laid out the same in the two pictures G_{DR}, G_{PA} as shown in FIG. 43, FIG. 44 will be explained using the flowchart shown not in FIG. 46 and FIG. 47, but in FIG. 48. However, except for the part surrounded by the one-dot chain line, it is the same as the processing operation shown in FIG. 45, so here only the different parts will be explained.

At step S91, if it is judged that the termination switch 61_{DR} provided at the driver's seat use picture G_{DR} for terminating the split display is operated, the termination switches 61_{DR}, 61_{PA} are erased from the screen (step S98B), among the two pictures, the driver's seat use picture G_{DR} is erased and the passenger's seat use picture G_{PA} is displayed on the full screen, the operating switches 62_{PA} to 67_{PA} arranged toward the left side are returned to their normal positions (step S99B), then the split display flag f_{SE} is returned to zero (step S100B).

Further, at step S91, when it is judged that the termination switch 61_{PA} provided at the passenger's seat use picture G_{PA} for terminating the split display is operated, the termination switches 61_{DR}, 61_{PA} are erased from the screen (step S101B), among the two pictures, the passenger's seat use picture G_{PA} is erased and the driver's seat use picture G_{DR} is displayed on the full screen (step S102B), then the split display flag f_{SE} is returned to zero (step S103B).

Further, at step S91, if it is judged that the termination switches 61_{DR}, 61_{PA} were doubly depressed, processing similar to steps S106 to S108 shown in FIG. 47 is performed (step S106B to S108B).

Next, as explained above, another mode of the judgment as to which direction the operation input was made from (here, the judgment of whether the operation input was performed from the driver's seat side or was performed from the passenger's seat side) will be explained in detail using FIG. 49 to FIG. 55.

Below, an AV navigation system employing a display device according to embodiment (7) of the present invention using a touch panel to judge from which direction of the driver's seat and passenger's seat an operation was performed from will be explained.

However, the AV navigation system is configured similarly to the AV navigation system shown in FIG. 5 except for the control unit 100 and the touch panel 118 of the display unit 4 (however, infrared ray LEDs 4a and phototransistors 4b not provided). Explanations of similar components will be omitted.

FIG. 49(a) is a front view of a display unit forming part of the display device according to embodiment (7), while FIG. 49(b) is a cross-sectional view along the line B-B in FIG. 49(a). A plurality of light emitting elements 210 emitting beams in a direction perpendicular to the screen are provided at the top side and left side of the display unit 4 (touch panel 118) at heights H1, H2 from the touch panel 118, while a plurality of light receiving elements 211 receiving beams from the light emitting elements 210 are provided at the bottom side and right side of the display unit 4 at heights H1, H2 from the touch panel 118. Note that as the light emitting elements 210, infrared ray LEDs etc. may be mentioned, while as the light receiving elements 211, phototransistors etc. may be mentioned.

When a finger or other object T approaches the touch panel 118, beams heading toward the light receiving elements 211 are cut, so based on the information obtained from the light receiving elements 211, it is possible to find the position of the object T at the height H1 from the touch panel 118 and the position of the object T at the height H2 from the touch panel 118.

The control unit 100F receives as input the signals from the light receiving elements 211. The control unit 100F can confirm the on/off states of the light receiving elements 211 and therefore can find the position of the object T at the height H1 from the touch panel 118 and the position of the object T at the height H2 from the touch panel 118.

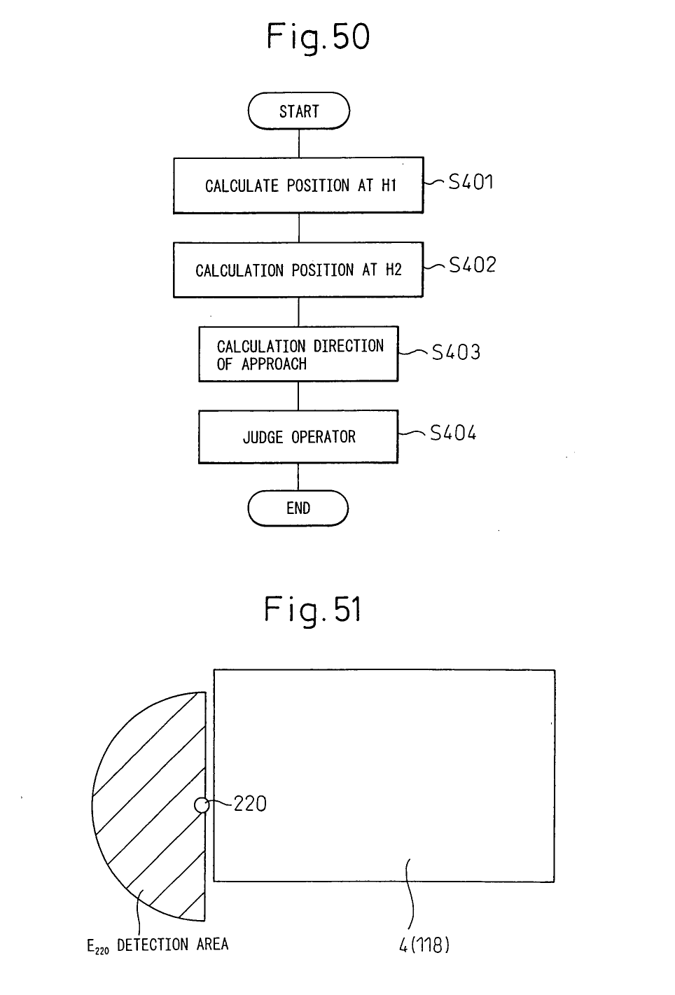

Next, a processing operation [7] performed by the control unit 100F in an AV navigation system employing the display device according to the embodiment (7) will be explained based on the flowchart shown in FIG. 50. Note that this processing operation [7] is processing for judging from what direction between the driver's seat and the passenger's seat the operation was from (that is, from what direction the operation input was from). It is an operation performed when contact with the touch panel 118 is detected during split display (multiview).

First, the position of the object T at the height H1 is calculated based on the information obtained from the light receiving element 211 provided at the bottom level (height H1) (step S401), next the position of the object T at the height H2 is calculated based on the information obtained from the light receiving element 211 provided at the top level (height H2) (step S402).

Next, a line connecting the position of the object T at the height H1 and the position of the object T at the height H2 is calculated, the direction of approach of the object T to the touch panel 116 is found (S403), and it is judged from which direction between the driver's seat side and passenger's seat side the object T approached from this direction of approach (step S404).

According to an AV navigation system employing a display device according to the embodiment (7), from which direction the operation input came is suitably judged. Further, here, the case where the light emitting elements 210 and light receiving elements 211 are provided at two levels is explained, but they may also be provided at three or more levels. Provision at three or more levels enables the direction of approach of the object T to be more accurately found.

Below, an AV navigation system employing a display device according to the embodiment (8) of the present invention using a sensor for detecting the object so as to judge from which direction between the driver's seat and passenger's seat the operation was made from will be explained.

However, the AV navigation system is configured similarly to the AV navigation system shown in FIG. 5 except for the control unit 100 and the sensor 220 detecting the object (however, infrared ray LEDs 4a and phototransistors 4b not provided). Explanations of similar components will be omitted.

FIG. 51 is a front view of a display unit forming a display device according to the embodiment (8). A detection sensor 220 for detecting an object T is provided near the left end of the display unit 4 (touch panel 118) (that is, passenger's seat side). In the figure, E₂₂₀ shows the detection area by the detection sensor 220. Note that as the detection sensor 220, for example, a heat sensitive sensor, infrared ray human sensitive sensor, air pressure sensor, etc. may be mentioned.

The control unit 100G receives as input a signal showing the results of detection by the detection sensor 220. The control unit 100G can recognize when an object T approaches the touch panel 118 from the passenger's seat side. Due to this, when the detection sensor 220 detects an object T, it can be judged that the operation input to the touch panel 118 was from the passenger's seat side, while conversely when the detection sensor 220 does not detect an object T, it can be judged that the operation input to the touch panel 118 was from the driver's seat side. Note that here, the detection sensor 220 is provided near the left end of the display unit 4 and detects the approach of an object from the passenger's seat side, but in another embodiment, it is possible to provide the detection sensor 220 near the right end of the display unit 4 and detect the approach of an object from the driver's seat side.

Below, an AV navigation system employing a display device according to the embodiment (8) of the present invention judging from which direction between the driver's seat and passenger's seat an operation was made from the contact mark of the touch panel will be explained.

However, the AV navigation system is configured similarly to the AV navigation system shown in FIG. 5 except for the control unit 100 (however, infrared ray LEDs 4a and phototransistors 4b not provided). Explanations of similar components will be omitted.

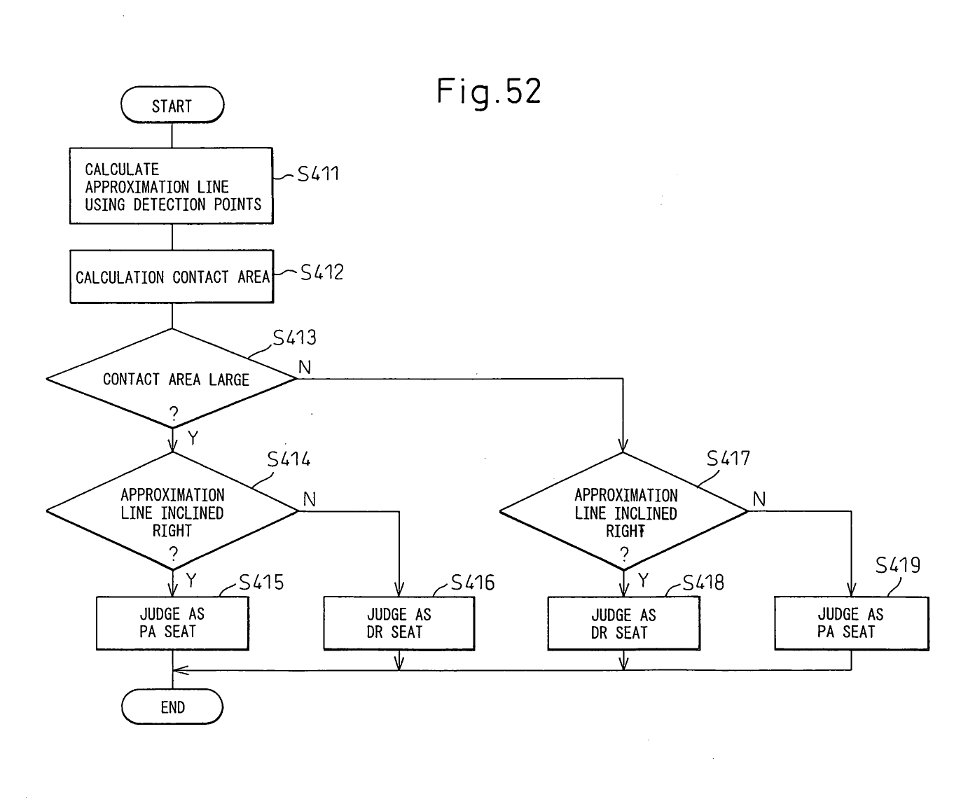

A processing operation [9] performed by the control unit 100H in an AV navigation system employing the display device according to the embodiment (9) will be explained based on the flowchart shown in FIG. 52. Note that this processing operation [9] is processing for judging from what direction between the driver's seat and the passenger's seat the operation was from (that is, from what direction the operation input was from). It is an operation performed when contact of a finger or other object with the touch panel 118 employing a multipoint detectable system is detected during split display (multiview).

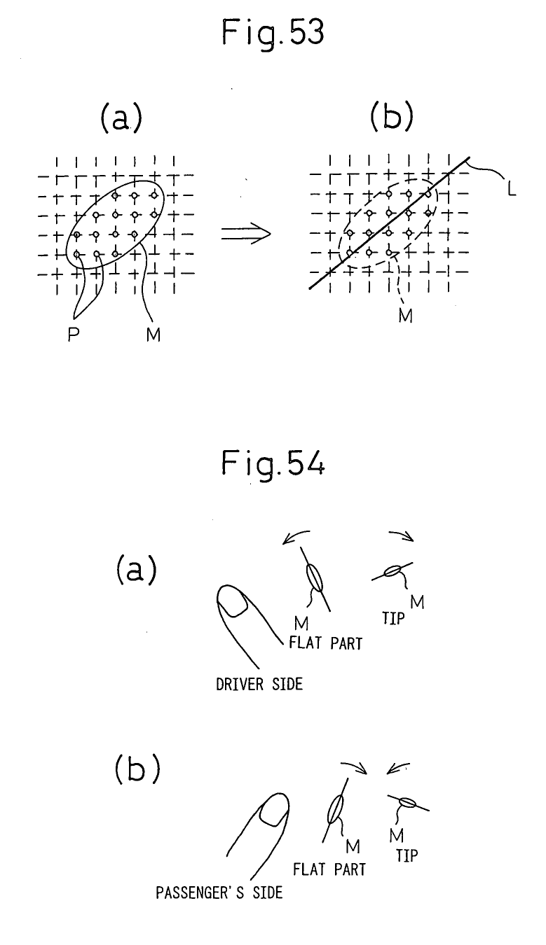

First, detection points included in a contact mark on the touch panel 118 (contact mark by the finger) are used to calculate an approximation line by the least square method (step S411). For example, when the contact mark M on the touch panel 118 is in the state as shown in FIG. 53(a), it is possible to use the plurality of detection points P included in the contact mark M to find the approximation line L inclined to the right such as shown in FIG. 53(b). Further, it is learned from this approximation line L that the contact mark M is inclined to the right.

Next, the area of the contact mark M (area of mark of contact by finger) is calculated (step S412) and whether the area of the contact mark M is a certain size or more is judged (step S413). As shown in FIG. 54, the area of the contact mark M becomes larger in the case where the flat part of the finger is used to touch the touch panel 118 than in the case where the tip part of the finger is used to touch the touch panel 118.

Further, as shown in FIG. 54(a), when the driver's seat passenger DR seated at the right side uses the flat part of the finger, the contact mark M is inclined to the left, while when he or she uses the tip part of the finger, the contact mark M is inclined to the right. Further, as shown in FIG. 54(b), when the passenger's seat passenger PA seated at the left side uses the flat part of the finger, the contact mark M is inclined to the right, while when he or she uses the tip part of the finger, the contact mark M is inclined to the left.

If judging that the area of the contact mark M is a certain fixed magnitude or more, it is deemed that the operator used the flat part of the finger to touch the touch panel 118, then it is judged if the approximation line L is inclined to the right (step S414). If judging that the approximation line L (that is, the contact mark M) is inclined to the right, it is judged that the operation input was performed from the passenger's seat side (step S415). On the other hand, if judging that the approximation line L is not inclined to the right, it is judged that the operation input was performed from the driver's seat side (step S416).

Further, at step S413, if judging that the area of the contact mark M is not a certain fixed magnitude or more, it is deemed that the operator used the tip part of the finger to touch the touch panel 118, then it is judged if the approximation line L is inclined to the right (step S417). If judging that the approximation line L (that is, the contact mark M) is inclined to the right, it is judged that the operation input was performed from the driver's seat side (step S418). On the other hand, if judging that the approximation line L is not inclined to the right, it is judged that the operation input was performed from the passenger's seat side (step S419).

According to the AV navigation system employing a display device according to the embodiment (9), it is possible to suitably judge from which direction the operation input was made. Further, here, it is judged by which of the flat part of the finger or tip part of the finger the operator touched the touch panel 118 based on the magnitude of the area of the contact mark M, but judgment of the method of touch is not limited to this. In other embodiments, this may also be judged by the change in area of the contact mark M, the method of application of pressure to the touch panel 118, information registered in advance, etc.

For example, when touching the touch panel 118 by the flat part of the finger, the time from when touching the touch panel 118 to when there is no longer a change in area of the contact mark M becomes longer compared with the case of touching it by the tip part. Therefore, when the time from when touching the touch panel 118 to when there is no longer a change in area of the contact mark M is long, it is judged that the flat part has been used to touch the panel, while when the time is short, it is judged that the tip part has bee used to touch it.

Further, when touching the touch panel 118 by the tip part of the finger, the part where pressure of a certain magnitude or more is applied becomes narrower, but when touching it by the flat part, the part where pressure of a certain magnitude or more is applied becomes broader. Therefore, when the part where pressure of a certain magnitude or more is applied is narrow, it is judged that the tip part was used to touch the panel, while when the part is broad, it is judged that the flat part was used to touch it.

Further, whether the touch panel 118 is touched by the tip part of the finger or touched by the flat part does not change over time. If the operator is the same, it may be considered to be the same at all times. Therefore, it is possible to register in advance if the tip part is used to touch the panel or the flat part is used to touch the panel and that information is used for judgment.

Below, an AV navigation system employing a display device according to embodiment (8) of the present invention which judges from which direction between the driver's seat side and passenger's seat side an operation was from by a contact mark on the touch panel will be explained.

However, the AV navigation system is configured similarly to the AV navigation system shown in FIG. 5 except for the control unit 100 and not shown fingerprint detection sensor (however, infrared ray LEDs 4a and phototransistors 4b not provided). Explanations of similar components will be omitted.

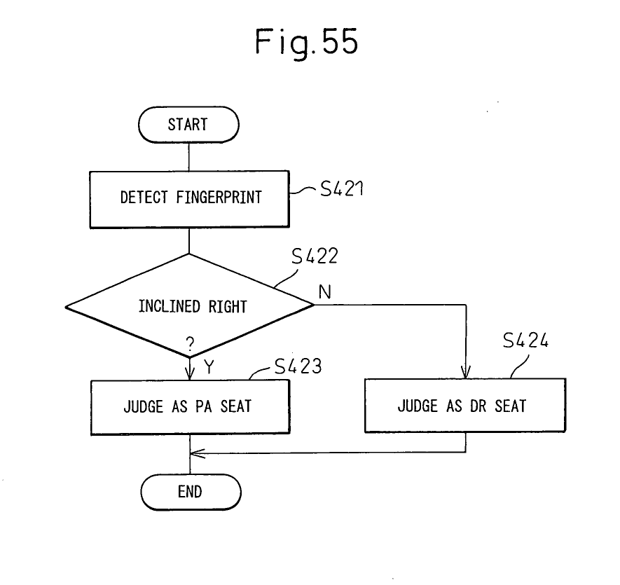

A processing operation [10] performed by the control unit 100I in an AV navigation system employing the display device according to the embodiment (10) will be explained based on the flowchart shown in FIG. 55. Note that this processing operation [10] is processing for judging from what direction between the driver's seat and the passenger's seat the operation was from (that is, from what direction the operation input was from). It is an operation performed when contact of a finger or other object with the touch panel 118 is detected during split display (multiview).

First, the fingerprint touching the touch panel 118 is detected (step S421) and it is judged if the projecting part of the detected fingerprint faces the right (step S422). If it is judged that the projecting part of the fingerprint faces the right, it is judged that the operation input was from the passenger's seat side (step S423). On the other hand, if it is judged that the projecting part of the fingerprint faces the left, it is judged that the operation input was from the driver's seat side (step S424).

According to the AV navigation system employing a display device according to the embodiment (10), it is possible to suitably judge from which direction the operation input was from. Further, the direction of the projecting part of the fingerprint does not change no matter which of the flat part or tip part of the finger is used to touch the touch panel 118, so it is not necessary to detect the method of touching the touch panel 118 and therefore the processing can be simplified.

In the display devices according to the embodiments (7) to (10), modes of judging from which direction the operation input was from were explained, but these judgment processings are not always perfect. For example, a situation may arise where the contact mark M of the finger is substantially straight and it cannot be judged to be inclined to the left or right.

Therefore, in a separate embodiment, when it cannot be judged from which direction the operation input was made from the current information, it is also possible to judge that the operation input was made from the same direction as the previous time. Since the operation is often repeated by the same individual, when it is not possible to judge from which direction the operation input was made from the current information, it is extremely effective to judge if the operation input was made from the same direction as the previous time.

Further, up to here, the explanation was given with reference to the case of use for a right side steering wheel car (right side is driver's seat), but depending on the processing, some inconvenience might occur if used for a left side steering wheel car. Therefore, in another embodiment, it is also possible to provide a selection switch for selecting use for a right side steering wheel car or use for a left side steering wheel car and consider the selection information obtained from the selection switch to control the processing.

In the display devices according to the embodiments (1) to (10), the case of operating the operating switches formed on the display unit 4 and an operating unit 15 provided around the display unit 4 (that is, the case where unless accurately discriminating the operator, there is a good chance of erroneous operation) is explained, but in a display device according to another embodiment, it is also possible to receive operation instructions from an operation device or remote controller 123 provided at other locations than the display unit 4 and for example enable only operation for the passenger's seat use picture G_{PA} at the operation device or remote controller 123 (of course, it is also possible to enable only operation for the driver's seat use picture G_{DR}). If using these operation device or remote controller 123, erroneous operation due to an error of an operator can be remarkably reduced.

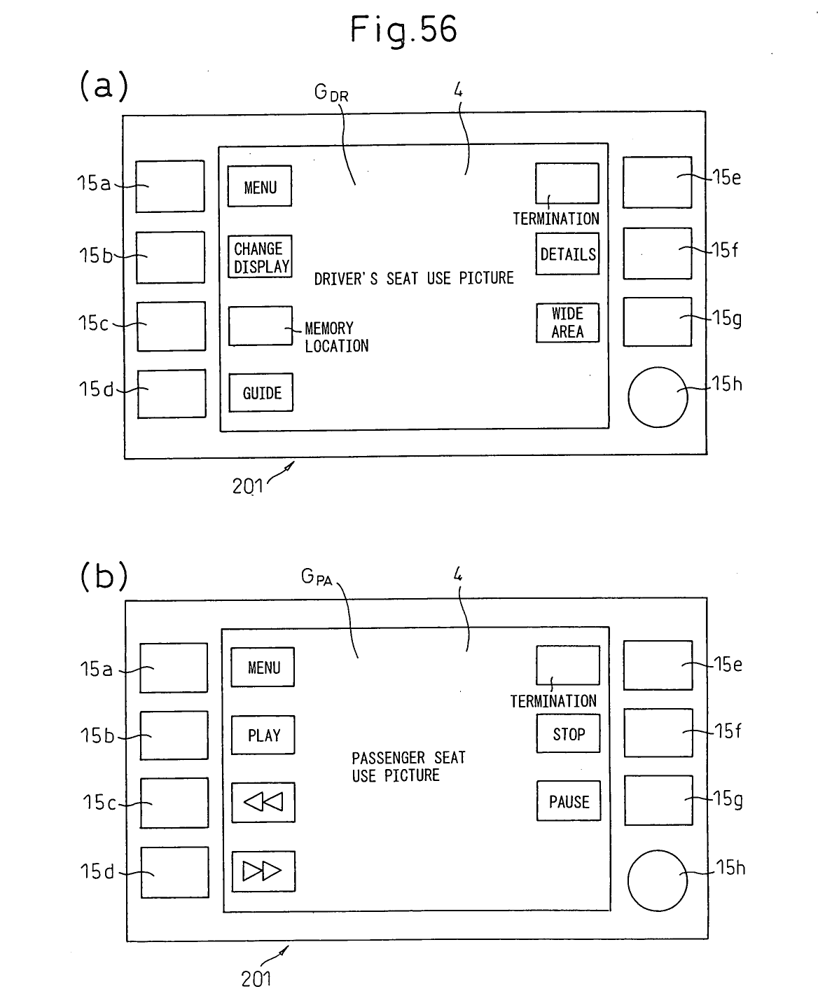

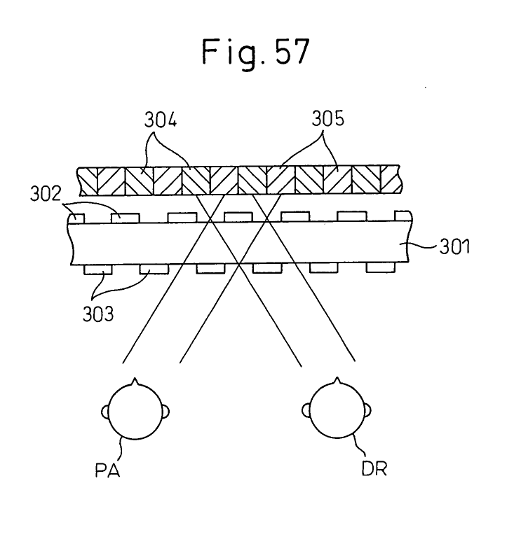

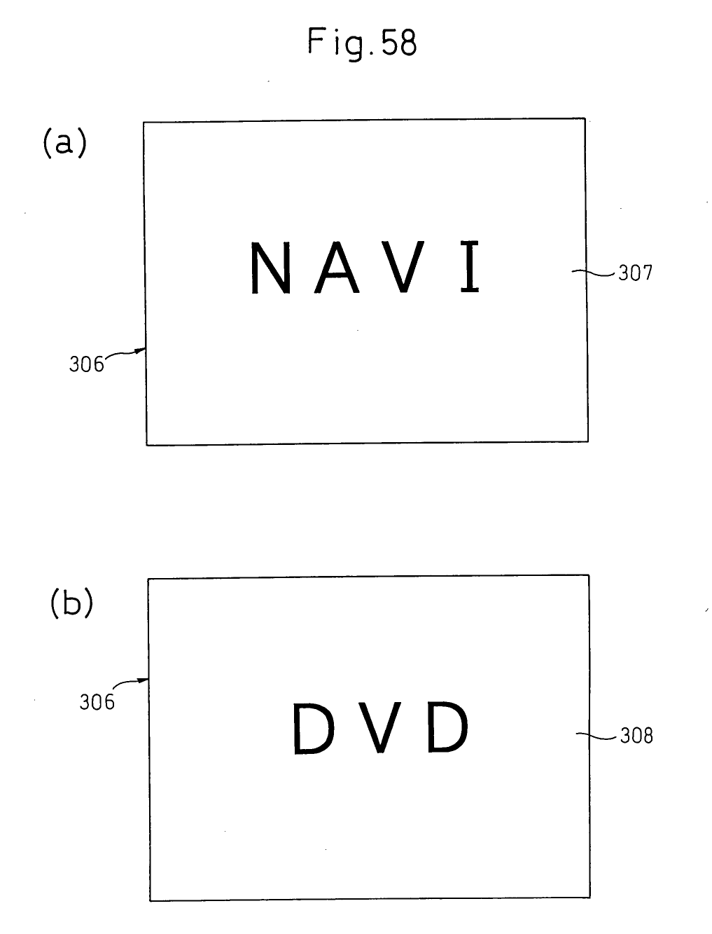

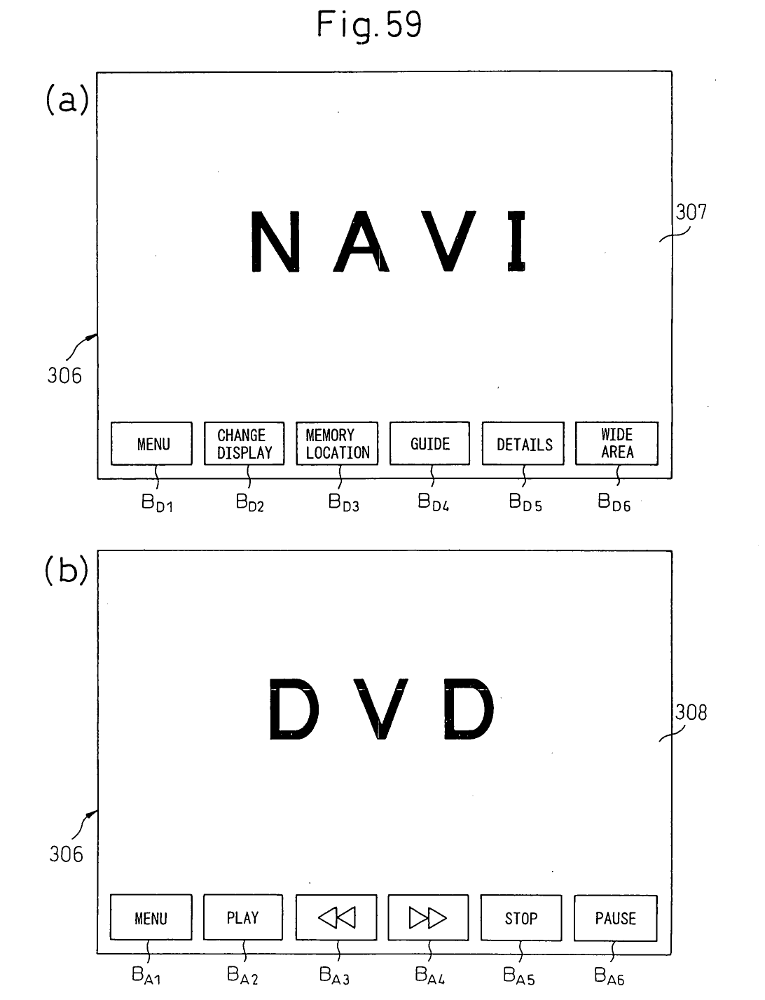

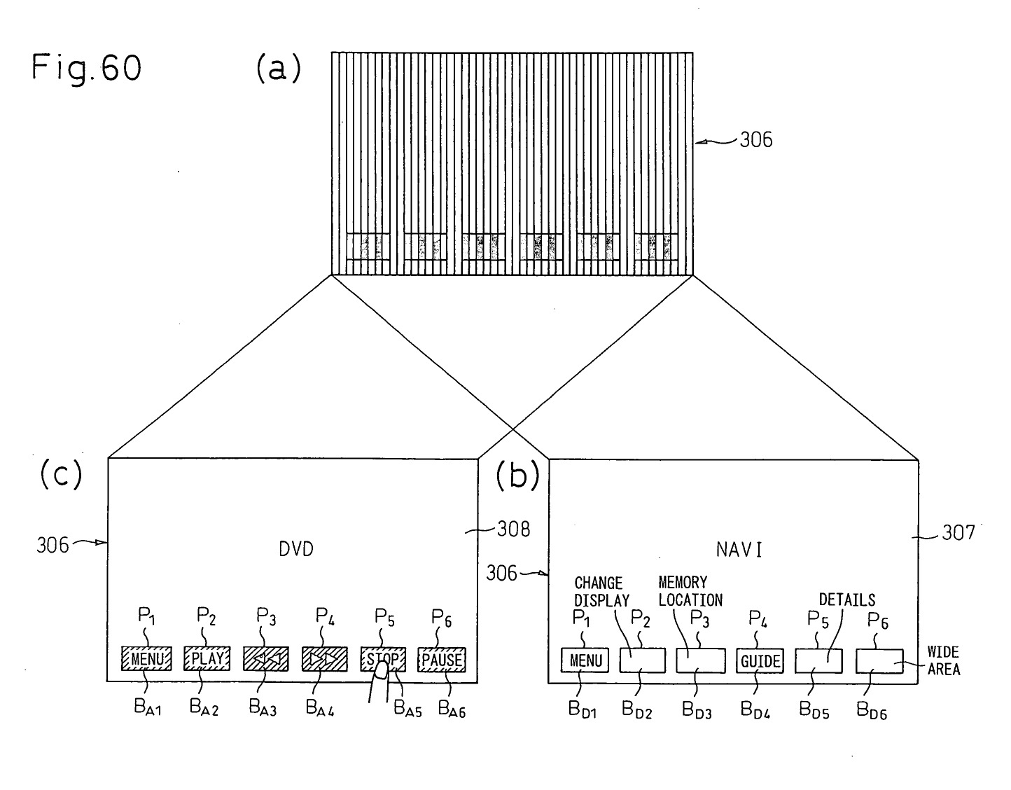

Further, up to here, the case of judging from which direction an operation input on a switch provided on the display unit 4 is made from and performing control based on the results of judgment was explained, but the display device according to the present invention is not limited to processing on a switch provided at the display unit 4. Similar processing may also be performed for the operating switches 15a to 15h provided around the display unit 4. For example, it is also possible to change the operation function between the case for a driver's seat use picture G_{DR} and the case for a passenger's seat use picture G_{PA} and, as shown in FIG. 56, explain the operation function for the operating switches 15a to 15g by the display unit 4.

Further, up to here, the case of use as an AV navigation system and mounting the same in a car was explained, but the display device according to the present invention is not limited to use mounted on a car. It may also be used for a household use television etc. The present invention is effective for displaying individual information for a plurality of viewing directions on the common screen. Further, the viewing directions are not limited to two directions and may be three directions or more.

Below, an AV navigation system employing a display device according to the embodiment (11) of the present invention will be explained.

FIG. 61 is a schematic block diagram showing the characterizing part of the embodiment (11). In FIG. 61, components similar to the AV navigation system shown in FIG. 5 are assigned the same notations. Further, in FIG. 61, in addition to the configuration of FIG. 5, a fingerprint comparison unit 330, fingerprint sensor 332, and audio adjustment circuit 113 are added.

The display unit 4, as explained above, is comprised of a touch panel 118, liquid crystal panel 21, backlight 30, etc. The first image adjustment circuit 114 controls the drive and display operations of the first strip part displaying an image to the driver's seat side, while the second image adjustment circuit 115 controls the drive and display operations of the second strip part displaying an image to the passenger's seat side.

The control unit 100 displays images from various types of sources (CD/DVD player 280, radio receiver 102, TV receiver 103, and navigation unit 106) using the first and second image adjustment circuits 114, 115 on the liquid crystal panel 21 separately at the driver's seat side and passenger's seat side.

The operator can input various types of data and operations from a touch panel 118 attached to the front surface of the display unit 4, an operating unit 15 provided around the display unit 4 and comprised of various types of buttons, switches, etc., and/or a remote controller 123.

The control unit 100 detects fingerprint data of an operator from the fingerprint sensor 332 when the fingertip of the operator is placed on the fingerprint sensor 332, uses a fingerprint comparison program stored in a fingerprint comparison unit 330 to compare this with the fingerprint data stored in the memory 125, and authenticates the operator placing his or her fingertip on the fingerprint sensor 332. Note that another bioauthenticating means for identifying an operator, for example, a vein pattern recognizing means and a retinal panel authenticating means etc. may be used in place of the fingerprint authenticating means.

Further, the control unit 100 is designed to be able to control the volumes of the first speaker 17-1 to fourth speaker 17-4 provided at different parts of the car 19 using the audio adjustment circuit 113.

Further, the control unit 100 is designed to be able to detect the volumes from the first detection sensor 320 to fifth detection sensor 328 provided at the headrest parts of the seats of the cars 19 through the audio detection unit 300.

The navigation unit 106 includes a map information storage unit storing map information used for navigation, a gyro sensor, and vehicle speed pulse detection unit. Further, it uses the various types of data from the VICS information receiver 111 and GPS information receiver 112 to prepare and output images for navigation operations and displays them via the control unit 100 on a display unit.

As shown in FIG. 2, the display unit 4 is provided at a dashboard part substantially at the center between the driver's seat 11 and passenger's seat 12, while the operating unit 15 and the fingerprint sensor 332 are provided at the size of the display unit 4. Further, the speaker 17 provided at the bottom of the driver's seat side door is the first speaker 17-1.

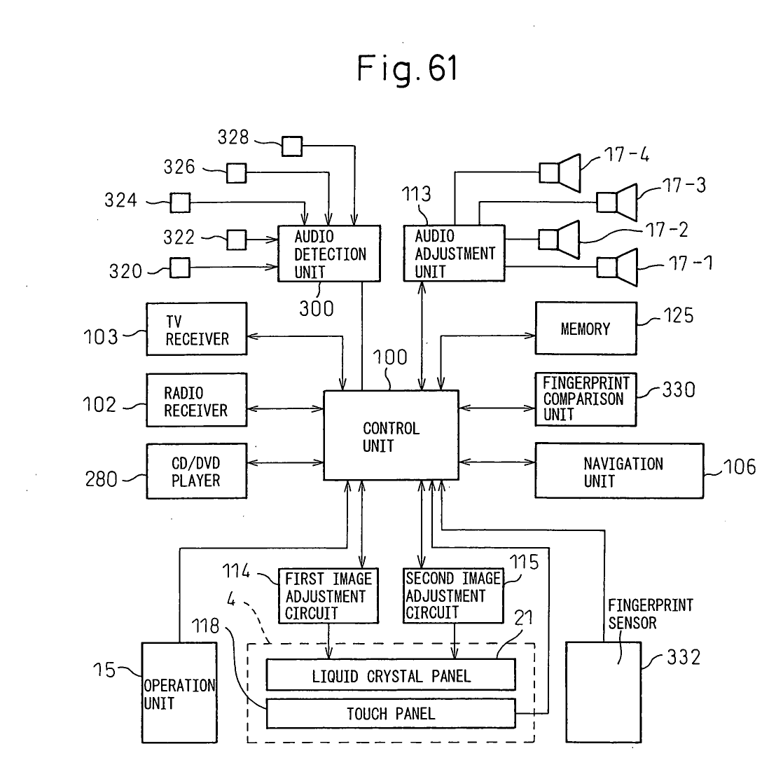

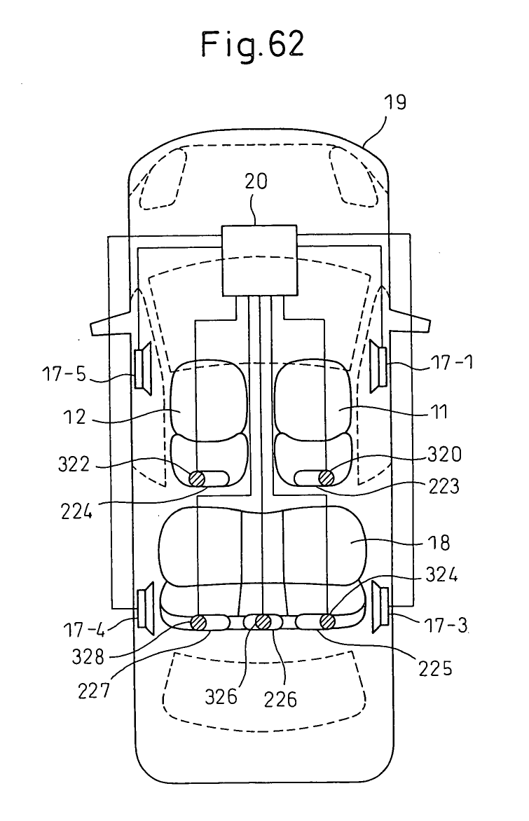

FIG. 62 shows an example of the arrangement of the speakers and detection sensors. As shown in FIG. 62, a first speaker 17-1 is arranged at the driver's seat side door, a second speaker 17-2 at the passenger's seat side door, a third speaker 17-3 at the right side of the rear seat 18, and a fourth speaker 17-4 at the left side of the rear seat 18. Further, a first detection sensor 320 is arranged in the headrest 223 of the driver's seat 11, a second detection sensor 322 is arranged in a headrest 224 of the passenger's seat 12, a third detection sensor 324 is arranged in a headrest 225 of the rear seat 18, a fourth detection sensor 326 is arranged in a headrest 226 of the rear seat 18, and a fifth detection sensor 328 is arranged in a headrest 227 of the rear seat 18. Note that the example of arrangement of the speakers and detection sensors is one example. Various modes may be adopted in accordance with the inside shape of the car, the arrangement of the seats, etc.

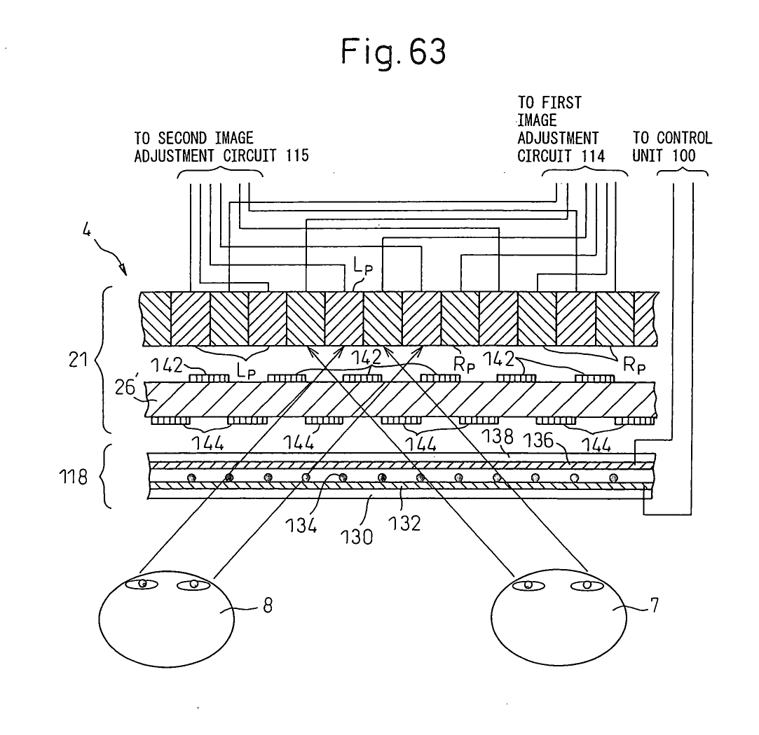

FIG. 63 is a schematic view showing the cross-sectional shape of the display unit 4. The touch panel 118 is comprised of a pair of flexible transparent insulating boards 130 and 138, transparent electrodes 132 and 136 formed on the transparent insulating board, and dot spacers 134 arranged in a matrix on the transparent electrode 132. When the operator presses against the transparent electrode board 130 and the dot spacers 134 contact the transparent electrode 136, the positions of the contact points are detected by measurement of the electrical resistance and the control unit 100 reads the input information. Note that the touch panel 118 is not limited to the above configuration. It is also possible to use another system.

The liquid crystal panel 21 is divided into a plurality of strips in the vertical direction. Left side (passenger's seat side) display pixels Lp and right side (driver's seat side) display pixels Rp are alternately formed. All of the left side (passenger's seat side) display pixels Lp are controlled in drive by the first image adjustment circuit 114, while all of the right side (driver's seat side) display pixels Rp are controlled in drive by the second image adjustment circuit 115.

At the front surface of the liquid crystal panel 21, a parallax barrier 26′ formed from polycarbonate etc. is arranged. At the front and rear of the parallax barrier 26′, light blocking strips 142 and 144 are alternately formed. In the example of FIG. 63, a parallax barrier 26′ comprised of alternately formed light blocking strips 142 and 144 is used, but it is of course also possible to use a parallax barrier 26 such as shown in FIG. 3(b).

The right side passenger 7 can view only an image of the set of the right side (driver's seat side) display pixels Rp as the driver's seat use display image by the action of the parallax barrier 26′. On the other hand, the left side passenger 8 can view only an image of the set of the left side (passenger's seat side) display pixels Lp as the passenger's seat use display image by the action of the parallax barrier 26′. In this way, in practice, every other image of a plurality of images dividing one screen in the vertical direction is viewed. By making the width of each strip extremely narrow, it becomes possible to view separate images from the right side and the left side.

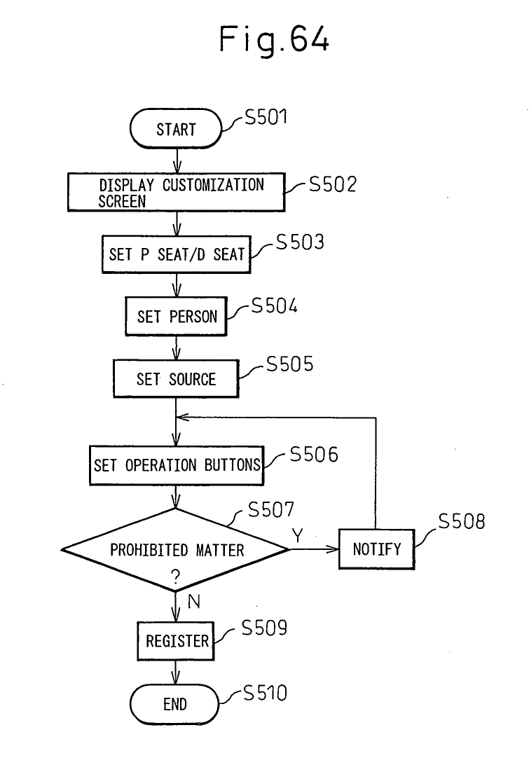

FIG. 64 shows an example of the operation flow at the time of registration for customizing an operation button array using the above-mentioned display device. The following operation flow is mainly executed by the control unit 100 in accordance with a prestored program.

In the state where the power of the AV navigation system employing the display device is turned on and various types of functions can be performed, a program is started by input of a customization operation by the operating unit 15 or remote controller 123 etc. (S501).

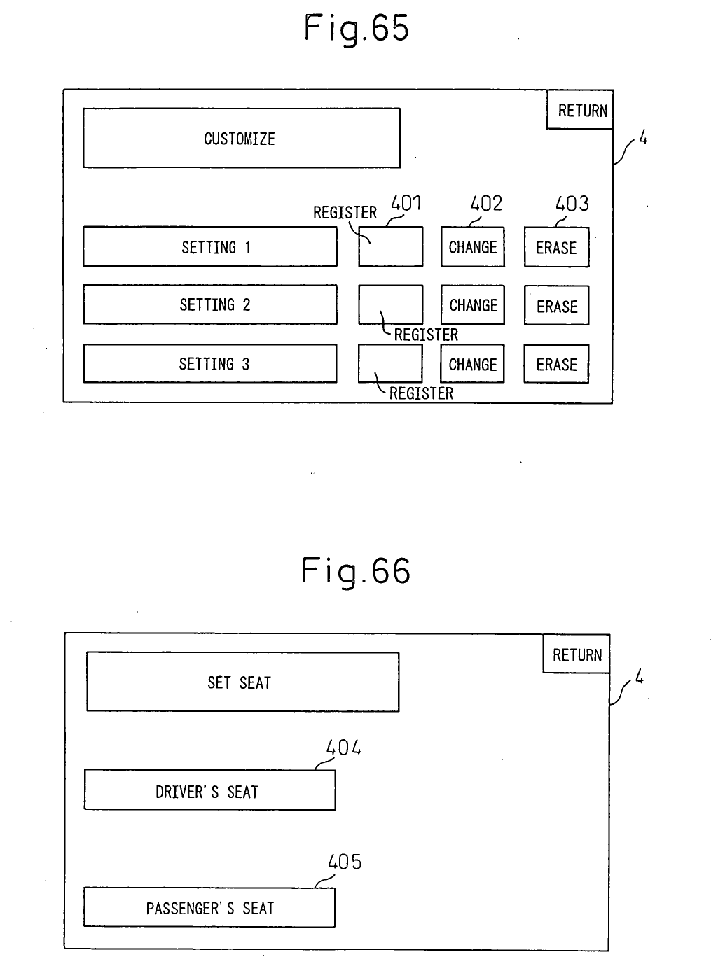

Next, when a customization operation is selected, a customization use image is displayed on the display unit 4 (S502). FIG. 65 shows an example of a customization use image displayed on the screen. The operator selections one registration button among the SETTING 1 to SETTING 3 on the customization use image displayed on the screen shown in FIG. 65, for example, 401.

Next, for customization of the button array at the passenger's seat (P seat) or driver's seat (D seat), the seat for customization is set (S503). An example of display of the image for setting the seat is shown in FIG. 66. When for example the registration button 401 is selected on the image displayed on the screen shown in FIG. 65, the selection image shown in FIG. 66 is automatically displayed on the screen, so the operator uses the screen to select the driver's seat 404 or the passenger's seat 405. Seat sensors etc. are arranged at the seats. When it can be determined which seat the operator is operating from, this step can be omitted.

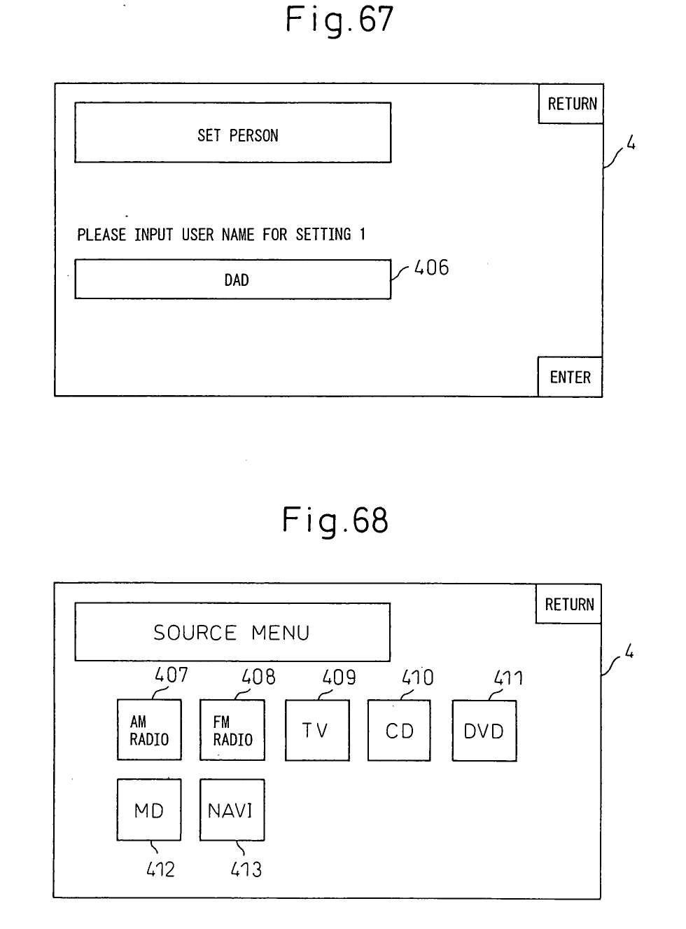

Next, the individual is set for customization (S504). An example of the image for setting the individual is shown in FIG. 67. When the seat is selected on the image displayed on the screen shown in FIG. 66, the image shown in FIG. 67 is automatically displayed on the screen, so the operator inputs an operator name identifying himself or herself (for example, “DAD”) utilizing the operating unit 15, remote controller 123, a software keyboard, etc. in a predetermined field 406. Note that when customizing the image without identifying the operator (case of common setting for the display device), this step may be omitted.

Note that at the same time as registering the operator name, it is also possible to use the fingerprint sensor 332 to register fingerprint data. The registered fingerprint data is stored together with the operator name in the memory 125. Note that when customizing the image without identifying the operator (for example, case of common setting for the display device), this processing is unnecessary.

Next, the source to be currently registered is set (S505). If the individual is set on the image displayed on the screen shown in FIG. 67, the image shown in FIG. 68 is automatically displayed on the screen, so the operator for example selects the button 413 for selecting navigation and sets the source for customization. Note that when customizing the image without specifying the source (for example, case of common setting for all sources), this step may be omitted. Further, it is also possible to have the currently selected source automatically set as the source covered. In this case, setting by the operator at this step becomes unnecessary.

Next, the operation buttons of the source set at the set seat side are customized (S506). In the customization of the operation buttons, the size, shape, brightness, color position on the screen, and function of the operation buttons can be freely set by the operator. Further, in this embodiment, the operator can use the operating unit 15, remote controller 123, etc. to freely arrange the operation buttons at any locations in the display region of the display unit 4. Note that as the method of the setting operation, it is of course possible to use another system.

Next, it is judged if the customization of the operation buttons set by the operator corresponds to prohibited matter (S507).

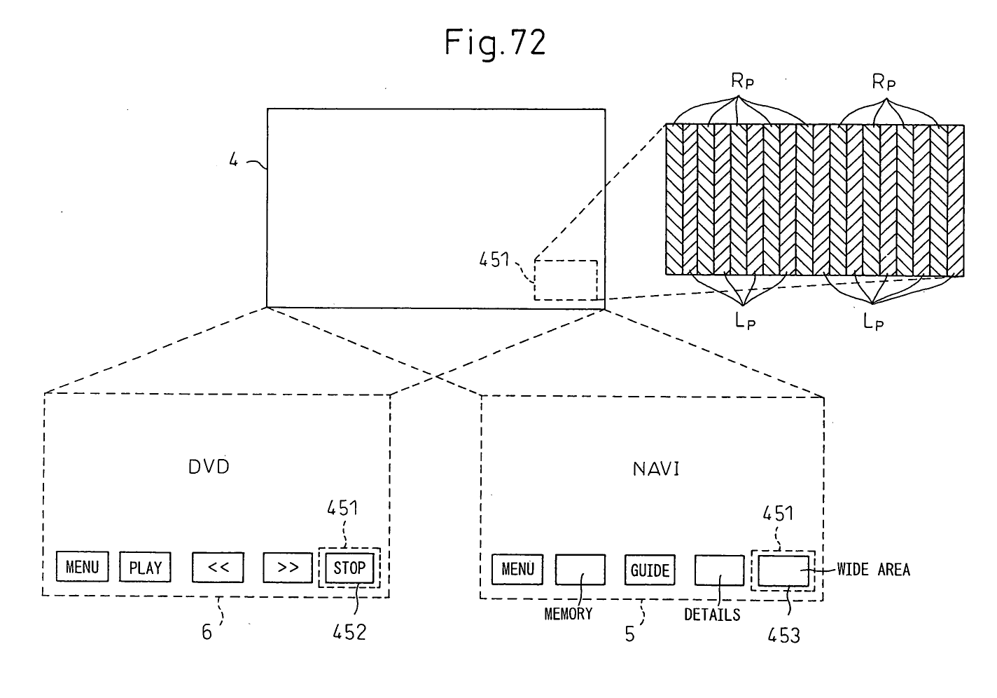

As prohibited matter, there is the case where the operation button array to be currently registered overlaps in position the operation button array of the seat at the opposite side already registered. This is because, in this embodiment, even if dividing one screen of the display unit 4 into multiple sections to enable a plurality of operators to view different images, since there is a single touch panel 118, for example, as shown in FIG. 72, if the arrays of operation buttons for the plurality of operators are arranged close to each other on the display unit 4 and the operating regions overlap, which seat operation input is for can no longer be judged by the control unit 100 side. As shown in FIG. 72, the region 451 of the display unit 4 is actually comprised of the left side display use pixels Lp and right side display use pixels Rp (see FIG. 3(a)). Therefore, part of the operation button 452 of the first display pixel 6 is displayed by the left side display use pixels Lp, while part of the operation button 453 of the second display pixels 5 is displayed by the right side display use pixels Rp. That is, the operation button 452 and the operation button 453 are arranged close to each other on the display unit 4. In this way, the arrays of operation buttons for the plurality of operators are arranged close to each other on the display unit. The operation button arrays with overlapping operating regions are called the “same” or “overlapping”.

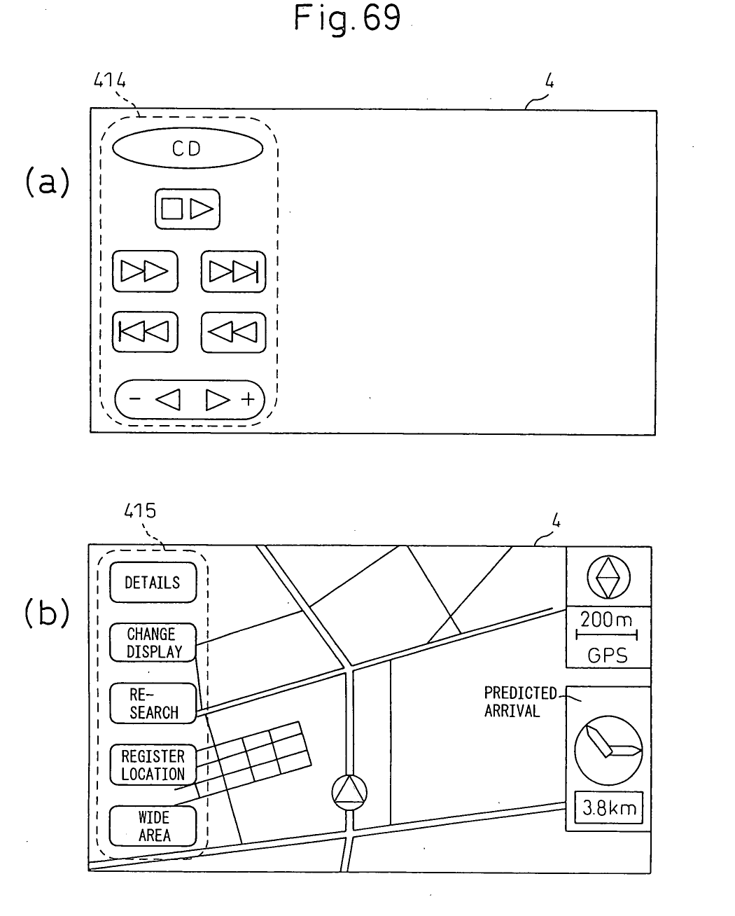

FIG. 69 shows an example where the operation button array of the driver's seat side and the operation button array of the passenger's seat side overlap. FIG. 69(a) shows an example 414 of the operation button array for CD operation already registered at the passenger's seat side, while FIG. 69(b) shows an example 415 of the operation button array to be currently registered for navigation at the driver's seat side. If currently registering the example 415 of the operation button array for navigation, if the control unit 100 displays a navigation image (including operation buttons) toward the driver's seat at the display unit 4 and displays a CD operation image toward the passenger's seat side, the operation buttons will overlap in position at the driver's seat side and the passenger's seat side and which seat the input using the touch panel 118 is related to in the operation input can no longer be judged by the control unit 100.

Therefore, in the present embodiment, the operation button array desired to be currently registered and all operation button arrays of the seats at the opposite side already registered are compared. If overlapping in position even slightly, it is judged that the array corresponds to prohibited matter. That is, even at the time of registration at the driver's seat side, overlap with all operation button arrays already registered at the passenger's seat side is checked and registration is allowed only when there is no overlap at all.

However, as the method for prohibiting overlap of arrays of operation buttons, the various methods shown below may be considered:

(1) The method of giving priority to registration at the driver's seat side, not providing prohibited matter for registration at the driver's seat side, and judging overlap with all registrations of the driver's seat side already registered only at the time of registration at the passenger's seat side.

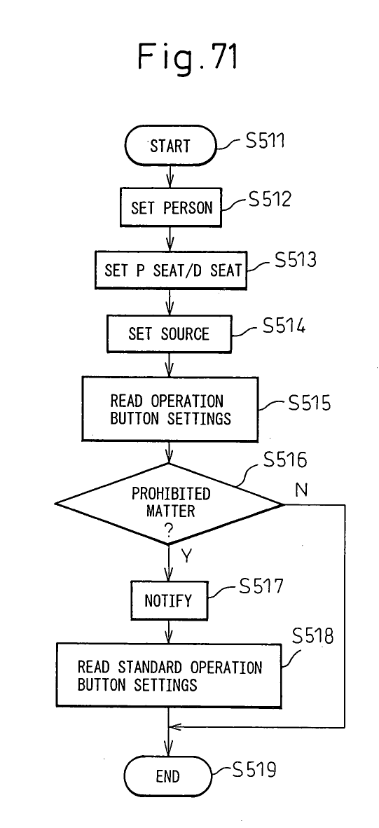

(2) Further, the method of not providing prohibited matter and judging overlap at the time of use for registration at each seat (see flow of FIG. 71).

(3) Method of setting regions in which operation buttons can be arranged at the different seats (for example, at the driver's seat side, right half of driver's seat side in the image region of the display unit 4) and not allowing arrangement of operation buttons at other regions.

(4) Method of preparing several patterns free of overlap between the driver's seat side and the passenger's seat side in advance and enabling the operator to select from among them.

(5) Method of invalidating only the mutually overlapping parts at the driver's seat side and passenger's seat side.

Note that in the case of the (3) and (4), there is no possibility of potential overlap occurring in the operation button arrays between the driver's seat side and passenger's seat side, so the judgment at S7 in the flow shown in FIG. 64 becomes unnecessary.

When it is judged at S7 that the pattern corresponds to prohibited matter, the fact that it corresponds to prohibited matter is notified to the operator utilizing the display unit 4 (S508), then the routine returns to S506 where the operator is prompted to reset the operation button array. Note that the operator receiving the notification may also ignore the notification and register the operation button as overlapping. In this case, the already registered arrangement is automatically moved so that they do not overlap.

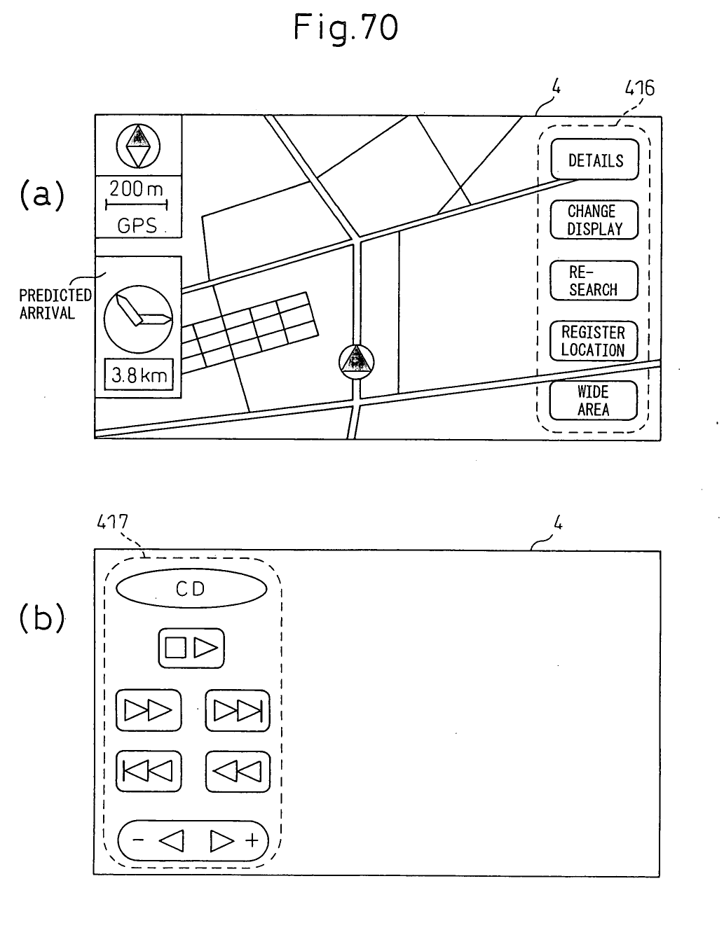

When not corresponding to prohibited matter at S7, the operation button array data of previous settings is stored and registered in the memory 125 (S509) and the series of operations is ended (S510). FIG. 70(a) shows an example 416 of the thus set driver's seat side, operator name “DAD”, and operation button array for a navigation operation. For example, this operation button array 416 is set so as not to overlap with the already registered passenger's seat side button array 417 for CD operation shown in FIG. 70(b).

In accordance with the above flow, it becomes possible to customize and register operation button arrays for specific seats, specific individuals, and specific sources. Note that at the step of setting the seat (S503), the step of setting the individual (S504), and the step of setting the source step (S505) need not be in the order shown in FIG. 64. Another order is also possible.

Further, it is also possible to count the frequencies of use at the step of setting the seat (S503), the step of setting the individual (S504), and the step of setting the source step (S505) in the memory 125 etc. and display as the initial displays of the setting screens the ones with the highest frequency of use by characteristics or in order of frequency.

Further, at the step of setting the seat (S503), the step of setting the individual (S504), and the step of setting the source step (S505), it is possible to store the final state when the power of the display device 20 was turned off in the memory 125 etc. and display the settings at that time as the initial displays of the setting images.

Further, in the flow of FIG. 64, the explanation was given for the example of display of different display images for two directions on the display unit 4, but it is also possible to handle the case of display of different display images for three or more directions based on the flow shown in FIG. 64 by increasing the settings at S503.

FIG. 71 shows the operation flow at the time of operation for using a customized operation button array. The following operation flow is mainly executed by the control unit 100 in accordance with a prestored program.

When the power of the AV navigation system employing the display device is turned on and the various types of functions are operable, the program is started when a predetermined instruction is input by the operating unit 15 or remote controller 123 etc. for changing from a single display (case of use of display unit to display only one display image) to a plurality of displays (case of displaying individual display images for a plurality of viewing directions on the common screen) (S511).

Next, the individual corresponding to the registered customization information is set (S512). The setting of the individual is selected by a suitable selection image displayed on the display unit 4. Note that instead of displaying a selection image for selection, it is also possible to use a fingerprint sensor 332 instead of setting the individual. For example, if fingerprint data is input from the fingerprint sensor 332, the fingerprint comparison unit 330 compares this with the fingerprint data stored in the memory 125 and identifies the individual inputting the fingerprint. Note that this step is unnecessary when not customizing the display for the individual.

Next, which side of the passenger's seat (P seat) or driver's seat (D seat) to read the customization information for is selected by the seat (S513) and the source covered is set (S514). Note that when not customizing the display in accordance with the seat, S513 is unnecessary, while when not customizing the display in accordance with the source and seat, S514 is unnecessary.

Next, the operation button array data customized for the specific seat, specific individual, and specific source is read out (S515).

Next, whether the read operation button array corresponds to prohibited matter or not is judged (S516).

As prohibited matter, there is the case where the operation button array to be currently registered overlaps in position the operation button array of the seat at the opposite side already registered. This is because even if displaying different images for a plurality of operators at the display unit 4, since there is a single touch panel 118, if the arrays of operation buttons overlap, which seat operation input is for can no longer be judged by the control unit 100 side.

When it is judged at S516 that the array corresponds to prohibited matter, the fact that it corresponds to prohibited matter is notified to the operator utilizing the display unit 4 (S517), then the standard operation button array not overlapping the already registered operation button array for the seat at the opposite side is read out and set to enable use (S518). Note that when it is judged at S516 that the array corresponds to prohibited matter, it is also possible not to read out the standard operation button array, but to prompt the operator to reselect an operation button array not corresponding to prohibited matter.

When not corresponding to prohibited matter at S516, the operation button array read out at S515 is set to be able to be used by the operator and the series of operations is ended (S519).

In this way, and customized registered operation button array is read out and set to be able to be used by the operator without overlapping between the driver's seat side and passenger's seat side. Note that the flow of S516 is not necessary at the time of customized registration (see flow of FIG. 64) if registration is allowed only when the operation button arrays do not overlap.

In the above embodiment, different images for the driver's seat use and passenger's seat use are provided and different operation button arrays are provided, but it is similarly possible to provide different images and provide different operation button arrays for three or more seats (for example, the case of dealing with cars with three front seats or the case including the rear seats etc.)

Note that as another example of the above embodiment, it is also possible to using various types of detecting means (for example, image recognition etc.) to identify a passenger when the passenger gets in the car 19 or detect the seating position (using image recognition, a seat sensor, or other detecting means) and identify (set) the individual and seat direction. In this case, it is also possible to automatically register and read out a button array for an identified individual and seat direction for a source selected by the operator through the operating unit 15 (automatic setting rather than menu setting).

Further, in the above embodiment, a display device mounted in a car was explained, but it is also possible to set the display device according to the present invention in a room etc., provide different images for an operator seated at the right side and an operator seated at the left side with respect to the display device, and provide different operation button arrays for the same.

Further, in the above embodiment, different operation button arrays were provided for the driver's seat use and passenger's seat use. The operation buttons are not limited to ones of so-called button shapes. Slide types, switch types, dial types, and other various types of operation input shapes are also included.

According to the display device enabling viewing of different images in accordance with the viewing direction, the method of customization of the operation button images in the display device, and the method of use of operation button images in the display device according to the present invention, suitable operation input from operators viewing a plurality of images becomes possible.

Further, according to the method of customization of the operation input image in a display device enabling viewing of different images in accordance with the viewing direction according to the present invention, even when one display unit displays a plurality of images (or display images), operation button images can be registered so that operation inputs for the plurality of images do not become confused.

Further, according to the method of setting an operation input image in a display device enabling simultaneous display of a plurality of images according to the present invention, even when one display unit displays a plurality of images (or display images), operation button images can be used so that operation inputs for the plurality of images do not become confused.

Below, an AV navigation system employing a display device according to embodiments (12) to (16) of the present invention will be explained.

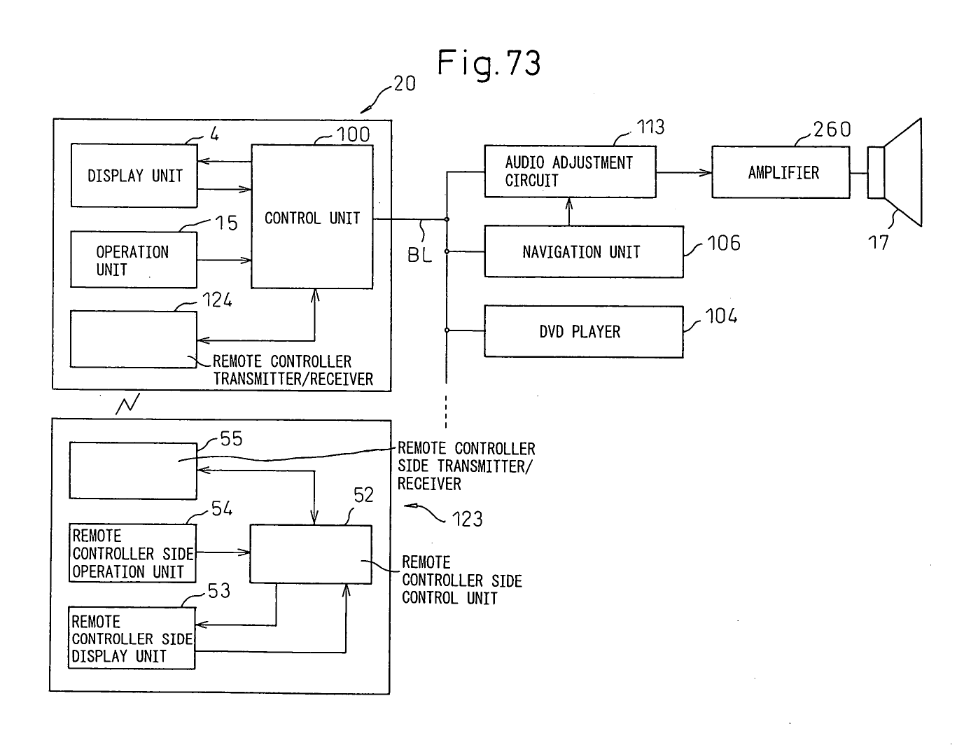

FIG. 73 is a schematic block diagram showing characterizing parts of the embodiments (12) to (16). In FIG. 73, parts the same as the AV navigation system shown in FIG. 5 are assigned the same notations.

In FIG. 73, the display device 20 included in the AV navigation system is a display device mounted at the center of the car instrument panel. The display device 20 is connected through a baseline BL to various types of electronic equipment mounted in the same car such as an audio adjustment circuit 113, navigation unit 106, and DVD player 104. Note that the display device 20, navigation unit 106, DVD player 104, amplifier 260, and speaker 17 correspond to configurations other than the remote controller 123 in FIG. 5.

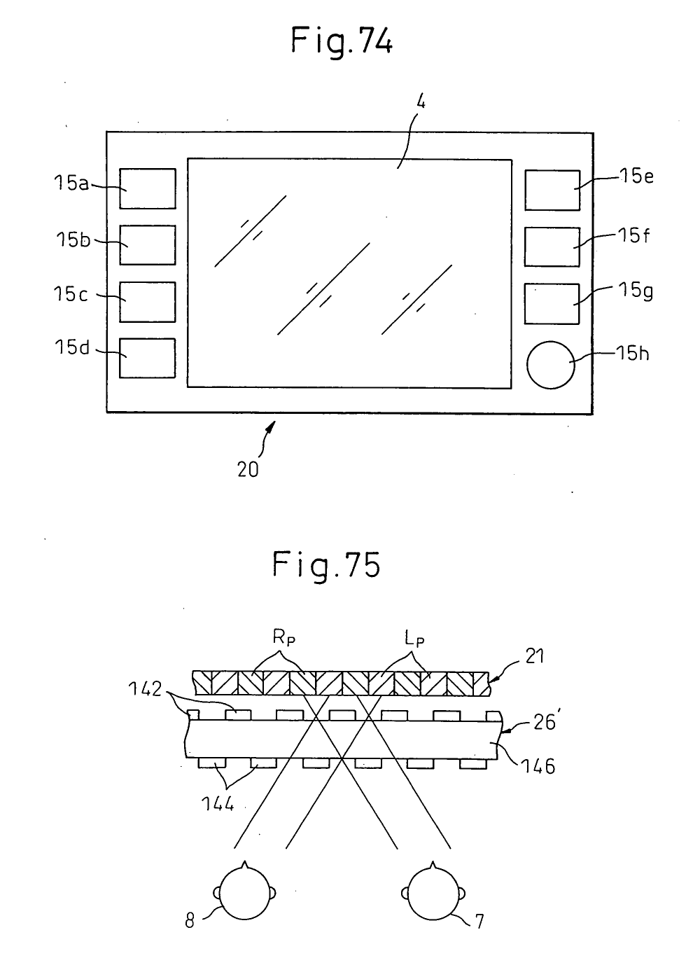

The display device 20 includes a control unit 100 provided with a not shown CPU, ROM, RAM, etc., a display unit 4 employing a touch panel 118, an operating unit 15 provided with various types of operating switches 15a to 15h giving operation instructions to the above various types of electronic equipment (audio adjustment circuit 113, navigation unit 106, DVD player 104, etc.) (see FIG. 74), and a remote controller transmitter/receiver 124 for wireless communication with the remote controller 123.

The control unit 100 transmits data relating to operation instructions input via the operating switches 15a to 15h provided on the display unit 4 to various types of electronic equipment (audio adjustment circuit 113, navigation unit 106, DVD player 104, etc.) and displays information showing the operating state, operating conditions, etc. of the various types of electronic equipment on the display unit 4 based on data sent from the various types of electronic equipment in response.

The display unit 4, as shown in FIG. 75, is for example provided with a TFT (thin film transistor) type liquid crystal panel 21 and a parallax barrier 26′ provided at the front surface side of the liquid crystal panel 21. At the liquid crystal panel 21, display images are displayed by a plurality of right side display use pixels Rp and left side display use pixels Lp arranged along the horizontal surface display direction (left-right direction on paper surface of FIG. 75). The right side display use pixels Rp and left side display use pixels Lp are alternately set. The right side display use pixels Rp display the right side display image, while the left side display use pixel Lp displays the left side display image. The parallax barrier 26′ arranged at the front surface side of the liquid crystal panel 21 (viewer side) is comprised of a transparent sheet member 146 on the front and rear surfaces of which pluralities of light blocking strips 142, 144 are formed spaced apart. The light blocking strips 142, 144 are formed in parallel to the right side display use pixels Rp and left side display use pixels Lp. By providing this parallax barrier 26′, light emitted from the right side display use pixels Rp displaying the right side display image reaches the eyes of the right side passenger 7, but light emitted from the left side display use pixels Lp displaying the left side display image does not reach the eyes of the right side passenger 7. On the other hand, light emitted from the left side display use pixels Lp displaying the left side display image reaches the eyes of the left side passenger 8, but light emitted from the right side display use pixels Rp displaying the right side display image does not reach the eyes of the left side passenger 8.

Further, the audio adjustment circuit 113 is connected to speakers 17 through an amplifier 260. An audio signal output from the audio adjustment circuit 113 is amplified by an amplifier 260 and supplied to the speakers 17. Further, the audio signals output from the navigation unit 106 and DVD player 104 are supplied through the audio adjustment circuit 113 and amplifier 260 to the speakers 17.

The remote controller 123 includes a remote controller side control unit 52 provided with a not shown CPU, ROM, RAM, etc., a remote controller side display unit 53 employing a touch panel, a remote controller side operating unit 54 provided with various types of operating switches giving operation instructions to the above various types of electronic equipment and remote controller 123 itself, and a remote controller side communication unit 55 for wireless communication with the display device 20. In the remote controller 123, operating switches are formed by displaying a display image of the operating switches on the display unit 53. The display image displayed on the display device 20 is operated on by the viewer.

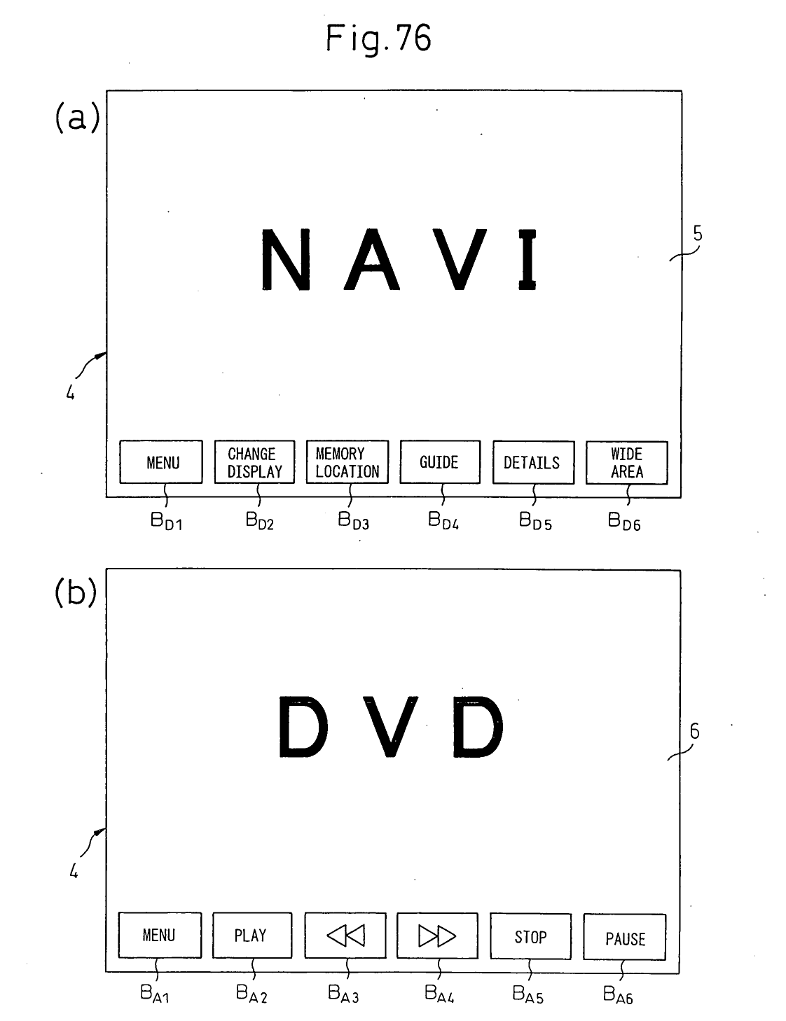

In the display device 20, the above-mentioned display unit 4 can be used to display the map display image 5 by the navigation unit 106 as shown in FIG. 76 so as to be able to be viewed from the driver 11 (so as not to be able to be viewed from the passenger's seat passenger 8) on the display unit 4 and display the DVD display image 8 by the DVD player 104 so as to be able to be viewed from the passenger's seat passenger 8 (so as not to be able to be viewed from the driver 11) on the display unit 4. Further, since the display unit 4 employs a touch panel 118, operating switches are formed by displaying a display image of the operating switches on the display screen. For this reason, when the content of the display for the driver 11 and the content of the display for the passenger's seat passenger 8 differ, operating switches B_{D1} to B_{D6} for the map display image 5 and operating switches B_{A1} to B_{A6} for the DVD display image 8 are displayed on the display screen as shown in FIG. 76.

In the example of FIG. 75, a parallax barrier 26′ comprised of light blocking strips 142 and 144 alternately formed was used, but of course it is also possible to use a parallax barrier 26 as shown in FIG. 3(b).

The present invention relates to a control system enabling suitable operation using a display device 20 and/or a remote controller 123 functioning as remote control system in the state where the display device 20 displays individual display images for a plurality of viewing directions (for example, different display images for two different directions). Below, the content of control in the control system will be explained divided into five embodiments. Note that displaying individual display images for a plurality of viewing directions (for example, different display images for two different directions) shall be referred to as a “split display”.

Below, an AV navigation system employing a display device according to an embodiment (12) of the present invention will be explained.

In the embodiment (12), the remote controller 123 has a mode setting unit determining whether to select the mode of a driver's seat use operation mode (DR mode) performing control operations on the second image source 1 for the second display image (driver's seat use display image) 5 and a passenger's seat use operation mode (PA mode) performing control operations for the first image source 2 for the first display image (passenger's seat use display image) 6. Note that “mode setting” corresponds to determining which viewing direction among a plurality of viewing directions is indicated and determining which of a plurality of image sources (navigation unit 106, DVD player 104, etc.) is indicted.

Further, the remote controller 123 is configured so that the remote controller side display unit 53 displays one of the corresponding DR mode use operating switches and PA mode use operating switches by mode setting by the later explained method and so that the remote controller operating unit 54 and/or touch panel included in the remote controller side display unit 53 can be used for operation input for either the DR mode or PA mode.

Further, the remote controller side control unit 52 of the remote controller 123 generates a mode setting signal showing the state of the mode setting and control signals corresponding to operation input which is input from the remote controller side operating unit 54 of the remote controller 123 or a touch panel provided at the remote controller side display unit 53. Next, the remote controller side control unit 52 transmits the generated mode setting signal and control signal from the remote controller side transmitter/receiver 55 to the remote controller transmitter/receiver 124. The control unit 100 of the display device identifies the image source covered by the received mode setting signal and controls the image source covered based on the received control signal.

That is, in the embodiment (12), the remote controller 123 has a mode setting function, while the display device 20 has a control function of controlling the image source covered by the control signal.

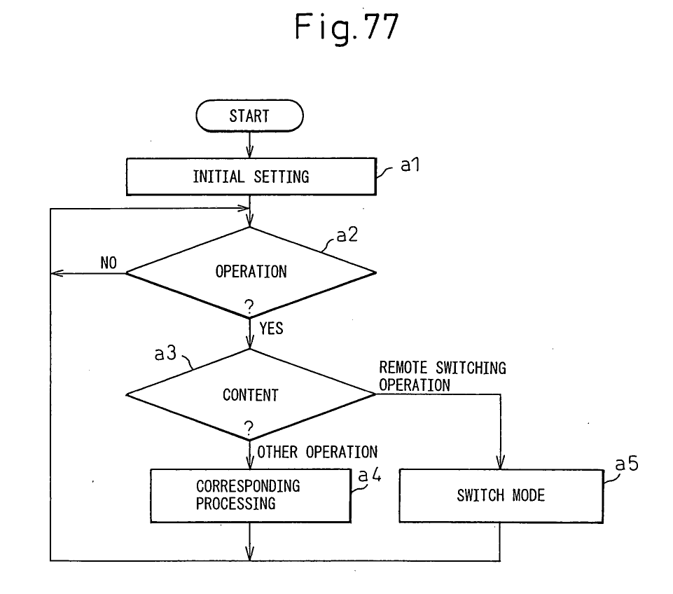

FIG. 77 is a flowchart for explaining the content of control in the embodiment (12). This control is started by instructing a split display in the display device 20. Further, the flow of this flowchart is repeated until the split display is terminated. First, at step a1, the control unit 52 of the remote controller 123 refers to the initial setting information and sets the operation mode of the remote controller 123. For example, when the DR mode is set as the initial mode, the DR mode is set in the remote controller 123.

At step a2, whether an operation has been performed on the remote controller 123 is judged. When an operation is performed, the content of the operation is judged (step a3). When the content of the operation is another operation other than a mode switching operation, processing corresponding to that operation is performed (step a4). For example, in the case of an operation in the DR mode, that is, an operation on the driver's seat use display image, the control unit 100 of the display device 20 performs the corresponding operational control. Next, the processing returns to step a2.

On the other hand, when the content of the operation is a mode switching operation, the operation mode is changed (step a5). For example, when the DR mode is set and the mode switching operation is performed, the PA mode is set at the remote controller 123. Next, the processing returns to step a2.

As the mode switching operation (mode setting operation), the following operations may be considered.

1) The switching switch formed at the display unit 53 is pushed. In this case, the initial mode of the initial setting information is set as the DR mode or PA mode. The operation mode is switched using depression of the switching switch as a mode switching instruction. The initial setting information is stored in the memory in the control unit 52. The initial setting information and mode switching instruction correspond to the mode setting information, the switching switch of the control unit 52 and display unit 53 corresponds to the mode setting information output unit, and the control unit 52 corresponds to an operation mode control unit.

2) A mechanical type switch having two connection modes (configured as part of the remote controller side operating unit 54) is switched. In this case, the operation mode is switched based on the connection mode of the mechanical type switch. For example, one connection mode is set as DR mode, the other connection mode is set as the PA mode, and the operation modes are switched based on the connection mode of the mechanical type switch. The initial mode is determined by the connection mode of the mechanical type switch. The connection mode of the mechanical type switch corresponds to the mode setting information, the mechanical type switch and control unit 52 corresponds to the mode setting information output unit, and the control unit 52 corresponds to the operation mode control unit.

3) The remote controller 123 is provided with a detector (gyroscope etc.) detecting the amount of vibration. The operation mode is switched by shaking the remote controller 123. In this case, the initial mode of the initial setting information is set as the DR mode or PA mode and the operation mode is switched using the amount of vibration detected by the detector exceeding a reference value as the mode switching instruction. The initial setting information and mode switching instruction correspond to the mode setting information, the detector and control unit 52 correspond to the mode setting information output unit, and the control unit 52 corresponds to the operation mode control unit.

4) An input unit inputting individual identification information for identifying a viewer, a recognition unit recognizing a viewer based on input individual identification information, and a storage unit storing viewers and set operation modes linked together are provided. The operation mode stored in the storage unit is set linked with the recognized viewer. In this case, the operation mode corresponding to the viewer first recognized after split display has been instructed becomes the initial mode. After this, the operation mode is switched each time a viewer is recognized. The operation mode stored in the storage unit corresponds to mode setting information, the input unit, recognition unit, and storage unit correspond to mode setting information output units, and the control unit 52 corresponds to the operation mode control unit.

5) A direction detection device detecting the direction in which the remote controller 123 is present with respect to the display device 20 is provided. The operation mode is switched in accordance with the direction detected by the direction detection device. For example, when the direction in which the remote controller 123 is present is the driver's seat direction, the DR mode is set. Note that details of the direction detection will be explained later (see embodiment (16)). The detected direction corresponds to the mode setting information, the direction detection device corresponds to the mode setting information output unit, and the control unit 52 corresponds to the operation mode control unit.

According to the embodiment (12), the following effects can be obtained.

(1) In the embodiment, the DR mode and PA mode can be suitably switched by the viewer perform a predetermined mode switching operation. Therefore, operations for two display images displayed on the display device 20 may be suitably performed from one remote controller 123.

The embodiment (12) may also be configured modified so that the display device 20 side judges the valid operation setting condition (first modification of embodiment (12)).

The “valid operation setting condition” means for example the condition for validating operations on the first image source 2 corresponding to the first display image (passenger's seat use display image) 6 and invalidating operations on the second image source 1 corresponding to the second display image (driver's seat use display image) 5. For example, if making the valid operation setting condition the condition standing when in a state where the driver should concentrate on driving, when the driver should concentrate on driving, (the control unit 100 of the display device 20 performs the judgment of whether the valid operation setting condition stands and controls the switching of the display image by the display switching signal from the remote controller 123) operation input on the second display image (driver's seat use display image) 5 is invalidated and operation by the remote controller 123 becomes no longer possible. Due to this, the driver can be kept from being distracted by operation of the remote controller 123 and the safety during driving can be improved.

That is, in the first modification of the embodiment (12), the remote controller 123 has a mode setting function, the display device 20 has a control function controlling the image source covered by a control signal, and the display device 20 performs a condition judgment as to if the valid operation setting condition stands and controls the mode setting based on the condition judgment.

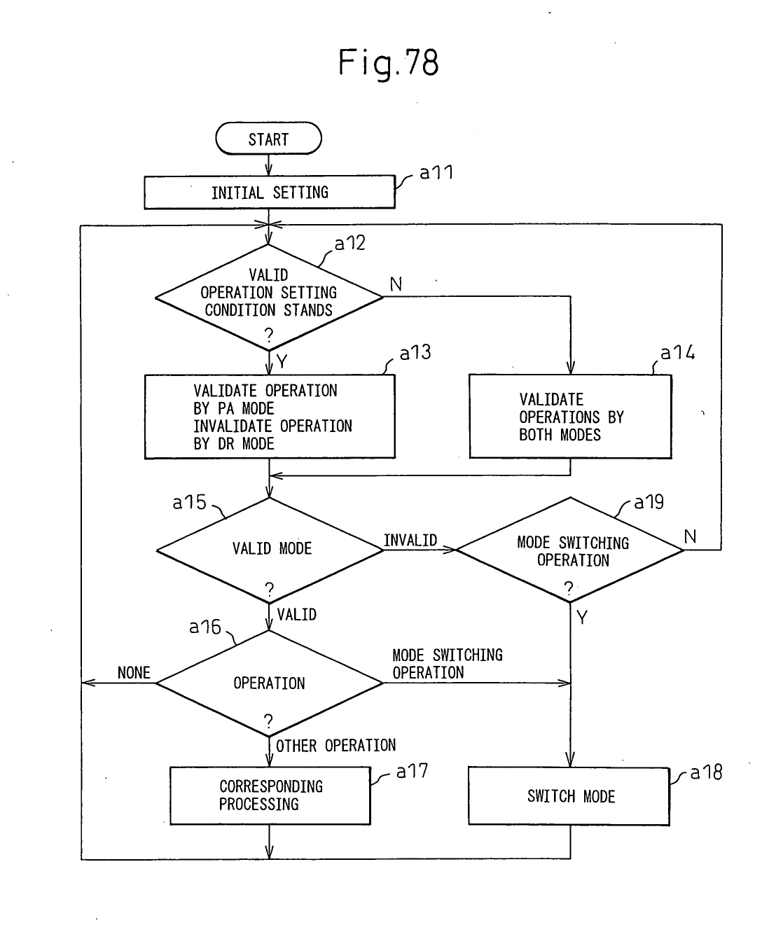

FIG. 78 is a flowchart for explaining the content of control performed when the valid operation setting condition stands. This control is started by instruction of a split display at the display device 20. Further, the flow of this flowchart is repeated until the split display is terminated. First, at step all, the control unit 52 of the remote controller 123 refers to the initial setting information and sets the operation mode of the remote controller 123. For example, when the DR mode is set as the initial mode, the DR mode is set at the remote controller 123.

At step a12, the control unit 100 of the display device 20 judges if the valid operation setting condition stands. When the condition stands, at step a13, only an operation under the PA mode is validated, while an operation under the DR mode is invalidated. On the other hand, when the condition does not stand, at step a14, operations under both modes of the PA mode and DR mode are validated.

As the control at step a13 (mode setting), the following control method may be considered. While the valid operation setting condition stands, even if an operation is performed in the DR mode, control corresponding to the operation is not performed. This can be realized by having the control unit 100 receiving an operation signal from the remote controller 123 not perform the corresponding control.

At step a15, it is judged at the control unit 100 if the operation mode set at the remote controller 123 is a valid mode. A “valid mode” is a mode in which the operation in the mode is made valid. When a valid mode, that is, a PA mode, the routine proceeds to step a16, while when not a valid mode (when an invalid mode), that is, a DR mode, the routine proceeds to step a19.

At step a16, it is judged at the control unit 100 if the remote controller 123 has been operated. If another operation other than a mode switching operation is performed, processing for that operation is performed (step a17). In this case, an operation in the PA mode, that is, an operation on the passenger's seat use display image, is performed, so the control unit 100 of the display device 20 performs the corresponding operational control. Next, the processing returns to step a12.

On the other hand, when a mode switching operation is performed, the control unit 52 changes the operation mode (step a18). Here, the PA mode is set, so the operation mode is switched to the DR mode. Next, the processing returns to step a12.

Further, when it is judged that the DR mode is set at step a15, at step a19 it is judged if a mode switching operation has been performed at the remote controller 123. When a mode switching operation has been performed, the operation mode is switched (step a18). Here, the DR mode is set, so the operation mode is switched to the PA mode. That is, to enable operation in the PA mode even when a valid setting condition is set, mode switching is made possible even when the valid setting condition stands in a state where the DR mode is set. Next, the processing returns to step a12. Note that when another operation other than a mode switching operation is performed at the remote controller 123, the routine returns to step a12 without processing corresponding to that operation.

“In a state where the driver should concentrate on driving” means when the car is being driven, at the night time, when driving on a highway, when driving on a complicated road such as one having a large number of curves, etc. may be considered.

The fact of the car being driven can for example be judged based on the speed of the car detected by the vehicle speed sensor being 5 km/h or more, a parking brake signal (PKB signal) being off, movement of the car being detected by a GPS (global positioning system) signal from a GPS information receiver 112, and detection of vibration based on the detection results of a gyroscope built in the navigation unit 106.

The fact of it being the night time can for example be judged by the viewer instructing night time use illumination to the display device 20, the current time obtained by a clock function falling in a time period corresponding to night time, etc.

The fact of the car driving on a highway and the fact of it driving on a complicated road such as one having many curves can for example be judged based on map information and the current position of the car in the navigation unit 106.

In the first modification, the display device 20 performs the condition judgment of whether the valid operation setting condition stands and control for setting the mode based on the condition judgment. However, to lighten the load of the control unit 100 of the display device 20, the condition judgment of whether the valid operation setting condition stands and the control for setting the mode based on the condition judgment may also be performed by the remote controller side control unit 52 of the remote controller 123. In this case, information for the condition judgment of whether the valid operation setting condition stands (for example, speed information from the vehicle speed sensor, PKB signal, GPS signal, etc.) must be received from the display device 20 by the remote controller 123.

The embodiment (12) may also be configured modified so as to judge the priority operation setting operation condition at the display device 20 side (second modification of embodiment (12)).

The “priority operation setting condition” means for example the condition for giving priority to operations on the second image source 1 corresponding to the second display image (driver's seat use display image) 5 over operations on the first image source 2 corresponding to the first display image (passenger's seat use display image) 6. For example, if making the priority operation setting condition the condition standing when in a state where the driver should concentrate on driving, when the driver should concentrate on driving, (the control unit 100 of the display device 20 performs the judgment of whether the valid operation setting condition stands and controls the setting of the image source by the mode setting signal from the remote controller 123) operation input on the second display image (driver's seat use display image) 5 can no longer be simply performed. Due to this, the driver can be kept from being distracted by operation of the remote controller 123 and the safety during driving can be improved.

Note that when operation input for the second display image (driver's seat use display image) 5 is required, invalidation termination may be instructed to validate even operation input for the second display image (driver's seat use display image) 5. Therefore, in the condition judgment of priority, it is possible to improve the operability compared with the case always invalidating operation input for the second display image (driver's seat use display image) 5 (condition judgment of validity: first modification of embodiment (12)). Note that the specific condition where the valid operation setting condition stands is similar to that of the valid operation setting condition.

That is, in the second modification of embodiment (12), the remote controller 123 has a mode setting function, the display device 20 has a control function controlling the image source covered by a control signal, and the display device 20 performs the condition judgment of whether the priority operation setting condition stands and controls the mode setting based on the condition judgment.

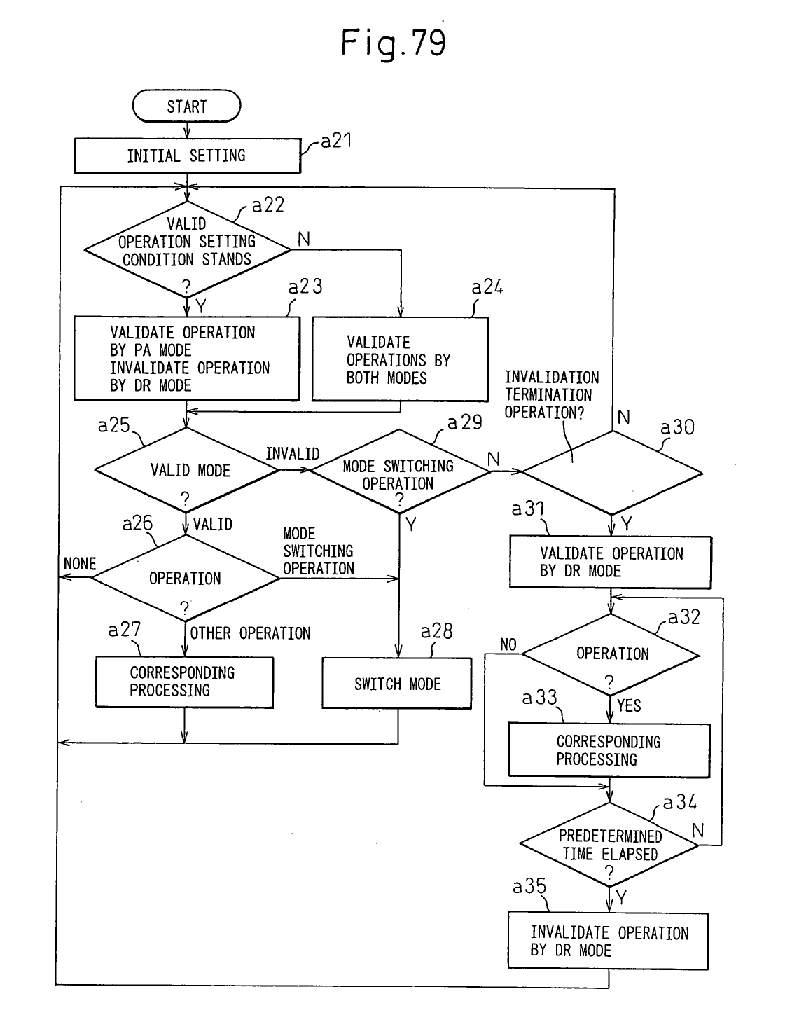

FIG. 79 is a flowchart for explaining the content of control performed when the priority operation setting condition stands. This control is started by instruction of a split display at the display device 20. Further, the flow of this flowchart is repeated until the split display is terminated. First, at step a21, the control unit 52 of the remote controller 123 refers to the initial setting information and sets the operation mode of the remote controller 123. When for example the DR mode is set as the initial mode, the DR mode is set at the remote controller 123.

At step a22, it is judged at the control unit 100 whether the priority operation setting condition stands. When the condition stands, at step a23, only operations under the PA mode are validated. Operations under the DR mode are invalidated. On the other hand, when the condition does not stand, at step a24, operations under both the PA mode and DR mode are validated.

As the control at step a23, the following method of control can be considered. While the priority operation setting condition stands, even if an operation by the DR mode is performed, control corresponding to that operation is not performed. This can be realized by prevent the control unit 100 receiving the operation signal from the remote controller 123 from performing the corresponding control.

At step a25, it is judged at the control unit 100 if the operation mode set by the remote controller 123 is a valid mode. A “valid mode” is a mode where operation in that mode is validated. In the case of a valid mode, that is, PA mode, the routine proceeds to step a26, while in the case not of a valid mode (the case of an invalid mode), that is, the case of the DR mode, the routine proceeds to step a29.

At step a26, it is judged at the control unit 100 whether the remote controller 123 has been operated. If another operation other than a mode switching operation is performed, processing corresponding to that operation is performed (step a27). This case is the case where operation under the PA mode, that is, an operation on the passenger's seat use display image, is performed, so the control unit 100 of the display device 20 performs the corresponding operational control. Next, the processing returns to step a22.

On the other hand, when the mode switching operation is performed, the control unit 52 switches the operation mode (step a28). Here, the PA mode is set, so the operation mode is switched to the DR mode. Next, the processing returns to step a22.

Further, when it is judged at step a25 that the DR mode has been set, at step a29, it is judged if a mode switching operation has been performed at the remote controller 123. When a mode switching operation has been performed, the operation mode is switched (step a28). Here, the DR mode is set, so the operation mode is switched to the PA mode. Next, the processing returns to step a22.

Further, when another operation other than a mode switching operation has been performed at step a29, at step a30, it is judged at the remote controller 123 if an invalidation termination operation has been performed. When an invalidation termination operation has been performed, an operation by the DR mode is validated at step a31. Next, at the step a32, it is judged if the remote controller 123 has been operated. If operated, the control unit 100 of the display device 20 performs operational control corresponding to that operation.

After the processing ends, at step a34, it is judged if a predetermined time has elapsed from when an operation under the DR mode was performed. When the predetermined time has not elapsed, the routine returns to step a32. On the other hand, when the predetermined time has elapsed, at step a35, operations under the DR mode are invalidated and the routine returns to step a22. Further, when a predetermined time has elapsed from when an invalidation termination operation was performed without any operation under the DR mode invalidation termination operation (steps a30, a31, a32, a34), at step a35, operations under the DR mode are invalidated and the routine returns to step a22.

Note that at step a30, when it is judged that another operation other than an invalidation termination operation has been performed at the remote controller 123, the routine returns to step a22 without performing processing corresponding to that operation.

In this way, when the priority operation setting condition stands and originally operations under the DR mode are invalidated, if invalidation is terminated by instruction of the viewer, operations under the DR mode are again invalidated after the elapse of a predetermined time, so it is possible to limit operations under the DR mode and improve safety during driving.

In the second modification, the display device 20 performs the condition judgment of whether the priority operation setting condition stands and controls the mode setting based on the condition judgment. However, to lighten the load of the control unit 100 of the display device 20, the condition judgment as to if the priority operation setting condition stands and control of the mode setting based on the condition judgment may also be performed by the remote controller side control unit 52 of the remote controller 123. In this case, information for the condition judgment of whether the priority operation setting condition stands (for example, speed information from the vehicle speed sensor, PKB signal, GPS signal, etc.) must be received from the display device 20 by the remote controller 123.

In the embodiment (12), the case where the remote controller 123 has a mode setting function and the display device 20 has a control function controlling the image source covered by a control signal was explained. However, the remote controller 123 may also be configured to have a mode setting function and a control function controlling the image source covered by a control signal. In this case, the control signal output from the remote controller 123 controls the image source covered. That is, the control unit 100 of the display device 20 functions as a relay device just for transferring a control signal from the remote controller to the source covered.

Further, even when the remote controller 123 is configured having a mode setting function and a control function controlling the image source covered by a control signal, it may be configured to perform the judgment of the valid operation setting condition (first modification) and judgment of the priority operation setting condition (second modification).

In the embodiment (12), the case where the remote controller 123 has a mode setting function and the display device 20 has a control function controlling the image source covered by a control signal was explained. However, the display device 20 may also be configured to have a mode setting function and a control function controlling the image source covered by a control signal. In this case, a mode setting unit is configured by the operating unit 15 or touch panel 118 of the display device 20. The display device 20 sends the set mode setting information through the remote controller transmitter/receiver 124 to the remote controller 123. The remote controller 123 can display either the corresponding DR mode use operating switches or PA mode use operating switches on the remote controller side display unit 53 based on the received mode setting information and utilize the remote controller operating unit 54 and/or touch panel included at the remote controller side display unit 53 for operation input for either the DR mode and PA mode. Further, the remote controller side control unit 52 of the remote controller 123 generates a control signal corresponding to the operation input which is input from the remote controller side operating unit 54 of the remote controller 123 or the touch panel provided at the remote controller side display unit 53 and sends it to the control unit 100 of the display device 20. The control unit 100 of the display device specifies the image source covered by the state of mode setting by its own mode setting unit and controls the image source covered based on the control signal received from the remote controller 123.

Further, even when the display device 20 is configured having a mode setting function and a control function controlling the image source covered by a control signal, it may be configured to perform the judgment of the valid operation setting condition (first modification) and judgment of the priority operation setting condition (second modification).

In the embodiment (12), the case where the remote controller 123 has a mode setting function and the display device 20 has a control function controlling the image source covered by a control signal was explained. However, the display device 20 may also be configured to have a mode setting function and a control function controlling the image source covered by a control signal. In this case, a mode setting unit is configured by the operating unit 15 or touch panel 118 of the display device 20. The display device 20 sends the set mode setting information through the remote controller transmitter/receiver 124 to the remote controller 123. The remote controller 123 can display either the corresponding DR mode use operating switches or PA mode use operating switches on the remote controller side display unit 53 based on the received mode setting information and utilize the remote controller operating unit 54 and/or touch panel included at the remote controller side display unit 53 for operation input for either the DR mode and PA mode. Further, the remote controller side control unit 52 of the remote controller 123 generates a control signal corresponding to the operation input which is input from the remote controller side operating unit 54 of the remote controller 123 or the touch panel provided at the remote controller side display unit 53. In this case, the control signal output from the remote controller 123 controls the image source covered. That is, the control unit 100 of the display device 20 functions as a relay device just for transferring a control signal from the remote controller to the covered source.

Further, even when the display device 20 has a mode setting function and the remote controller 123 has a control function controlling the image source covered by a control signal, they can be configured to perform judgment of the valid operation setting condition (first modification) and judgment of the priority operation setting condition (second modification).

Below, an AV navigation system employing a display device according to embodiment (13) of the present invention will be explained.

In the embodiment (13), in the state where a split display is being performed, the split display is terminated once, the display unit 4 displays only one display image for operation, then the image source corresponding to the displayed one display image is controlled. Note that in the embodiment (13), the control system itself including the display device 20 and remote controller 123 is similar to that of the embodiment (12).

In the embodiment (13), the remote controller 123 has a display switching unit determining which display image of a second display image (driver's seat use display image) 5 and first display image (passenger's seat use display image) 6 to switch to (also functioning as an operating unit for terminating the split display). Note that this “display switching” corresponds to determining which viewing direction of a plurality of viewing directions is indicated and determining which of a plurality of image sources (navigation unit 106, DVD player 104, etc.) is indicated.

Further, in the remote controller 123, by using the later explained method for switching the display, the remote controller side display unit 53 displays either of the corresponding operating switches. The remote controller operating unit 54 and/or touch panel included in the remote controller side display unit 53 may be used for operation input for either of the DR mode and PA mode.

Further, the remote controller side control unit 52 of the remote controller 123 generates a display switching signal showing the state of display switching and a control signal corresponding to the operation input to a remote controller side operating unit 54 of a remote controller 123 or a touch panel provided at the remote controller side display unit 53. Next, the remote controller side control unit 52 transmits the generated display switching signal and control signal from the remote controller side transmitter/receiver 55 to the remote controller transmitter/receiver 124. The control unit 100 of the display device specifies the image source covered by the received display switching signal and switches all display images displayed on the display unit 4 to a display image based on the image data from the image source covered. Next, the control unit 100 of the display device 20 receiving a control signal resulting from operation input at the remote controller 123 by the viewer while for example viewing the switched display image controls the image source covered based on the received control signal.

That is, in the embodiment (13), the remote controller 123 has a display switching function, and the display device 20 has a control function for controlling the image source covered by a control signal.

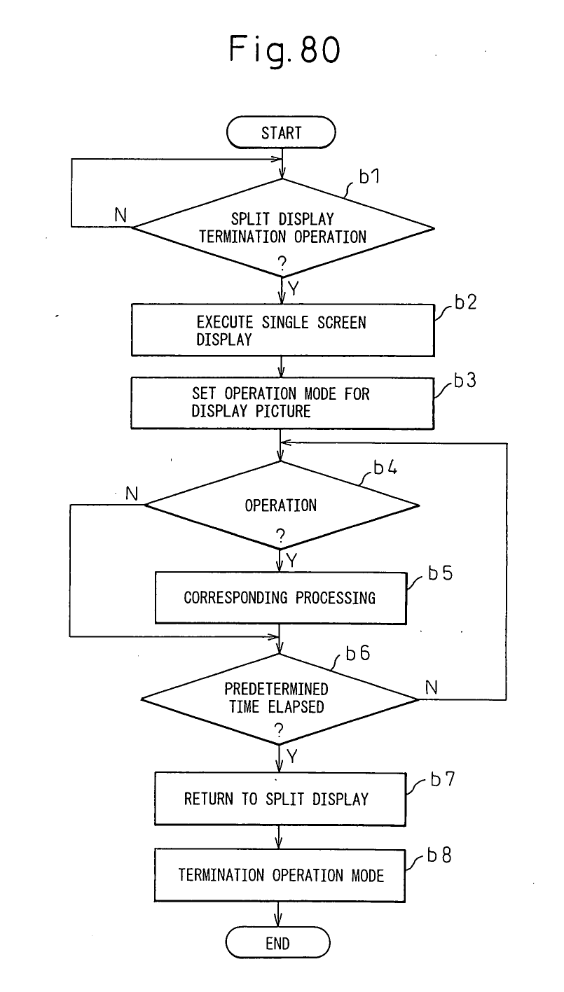

FIG. 80 is a flowchart for explaining the content of control in the embodiment (13). This control is started by a viewer performing an operation in state where the display device 20 is performing a split display. First, whether the operation performed on the remote controller 123 is a split display termination operation or not is judged (step b1). When a termination operation is performed, the control unit 100 of the display device 20 executes a single screen display at the display unit 4 (step b2).

Which display image of the driver's seat use display image and passenger's seat use display image is used for the single screen display is determined in accordance with the content of the termination operation. For example, it is possible to provide one termination switch (display switching switch), set a single screen display by the driver's seat use display image when the termination switch is depressed once, set a single screen display by the passenger's seat use display image when the termination switch is depressed again, then switch the display image of the single screen display each time the termination switch is depressed. Further, it is possible to provide two termination switches, set a single screen display by the driver's seat use display image when one termination switch is depressed, and set a single screen display by the passenger's seat use display image when the other termination switch is depressed. Alternatively, it is also possible to detect in which direction the remote controller 123 is present with respect to the display device 20, set a single screen display by the driver's seat use display image when the remote controller 123 is in the driver's seat direction, and set a single screen display by the passenger's seat use display image when it is in the passenger's seat direction.

Further, along with the single screen display at the display device 20, at the remote controller 123, an operation mode enabling operations on the image source corresponding to the display image of a single screen display is set (step b3). This “setting of the operation mode” means displaying operating switches for the display image of a single screen display on the display unit 53.

If the viewer operates the remote controller 123, the fact of the operation is recognized by the control unit 100 of the display device 20 (step b4), then the control unit 100 performs operational control corresponding to the performed operation (step b5). When a predetermined time elapses from when the remote controller 123 was operated (step b6), the single screen display at the display device 20 is returned to a split display (step b7) and along with this the operation mode of the remote controller 123 is terminated (step b8). That is, the operating switches for the display image of the single display are erased from the display unit 53 of the remote controller 123. Note that the operation mode may also be terminated by invalidating operations of the operating switches.

Further, even when a predetermined time elapses with no operation from when the termination operation was performed (steps b1 to b4, b6), the single screen display at the display device 20 is returned to a split display and along with this the operation mode of the remote controller 123 is terminated (steps b7, b8).

According to the embodiment (13), the following effects can be obtained.

(1) In the embodiment, operations are performed in the state where the split display is terminated and a single screen display by the display image desired to be operated on by the viewer is performed, so the viewer can easily recognize which display image is being operated on.

(2) In the embodiment, a suitable operation mode is set in the remote controller 123 by the operation relating to the split display, so operations on the two display images displayed on the display device 20 can be suitably performed.

(3) In the embodiment, regarding the single screen display at the display device 20 and the operation mode at the remote controller 123, a split display is returned to and the operation mode is terminated after the elapse of a predetermined time, so the inconvenience of the viewer of the display image not covered by an operation is lightened.

In the above explanation, when performing a single screen display, the remote controller 123 sets the operation mode for the display image displayed and displays the corresponding operating switches on the display unit 53. However, it is also possible to display all of the operating switches for a plurality of display images on the display unit 53 and not switch the display of the display unit by switching of the operation mode. In this case, control is necessary so that operations on the operating switches for display images not displayed on the display device 20 are invalidated.

The embodiment (13) may also be configured modified so that the display device 20 side judges the valid operation setting condition (first modification of embodiment (13)).

The “valid operation setting condition” means for example the condition for validating operations on the first image source 2 corresponding to the first display image (passenger's seat use display image) 6 and invalidating operations on the second image source 1 corresponding to the second display image (driver's seat use display image) 5. For example, if making the valid operation setting condition the condition stand when in a state where the driver should concentrate on driving, when the driver should concentrate on driving, (the control unit 100 of the display device 20 performs the judgment of whether the valid operation setting condition stands and controls the switching of the display image by the display switching signal from the remote controller 123) operation input on the second display image (driver's seat use display image) 5 is invalidated and operation by the remote controller 123 becomes no longer possible. Due to this, the driver can be kept from being distracted by operation of the remote controller 123 and the safety during driving can be improved.

That is, in a first modification of the embodiment (13), the remote controller 123 has a display switching function, the display device 20 has a control function controlling the image source covered by a control signal, and the display device 20 performs condition judgment of whether the valid operation setting condition stands and control for switching the display image based on the condition judgment.

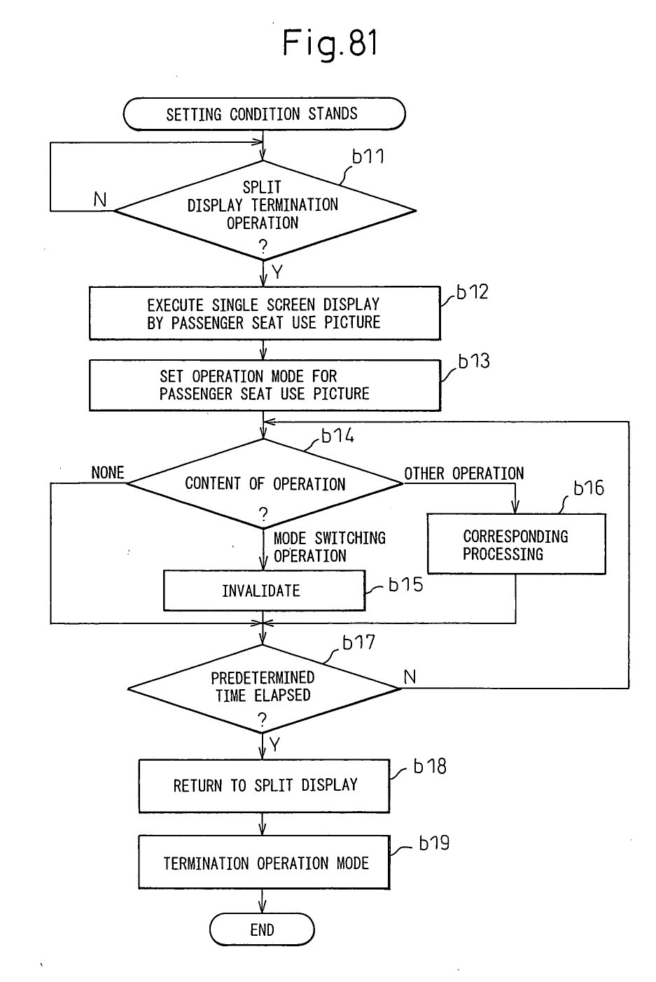

FIG. 81 is a flowchart for explaining the content of control performed when the valid operation setting condition stands. When the valid operation setting condition stands, if a split display termination operation is performed (step b11), a single screen display by the passenger's seat use display image is executed at the display device 20 (step b12). Along with this, at the remote controller 123, an operation mode (PA mode) enabling operations on the passenger's seat use display image is set (step b13).

When the viewer performs an operation on the remote controller 123, the content of operation is judged (step b14). When the content of operation is a mode switching operation, the operation is invalidated (step b15). The invalidation processing may be performed by not transmitting the operation signal to the control unit 100 of the display device 20 when judging the content of operation by the control unit 52 of the remote controller 123. Further, when the content of operation is judged by the control unit 100 of the display device 20, the invalidation processing may also be performed by having the control unit 100 not perform the mode switching processing.

Further, when the content of operation is another operation other than a mode switching operation, the control unit 100 performs operational control corresponding to the performed operation (step b16). When a predetermined time elapses from when an operation is performed on the remote controller 123 (step b17), the single screen display in the display device 20 is returned to a split display (step b18) and along with this the operation mode of the remote controller 123 is terminated (step b19).

Further, even when a predetermined time elapses with no operation from when the termination operation was performed (steps b11 to b14, b17), the single screen display at the display device 20 is returned to a split display and along with this the operation mode of the remote controller 123 is terminated (steps b18, b19).

In the first modification, the display device 20 performs the condition judgment of whether the valid operation setting condition stands and control for switching the display image based on the condition judgment. However, to lighten the load of the control unit 100 of the display device 20, the condition judgment of whether the valid operation setting condition stands and the control for switching the display image based on the condition judgment may also be performed by the remote controller side control unit 52 of the remote controller 123. In this case, information for the condition judgment of whether the valid operation setting condition stands (for example, speed information from the vehicle speed sensor, PKB signal, GPS signal, etc.) must be received from the display device 20 by the remote controller 123.

The embodiment (13) may further be modified so that the display device 20 side judges the priority operation setting operation condition (second modification of embodiment (13)).

The “priority operation setting condition” means for example the condition for giving priority to operation on the second image source 1 corresponding to the second display image (driver's seat use display image) 5 over an operation on the first image source 2 corresponding to the first display image (passenger's seat use display image) 6. For example, if the priority operation setting condition is made the condition standing when in the state where the driver should concentrate on driving, when the driver should concentrate on driving (the control unit 100 of the display device 20 judges whether the valid operation setting condition stands and controls the switching of the display image by the display switching signal from the remote controller 123), operation input to the second display image (driver's seat use display image) 5 can no longer be simply performed. Due to this, the driver can be kept from being distracted by operation of the remote controller 123 and the safety during driving can be improved.

Note that when operation input on the second display image (driver's seat use display image) 5 is necessary, if instructing invalidation termination, operation input on the second display image (driver's seat use display image) 5 also is validated. Therefore, in the condition judgment of priority, the operability can be improved compared with the case of always invalidating operation input on the second display image (driver's seat use display image) 5 (condition judgment of validity: first modification of embodiment (13)). Note that the specific condition where the valid operation setting condition stands is similar to the valid operation setting condition.

That is, in a second modification of the embodiment (13), the remote controller 123 has a display switching function, the display device 20 has a control function of controlling the image source covered by a control signal, and the display device 20 performs condition judgment of whether the priority operation setting condition stands and control of switching of the display image based on the condition judgment.

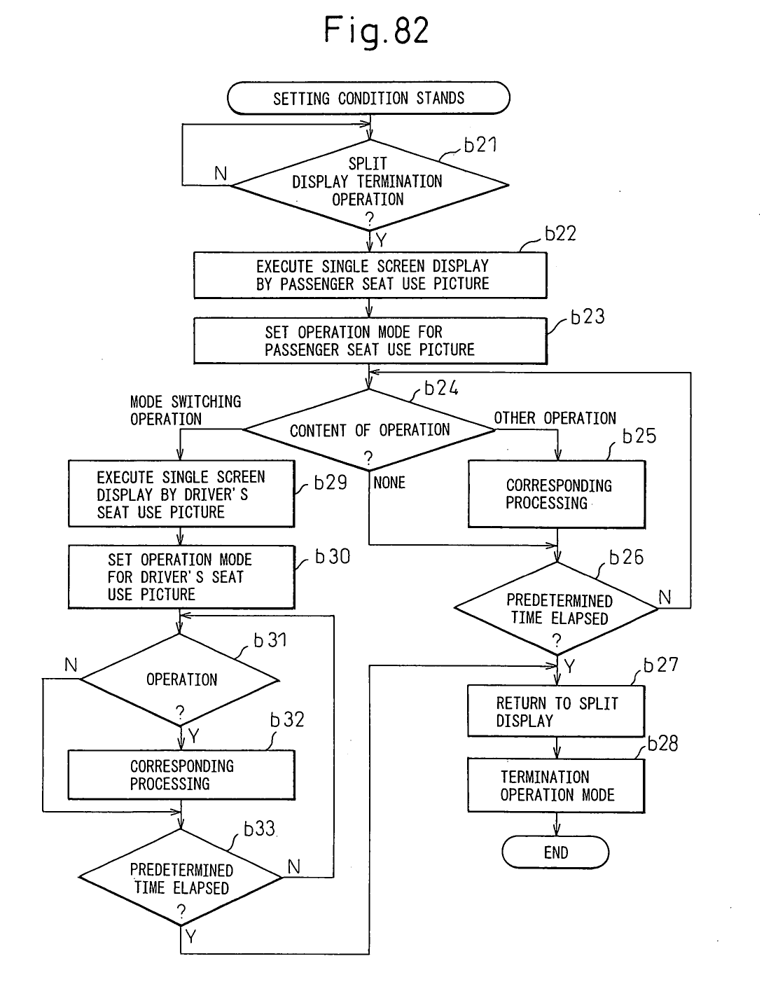

FIG. 82 is a flowchart for explaining the content of control when the priority operation setting condition stands. When the priority operation setting condition stands, if the split display termination operation is performed (step b21), a single screen display by the passenger's seat use display image is performed by the display device 20 (step b22). Along with this, at the remote controller 123, an operation mode (PA mode) enabling operations on the passenger's seat use display image is set (step b23).

If the viewer operates the remote controller 123, the content of the operation is judged (step b24). When the content of the operation is another operation mode other than a switching operation, the control unit 100 performs operational control corresponding to the performed operation (step b25). When a predetermined time elapses from the operation on the remote controller 123 (step b26), the single screen display at the display device 20 is returned to a split display (step b27) and along with this the operation mode of the remote controller 123 is terminated (step b28).

Further, even when a predetermined time elapses without any operation after a termination operation is performed (steps b21 to b24, b26), the single screen display at the display device 20 is returned to a split display and along with this the operation mode of the remote controller 123 is terminated (steps b27, b28).

As opposed to this, when the content of operation is the mode switching operation, single screen display by the driver's seat use display image is executed at the display device 20 (step b29). Along with this, in the remote controller 123, an operation mode (DR mode) enabling operations on the driver's seat use display image is set (step b30). When the viewer operates the remote controller 123, the fact of the operation is recognized by the control unit 100 of the display device 20 (step b31) and the control unit 100 performs operational control corresponding to the operation performed (step b32).

When a predetermined time elapses from when the remote controller 123 was operated (step b33), the single screen display of the display device 20 is returned to a split display (step b27). Along with this, the operation mode of the remote controller 123 is terminated (step b28). Further, even when a predetermined time elapses without any operation after a mode switching operation (steps b24, b29 to b31, b33), the single screen display at the display device 20 is returned to a split display. Along with this, the operation mode of the remote controller 123 is terminated (step b27, b28).

In the second modification, the display device 20 performs the condition judgment of whether the priority operation setting condition stands and control for switching the display image based on the condition judgment. However, to lighten the load of the control unit 100 of the display device 20, the condition judgment of whether the priority operation setting condition stands and the control for switching the display image based on the condition judgment may also be performed by the remote controller side control unit 52 of the remote controller 123. In this case, information for the condition judgment of whether the priority operation setting condition stands (for example, speed information from the vehicle speed sensor, PKB signal, GPS signal, etc.) must be received from the display device 20 by the remote controller 123.

In the embodiment (13), the case where the remote controller 123 has a display switching function and the display device 20 has a control function controlling the image source covered by a control signal was explained. However, the remote controller 123 may also be configured to have a display switching function and a control function controlling the image source covered by the control signal. In this case, the control signal output from the remote controller 123 controls the image source covered. That is, the control unit 100 of the display device 20 functions as a relay device just for transferring a control signal from the remote controller to the covered source.

Further, even when the remote controller 12 is configured having a display switching function and a control function controlling the image source covered by the control signal, judgment of the above-mentioned valid operation setting condition (first modification) and judgment of the priority operation setting condition (second modification) may be performed.

In the embodiment (13), the case where the remote controller 123 has a display switching function and the display device 20 has a control function controlling the image source covered by a control signal will be explained. However, the display device 20 may also be configured having a display switching function and a control function controlling the image source covered by a control signal. In this case, a display switching unit is configured by the operating unit 15 or touch panel 118 of the display device 20 and display switching information is sent from the display device 20 through the remote controller transmitter/receiver 124 to the remote controller 123. The remote controller 123 displays on the remote controller side display unit 53 either the corresponding DR mode use operating switches or PA mode use operating switches based on the received display switching information. The remote controller operating unit 54 and/or touch panel included in the remote controller side display unit 53 may be utilized for operation input for either the DR mode or PA mode. Further, the remote controller side control unit 52 of the remote controller 123 generates a control signal corresponding to the operation input which is input from the remote controller side operating unit 54 of the remote controller 123 or the touch panel provided at the remote controller side display unit 53. The control unit 100 of the display device may be configured to specify the image source covered by the display switching state by its own display switching unit and controls the image source covered by the control signal received from the remote controller 123.

Further, even when the display device 20 is configured having a display switching function and control function controlling the image source covered by the control signal, judgment of the above-mentioned valid operation setting condition (first modification) and judgment of the priority operation setting condition (second modification) may be performed.

In the embodiment (13), the case where the remote controller 123 has a display switching function and the display device 20 has a control function controlling the image source covered by the control signal will be explained. However, it is also possible to configure this so that the display device 20 has a display switching function and the remote controller 123 has a control function controlling the image source covered by the control signal. In this case, a display switching unit is configured by the operating unit 15 or touch panel 118 of the display device 20 and display switching information is sent from the display device 20 through the remote controller transmitter/receiver 124 to the remote controller 123. The remote controller 123 displays on the remote controller side display unit 53 either the corresponding DR mode use operating switches or PA mode use operating switches based on the received display switching information. The remote controller operating unit 54 and/or touch panel included in the remote controller side display unit 53 may be utilized for operation input for either the DR mode or PA mode. Further, the remote controller side control unit 52 of the remote controller 123 generates a control signal corresponding to the operation input which is input from the remote controller side operating unit 54 of the remote controller 123 or the touch panel provided at the remote controller side display unit 53. In this case, the control signal output from the remote controller 123 controls the image source covered. That is, the control unit 100 of the display device 20 functions as a relay device for transferring a control signal from the remote controller to the source covered.

Further, even when the display device 20 has a display switching function and the remote controller 123 has a control function controlling the image source covered by the control signal, judgment of the above-mentioned valid operation setting condition (first modification) and judgment of the priority operation setting condition (second modification) may be performed.

Below, an AV navigation system employing a display device according to embodiment (14) of the present invention will be explained.

In the embodiment (14), suitable operation is possible by a remote controller 123 having all the operating switches corresponding to both the first display image (passenger's seat side display image) 6 and second display image (driver's seat side display image) 5 under the state of a split display. Note that in the embodiment (14), the control system itself including the display device 20 and remote controller 123 is similar to that of the embodiment (12).

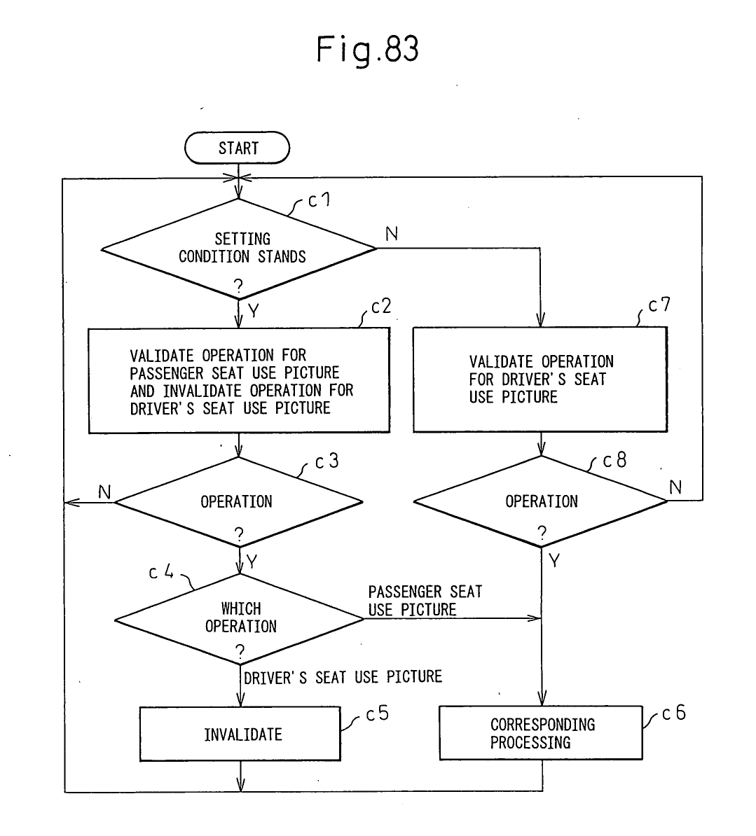

FIG. 83 is a flowchart for explaining the content of control in the embodiment (14). This control is control performed in the state where the display device 20 is performing a split display. Further, the flow of this flowchart is repeated until the split display is terminated. First, it is judged if the valid operation setting condition for invalidating operations on the driver's seat use display image and validating operations on the passenger's seat use display image stands (step c1). When the valid operation setting condition stands, operations on the passenger seat use display image are validated and operations on the driver's seat use display image are invalidated (step c2). The processing for invalidation may be realized by the control unit 100 of the display device 20 not performing operational control corresponding to the operation on the driver's seat use display image.

If the viewer operates the remote controller 123, the fact of the operation is recognized by the control unit 100 of the display device 20 (step c3), then it is judged at the control unit 100 which display image was operated on (step c4). When an operation on the driver's seat use display image, the control unit 100 does not perform operational control corresponding to the operation (step c5). On the other hand, when an operation on the passenger's seat use display image, the control unit 100 performs operational control corresponding to the operation (step c6). Next, the routine returns to step c1.

Further, when the valid operation setting condition does not stand, operations on the driver's seat use display image are validated and operations on the display image are validated (step c7). If the viewer operates the remote controller 123, the fact of the operation is recognized by the control unit 100 of the display device 20 (step c8), then the control unit 100 performs operational control for the performed operation (step c6). Next, the routine returns to step c1.

According to the embodiment (14), the following effects can be obtained.

(1) In the embodiment, all operating switches required for operations on the display image displayed by the remote controller 123 on the display device 20 are provided, so it is possible to immediately perform operations on the two display images without a mode switching mode like in the first and embodiment (13). Therefore, the operability of the remote controller 123 can be improved.

(2) If making the valid operation setting condition for invalidating operations on the driver's seat use display image and validating operations on the passenger's seat use display image the state where the driver should concentrate on driving, when the driver should concentrate on driving, operations on the driver's seat use display image are invalidated and operation becomes impossible. Due to this, the driver can be kept from being distracted by operation of the remote controller 123 and the safety during driving can be improved. Further, an individual other than the driver, for example, the passenger's seat passenger, can operate the remote controller 123 for the desired operational control, so enjoyable operation becomes possible. Further, an individual other than the driver can operate the remote controller 123 in place of the driver.

The processing explained in the embodiment (14) for validating operations on the passenger's seat use display image and invalidating operations on the driver's seat use display image may be replaced by preventing the control unit 52 of the remote controller 123 from transmitting control signals to the display device 20 when an operation on the driver's seat use display image is performed. In this case, there is no longer a need for the control unit 100 of the display device 20 to judge validity/invalidity of the control signal, so the load on the control unit 100 of the display device 20 can be lightened.

Further, in the embodiment (14), the fact that operations on the driver's seat use display image are invalidated and operations on the passenger's seat use display image are validated may be reported to the viewer. The report may be performed by displaying on the display unit 53 of the remote controller 123 words or predetermined characters indicating that operations on the driver's seat use display image are invalidated. Due to this, when the viewer operates the remote controller 123, he or she can easily determine whether various types of equipment can be controlled.

Below, an AV navigation system employing a display device according to embodiment (15) of the present invention will be explained.

In the embodiment (15), in the state of a split display, operation input on the first display image (passenger's seat side display image) 6 is performed at the remote controller 123 side and operation input on the second display image (driver's seat side display image) 5 is performed by the display device side. Note that in the embodiment (15), the control system itself including the display device 20 and remote controller 123 is similar to that of the embodiment (12).

In the embodiment (15), for example, the remote controller 123 is formed with operating switches for the passenger's seat use display image and is not formed with operating switches for the driver's seat use display image. Therefore, the remote controller 123 can be used for operations on the passenger's seat use display image, but cannot be used for operations on the driver's seat use display image. Further, the control unit 100 of the display device 20 is configured to recognize operations on the touch panel provided at the display unit 4 as being operations on the passenger's seat use display image.

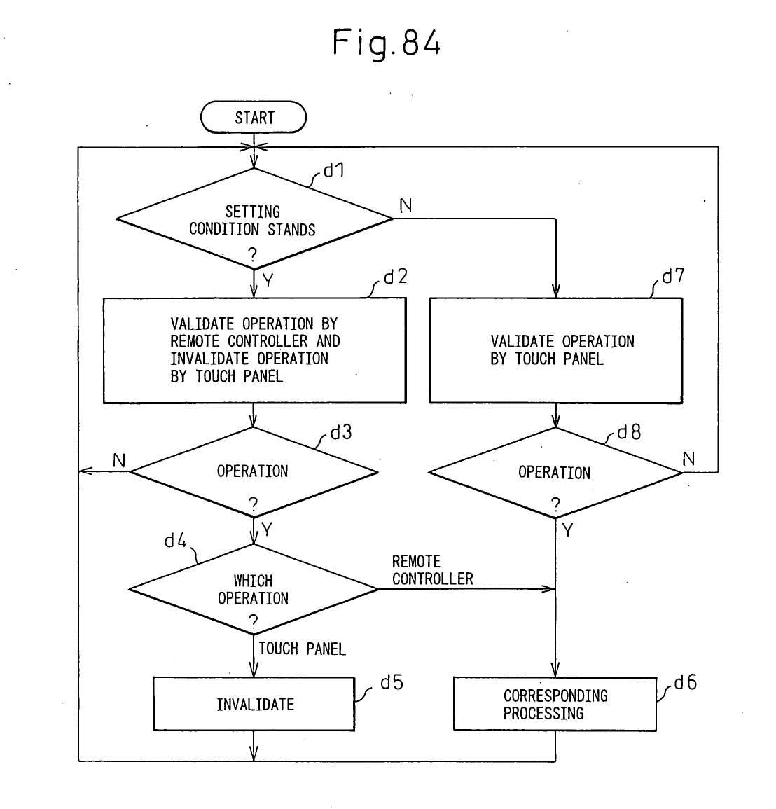

FIG. 84 is a flowchart for explaining the content of control in the embodiment (15). This control is control performed in the state where the display device 20 is performing a split display. Further, the flow of this flowchart is repeated until the split display is terminated. First, it is judged if the valid operation setting condition for invalidating operations on the driver's seat use display image and validating operations on the passenger's seat use display image stands (step d1). When the valid operation setting condition stands, operations by the remote controller 123 are validated and operations by the touch panel are invalidated (step d2). The processing for invalidation may be realized by the control unit 100 of the display device 20 not performing operational control corresponding to the operation on the touch panel 118, that is, an operation on the driver's seat use display image, when the touch panel 118 of the display unit 4 is operated.

When the viewer operates the remote controller 123 or touch panel of the display unit 4, the fact of the operation is recognized by the control unit 100 of the display device 20 (step d3), then it is judged at the control unit 100 if the operation is an operation by the remote controller 123 or an operation by the touch panel (step d4). When an operation on the touch panel, the control unit 100 does not perform operational control corresponding to the operation (step d5). On the other hand, when an operation by the remote controller 123, the control unit 100 performs operational control corresponding to the operation (step d6). Next, the processing returns to step d1.

Further, when the valid operation setting condition does not stand, operations on the touch panel are validated and operations by the remote controller 123 and operations by the touch panel are validated (step d7). When the viewer operates the remote controller 123 or touch panel 118 of the display unit 4, the fact of the operation is recognized by the control unit 100 of the display device 20 (step d8), then the control unit 100 performs operational control for the performed operation (step d6). Next, the processing returns to step d1.

According to the embodiment (15), the following effects can be obtained.

(1) In the embodiment, the operations on the passenger's seat use display image are performed by the remote controller 123 and the operations on the driver's seat use display image are performed by the touch panel 118 of the display unit 4, so it is possible to immediately perform operations on the two display images without a mode switching mode like in the first and embodiment (13). Therefore, the operability of the remote controller 123 can be improved.

(2) If making the valid operation setting condition for invalidating operations on the driver's seat use display image and validating operations on the passenger's seat use display image the state where the driver should concentrate on driving, when the driver should concentrate on driving, operations on the driver's seat use display image are invalidated and operation becomes impossible. Due to this, the driver can be kept from being distracted by operation of the touch panel and the safety during driving can be improved. Further, an individual other than the driver, for example, the passenger's seat passenger, can operate the remote controller 123 for the desired operational control, so enjoyable operation becomes possible.

In the embodiment (15), it is possible to report to the viewer that operation at the remote controller 123 on the passenger's seat use display image is possible. The method of report may be to display on the display unit 43 of the remote controller 123 words or predetermined characters indicating that operation on the passenger's seat use display image is possible. Due to this, operation on the driver's seat use display image by the viewer mistakenly operating the remote controller 123 can be suppressed and the operability of the remote controller 123 can be improved.

Below, an AV navigation system employing the display device according to the embodiment (16) of the present invention will be explained.

In the embodiment (16), the positional relationship between the display device 20 and remote controller 123 in the state where a split display is performed is judged. Based on the positional relationship, it is judged which operation input of the first display image (passenger's seat side display image) 6 and second display image (driver's seat side display image) 5 the viewer desires and operational control at the remote controller 123 is executed or prohibited. Note that in the embodiment (16), the control system itself including the display device 20 and remote controller 123 is similar to that of the embodiment (12).

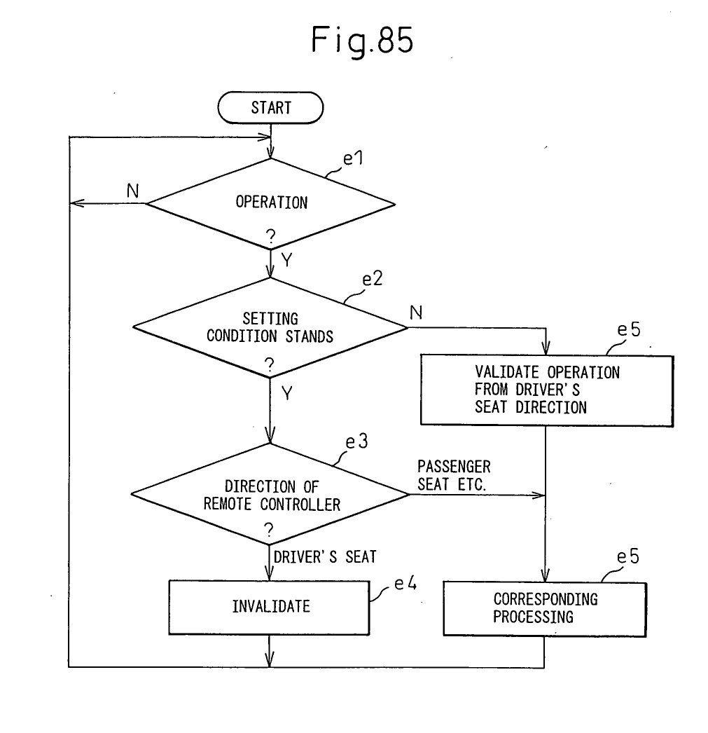

FIG. 85 is a flowchart for explaining the content of control in the embodiment (16). This control is control performed in the state where the display device 20 is performing a split display. Further, the flow of the flowchart is repeated until the split display is terminated. First, it is judged if the viewer has operated the remote controller 123 (step e1). When the remote controller 123 is operated, it is judged if a valid operation setting condition for invalidating operations on the driver's seat use display image and validating operations on the passenger's seat use display image stands (step e2).

When the valid operation setting condition stands, the direction in which the remote controller 123 is present with respect to the display device 20 is detected (step e3). When the direction in which the remote controller 123 is present is the driver's seat direction, operations by the remote controller 123 are invalidated (step e4). The processing for invalidation may be realized by the control unit 100 of the display device 20 not performing operational control in accordance with operation signals.

On the other hand, when the direction in which the remote controller 123 is present is the passenger's seat direction or another direction (for example, the rear seat direction), the control unit 100 performs operational control corresponding to the operation performed at the remote controller 123 (step e5).

Further, at step e2, when the valid operation setting condition does not stand, operations from the driver's seat direction are validated, all operations are validated regardless of the direction in which the remote controller 123 is present (step e6), and the control unit 100 performs operational control corresponding to the operation performed at the remote controller 123 (step e5).

As the method for direction of the direction in which the remote controller 123 is present with respect to the display device 20, for example, the following detection methods may be used.

1) When the display device 20 receives an operation signal from the remote controller 123, it detects from which direction the received operation signal was emitted.

2) A position detection device for detecting in which direction the remote controller 123 is positioned with respect to the display device 20 is provided at the remote controller 123. The remote controller 123 transmits the position information detected by the position detection device superposed on the operation signal to the display device 20. The control unit 100 of the display device 20 detects the direction in which the remote controller 123 is present based on the received position information.

3) A position detection device detecting in which direction the remote controller 123 is positioned with respect to the display device 20 is provided at the remote controller 123. The remote controller 123 changes the signal transmitted in accordance with the position information detected by the position detection device and transmits the operation signal to the display device 20. The control unit 100 of the display device 20 detects the direction in which the remote controller 123 is present based on the mode of the received operation signal. The “mode of the signal” is the frequency, added code information, etc. For example, the method of changing the transmission frequency or changing the added code information between the case where the remote controller 123 is present in the driver's seat direction and the case where it is present in the passenger's seat direction may be used.

4) A position detection device detecting in which direction the remote controller 123 is present with respect to the display device 20 is provided at the remote controller 123. The remote controller 123 changes the type of the signal transmitted in accordance with the position information detected by the position detection device and transmits the operation signal to the display device 20. The control unit 100 of the display device 20 detects the direction in which the remote controller 123 is present based on the type of the received operation signal. The “type of the signal” is light, infrared rays, radio waves, etc. For example, the method of transmitting the signal by light when the remote controller 123 is present in the driver's seat direction and transmitting it by infrared rays when it is present in the passenger's seat direction may be used.

According to the embodiment (16), the following effects can be obtained.

(1) In the embodiment, it is possible to detect the direction in which the remote controller 123 is present with respect to the display device 20 and perform operational control in accordance with an operation on the driver's seat use display image or operation on the passenger's seat use display image in accordance with the detection direction. Therefore, operations on the two display images displayed at the display device 20 can be suitably performed by a single remote controller 123.

(2) If making the valid operation setting condition for invalidating operations on the driver's seat use display image and validating operations on the passenger's seat use display image the state where the driver should concentrate on driving, when the driver should concentrate on driving, operations on the driver's seat use display image are invalidated and operation becomes impossible. Due to this, the driver can be kept from being distracted by operation of the remote controller 123 and the safety during driving can be improved. Further, an individual other than the driver, for example, the passenger's seat passenger, can operate the remote controller 123 for the desired operational control, so enjoyable operation becomes possible. Further, an individual other than the driver can operate the remote controller 123 in place of the driver.

In the embodiment (16), the processing for invalidating the operation by the remote controller 123 may also be performed by the control unit 123 of the remote controller 123 not transmitting an operation signal to the display device 20. In this case, the load of the control unit 100 of the display device 20 can be lightened.

Further, in the embodiment (16), it is also possible to report to the viewer that operations on the driver's seat use display image are invalidated and operations on the passenger's seat use display image are validated. The method of report may be the display of words or predetermined characters on the display unit 53 of the remote controller 123 that operations on the driver's seat use display image are invalidated. Due to this, the viewer can easily learn whether it is possible to operate the remote controller 123 to control various types of equipment.

Note that the embodiment (16) may also be executed in combination with the above-mentioned embodiments (12) to (14). That is, control for invalidating operations on the driver's seat use display image performed by the remote controller 123 when the valid operation setting condition does not stand like in the embodiments (12) to (14) and control for invalidating the operation when the remote controller 123 is operated from the driver's seat direction like in the embodiment (16) may be combined.

Further, in the embodiments (12), (13), and (16), it is preferable to report to the viewer whether the image source for a viewing direction can be operated on by the remote controller at that point of time. The report may be made by displaying on the display unit 53 of the remote controller 123 predetermined words, symbols, or characters indicating an operable mode at the present (mode in which operation by the remote controller is possible). By this method, the viewer can confirm the operable mode at the present by just viewing the remote controller 123. Note that the predetermined words, symbols, or characters indicating an operable mode at the present (mode in which operation by the remote controller is possible) may also be displayed on a screen for all viewing directions of the display unit 4 of the display device 20.

Further, in the embodiments (12), (13), and (16), it is preferable to report to the viewer the switching of the image source for the viewing direction able to be operated on by the remote controller (change from the DR mode to the PA mode, from the PA mode to the DR mode, etc.) The report may be performed by displaying on the display unit 53 of the remote controller 123 predetermined words, symbols, or characteristics indicating “switching”. By this method, the viewer can confirm the occurrence of “switching” by just viewing the remote controller 123. Note that the predetermined words, symbols, or characters indicating “switching” may also be displayed on a screen for all viewing directions of the display unit 4 of the display device 20.

In the embodiments (12) to (16), as shown in FIG. 73, the case of utilizing a remote controller 123 having a remote controller side display unit 53 was explained. However, the present invention can also be applied to a remote controller not having any remote controller side display unit 53. For example, in the case of the embodiment 1, it is possible to prepare a mode setting button and a group of buttons common to all modes and utilize the common buttons in accordance with the mode setting. Note that when set to a specific mode (for example, DR mode), control signals relating to buttons not utilized for that mode may be prevented from being output from the remote controller or may be made to be judged invalid at the display device 20 side.

(APPENDED NOTE)

1. A display device comprising:
a displaying means for displaying individual information for a plurality of viewing directions on the common screen;
an operation input means for receiving operation input;
an input direction judging means for judging which information among said individually displayed information corresponds to said operation input; and
a limiting means for limiting information receiving said operation input based on the results of judgment of said input direction judging means.

2. A display device comprising:
a displaying means for displaying individual information for a plurality of viewing directions on the common screen;
a first operation input means arranged in a first region and receiving operation input corresponding to first information in said individually displayed information; and
a second operation input means arranged in a second region not overlapping said first region and receiving operation input corresponding to second information in said individually displayed information.

3. The display device according to note 2, wherein said first operation input means and said second operation input means are constituted as a touch panel, said second region is close to said first region, the layout of said second operation inputting means on said screen is substantially the same as the layout of said first operation input means on said screen.

4. The display device according to note 2 or 3, further comprising:
an input direction judging means for judging which information among said individually displayed information corresponds to said operation input; and
an execution controlling means for not allowing execution of operational control in accordance with the operation input corresponding to information displayed for a direction different from a certain specific viewing direction when said input direction judging means judges that said operation input is one corresponding to information displayed for said certain specific viewing direction.

5. The display device according to any one of notes 2 to 4 wherein said input direction judging unit judges which information among said individually displayed information corresponds to said operation input based on the contact area of a contact object on said first operation inputting means and said second operation inputting means.

6. The display device according to any one of notes 1 to 4, further comprising a plurality of detecting unit provided in a direction perpendicular to said screen and detecting an object approaching said screen, and wherein
said input direction judging means judges which information among said individually displayed information corresponds to said operation input based on information obtained from said detecting unit.

7. The display device according to any one of notes 1 to 4, further comprising a detecting means for detecting an object approaching said screen from a certain direction, and wherein
said input direction judging means judges which information among said individually displayed information corresponds to said operation input based on information obtained from said detecting means.

8. The display device according to any one of notes 1 to 4, further comprising a calculating means for calculating a direction of a finger touching said screen, and wherein
said input direction judging means judges which information among said individually displayed information corresponds to said operation input based on the direction of a finger touching said screen calculated by said calculating means.

9. The display device according to note 8, further comprising a determining means for determining a method of a finger touching said screen, and wherein
said input direction calculating means judges which information among said individually displayed information corresponds to said operation input considering said method of a finger touching said screen determined by said determining means.

10. The display device according to note 9, wherein said determining means determines said method of a finger touching said screen based on one of a size of contact area of a finger on said screen, a change of contact area of a finger on said screen, a method of application of pressure to said screen, and information registered in advance.

11. The display device according to any one of notes 1 to 10, wherein said calculating means finds an approximation line from a set of points touching said screen so as to calculate a direction of a finger touching said screen.

12. The display device according to any one of notes 1 to 4, further comprising a calculating means for calculating a direction of a fingerprint touching said screen, and wherein
said input direction judging means judges which information among said individually displayed information corresponds to said operation input based on the direction of a fingerprint touching said screen calculated by said calculating means.

13. The display device according to any one of notes 5 to 12 wherein
said input direction judging means judges which information among said individually displayed information corresponds to said operation input based on past results of judgment when said input direction judgment means cannot be judged which information among said individually displayed information corresponds to said operation input.

14. The display device according to any one of notes 5 to 13, wherein
individual information are displayed on the common screen for at least a direction in which the driver is present and a direction in which the passenger's seat passenger is present,
said input direction judging means judges if said operation input is one corresponding to information displayed for the direction in which the driver is present or one corresponding to information displayed for the direction in which the passenger seat passenger is present; and
further comprising a switching means for switching said judgment by said input direction judging means between left and right based on a steering wheel mounting position of the car.

15. A display device comprising:
a displaying means for displaying individual information for a plurality of viewing directions on the common screen;
an operation inputting means for receiving operation input; and
a confirmation information requesting means for requesting input of confirmation information for said operation input.

16. The display device according to note 15, further comprising a reporting means for reporting a content of control in accordance with said operation input.

17. The display device according to note 15 or 16, wherein said confirmation information input confirms said operation input.

18. The display device according to note 17, further comprising an execution controlling means for allowing execution of operational control in accordance with the operation input corresponding to information displayed for a certain viewing direction,
when receiving input of a confirmation operation of said operation input corresponding to information displayed for said certain viewing direction while an opportunity for input of said confirmation information is provided.

19. The display device according to note 15 or 16 wherein said confirmation information input cancels said operation input.

20. The display device according to note 19, further comprising an execution controlling means for allowing execution of operational control in accordance with the operation input corresponding to information displayed for a viewing direction different from a certain viewing direction,
when receiving input of a cancellation operation of said operation input corresponding to information displayed for said certain viewing direction while an opportunity for input of said confirmation information is provided.

21. A display device comprising:
a displaying means for displaying individual information for a plurality of viewing directions on the common screen; and
an execution controlling means for allowing execution of operational control corresponding to information displayed not for a viewing direction different from a certain specific viewing direction, but for said certain specific viewing direction based on information obtained from a certain operation device.

22. A display device comprising:
a display unit displaying individual display images for a plurality of viewing directions on the common screen;
an operation inputting unit provided at said display unit; and
a control unit for adjusting the display position of an operation input image showing an operation input position of said operation input unit for each viewing direction displayed on said display unit.

23. The display device according to note 22 wherein said control unit adjusts a display position of said operation input image so that display positions of said operation input images corresponding to the viewing directions do not overlap on said display unit.

24. The display device according to note 22 or 23 wherein said control unit adjusts the display position of another operation input image corresponding to another viewing direction in said plurality of viewing directions in accordance with the display position of the operation input image corresponding to one viewing direction in said plurality of viewing directions.

25. The display device according to note 22 wherein said control unit adjusts a display position of an operation input image corresponding to one viewing direction in said plurality of viewing directions and a display position of another operation input image corresponding to another viewing direction in said plurality of viewing directions.

26. The display device according to any one of notes 22 to 25, further comprising an operator identifying unit for identifying an operator, and wherein
said control unit adjusts the display position of said operation input image based on the identification result of said operator identifying unit.

27. The display device according to any one of notes 22 to 26, wherein said control unit adjusts the display position of said operation input image in accordance with the source corresponding to said display image.

28. The display device according to any one of notes 22 to 27, further comprising a selection unit for selecting a specific pattern from operation input position patterns predetermining display positions of a plurality of operation input images, and wherein
said control unit adjusts the display position of an operation input image based on the pattern selected by said selection unit.

29. The display device according to any one of notes 22 to 28, further comprising a registration unit for registering a display position of an operation input image independently for each viewing direction.

30. The display device according to note 29, further comprising a setting unit for setting a display position of said operation input image based on a display position of the operation input image registered in said registration unit.

31. A method for customizing an operation input image in a display device displaying individual display images for a plurality of viewing directions on the common screen and displaying operation input images showing operation input positions for different viewing directions, the method comprising the steps of:
adjusting the display position of the operation input image; and
registering the adjusted display position.

32. The method according to note 31, wherein said adjustment step comprising the steps of:
specifying specification information specifying at least one of source information and an operator corresponding to the viewing direction and display image; and
adjusting the display position of the operation input image step linked with the specified specification information, and wherein
said registration step registers the adjusted display position of the operation input image linked with the specified specification information.

33. The method according to note 31 or 32, further comprising the steps of reporting when the adjusted display position of the operation input image overlaps the display position of an operation input image for another viewing direction.

34. A method for setting an operation input image in a display device displaying individual display images for a plurality of viewing directions on the common screen and displaying operation input images showing operation input positions for different viewing directions, the method comprising the steps of:
specifying specification information specifying at least one of source information and an operator corresponding to the viewing direction and display image; and
setting the operation input image to a prestored display position of the operation input image corresponding to the specified specification information.

35. The method according to note 34, wherein said setting step includes a movement step of moving a display position of the operation input image for at least one viewing direction when the display position of the operation input image for one viewing direction and the display position of the operation input image for another viewing direction overlap.

36. The method according to note 34, wherein said setting step includes a reporting step of reporting when the display position of the operation input image for one viewing direction and the display position of the operation input image for another viewing direction overlap.

37. A control system comprising:
a display device having a display unit displaying individual display images for a plurality of viewing directions on the common screen;
a remote control device for outputting to the display device a control signal for controlling a plurality of signal sources corresponding to the individual display images for a plurality of viewing directions and remotely controlling the display device;
a setting unit for setting a specific signal source in the plurality of signal sources; and
a control unit for controlling the signal source set by the setting unit based on the control signal.

38. The control system according to note 37, wherein said control unit is provided at said remote control device and said setting unit is provided at said remote control system.

39. The control system according to note 37, wherein said control unit is provided at said display device and said setting unit is provided at said remote control device.

40. The control system according to note 37, wherein said control unit is provided at said remote control device and said setting unit is provided at said display device.

41. The control system according to note 37, wherein said control unit is provided at said display device and said setting unit is provided at said display device.

42. The control system according to any one of notes 38 to 41, further comprising:
a condition judgment unit judging if a condition invalidating control of a signal source corresponding to the display image for a specific viewing direction among the plurality of viewing directions stands; and
a setting control unit controlling the setting by the setting unit based on the results of judgment of the condition judgment unit.

43. The control system according to note 43, wherein said condition setting unit and said setting control unit are provided at said remote control device.

44. The control system according to note 43, wherein said condition setting unit and said setting control unit are provided at said display device.

45. The control system according to any one of notes 42 to 44, further comprising a termination unit for terminating control by said setting control unit.

46. A control system comprising:
a display device having a display unit displaying individual display images for a plurality of viewing directions on the common screen;
a remote control device for outputting to the display device a control signal for controlling a plurality of signal sources corresponding to individual display images for a plurality of viewing directions and remotely controlling the display device;
a display switch unit for switching from common screen display of the plurality of display images of the individual display images for the plurality of viewing directions to a single screen display of only a predetermined single display image among the individual display images for the plurality of viewing directions; and
a control unit for controlling the signal source corresponding to the predetermined single display image switched by the display switch unit based on the control signal.

47. The control system according to note 46, wherein said control unit is provided at said remote control device and said display switch unit is provided at said remote control device.

48. The control system according to note 46, wherein said control unit is provided at said display device and said display switch unit is provided at said remote control device.

49. The control system according to note 46, wherein said control unit is provided at said remote control system and said display switch unit is provided at said display device.

50. The control system according to note 46, wherein said control unit is provided at said display device and said display switch unit is provided at said display device.

51. The control system according to any one of notes 47 to 50, further comprising:
a condition judgment unit for judging if a condition invalidating control of a signal source corresponding to the display image for a specific viewing direction among the plurality of viewing directions stands; and
a switching control unit for controlling the switching by said display switching unit based on the results of judgment of the condition judgment unit.

52. The control system according to note 51, wherein said condition setting unit and said switching control unit are provided at said remote control device.

53. The control system according to note 51, wherein said condition setting unit and said switching control unit are provided at said display device.

54. The control system according to any of notes 51 to 53, further comprising a termination unit for terminating control by said switching control unit.

55. A control system comprising:
a display device having a display unit displaying individual display images for a plurality of viewing directions on the common screen;
a remote control device having a plurality of operation input units corresponding to a plurality of signal sources corresponding to individual display images for the plurality of viewing directions, a control signal generation unit generating control signals corresponding to the plurality of operation input units, and an output unit outputting the control signals to the display device and remotely controlling the display device; and
a control unit for controlling the plurality of signal sources based on the control signals.

56. The control system according to note 55, wherein said control unit is provided at said display device.

57. The control system according to note 55, wherein said control unit is provided at said remote control system.

58. A control system comprising:
a display device having a display unit displaying individual display images for a plurality of viewing directions on the common screen and an operating unit outputting a control signal for a single signal source corresponding to a display image for a single viewing direction among the plurality of viewing directions; and
a remote control device for outputting control signals for other signal sources corresponding to the display images for the other viewing directions among the plurality of viewing directions.

59. A control system comprising:
a display device having a display device displaying individual display images for a plurality of viewing directions on the common screen;
a remote control device for outputting control signals for controlling a plurality of signal sources corresponding to the individual display images for a plurality of viewing directions to the display device and remotely controlling the display device;
a remote control direction detection unit for detecting a direction in which the remote control device is present; and
a control unit for controlling the signal sources corresponding to the results of detection of the remote control direction detection unit based on the control signals.

60. The control system according to note 59, wherein said remote control direction detection unit is provided at said remote control device or display device.

61. The control system according to note 59, wherein said remote control direction detection unit is provided at said display device.

What is claimed is:

1. A display device comprising:
a display unit for displaying individual information for a plurality of viewing directions on a common screen;
an operation input unit for receiving an operation input;
an input direction judgment unit for judging which information among said individually displayed information corresponds to said operation input; and
a control unit for performing control based on the results of judgment of said input direction judgment unit.

2. The display device according to claim 1, wherein said control unit includes a limiting unit for limiting an information receiving said operation input based on the results of judgment by said input direction judgment unit.

3. The display device according to claim 1, wherein said operation input unit includes a first operation input unit arranged in a first region and receiving an operation input corresponding to a first information among said individually displayed information, and a second operation input unit arranged in a second region not overlapping with said first region and receiving an operation input corresponding to a second information among said individually displayed information.

4. The display device according to claim 3, wherein said first operation input unit and said second operation input unit are constituted as a touch panel, said second region is close to said first region, and the layout of said second operation input unit on said screen is substantially the same as the layout of said first operation input unit on said screen.

5. The display device according to claim 1, wherein said control unit includes an execution control unit for not allowing execution of operational control in accordance with said operation input corresponding to information displayed for a direction different from a certain specific viewing direction when said input direction judgment unit judges that said operation input corresponds to information displayed for said certain specific viewing direction.

6. The display device according to claim 3, wherein said input direction judgment unit judges which information among said individually displayed information corresponds to said operation input based on the contact area of a contact object with said first operation input unit and said second operation input unit.

7. The display device according to claim 1, further comprising a plurality of detection units provided in a direction perpendicular to said screen and detecting an object approaching the screen, wherein
said input direction judgment unit judges which information among said individually displayed information corresponds to said operation input based on information obtained from said detection units.

8. The display device according to claim 1, further comprising a detection unit for detecting an object approaching said screen from a certain direction, wherein
said input direction judgment unit judges which information among said individually displayed information corresponds to said operation input based on information obtained from said detection unit.

9. The display device according to claim 1, further comprising a calculation unit for calculating a direction of a finger touching said screen, wherein
said input direction judgment unit judges which information among said individually displayed information corresponds to said operation input based on the direction of the finger touching said screen calculated by said calculation unit.

10. The display device according to claim 1, further comprising a calculation unit for calculating a direction of a fingerprint touching said screen, wherein
said input direction judgment unit judges which information among said individually displayed information corresponds to said operation input based on the direction of the fingerprint touching said screen calculated by said calculation unit.

11. The display device according to claim 1, wherein said input direction judgment unit judges which information among said individually displayed information corresponds to said operation input based on the past results of judgment when said input direction judgment unit cannot judge which information among said individually displayed information corresponds to said operation input.

12. The display device according to claim 1, wherein
individual information for at least the direction in which the driver is present and the direction in which the passenger's seat passenger is present are displayed on the common screen,
said input direction judgment unit judges if said operation input corresponds to information displayed for the direction in which the driver is present or corresponds to information displayed for the direction in which the passenger's seat passenger is present, and
further comprising a switch unit for switching the judgment by said input direction judgment unit to the left or right based on the steering wheel mounting position of the car.

13. The display device according to claim 1, further comprising a confirmation information request unit for requesting input of confirmation information for said operation input.

14. The display device according to claim 13, further comprising a report unit for reporting the content of control according to said operation input.

15. The display device according to claim 13 wherein said confirmation information input confirms said operation input.

16. The display device according to claim 13 wherein said confirmation information input cancels said operation input.

17. The display device according to claim 11 wherein said control unit adjusts the display positions of the operation input images showing the operation input positions of the operation input unit for the different viewing directions displayed on the display unit based on the results of judgment of said input direction judgment unit.

18. The display device according to claim 17 wherein said control unit adjusts the display position of said operation input image so that the display positions of the operation input images corresponding to the different viewing directions do not overlap on the display unit.

19. The display device according to claim 17 wherein said control unit adjusts the display position of another operation input image corresponding to another viewing direction among a plurality of viewing directions in accordance with the display position of an operation input image corresponding to one viewing direction in the plurality of viewing directions.

20. The display device according to claim 17 wherein said control unit adjusts a display position of an operation input image corresponding to one viewing direction in a plurality of viewing directions and a display position of another operation input image corresponding to another viewing direction in the plurality of viewing directions.
